(19) United States
(12) Patent Application Publication
(10) Pub. No.: US 2023/0138065 A1
(43) Pub. Date: May 4, 2023

(54) PROGRAM, INFORMATION PROCESSING METHOD, AND TERMINAL

(71) Applicant: LINE CORPORATION, Tokyo (JP)

(72) Inventors: Ryosuke HAMASAKO, Tokyo (JP); Yosuke MAZAKI, Tokyo (JP)

(73) Assignee: LINE CORPORATION, Tokyo (JP)

(21) Appl. No.: 18/090,888

(22) Filed: Dec. 29, 2022

Related U.S. Application Data
(63) Continuation of application No. PCT/JP2021/022487, filed on Jun. 14, 2021.

(30) Foreign Application Priority Data
Jun. 30, 2020 (JP) 2020-113408
Jun. 30, 2020 (JP) 2020-113409
Jun. 30, 2020 (JP) 2020-113410

(51) Int. Cl. G06Q 20/32; G06Q 20/40

(52) U.S. Cl. CPC G06Q 20/3223; G06Q 20/403

(57) ABSTRACT

An information processing method may be performed by a terminal, and the method may include displaying, on a display of the terminal, at least a first display based on first information relating to a remittance request from a first user to a user of the terminal or a remittance request from a user of the terminal to the first user, and a second display based on second information relating to a remittance request from a second user to the user of the terminal or a remittance request from the user of the terminal to the second user, and performing, by a processor of the terminal, first processing based on the first information and the second information, based on input to the terminal on which the first display and the second display are displayed.

### CROSS-REFERENCE TO RELATED APPLICATION(S)

This application is a bypass continuation of PCT International Application No. PCT/JP2021/022487, which was filed on Jun. 14, 2021, and claims priority to Japanese Patent Application No. JP2020-113408, filed on Jun. 30, 2020, Japanese Patent Application No. JP2020-113409, filed on Jun. 30, 2020, and Japanese Patent Application No. JP2020-113410, filed on Jun. 30, 2020, in the Japanese Intellectual Property Office, the disclosures of which are incorporated herein by reference in their entirety.

### BACKGROUND

### 1. Field

The disclosure relates to an information processing method, program, and a terminal.

### 2. Description of Related Art

Recent years have seen widespread use of services in which an application executable in a terminal such as a smartphone is used to realize the management, transmission/reception, and the like of electronic money by a terminal or the user of a terminal. For example, JP 2002-176671A discloses a technology for making a payment for purchased goods.

### SUMMARY

According to an aspect of the disclosure, an information processing method performed by a terminal includes: displaying, on a display of the terminal, at least a first screen based on first information relating to a remittance request from a first user to a user of the terminal or a remittance request from a user of the terminal to the first user, and a second screen based on second information relating to a remittance request from a second user to the user of the terminal or a remittance request from the user of the terminal to the second user; and based on input to the terminal on which the first screen and the second screen are displayed, performing, by a controller of the terminal, first processing based on the first information and the second information first screen second screen.

According to an aspect of the disclosure, a non-transitory computer readable medium stores computer readable program code or instructions which are executable by a processor to perform a method. The method includes: displaying, on a display of a terminal, at least a first screen based on first information relating to a remittance request from a first user to a user of the terminal or a remittance request from a user of the terminal to the first user, and a second screen based on second information relating to a remittance request from a second user to the user of the terminal or a remittance request from the user of the terminal to the second user; and based on input to the terminal on which the first screen and the second screen are displayed, performing, by a controller of the terminal, first processing based on the first information and the second information first screen second screen.

According to an aspect of the disclosure, a terminal includes: a display configured to display at least a first screen based on first information relating to a remittance request from a first user to a user of the terminal or a remittance request from a user of the terminal to the first user, and a second screen based on second information relating to a remittance request from a second user to the user of the terminal or a remittance request from the user of the terminal to the second user; and a controller configured to perform first processing based on input to the terminal on which the first screen and the second screen are displayed, the first processing being based on the first information and the second information.

### BRIEF DESCRIPTION OF DRAWINGS

The above and other aspects, features and advantages of certain embodiments of the present disclosure will be more apparent from the following description taken in conjunction with the accompanying drawings, in which:

FIG. 1-1 is a diagram showing an example of a configuration of a communication system according to an embodiment;

FIG. 1-2 is a diagram showing an example of functions implemented by a controller of a server according to a first embodiment;

FIG. 1-3 is a diagram showing an example of information stored in a storage device of the server according to the first embodiment;

FIG. 1-4 is diagram showing an example of user registration data according to the first embodiment;

FIG. 1-5 is a diagram showing an example of a user management database according to the first embodiment;

FIG. 1-6 is a diagram showing an example of remittance request management data according to the first embodiment;

FIG. 1-7 is a diagram showing an example of functions realized by a controller of the terminal according to the first embodiment;

FIG. 1-8 is diagram showing an example of information stored in a storage device of the terminal according to the first embodiment;

FIG. 1-9 is a diagram showing an example of a display screen of the terminal according to the first embodiment;

FIG. 1-10 is a diagram showing an example of the display screen of the terminal according to the first embodiment;

FIG. 1-11 is a diagram showing an example of the display screen of the terminal according to the first embodiment;

FIG. 1-12 is a diagram showing an example of the display screen of the terminal according to the first embodiment;

FIG. 1-13 is a diagram showing an example of the display screen of the terminal according to the first embodiment;

FIG. 1-14 is a diagram showing an example of the display screen of the terminal according to the first embodiment;

FIG. 1-15 is a diagram showing an example of the display screen of the terminal according to the first embodiment;

FIG. 1-16 is a diagram showing an example of the display screen of the terminal according to the first embodiment;

FIG. 1-17 is a diagram showing an example of the display screen of the terminal according to the first embodiment;

FIG. 1-18 is a flow chart showing an example of a flow of processing of the terminal and a server according to the first embodiment;

FIG. 1-19 is a flow chart showing an example of a flow of settlement processing according to the first embodiment;

FIG. 1-20 is a diagram showing an example of a table for describing collective settlement according to the first embodiment;

FIG. 1-21 is a flow chart showing an example of a flow of processing of the terminal and the server according to the first embodiment;

FIG. 1-22 is a flow chart showing an example of a flow of settlement processing according to the first embodiment;

FIG. 1-23 is a diagram showing an example of a display screen of a terminal according to a first modified example;

FIG. 1-24 is a diagram showing an example of the display screen of the terminal according to the first modified example;

FIG. 2-1 is a diagram showing an example of a display screen of a terminal according to a second embodiment;

FIG. 2-2 is a diagram showing an example of the display screen of the terminal according to the second embodiment;

FIG. 2-3 is a diagram showing an example of the display screen of the terminal according to the second embodiment;

FIG. 2-4 is a flow chart showing an example of a flow of processing of the terminal and a server according to the second embodiment;

FIG. 2-5 is a flow chart showing an example of a flow of processing of the terminal and the server according to the second embodiment;

FIG. 3-1 is a diagram showing an example of a display screen of a terminal according to a third embodiment;

FIG. 3-2 is a diagram showing an example of the display screen of the terminal according to the third embodiment;

FIG. 4-1 is a diagram showing an example of a display screen of a terminal according to a fourth embodiment;

FIG. 4-2 is a diagram showing an example of the display screen of the terminal according to the fourth embodiment;

FIG. 5-1 is a diagram showing an example of a display screen of a terminal according to a fifth embodiment;

FIG. 5-2 is a flow chart showing an example of a flow of processing of the terminal and a server according to the fifth embodiment;

FIG. 6-1 is a diagram showing an example of a display screen of a terminal according to a sixth embodiment;

FIG. 6-2 is a diagram showing an example of the display screen of the terminal according to the sixth embodiment;

FIG. 6-3 is a flow chart showing an example of a flow of collective remittance request creation processing according to the sixth embodiment;

FIG. 7-1 is a diagram showing an example of a display screen of a terminal according to a seventh embodiment;

FIG. 7-2 is a diagram showing an example of the display screen of the terminal according to the seventh embodiment;

FIG. 7-3 is a flow chart showing an example of a flow of settlement processing according to the seventh embodiment;

FIG. 7-4 is a flow chart showing an example of a flow of settlement processing according to the seventh embodiment;

FIG. 8-1 is a diagram showing an example of a display screen of a terminal according to an eighth embodiment;

FIG. 8-2 is a diagram showing an example of the display screen of the terminal according to the eighth embodiment;

FIG. 8-3 is a flow chart showing an example of a flow of processing of the terminal and a server according to the eighth embodiment;

FIG. 8-4 is a flow chart showing an example of a flow of processing of a terminal and a server according to an eighth modified example;

FIG. 9-1 is a diagram showing an example of a table for describing collective settlement according to a ninth embodiment;

FIG. 9-2 is a diagram showing an example of a display screen of a terminal according to the ninth embodiment;

FIG. 9-3 is a diagram showing an example of the display screen of the terminal according to the ninth embodiment;

FIG. 9-4 is a diagram showing an example of the display screen of the terminal according to the ninth embodiment;

FIG. 9-5 is a diagram showing an example of the display screen of the terminal according to the ninth embodiment;

FIG. 9-6 is a flow chart showing an example of a flow of processing of the terminal and the server according to the ninth embodiment;

FIG. 10-1 is a diagram showing an example of a display screen of a terminal according to a tenth embodiment;

FIG. 10-2 is a diagram showing an example of the display screen of the terminal according to the tenth embodiment;

FIG. 10-3 is a diagram showing an example of the display screen of the terminal according to the tenth embodiment;

FIG. 10-4 is a diagram showing an example of the display screen of the terminal according to the tenth embodiment;

FIG. 10-5 is a diagram showing an example of the display screen of the terminal according to the tenth embodiment;

FIG. 10-6 is a flow chart showing an example of a flow of processing of the terminal and a server according to the tenth embodiment;

FIG. 11-1 is a diagram showing an example of a display screen of a terminal according to an eleventh embodiment;

FIG. 11-2 is a diagram showing an example of the display screen of the terminal according to the eleventh embodiment;

FIG. 11-3 is a diagram showing an example of the display screen of the terminal according to the eleventh embodiment;

FIG. 11-4 is a diagram showing an example of the display screen of the terminal according to the eleventh embodiment;

FIG. 11-5 is a diagram showing an example of the display screen of the terminal according to the eleventh embodiment;

FIG. 11-6 is a flow chart showing an example of a flow of processing of the terminal and a server according to the eleventh embodiment;

FIG. 12-1 is a diagram showing an example of a display screen of a terminal according to a twelfth embodiment;

FIG. 12-2 is a diagram showing an example of the display screen of the terminal according to the twelfth embodiment;

FIG. 12-3 is a diagram showing an example of the display screen of the terminal according to the twelfth embodiment;

FIG. 12-4 is a diagram showing an example of the display screen of the terminal according to the twelfth embodiment;

FIG. 13-1 is a diagram showing an example of a display screen of a terminal according to a thirteenth embodiment;

FIG. 13-2 is a diagram showing an example of the display screen of the terminal according to the thirteenth embodiment;

FIG. 13-3 is a diagram showing an example of the display screen of the terminal according to the thirteenth embodiment;

FIG. 14-1 is a diagram showing an example of a display screen of a terminal according to a sixteenth embodiment;

FIG. 14-2 is a diagram showing an example of the display screen of the terminal according to the sixteenth embodiment;

FIG. 14-3 is a diagram showing an example of the display screen of the terminal according to the sixteenth embodiment;

FIG. 15-1 is a diagram showing an example of a display screen of a terminal according to a seventeenth embodiment;

FIG. 15-2 is a diagram showing an example of the display screen of the terminal according to the seventeenth embodiment;

FIG. 15-3 is a diagram showing an example of the display screen of the terminal according to the seventeenth embodiment;

FIG. 15-4 is a flow chart showing an example of a flow of processing of the terminal and a server according to the seventeenth embodiment;

FIG. 15-5 is a flow chart showing an example of a flow of processing of the terminal and the server according to the seventeenth embodiment;

FIG. 15-6 is a flow chart showing an example of a flow of processing of a terminal and a server according to a seventeenth modified example;

FIG. 16-1 is a diagram showing an example of a table for describing a processing method according to an eighteenth embodiment;

FIG. 16-2 is a diagram showing an example of a display screen of a terminal according to the eighteenth embodiment;

FIG. 16-3 is a diagram showing an example of the display screen of the terminal according to the eighteenth embodiment;

FIG. 16-4 is a flow chart showing an example of a flow of processing of the terminal and a server according to the eighteenth embodiment;

FIG. 17-1 is a diagram showing an example of a display screen of a terminal according to a nineteenth embodiment;

FIG. 17-2 is a diagram showing an example of the display screen of the terminal according to the nineteenth embodiment;

FIG. 18-1 is a diagram showing an example of a display screen of a terminal according to a twentieth embodiment;

FIG. 18-2 is a diagram showing an example of the display screen of the terminal according to the twentieth embodiment;

FIG. 18-3 is a diagram showing an example of the display screen of the terminal according to the twentieth embodiment;

FIG. 18-4 is a flow chart showing an example of a flow of processing of the terminal and a server according to the twentieth embodiment;

FIG. 19-1 is a diagram showing an example of a display screen of a terminal according to a twenty-first embodiment;

FIG. 19-2 is a diagram showing an example of the display screen of the terminal according to the twenty-first embodiment;

FIG. 19-3 is a diagram showing an example of the display screen of the terminal according to the twenty-first embodiment;

FIG. 19-4 is a flow chart showing an example of a flow of processing of the terminal and a server according to the twenty-first embodiment;

FIG. 20-1 is a diagram showing an example of a display screen of a terminal according to a twenty-second embodiment;

FIG. 20-2 is a diagram showing an example of the display screen of the terminal according to the twenty-second embodiment;

FIG. 20-3 is a diagram showing an example of the display screen of the terminal according to the twenty-second embodiment;

FIG. 20-4 is a diagram showing an example of the display screen of the terminal according to the twenty-second embodiment;

FIG. 21-1 is a diagram showing an example of a display screen of a terminal according to a twenty-sixth embodiment;

FIG. 21-2 is a diagram showing an example of the display screen of the terminal according to the twenty-sixth embodiment;

FIG. 22-1 is a diagram showing an example of a display screen of a terminal according to a twenty-seventh embodiment;

FIG. 22-2 is a diagram showing an example of the display screen of the terminal according to the twenty-seventh embodiment;

FIG. 22-3 is a diagram showing an example of the display screen of the terminal according to the twenty-seventh embodiment; and

FIG. 22-4 is a diagram showing an example of the display screen of the terminal according to the twenty-seventh embodiment.

### DETAILED DESCRIPTION

The embodiments herein and the various features and advantageous details thereof are explained more fully with reference to the non-limiting embodiments that are illustrated in the accompanying drawings and detailed in the following description, where similar reference characters denote corresponding features consistently throughout. Descriptions of well-known components and processing techniques are omitted so as to not unnecessarily obscure the embodiments herein. Also, the various embodiments described herein are not necessarily mutually exclusive, as some embodiments may be combined with one or more other embodiments to form new embodiments. The examples used herein are intended merely to facilitate an understanding of ways in which the embodiments herein may be practiced and to further enable those skilled in the art to practice the embodiments herein. Accordingly, the examples should not be construed as limiting the scope of the embodiments herein.

In the present specification, the expression “via a communication I/F” is used as appropriate. This expression means that a device transmits and receives various types of information and data via the communication I/F (via a communication part) based on control performed by a controller (a processor, etc.), in a non-limiting example.

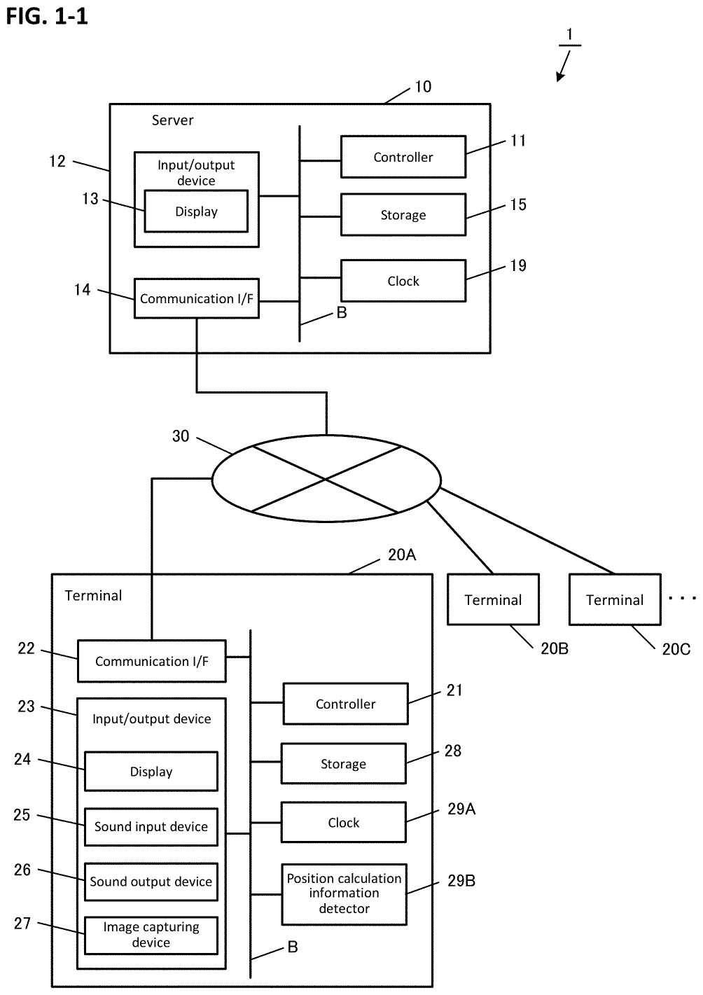

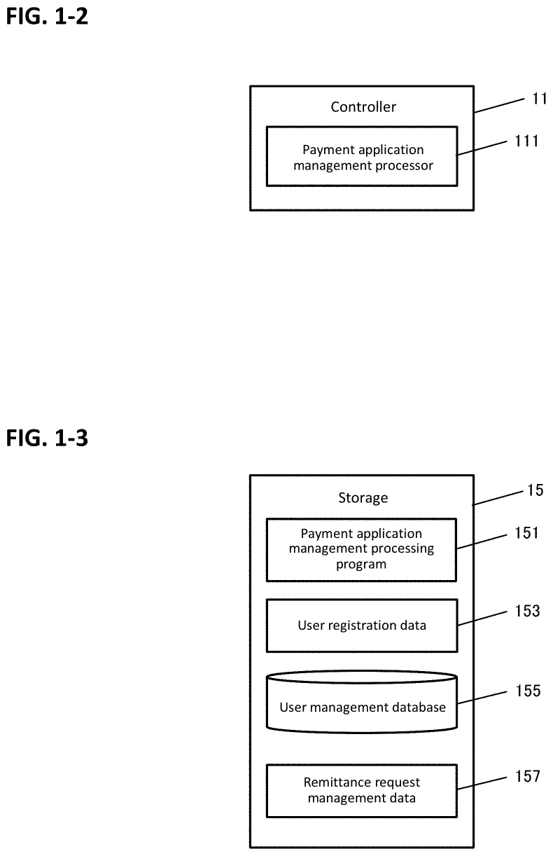

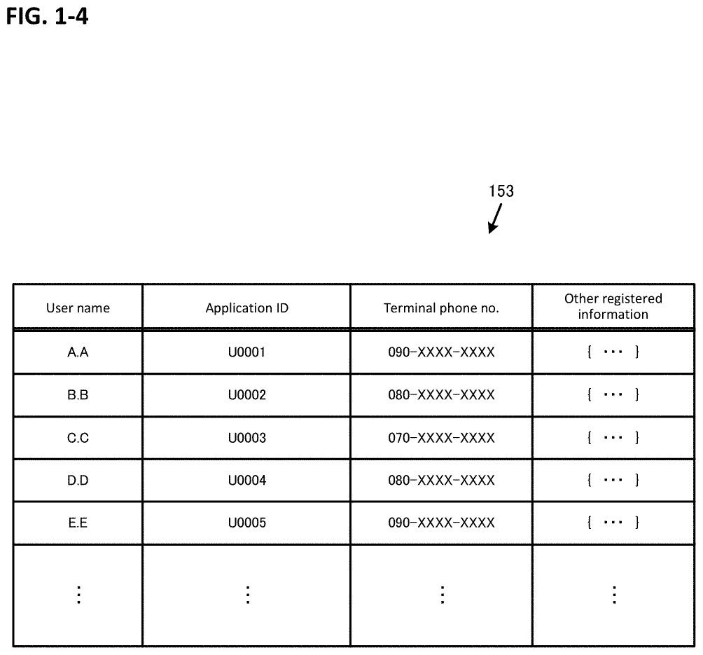

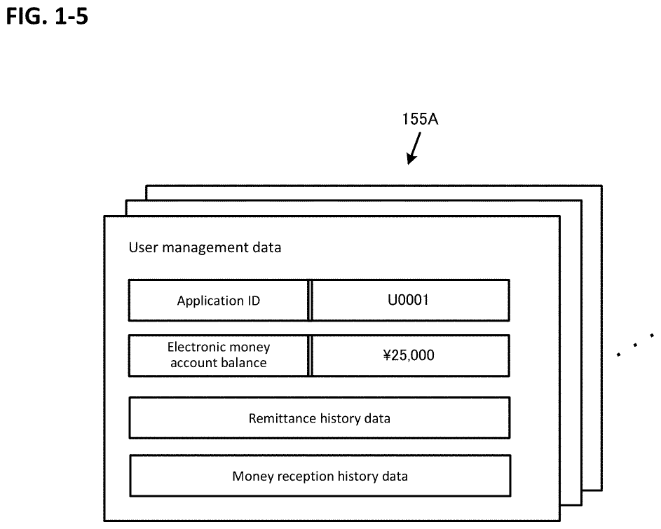

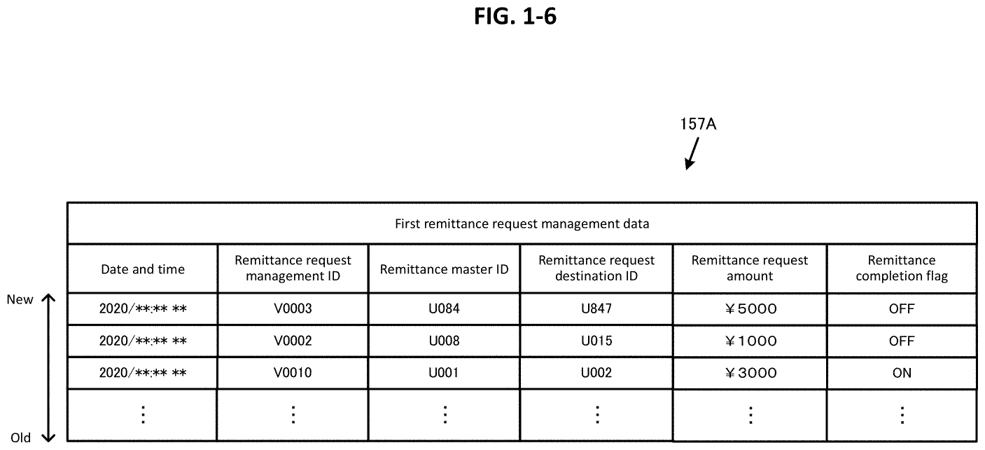

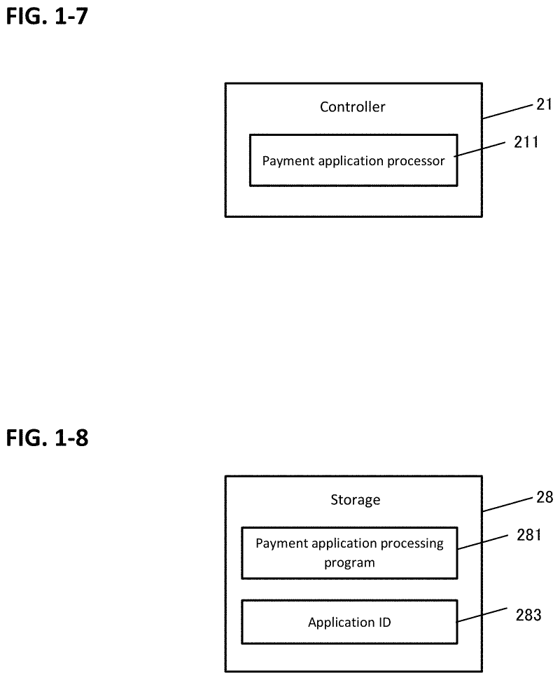

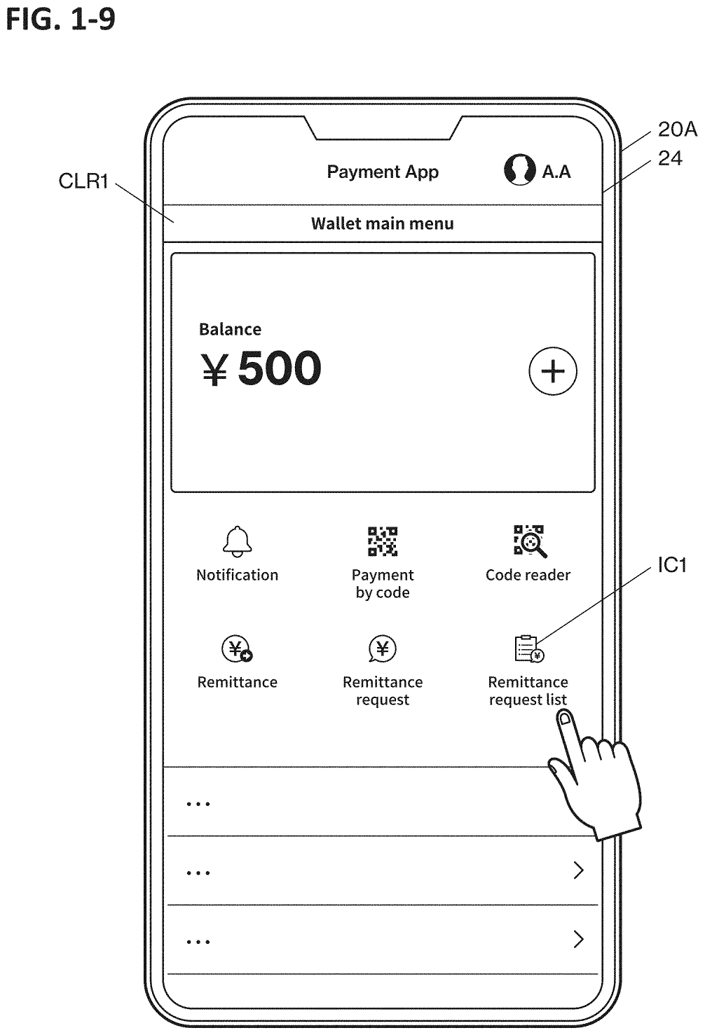

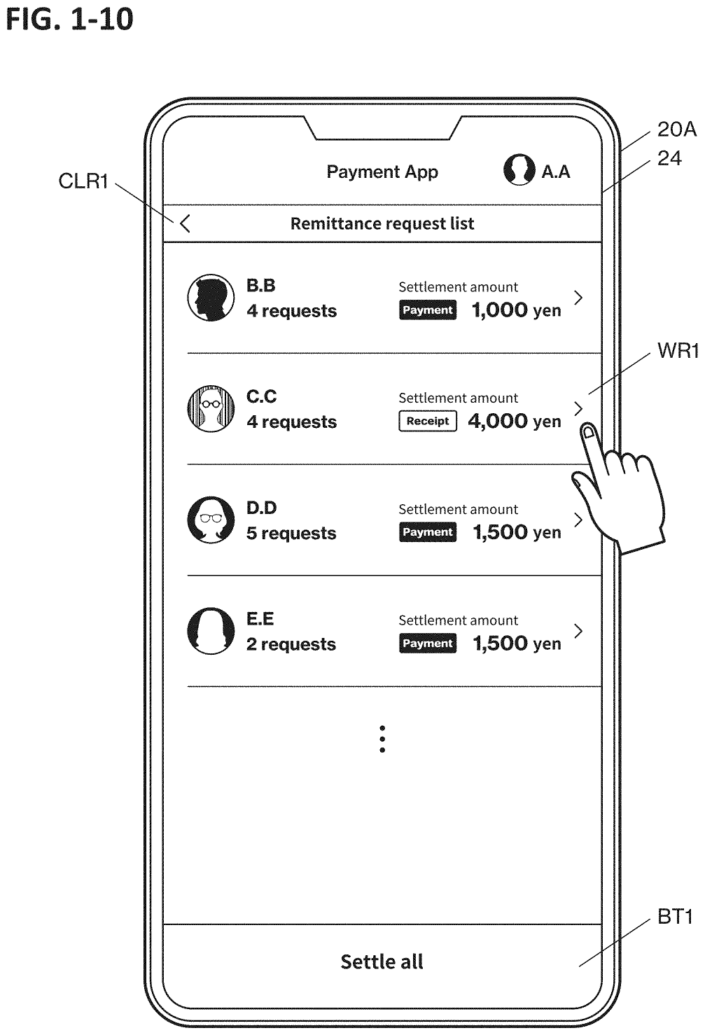

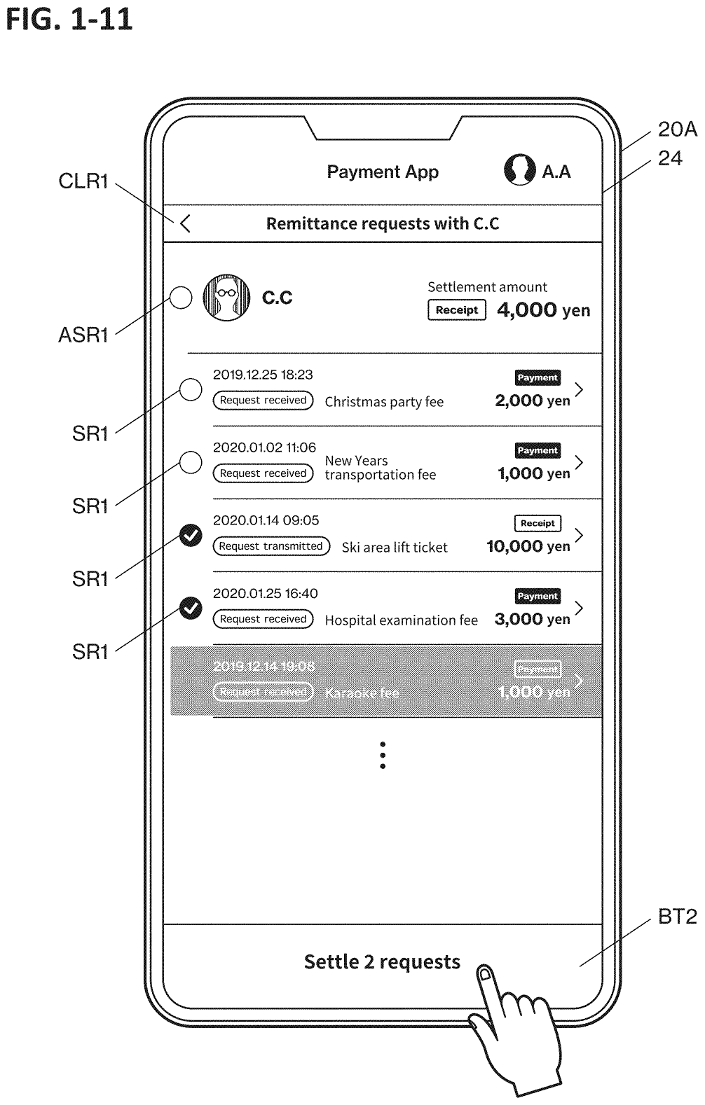

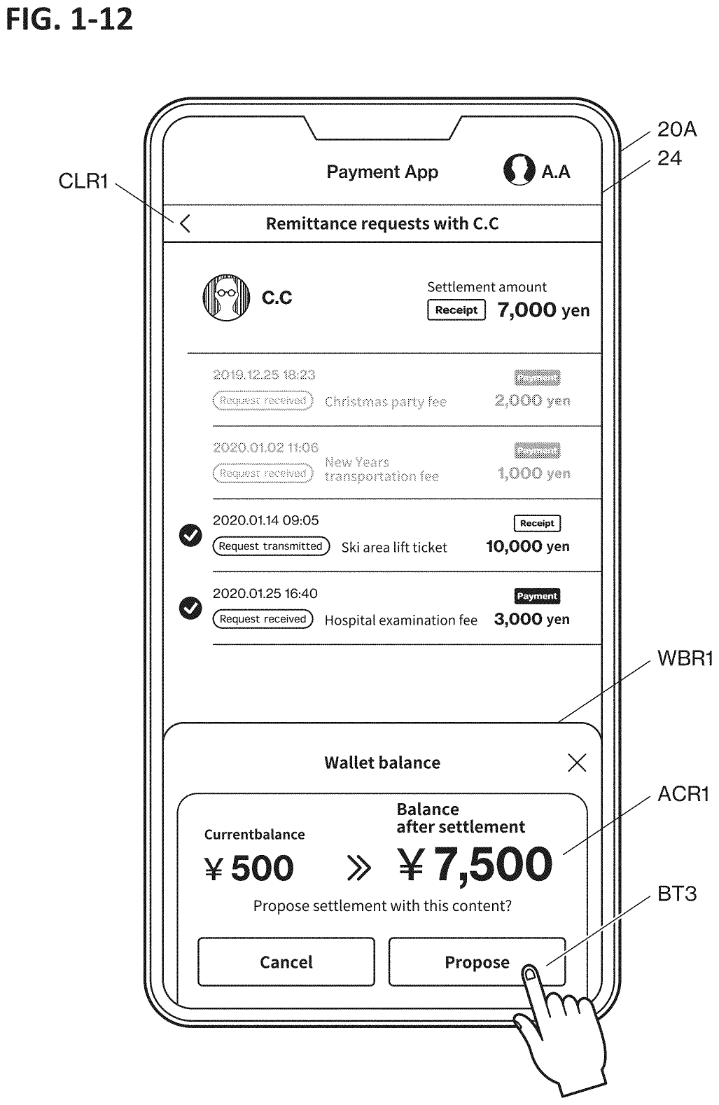

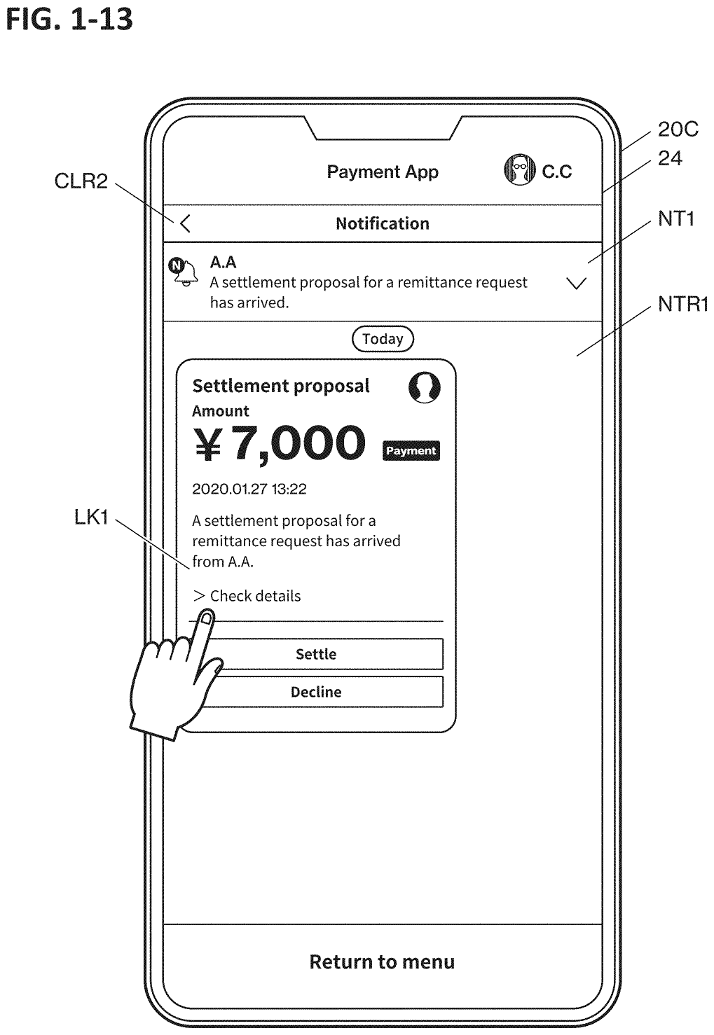

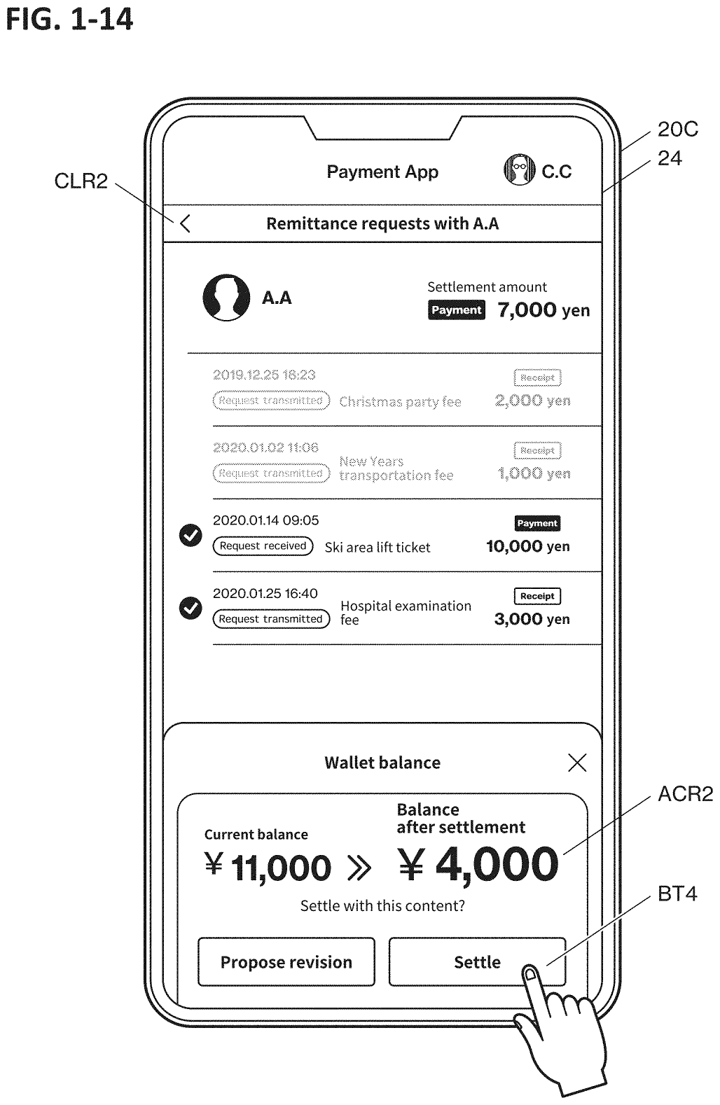

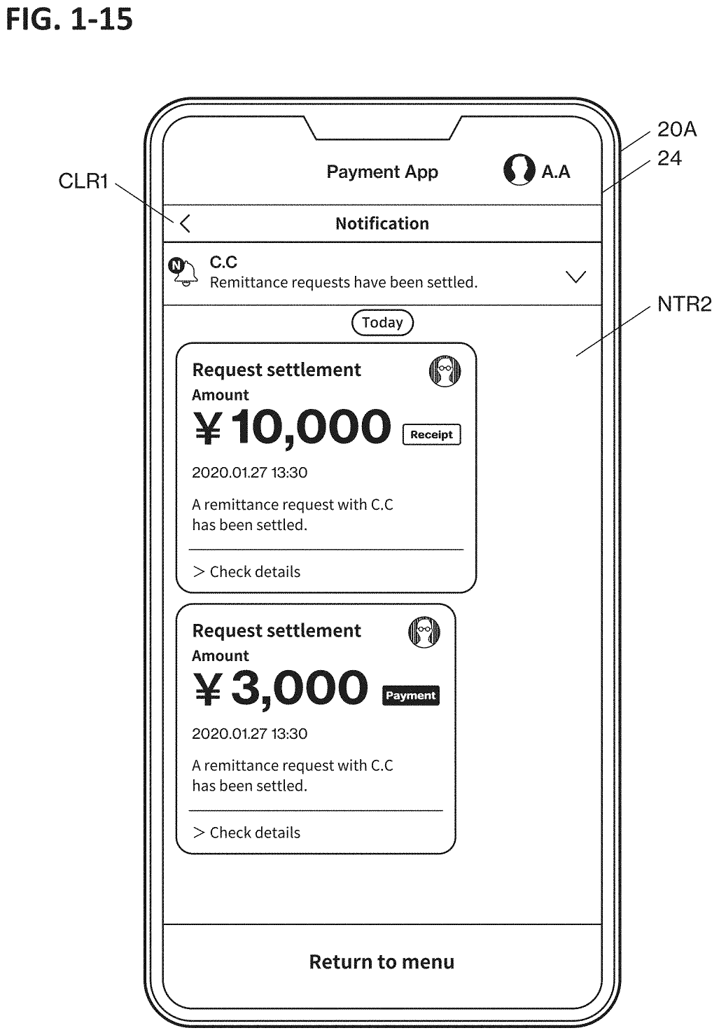

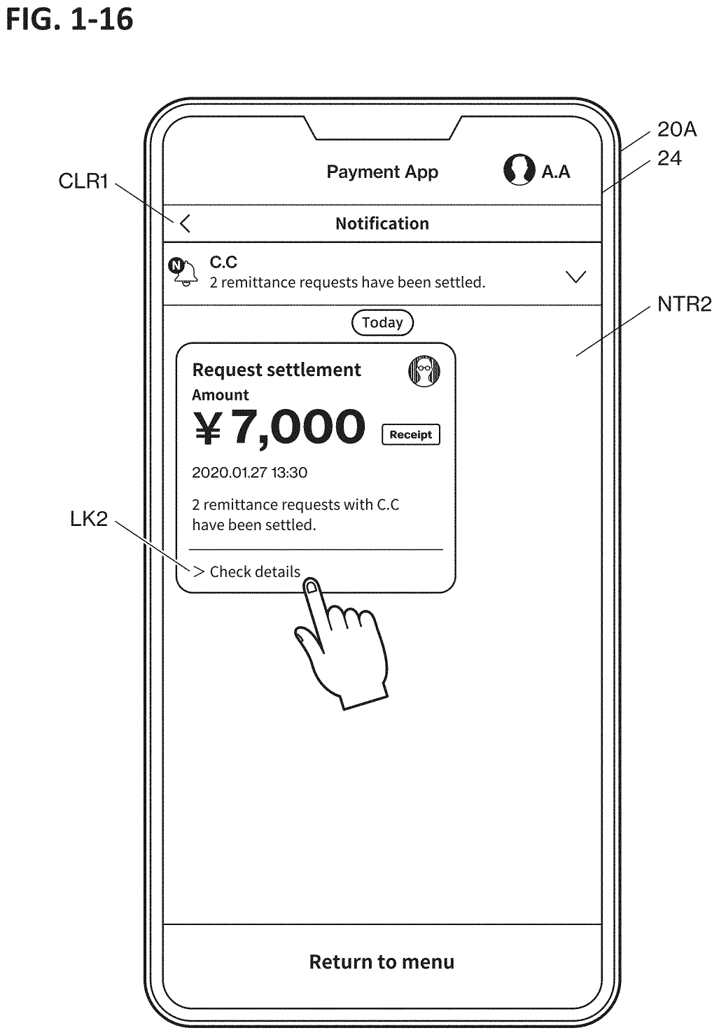

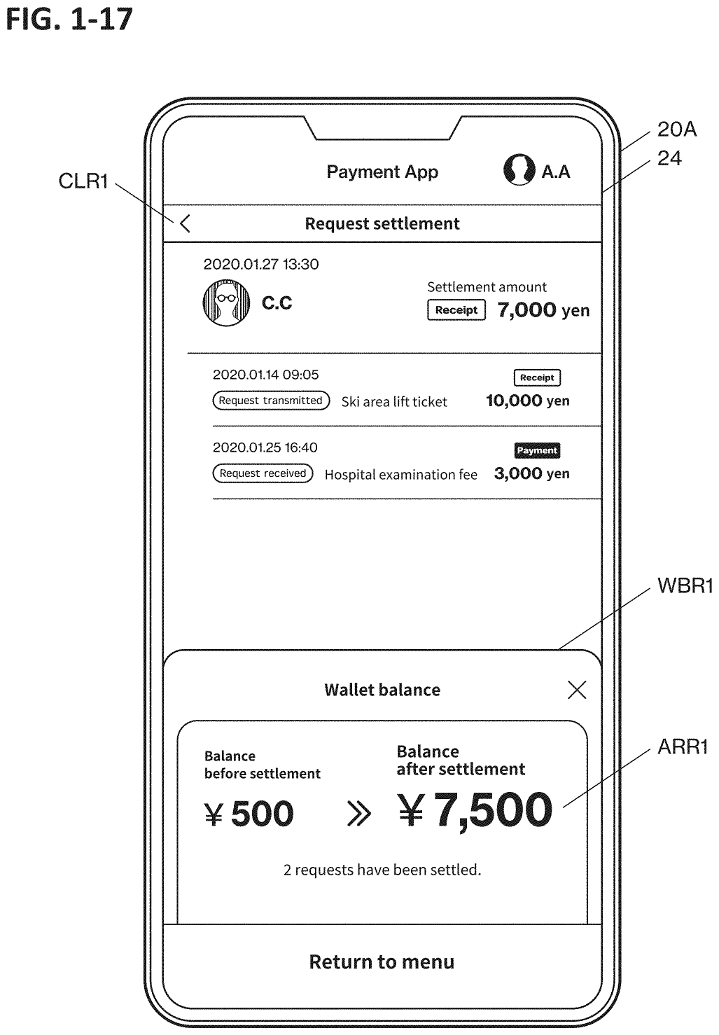

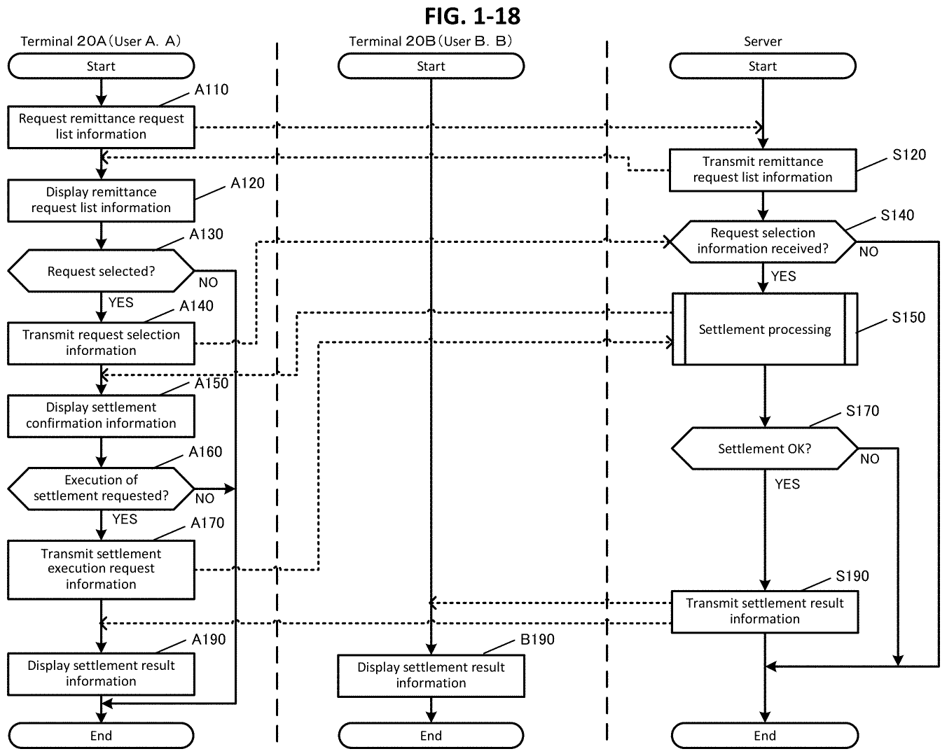

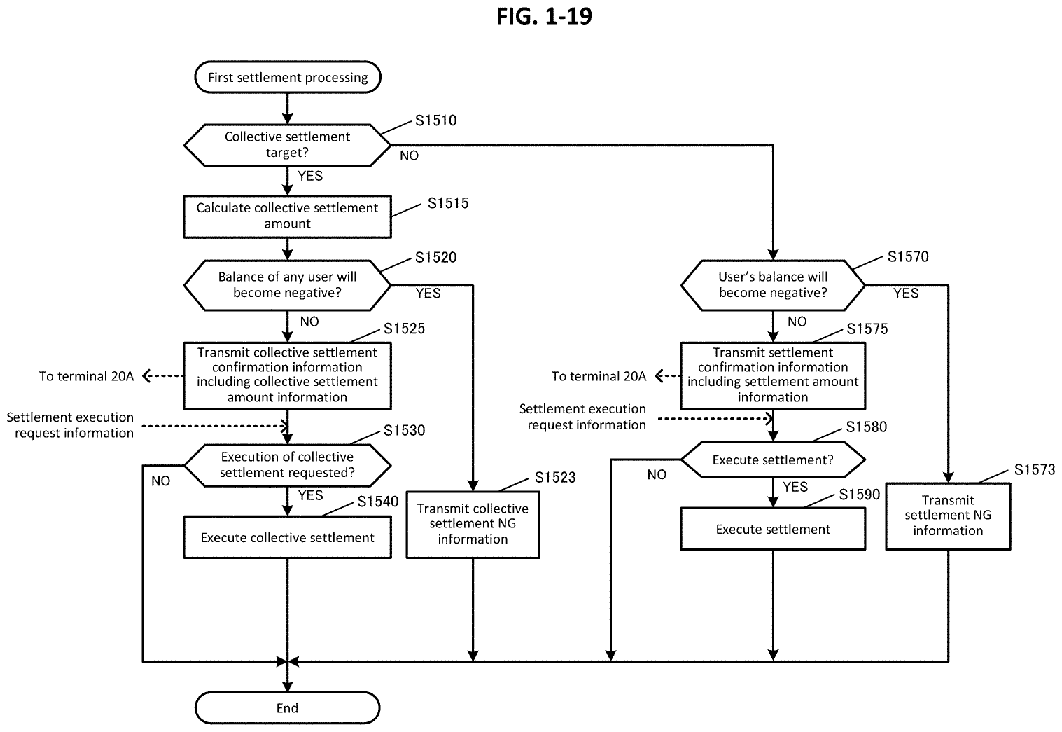

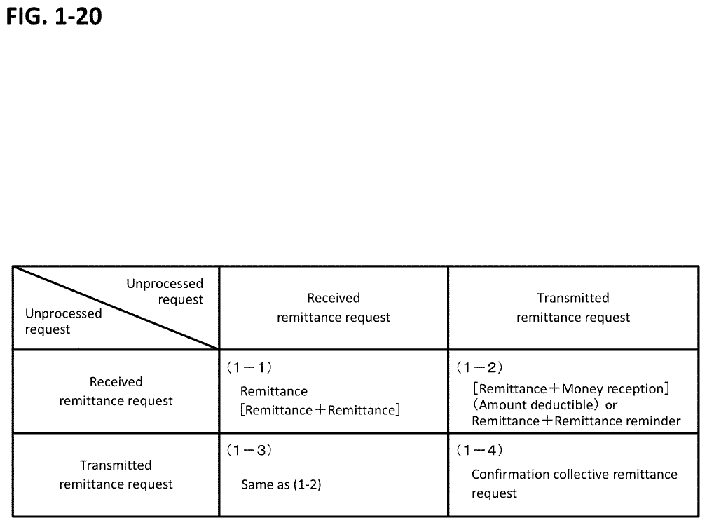

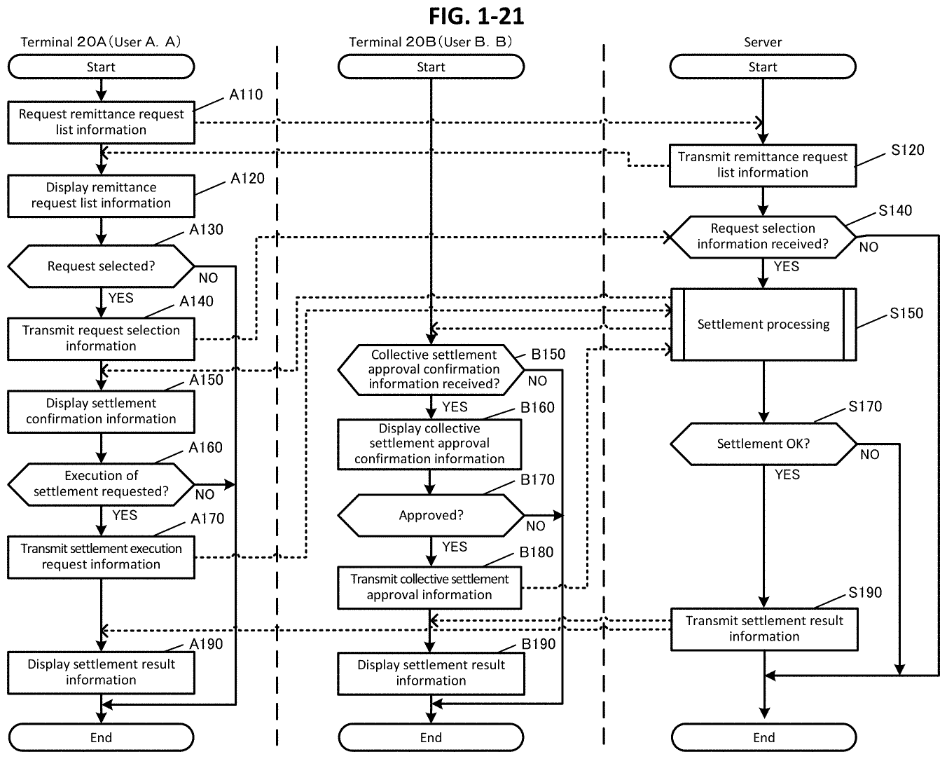

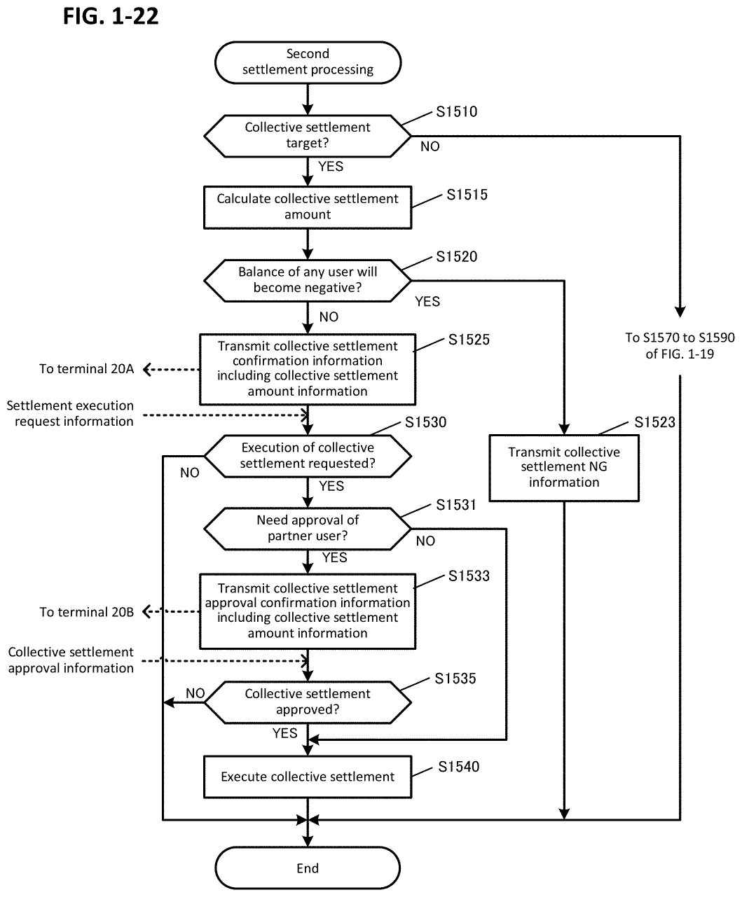

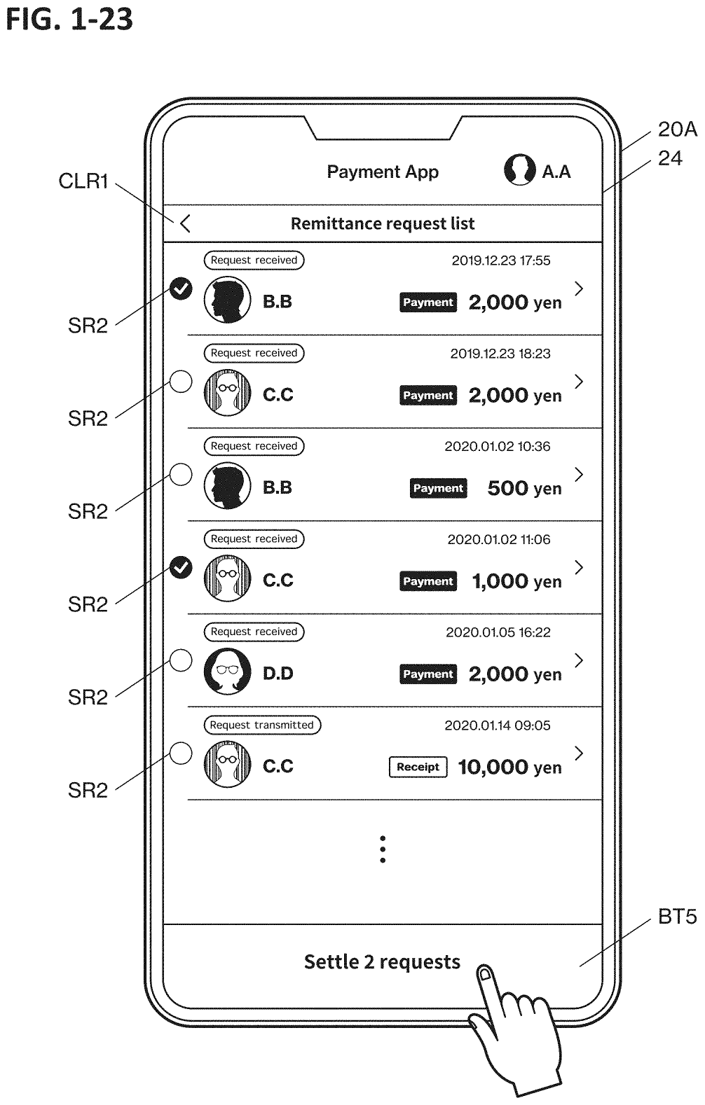

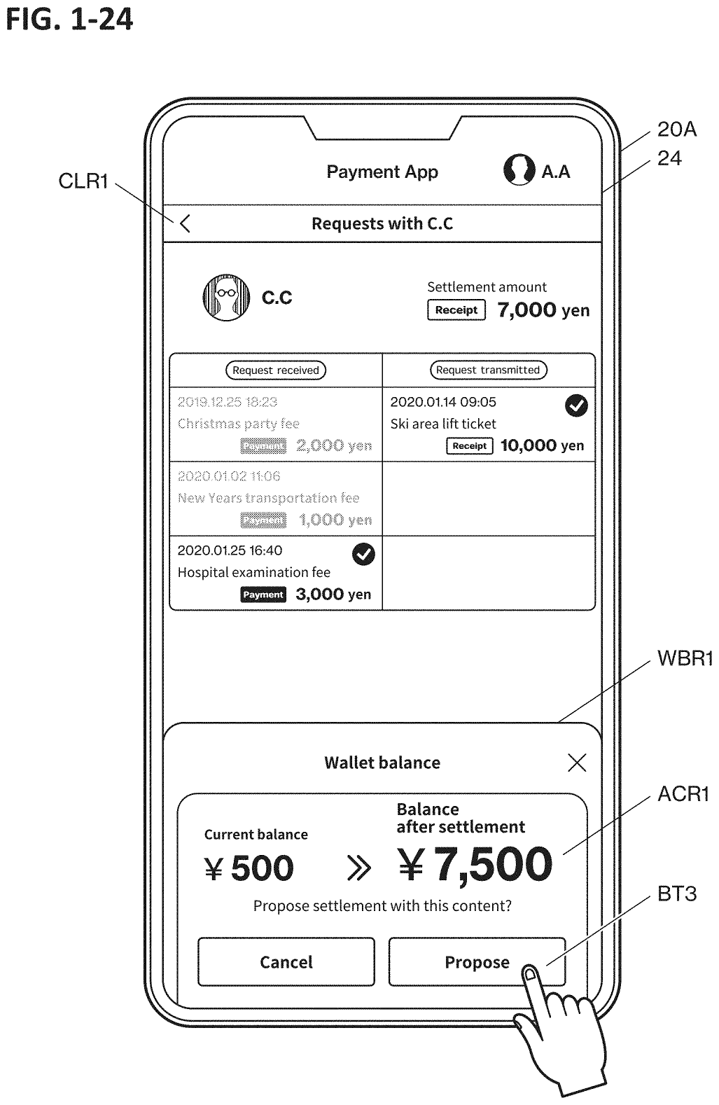

FIG. 1-1 is a diagram showing an example of a system configuration of a communication system 1 according to an embodiment.

In the communication system 1, a server 10 and a plurality of terminals 20 (terminals 20A, 20B, 20C, . . . ) are connected to each other via a network 30, in a non-limiting example.

The server 10 has the function of providing the terminals 20 owned by users with a payment service and a messaging service via the network 30. The server 10 may also be referred to as “a payment management server”, “a payment service server”, “a messaging server”, “a messaging service server”, or the like. according to an embodiment, as a non-limiting example, a user of the server 10 is an operator of the payment service or an operator of the messaging service.

Each of the terminals 20 (terminals 20A, 20B, 20C, . . . ) may be any information processing terminal that is capable of implementing functions described in embodiments. Non-limiting examples of the terminals 20 include a smartphone, a mobile phone (a feature phone), a computer (non-limiting examples of which include a desktop, a laptop, and a tablet), a media computer platform (non-limiting examples of which include cable and satellite set-top boxes and a digital video recorder), a handheld computer device (non-limiting examples of which include a personal digital assistant (PDA) and an electronic mail client), a wearable terminal (an eyeglasses-type device, a watch-type device, etc.), a virtual reality (VR) terminal, a smart speaker (an audio recognition device), and other types of computers and communication platforms. The terminals 20 may also be referred to as “information processing terminals”.

The configurations of the terminals 20A, 20B, and 20C are essentially the same. A terminal that is used by a user X will be referred to as a “terminal 20X”, and user information that is associated with the user X or the terminal 20X in a predetermined service will be referred to as “user information X”, as necessary.

The user information is information regarding a user associated with an account that is used by the user in the predetermined service. Non-limiting examples of the user information include information that is input by the user or is assigned by the predetermined service, and is associated with the user, such as the user's name, an icon image of the user, the user's age, the user's sex, the user's address, the user's hobbies/preferences, and the user's identifier, and the user information may optionally be any one of or a combination of two or more of these pieces of information.

The network 30 serves to connect one or more terminals 20 and one or more servers 10 to each other. That is, the network 30 serves as a communication network that provides a connection path to enable the various types of devices described above to transmit and receive data after the devices are connected to each other.

Note that the number of servers 10 and terminals 20 connected to the network 30 is not limited.

One or more portions of the network 30 may optionally be a wired network or a wireless network. Non-limiting examples of the network 30 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of a public switched telephone network (PSTN), a mobile phone network, integrated service digital networks (ISDNs), a radio LAN, long term evolution (LTE), code division multiple access (CDMA), Bluetooth (registered trademark), satellite communication, and a combination of two or more of these networks. The network 30 may be constituted by a single network 30 or a plurality of networks 30.

The server 10 (a non-limiting example of a server, an information processing device, and an information management derive) has the function of providing a predetermined service (in the present embodiment, a payment service, a messaging service, or the like) to the terminals 20. The server 10 may be any information processing device that is capable of implementing functions described in embodiments. Non-limiting examples of the server 10 include a server device, a computer (non-limiting examples of which include a desktop, a laptop, and a tablet), a media computer platform (non-limiting examples of which include cable and satellite set-top boxes and a digital video recorder), a handheld computer device (non-limiting examples of which include a PDA and an electronic mail client), and other types of computers and communication platforms. The server 10 may also be referred to as an “information processing device”. If there is no need to distinguish the server 10 and the terminals 20, each of the server 10 and the terminals 20 may optionally be referred to as an “information processing device”.

### Hardware (HW) Configurations of Devices

The HW configurations of the devices included in the communication system 1 will be described.

### (1) HW Configurations of Terminals

FIG. 1-1 shows an example of the HW configuration of each terminal 20.

Each terminal 20 includes a controller 21 (central processing unit: CPU), a storage 28, a communication I/F (interface) 22, an input/output device 23, a clock 29A, and a position calculation information detector 29B. The HW constituent elements of each terminal 20 are connected to each other via a bus B, in a non-limiting example. Note that the HW configuration of each terminal 20 does not necessarily have to include all of the constituent elements. Each terminal 20 may optionally be configured such that one or more constituent elements are removable, in a non-limiting example.

The communication I/F 22 transmits and receives various types of data via the network 30. Communication may be carried out in a wired or wireless manner, and may be based on any communication protocol that enables mutual communication to be carried out. The communication I/F 22 functions to communicate with various types of devices such as the server 10 via the network 30. The communication I/F 22 transmits various types of data to various types of devices such as the server 10 in accordance with instructions from the controller 21. Further, the communication I/F 22 receives various types of data transmitted from various types of devices such as the server 10 and conveys the data to the controller 21. The communication I/F 22 may also be simply referred to as a “communication part”. The communication I/F 22 may also be referred to as a “communication circuit” in cases where the communication I/F is constituted by a physically structured circuit.

The input/output device 23 includes a device that inputs various operations made to the terminal 20 and a device that outputs a result of processing performed by the terminal 20. The input/output device 23 may optionally be constituted by a single device into which an input device and an output device are integrated, or an input device and an output device that are separate from each other.

The input device is implemented by any one of or a combination of two or more of all types of devices capable of accepting input from a user and conveying information regarding the input to the controller 21. Non-limiting examples of the input device include a touch panel, a touch display, hardware keys of a keyboard or the like, a pointing device such as a mouse, a camera (input of operations via moving images), and a microphone (input of operations using voice).

The output device is implemented by any one of or a combination of two or more of all types of devices capable of outputting a result of processing performed by the controller 21. Non-limiting examples of the output device include a touch panel, a touch display, a speaker (audio output), a lens (non-limiting examples of which include 3D (three-dimensional) output and hologram output), and a printer.

In one embodiment, the input/output device 23 includes a display 24, an audio input device 25, an audio output device 26, and an image capturing device 27, in anon-limiting example.

The display 24 is implemented by any one of or a combination of two or more of all types of devices capable of providing display in accordance with display data written in a frame buffer. Non-limiting examples of the display 24 include a touch panel, a touch display, a monitor (non-limiting examples of which include a liquid crystal display and an organic electroluminescence display (OELD)), a head mounted display (HDM), and devices capable of displaying images, text information, and the like using projection mapping or holograms, or in the air (may optionally be a vacuum). Note that the display 24 may optionally be capable of displaying display data in 3D.

The audio input device 25 is used to input audio data (which may be speech data. The same applies hereinafter). The audio input device 25 includes a microphone and so on.

The audio output device 26 is used to output audio data. The audio output device 26 includes a speaker and so on.

The image capturing device 27 is used to acquire moving image data. The image capturing device 27 includes a camera and so on.

If the input/output device 23 is a touch panel, the input/output device 23 and the display 24 may also have substantially the same size and shape and be arranged opposing each other.

The clock 29A is a built-in clock of the terminal 20 and outputs time information (time measurement information). The clock 29A includes a clock that employs a crystal oscillator, or the like, in a non-limiting example. The clock 29A may also be referred to as a “time measurement device” or a “time information detecting device”, in a non-limiting example.

Note that the clock 29A may optionally include a clock to which NITZ (Network Identity and Time Zone) standards or the like are applied.

The position calculation information detector 29B is a functional unit that detects (measures) information (hereinafter referred to as “position calculation information”) that is necessary for the controller 21 to calculate (measure) the position of the terminal 20. The position calculation information detector 29B may also be referred to as a “position calculation sensor unit”, in a non-limiting example.

Non-limiting examples of the position calculation information detector 29B include a satellite positioning sensor (a satellite positioning unit) that is a sensor or a unit for calculating the position of the terminal 20 using a satellite positioning system such as GPS (Global Positioning System), an inertial measurement sensor (IMU (Inertial Measurement Unit)) that is a sensor or a unit for calculating the position of the terminal 20 using an inertial navigation system, and a ultrawide band (UWB) positioning sensor (UWB positioning unit) that is a sensor or a unit for calculating the position of the terminal 20 using a UWB.

The satellite positioning unit includes an RF (Radio Frequency) receiving circuit that converts RF signals, which include a positioning satellite signal emitted from a positioning satellite and received by an antenna (not illustrated), into digital signals and a baseband processing circuit that captures the positioning satellite signal by performing correlation operation processing or the like on a digital signal output from the RF receiving circuit and outputs information such as satellite orbit data and time data that are taken from the positioning satellite signal, as position calculation information, in a non-limiting example.

The inertial measurement unit includes an inertial sensor that detects information necessary to calculate the position of the terminal 20 through an inertial navigation operation. The inertial sensor includes a three-axis acceleration sensor and a three-axis gyroscope sensor, and outputs acceleration detected by the acceleration sensor and angular velocity detected by the gyroscope sensor, as position calculation information, in a non-limiting example.

The UWB positioning unit includes a ultrawide band RF (Radio Frequency) receiving circuit that converts ultrawide band RF signals, which include a positioning ultrawide band pulse signal emitted from a positioning beacon and received by an antenna (not illustrated), into digital signals and a relative position calculation processing circuit that calculates the position of the terminal 20 relative to the positioning beacon based on digital signals output from the ultrawide band RF receiving circuit, in a non-limiting example.

Note that the UWB positioning unit may optionally cause the terminal 20 to function as a positioning beacon by transmitting a ultrawide band RF signal including a positioning ultrawide band pulse signal from the antenna (not illustrated), in in a non-limiting example.

The controller 21 calculates the position of the terminal 20 at periodical timings or specified timings based on the position calculation information detected by the position calculation information detector 29B, in a non-limiting example. The position of the terminal will be referred to as a “terminal position”, and the calculated terminal position will be referred to as a “calculated terminal position”. The controller 21 associates the calculated terminal position with date and time at which the calculated terminal position is calculated, and stores the calculated terminal position as calculated terminal position history data in the storage 28.

The controller 21 includes a physically structured circuit for executing functions that are implemented in accordance with codes or commands included in a program, and is implemented by a data processing device embedded in hardware, in a non-limiting example. Accordingly, the controller 21 may optionally be referred to as a “control circuit”.

Non-limiting examples of the controller 21 include a central processing unit (CPU), a microprocessor, a processor core, a multiprocessor, an ASIC (Application-Specific Integrated Circuit), and a FPGA (Field Programmable Gate Array).

The storage 28 functions to store various programs and various types of data that are necessary for the terminal 20 to operate. Non-limiting examples of the storage 28 include various storage media such as an HDD (Hard Disk Drive), an SSD (Solid State Drive), a flash memory, a RAM (Random Access Memory), and a ROM (Read Only Memory). The storage 28 may optionally be referred to as a “memory”.

The terminal 20 stores a program P in the storage 28, and the controller 21 executes the program P to perform processing while serving as devices that are included in the controller 21. That is, the program P stored in the storage 28 causes the terminal 20 to implement the functions to be executed by the controller 21. The program P may optionally be referred to as a “program module”.

### (2) HW Configuration of Server

FIG. 1-1 shows an example of the HW configuration of the server 10.

The server 10 includes a controller (CPU) 11, a storage 15, a communication I/F (interface) 14, an input/output device 12, and a clock 19. The HW constituent elements of the server 10 are connected to each other via a bus B, in a non-limiting example. Note that the HW configuration of the server 10 does not necessarily have to include all of the constituent elements. The HW of the server 10 may optionally be configured such that one or more constituent elements are removable, in a non-limiting example.

The controller 11 includes a physically structured circuit for executing functions that are implemented in accordance with codes or commands included in a program, and is implemented by a data processing device embedded in hardware, in a non-limiting example.

The controller 11 is typically a central processing unit (CPU), and may optionally be a microprocessor, a processor core, a multiprocessor, an ASIC, or an FPGA. In the present disclosure, the controller 11 is not limited to these examples.

The storage 15 functions to store various programs and various types of data that are necessary for the server 10 to operate. The storage 15 is implemented by various storage media such as an HDD, an SSD, and a flash memory. However, in the present disclosure, the storage 15 is not limited to these examples. The storage 15 may optionally be referred to as a “memory”.

The communication I/F 14 transmits and receives various types of data via the network 30. Communication may be carried out in a wired or wireless manner, and may be based on any communication protocol that enables mutual communication to be carried out. The communication I/F 14 functions to communicate with various types of devices such as the terminals 20 via the network 30. The communication I/F 14 transmits various types of data to various types of devices such as the terminals 20 in accordance with instructions from the controller 11. Further, the communication I/F 14 receives various types of data transmitted from various types of devices such as the terminals 20 and conveys the data to the controller 11. The communication I/F 14 may also be simply referred to as a “communication part”. The communication I/F 14 may also be referred to as a “communication circuit” in cases where the communication I/F is constituted by a physically structured circuit.

The input/output device 12 is implemented by a device that inputs various operations made to the server 10.

The input device is implemented by any one of or a combination of two or more of all types of devices capable of accepting input from a user and conveying information regarding the input to the controller 11. The input device is implemented by hardware keys, a typical example of which is a keyboard, and a pointing device such as a mouse. Note that the input device may optionally include a touch panel, a camera (input of operations via moving images), or a microphone (input of operations using voice), in a non-limiting example.

The output device is implemented by any one of or a combination of two or more of all types of devices capable of outputting a result of processing performed by the controller 11. Non-limiting examples of the output device include a touch panel, a touch display, a speaker (audio output), a lens (non-limiting examples of which include 3D (three-dimensional) output and hologram output), and a printer.

In one embodiment, the input/output device 12 includes a display 13.

The display 13 is typically implemented by a monitor (non-limiting examples of which include a liquid crystal display and an organic electroluminescence display (OELD)). Note that the display 13 may optionally be a head mounted display (HDM) or the like. Note that the display 13 may optionally be capable of displaying display data in 3D. In the present disclosure, the display 13 is not limited to these examples.

The clock 19 is a built-in clock of the server 10 and outputs time information (time measurement information). The clock 19 includes an RTC (Real Time Clock) as a hardware clock, a system clock, or the like, in a non-limiting example. The clock 19 may also be referred to as a “time measurement device” or a “time information detecting device”, in a non-limiting example.

### (3) Others

The server 10 stores a program Pin the storage 15, and the controller 11 executes the program P to perform processing while serving as devices that are included in the controller 11. That is, the program P stored in the storage 15 causes the server 10 to implement the functions to be executed by the controller 11. The program P may optionally be referred to as a “program module”.

The same applies to other devices.

Embodiments of the present disclosure will be described assuming that the embodiments are implemented as a result of CPU(s) of the terminals 20 and/or the server 10 executing the program P.

The same applies to other devices.

Note that the controller 21 of each terminal 20 and/or the controller 11 of the server 10 may optionally implement processing by using not only the CPU(s) including a control circuit, but also a logic circuit (hardware) or a dedicated circuit that is formed on an integrated circuit (an IC (Integrated Circuit) chip or an LSI (Large Scale Integration) chip) or the like. Further, these circuits may optionally be implemented by one or more integrated circuits, and a plurality of types of processing described in the embodiments may optionally be implemented by a single integrated circuit. LSI may be referred to as VLSI, super LSI, ultra LSI, or the like depending on the degree of integration. Accordingly, the controller 21 may optionally be referred to as a “control circuit”.

The same applies to other devices.

The program P (non-limiting examples of which include a software program, a computer program, and a program module) in the embodiments of the present disclosure may optionally be provided in a state where the program is stored in a computer-readable storage medium. The program P can be stored in a “non-transitory tangible medium”. Further, the program P may optionally be a program for implementing some of the functions described in the embodiments of the present disclosure. Furthermore, the program P may optionally be a differential file (differential program) that is configured to implement the functions described in the embodiments of the present disclosure in combination with a program P that is already recorded in a storage medium.

The storage medium may include one or more semiconductor-based or other integrated circuits (ICs, non-limiting examples of which include field programmable gate arrays (FPGAs) and application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM drives, secure digital cards, drives, any other appropriate storage media, and a suitable combination of two or more of these storage media. Where appropriate, the storage medium may consist only of a volatile storage medium or a non-volatile storage medium, or a combination of volatile and non-volatile storage media. Note that the storage medium is not limited to these examples, and may be any device or medium that is capable of storing the program P. Further, the storage medium may optionally be referred to as a “memory”.

The server 10 and/or the terminals 20 can implement functions of a plurality of functional units described in the embodiments by reading the program P stored in the storage medium and executing the read program P.

The same applies to other devices.

The program P according to the present disclosure may optionally be provided to the server 10 and/or the terminals 20 via any transmission medium (a communication network, broadcast waves, etc.) that is capable of transmitting the program. The server 10 and/or the terminals 20 implement(s) the functions of the functional units described in the embodiments by executing the program P downloaded via the Internet or the like, in a non-limiting example.

The same applies to other devices.

The embodiments of the present disclosure can also be implemented in the form of a data signal in which the program P is embodied through electronic transmission.

At least a portion of the processing executed in the server 10 and/or the terminals 20 may optionally be implemented through cloud computing constituted by one or more computers.

At least a portion or all of the processing executed in the terminals 20 may optionally be carried out by the server 10. In this case, the server 10 may optionally carry out at least a portion or all of the processing carried out by functional units of the controller 21 of each terminal 20.

At least a portion of the processing executed in the server 10 may optionally be carried out by the terminals 20. In this case, the terminals 20 may optionally carry out at least a portion or all of the processing carried out by functional units of the controller 11 of the server 10.

In the embodiments of the present disclosure, configurations for determination are not essential unless explicitly mentioned otherwise, and predetermined processing may be activated when a determination condition is satisfied, or predetermined processing may be activated when a determination condition is not satisfied, without limitation thereto.

The program according to the present disclosure is implemented using a script language such as ActionScript or JavaScript (registered trademark), a compiler language such as Objective-C or Java (registered trademark), or a markup language such as HTML5, for example, although there is no limitation thereto.

The following describes embodiments in which the present disclosure is implemented by a server client system.

However, the present disclosure can be implemented by not only the server client system but also a system that does not include a server. Non-limiting examples of such a system include the following.

A system (distributed system) in which the terminals 20 have the functions of the server. Such a system can be realized using a block chain technology, in a non-limiting example.

A system in which the terminals 20 perform wireless communication with each other. Such a system can be realized by using a short-range wireless communication technology such as Bluetooth to perform communication in a P2P (peer to peer) method.

In the following description, the expression “by means of a communication I/F” is used as appropriate. This expression means that a device transmits and receives various types of information and data via the communication I/F (via a communication part) based on control performed by a controller (a processor, etc.), in a non-limiting example. Outline

Recent years have seen widespread use of applications (application software) relating to network services such as applications (payment applications) for making payments using electronic money, applications (settlement applications) for making settlements using electronic money, applications (remittance applications) for sending and receiving electronic money, and applications into which some or all functions of these applications are integrated, and users of the terminals 20 can use various services in which electronic money is used by using these applications.

“Electronic money” refers to electronic money that is distinguished from physical money and is possessed by the terminals 20 managed in the various applications described above or the users of the terminals 20.

Note that electronic money may optionally be referred to as “digital currency (digital money)”.

Also, legal tender or a virtual currency may also be used as “electronic money” or “digital currency (digital money)”.

Also, cryptocurrency (crypto-assets) may also be included in “electronic money” or “digital currency (digital money)”.

Also, physical money such as coupons may also be included in a virtual currency.

In the present specification, the term “electronic money” is used as an example, and the balance of an electronic money account of a user of a terminal 20 will be referred to as an “electronic money account balance”, in a non-limiting example.

In the following description, a request that is made by a user of a terminal 20 to ask a user (a partner user) of another terminal 20 to send money will be referred to as a “remittance request”. Information relating to this remittance request will be referred to as “remittance request information”.

Requesting remittance may also be referred to as “making a remittance request”, “issuing a remittance request”, or the like.

Also, being requested to remit may also be referred to as “receiving a remittance request”, “getting a remittance request”, or the like.

Also, sending a remittance request is expressed as “transmitting a remittance request”, “sending a remittance request”, and the like, but these are substantially synonymous.

Conversely, receiving a remittance request is expressed as “receiving a remittance request”, “accepting a remittance request”, and the like, but these are substantially synonymous.

The term “remittance reminding” used in the following description has the meaning of causing the partner user remember, recall, or check again the content of a remittance request, for example, and information relating to remittance reminding will be referred to as “remittance reminder information”.

Reminding someone to remit may also be referred to as “issuing a remittance reminder”, “performing remittance reminding”, or the like.

Also, being reminded to remit may also be referred to as “getting a remittance reminder”, “receiving a remittance reminder”, or the like.

Also, the remittance request information (similar to the remittance reminder information) need only include at least information indicating that a remittance has been requested, information on the user requesting the remittance (remittance request source), and information on the user to whom the remittance is requested.

Note that as will be described later, information such as the amount requested for remittance (hereinafter referred to as “remittance request amount”), the reason for remittance, the deadline for payment by remittance (hereinafter referred to as “payment deadline”), and the like can also be included in the remittance request.

The following describes various types of processing according to the present disclosure as processing that is executed through an application (a payment application or a messaging application) installed in the terminals 20.

Note that the function of a chat service (as a non-limiting example, a messaging service) can be included as a function of a payment application, or the function of a payment service function can be included as a function of a chat application (as a non-limiting example, a messaging application).

The messaging service is configured so that users can chat using a chat room.

In the following description, a UI (User Interface) or a GUI (Graphical User Interface) that allows each user to view content transmitted and received between terminals of a plurality of users will be referred to as a “talk room” as appropriate. Also, a talk room may be called a chat room.

Note that non-limiting examples of talk rooms can include a one-to-one user talk room as well as a talk room for a group including a plurality of users (group talk room). A talk room in this case means a UI or GUI that allows users included in a group to view content transmitted and received between terminals of the group including the plurality of users.

The messaging service may optionally include an instant messaging service (IMS) that enables transmission and reception of contents such as simple messages between the terminals 20.

Note that the messaging service (MS including IMS) can also be considered as being a form of a social networking service (SNS).

Accordingly, the messaging service (MS) and the social networking service (SNS) may be distinguished from each other, but do not necessarily have to be distinguished from each other.

### EMBODIMENTS

Hereinafter, embodiments to which the present disclosure is applied will be described below.

A remittance request to a user (user of a terminal) from a partner user (first user) or a remittance request from the user to the partner user is not processed, and a plurality of remittance requests are accumulated in the terminal 20 in some cases. Non-limiting examples of such a case include a case of inadvertently forgetting to process a remittance request.

In this case, processing unprocessed remittance requests one by one takes time and is inconvenient. Also, when unprocessed remittance requests are processed one by one, the balance of the user may become insufficient.

In view of this, a method of collectively processing a plurality of remittance requests (here, a plurality of unprocessed remittance requests) will be described. This collective processing is called “collective processing”.

Collective processing can be roughly divided into at least the following processing.

(1) Processing relating to collective settlement (hereinafter referred to as “collective settlement”)
(2) Processing for canceling out remittance requests (hereinafter referred to as “request cancellation”)
(3) Processing relating to the creation of a collective remittance request (hereinafter referred to as “collective remittance request”)
(4) Processing relating to special collective remittance (hereinafter referred to as “special collective remittance”), processing relating to creating a special collective remittance request (hereinafter referred to as “special collective remittance request”)

Also, in the embodiments described below, a case where the partner user is one user, that is, a case where the second user is the first user (or the first user is the second user), will be described as an example.

Also, as will be described in a modified example and the like, the method described below can be similarly applied also to a case where the partner users are a plurality of different users, that is, a case where the first user is a user different from the second user (the second user is a user different from the first user).

### First Embodiment

The first embodiment is an embodiment relating to collective settlement among the collective processing described above.

The content described in the first embodiment can also be applied to other embodiments and other modified examples.

Also, constituent elements that are the same as constituent elements that have already been described are denoted by the same reference signs thereas, and redundant description thereof is omitted.

Functional Configuration

### (1) Server

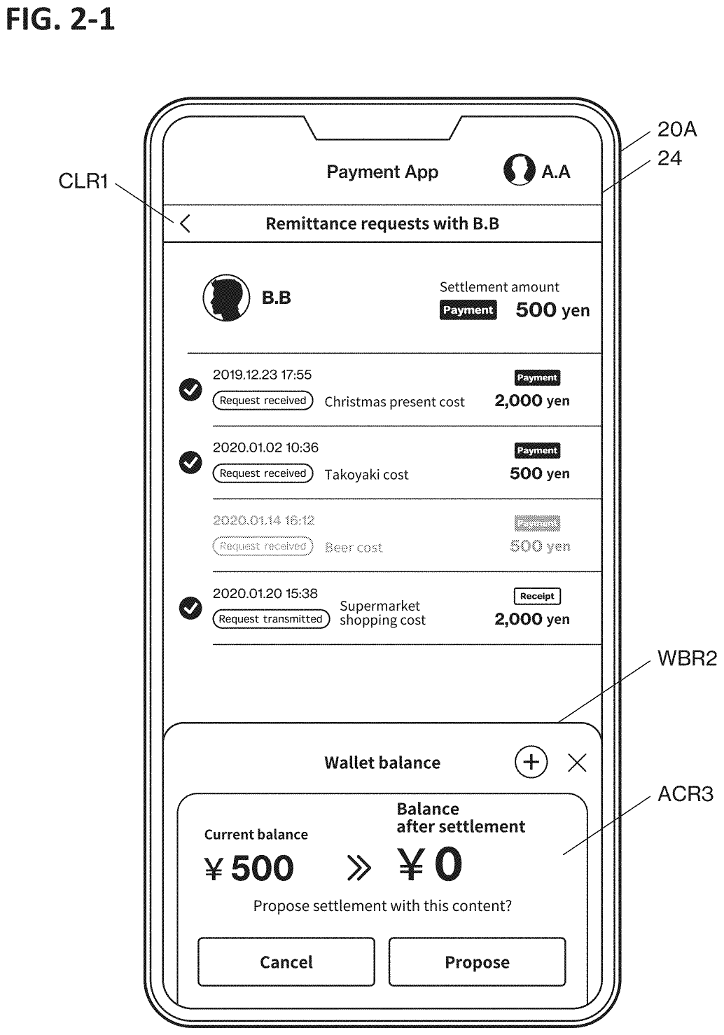

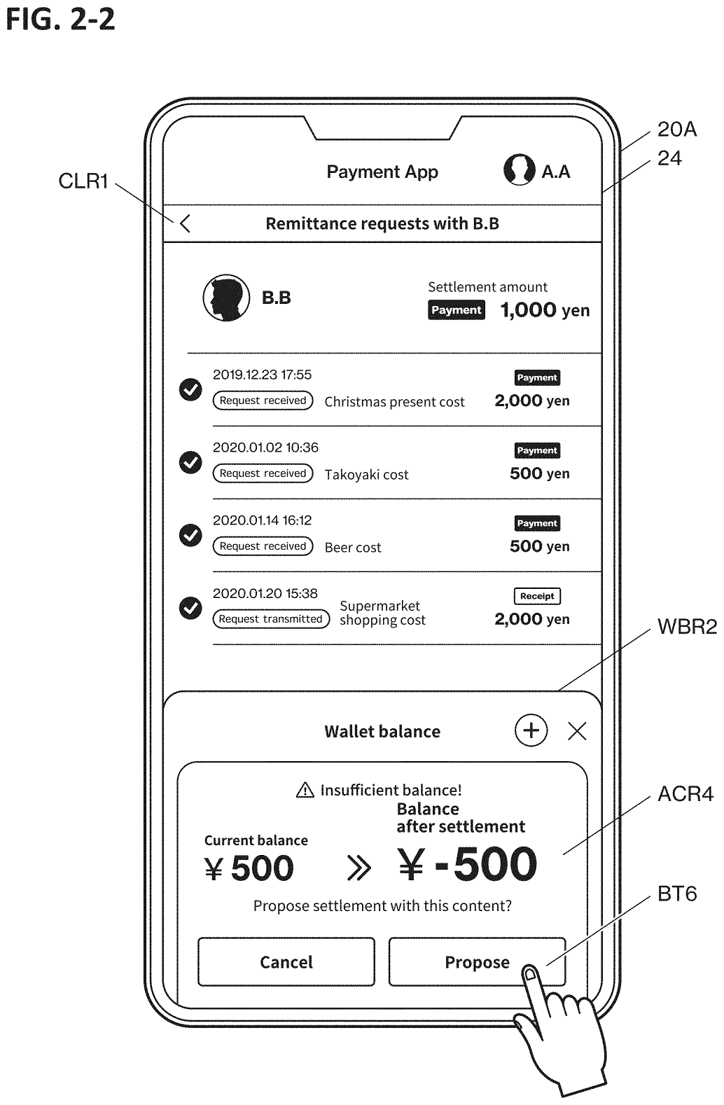

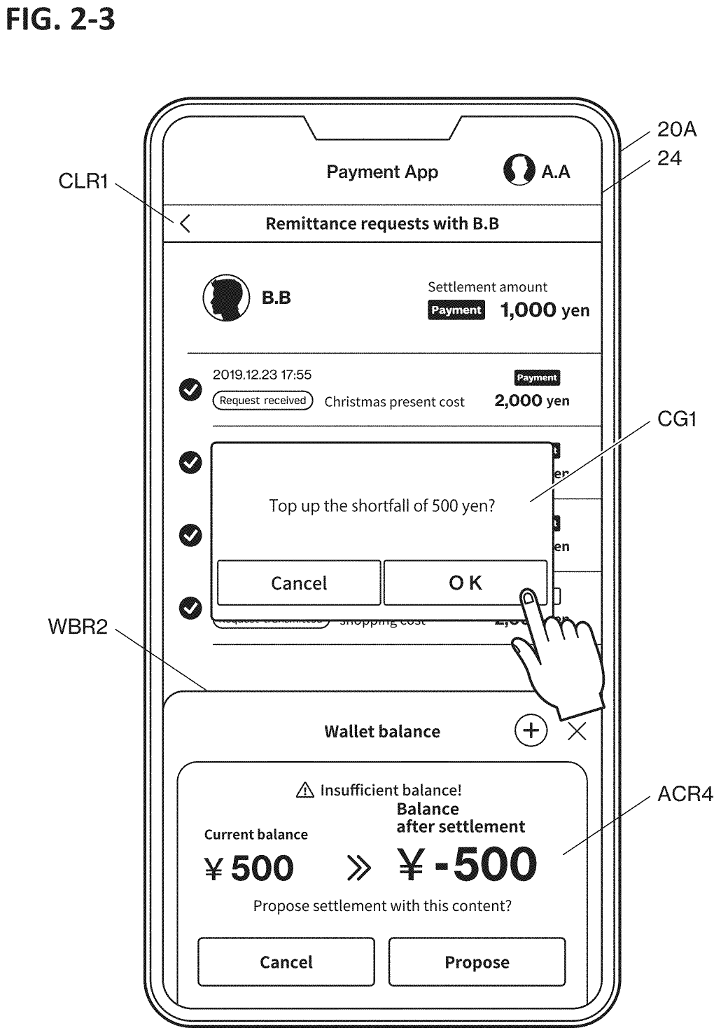

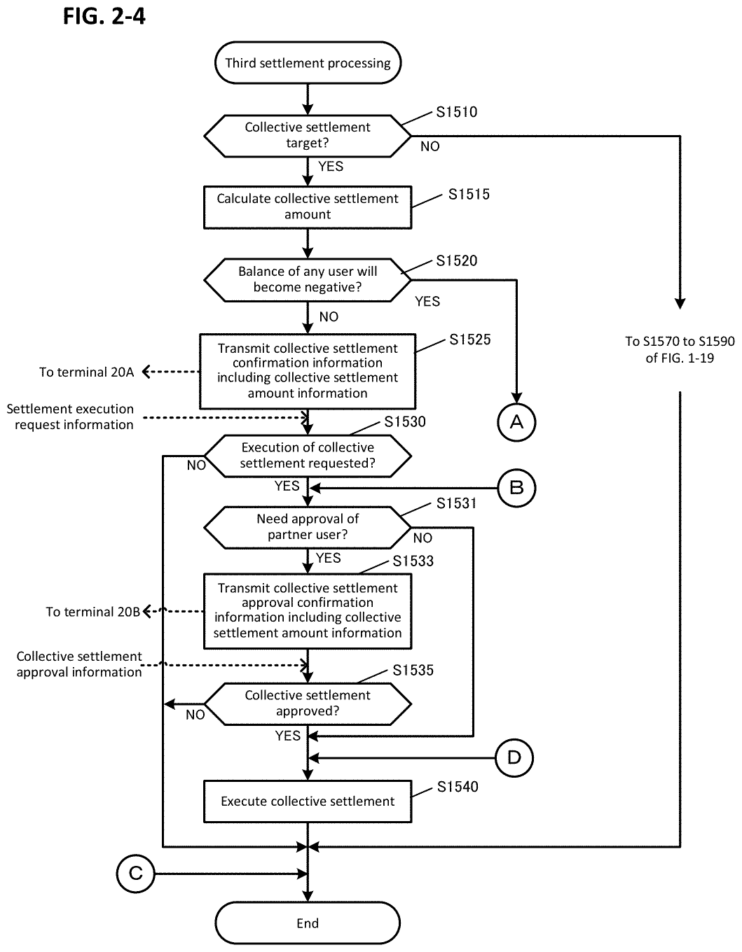

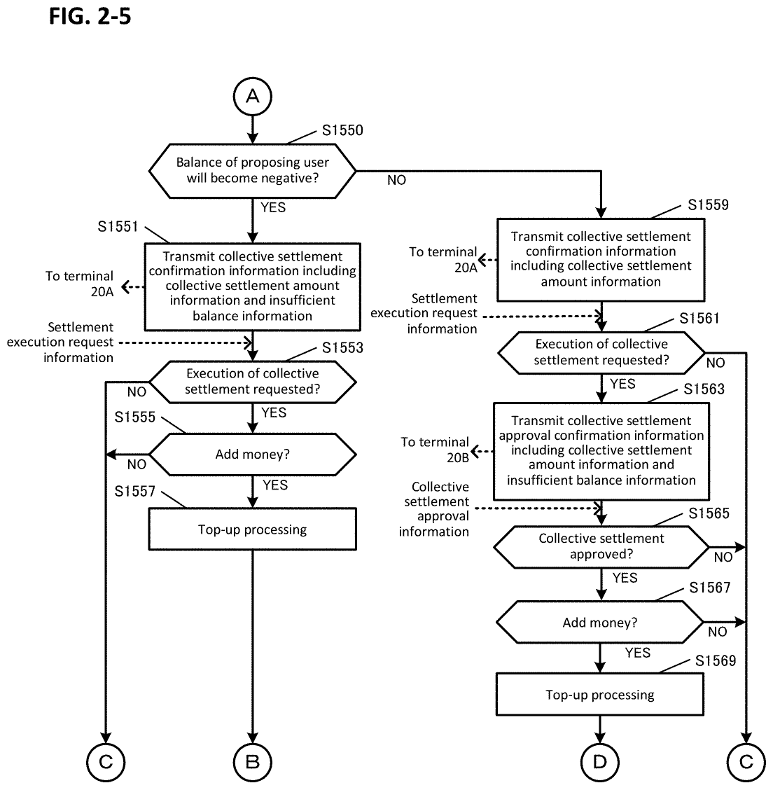

FIG. 1-2 is a diagram showing an example of functions implemented by the controller 11 of the server 10 according to an embodiment.

In a non-limiting example, the controller 11 of the server 10 includes, as a functional unit, a payment application management processing unit 111 that performs processing for providing the terminals 20 or users of the terminals 20 with various payment services realized by the payment application, in accordance with a payment application management processing program 151 that is stored in the storage 15.

FIG. 1-3 is a diagram showing an example of information stored in the storage 15 of the server 10 according to an embodiment.

In a non-limiting example, the storage 15 stores the payment application management processing program 151 that is read by the controller 11 and executed as payment application management processing, user registration data 153, a user management database 155, and remittance request management data 157.

The user registration data 153 is registered data regarding the terminals 20 that use the payment application, or users of the terminals 20, and FIG. 1-4 shows an example of the data configuration.

In a non-limiting example, a user name, an application ID, a terminal phone number, and other registered information are stored in association with each other in the user registration data 153.

The user name is the name of a user of a terminal 20 that uses the payment application. In a non-limiting example, a name that is registered by the user of the terminal 20 to use the payment application is stored as the user name.

The application ID is information that is used to identify an account of the payment application, or the account itself.

The application ID is preferably a value that is unique to the account. In a non-limiting example, a unique value (specific value) is set for each account by the server 10 and stored as the application ID.

The application ID is information associated with the terminal 20 or the user of the terminal 20, and is an example of information regarding the terminal or information regarding the user of the terminal.

The terminal phone number is the phone number of the terminal 20 of the user having the user name. In a non-limiting example, a phone number of the terminal 20 that is registered by the user of the terminal 20 to use the payment application is stored as the terminal phone number.

In a non-limiting example, the other registered information may include an ID of the terminal 20 (terminal ID, a non-limiting example of which is IMEI (International Mobile Equipment Identity)), an e-mail address of the terminal 20 (terminal e-mail address) of the user having the user name, and authentication information such as a password (login password, authentication password, etc.) that is used for various types of authentication in the payment application.

In a non-limiting example, identification information for identifying the terminal 20 may be the terminal ID.

Also, in a non-limiting example, identification information for identifying the user of the terminal 20 may be the application ID. Note that the application ID may be optionally referred to as a “user ID”.

In the case of an application in which only one account can be registered for each terminal 20, the identification information for identifying the terminal 20 may be the same as the identification information for identifying the user of the terminal 20, which is the application ID, although there is no limitation thereto.

Also, a plurality of terminal IDs may optionally be allocated to a single user ID, in a non-limiting example.

Note that registration of a terminal telephone number is not essential, and the terminal telephone number need not be stored in the user registration data 153.

Also, it is possible to apply a method of managing accounts by terminal phone numbers instead of various IDs such as application IDs. In this case, instead of storing an ID such as an application ID in the user registration data 153, the terminal telephone number can be stored in the user registration data 153.

The user management database 155 is a database in which data for managing information regarding the terminals 20 using the payment application or users of the terminals 20 is accumulatively stored. FIG. 1-5 shows an example of the configuration of a first user management database 155A, which is an example of the user management database 155.

In the first user management database 155A, user management data is stored as management data for each application ID.

In a non-limiting example, each piece of user management data includes an application ID, an electronic money account balance of the user identified based on the application ID, remittance history data, and money reception history data.

Information (remittance history information) regarding a history of remittance from the user having the application ID to users having other application IDs is stored as the remittance history data.

Information (money reception history information) regarding a history of money that the user having the application ID received from users having other application IDs is stored as the money reception history data.

The remittance request management data 157 is a database in which data for managing information relating to remittance requests is accumulatively stored. FIG. 1-6 shows an example of the configuration of first remittance request management data 157A, which is an example of the remittance request management data 157.

In a non-limiting example, date and time, a remittance request management ID, a remittance master ID, a remittance requested ID, a remittance requested amount, and a remittance completion flag are stored in association with each other in the first remittance request management data 157A.

In a non-limiting example, the date and time at which remittance request information of a corresponding remittance request was transmitted from the server 10 to the terminal 20 of the remittance requested user are stored as the date and time.

An ID that is uniquely set for each remittance request by the server 10 is stored as the remittance request management ID.

The remittance master ID stores the application ID of the user who requested the remittance (also called “remittance master user”).

The remittance request destination ID stores the application ID of the user to whom the remittance is requested (also referred to as “remittance request destination user”).

In the remittance request amount, the amount for which remittance is requested by the remittance master user for remittance to the remittance request destination user with the remittance request is stored.

A remittance completion flag is a flag indicating whether or not the remittance corresponding to the remittance request has been completed due to the controller 11 executing the settlement processing, and is set to “OFF” by default, and is set to “ON” due to the remittance being completed.

The following two patterns are conceivable as methods for the server 10 to manage remittance requests.

(1) Pattern A: Remittance requests for which remittance has been executed are not deleted.
(2) Pattern B: Remittance requests for which remittance has been executed are deleted.

Either of these patterns can be applied, but when pattern A is applied, the data of the remittance request with the remittance completed flag set to “ON” is not deleted.

On the other hand, when pattern B is applied, the record of data of the remittance request for which remittance has been executed is deleted.

### (2) Terminal

FIG. 1-7 is a diagram showing an example of functions implemented by the controller 21 of the terminal 20 according to an embodiment.

In a non-limiting example, the controller 21 includes, as a functional unit, a payment application processing unit 211 that executes payment application processing in accordance with a payment application processing program 281 that is stored in the storage 28.

FIG. 1-8 is a diagram showing an example of information stored in the storage 28 of the terminal 20 according to an embodiment.

In a non-limiting example, the storage 28 stores the payment application processing program 281 that is read by the controller 21 and executed as the payment application processing and an application ID 283 that is associated with the terminal 20 or the user of the terminal 20.

### Display Screen

The following describes a case where the terminal 20 is a smartphone including a vertically elongated display as the display 24, although there is no limitation thereto.

In a non-limiting example, the smartphone includes a touch panel that serves as an input device and is arranged opposing the display, and the touch panel and the display constitute a touch screen. When an element such as an icon, a button, an item, or an entry field is displayed in the display and the user performs an operation on a region of the touch panel opposing the region in which the element is displayed, a program that is associated with the element or a subroutine of the program is executed.

In the following description, tapping (tap operation) is described as a non-limiting example of the operation performed by the user.

Tapping (a tap operation) refers to a motion of the user touching the display 24 (touch screen) integrated with the touch panel by hitting the display with a light blow using his or her finger, a pen tip, or the like, for example, and then removing it from the display.

Note that the following transitions of display screens are merely examples of transitions of display screens that realize the method of the present disclosure. In the following examples of transitions of display screens, some display screens may be omitted, or another display screen may be added.

FIG. 1-9 is a diagram showing an example of a screen displayed on the display 24 of the terminal 20 according to an embodiment. This screen is, in a non-limiting example, a main menu screen of a payment application displayed on the display 24 of a terminal 20A of a user A.A.

At the top center of the menu screen, the words “Payment App” are displayed as the name of the payment application. Also, in the upper right of the screen, an icon image and user name (the user A.A in this example) of the payment application of the user of this terminal 20 are displayed.

Below that is a current location display region CLR1 that indicates the current location in the payment application, and in this example, the words “Wallet Main Menu”, which indicate that the current location is a main menu of the payment application, are displayed in the current location display region.

When a remittance request list icon IC1 displayed at the lower part of the main menu screen is tapped, information requesting a remittance request list information is transmitted from the terminal 20A to the server 10, and the server 10 transmits the remittance request list information to the terminal 20A. As a result, in a non-limiting example, a remittance request list screen is displayed as shown in FIG. 1-10.

In the current location display region CLR1, the words “Remittance Request List” indicating that the remittance request list information is being displayed are displayed.

On this remittance request list screen, unprocessed remittance requests (hereinafter referred to as “unprocessed requests”) between users of different terminals 20 are displayed as remittance requests relating to the user (the user A.A) of the terminal 20, for each of the users of the different terminals 20.

Hereinafter, a user who proposes collective processing will be referred to as a “proposing user” as appropriate.

Also, the user to whom collective processing is proposed by the proposing user will be referred to as a “partner user”.

Specifically, the number of unprocessed requests for each of a plurality of users such as a user B.B, a user C.C, a user D.D, and a user E.E, who are the partners, and the settlement amount (hereinafter referred to as “collective settlement amount”) in the case of collectively processing the unprocessed requests between the users are displayed in association with the icon image and the user name of each user.

Here, an amount to be paid to a partner according to a remittance request made by the partner will be referred to as a “payment amount” as appropriate, and an amount to be received from the partner according to a remittance request made to the partner will be referred to as a “receipt amount” as appropriate.

In this case, the “collective settlement amount” will be an amount obtained by reversing the positive/negative signs of the payment amount and the receipt amount corresponding to each unprocessed request and adding the amounts together when all of the unprocessed requests are processed collectively. This collective settlement amount is calculated in the settlement processing executed by the controller 11 of the server 10 in a non-limiting example.

Also, in this example of the display screen, next to the collective settlement amount, a payment mark indicating “payment” is displayed in an associated manner when the collective settlement amount is to paid to the partner, and a receipt mark indicating “receipt” is displayed in an associated manner when the collective settlement amount is to be received from the partner.

In a non-limiting example, it is indicated that the user A.A (user) has 4 unprocessed requests with the user B.B (partner), and if these 4 unprocessed requests are processed collectively, the user A.A will pay “1,000 yen” as a collective settlement amount to the user B.B.

Similarly, in a non-limiting example, it is indicated that the user A.A (user) has 4 unprocessed requests with the user C.C (partner), and if these 4 unprocessed requests are processed collectively, the user A.A will receive “4,000 yen” as a collective settlement amount from the user C.C.

Also, a settlement button BT1 for requesting the server 10 to collectively settle all unprocessed requests is displayed at the lower part of the screen.

On this screen, in a non-limiting example, when a display region WR1 of the user C.C is tapped, a remittance request details screen shown in FIG. 1-11 is displayed. This remittance request details screen displays the details of unprocessed requests with the user C.C.

Collective settlement refers to performing settlement all together based on a plurality of unprocessed requests, and in a non-limiting example, includes “full-selection collective settlement” in which all of the unprocessed requests are settled collectively, and “partial-selection collective settlement”, in which some of the unprocessed requests are collectively settled.

In the current location display region CLR1 at the upper part of the screen, the words “Remittance Requests with C.C” are displayed, indicating that unprocessed requests with the user C.C are being displayed.

Also, below the current location display region CLR1, the collective settlement amount (in this example, “4,000 yen”) and a mark (in this example, “receipt mark”) for when it is assumed that full-selection collective settlement is to be performed are displayed in association with the icon image and the user name of the user C.C.

Next to the icon image of the user C.C, there is a check region ASR1 configured so that the check can be switched “ON/OFF” by tapping, a check mark is displayed in the check region by switching “ON” the check, and all unprocessed requests can be collectively settled.

Below that, a list of remittance requests in which the partner is the user C.C is displayed. In this example, unprocessed requests in which the partner is the user C.C are listed in chronological order starting from the oldest at the top, and requests that have been processed (hereinafter referred to as “processed requests”) are listed in chronological order starting from the oldest at the top, below the list of unprocessed requests. Also, processed requests are displayed in a different display mode (grayed out in this example) to distinguish them from unprocessed requests.

Hereinafter, a remittance request that has been transmitted to the partner will be referred to as a “transmitted remittance request”, and a remittance request that has been received from the partner will be referred to as a “received remittance request”.

In this case, a transmitted remittance request among the unprocessed requests is displayed with a request transmitted mark indicating “request transmitted”, and a received remittance request among the unprocessed requests is displayed with a request received mark indicating “request received”.

Also, regarding a transmitted remittance request that is an unprocessed request, the date and time when the request was sent from the terminal 20 to the terminal 20 of the partner user is displayed in association with that request, and regarding a received remittance request that is an unprocessed request, the date and time when the request was received by the terminal 20 from the terminal 20 of the partner user is displayed in association with that request.

In a non-limiting example, each unprocessed request is displayed in association with a reason for performing remittance through that unprocessed request.

Note that the information on the remittance request amount need not be included in the remittance request information and the information on the remittance request amount need not be displayed. In this case, as a non-limiting example, the proposing user can query the server 10 or the partner user for information on the remittance request amount.

Also, although the information on the remittance request amount is included in the remittance request information, it need not be displayed on the remittance request list screen or the remittance request individual screen. In this case, as a non-limiting example, the remittance request details screen including information on the remittance request amount may be displayed based on the fact that input for checking the detailed content of the remittance request has been made on the remittance request individual screen.

Note that the same applies to other information relating to the remittance request, such as information on the reason for remittance.

Also, as a non-limiting example, each transmitted remittance request that is an unprocessed request is displayed in association with a receipt mark and a receipt amount to be received from the partner by processing the transmitted remittance request, and each received remittance request that is an unprocessed request is displayed in association with a payment mark and a payment amount to be paid to the partner by processing the received remittance request.

Also, next to each unprocessed request, a check region SR1 is provided in which a check can be switched “ON/OFF” by tapping, a check mark is displayed in the check region SR1 by switching “ON” the check, and the unprocessed request can be selected as a target for collective settlement.

Also, a settlement button BT2 for requesting the server 10 to collectively settle the selected unprocessed requests is displayed at the lower part of the screen.

Note that in FIG. 1-11, processed requests are displayed together with unprocessed requests, but processed requests need not be displayed.

In a non-limiting example, when selection is performed by switching “ON” the checks for two requests, namely the third transmitted remittance request (receipt of 10,000 yen) and the fourth received remittance request (payment of 3,000 yen) and the settlement button BT2 is tapped, a display such as that shown in FIG. 1-12 is displayed.

In FIG. 1-12, collective settlement confirmation information for the user to confirm the content of the collective settlement is displayed at the lower part of the screen in FIG. 1-11. In this example, a settlement content confirmation region ACR1 indicating how the user's current electronic money account balance will change due to collective settlement is provided in an electronic money account balance display region WBR1 including the text “wallet balance”.

In the settlement content confirmation region ACR1, as a non-limiting example, the current electronic money account balance of the user (the user A.A) is displayed on the left side, and the electronic money account balance of the user after settlement is displayed on the right side.

Below that, a proposal button BT3 indicated as “Propose” for proposing settlement and a cancel button indicated as “Cancel” for canceling settlement are displayed along with the text “Propose settlement with this content?”.

In this example, the current electronic money account balance of the user A.A is “500 yen”.

Then, when the two requests selected above are settled collectively, for the user A.A, “receipt of 10,000 yen” and “payment of 3,000 yen” result in “receipt of 7,000 yen”. Thus, by adding the collective settlement amount of “7,000 yen” to the current electronic money account balance of “500 yen”, the electronic money account balance after settlement is displayed as “7,500 yen”.

FIG. 1-13 is a diagram showing an example of a notification screen of the payment application that is displayed when the proposal button BT3 is tapped on the above screen. This notification screen is an example of a screen displayed on the display 24 of the terminal 20C of the user C.C, who is the partner of the user A.A.

When the proposal button BT3 is tapped on the screen displayed on the display 24 of the terminal 20A in FIG. 1-12, the terminal 20A requests the server 10 to execute collective settlement. Then, the server 10 transmits collective settlement approval information for confirming whether or not to approve collective settlement to the terminal 20C of the user C.C, who is the partner, and the collective settlement approval information is displayed on the display 24 of the terminal 20C.

The current location display region CLR2 is formed in the upper part of this notification screen, and the word “Notification” is displayed, which indicates that notification regarding the payment application is being displayed.

Under the current location display region CLR2, a notification NT1 including the words “A settlement proposal for a remittance request has arrived” is displayed along with a bell mark, as a notification indicating that a settlement proposal for a remittance request has been received from the terminal 20A of the user A.A via the server 10.

Below that, a notification information display region NTR1 for displaying notification information is included, and information corresponding to the above notification NT1 is displayed in this notification information display region NTR1.

In this example, the icon image of the user A.A, who is the partner, and the collective settlement amount are displayed together with the words “Settlement proposal” as the collective settlement approval confirmation information. In this example, it is displayed that the user C.C needs to pay “7,000 yen” to the user A.A as the collective settlement amount.

Also, in the collective settlement approval confirmation information, a link LK1 with the text “Check details” for checking the detailed content of the collective settlement is formed, and when this link LK1 is tapped, the detailed content of the collective settlement (non-limiting examples of which include a breakdown) can be checked.

Also, instead of displaying the detailed content of the collective settlement from the link LK1 of “Check details”, in a non-limiting example, the detailed content of the collective settlement may be displayed so that it can be switched in the left-right direction and the depth direction. One non-limiting example of this is a carousel display.

This method can be similarly applied to any embodiment.

Also, in the collective settlement approval confirmation information, a settlement button indicated as “Settle” for approving the settlement with the above content and a decline button indicated as “Decline” for declining without approving the settlement with the above content are displayed.

When the above link LK1 is tapped, in a non-limiting example, a screen such as that shown in FIG. 1-14 is displayed.

This screen is a screen displaying a list of unprocessed requests with the user A.A, who is the partner, among the remittance request list screens displayed on the display 24 of the terminal 20C. This screen is a screen corresponding to the screen displayed on the display 24 of the terminal 20A shown in FIG. 1-12.

In the current location display region CLR2, the words “Remittance Requests with User A.A” are displayed, indicating that unprocessed requests with the user A.A are being displayed.

In the settlement content confirmation region ACR2 at the lower part of the screen, as a non-limiting example, the current electronic money account balance of the user (the user C.C) is displayed on the left side, and the electronic money account balance of the user after settlement is displayed on the right side.

Also, below that, a settlement button BT4 indicated as “Settle” for approving settlement and a revision proposal button indicated as “Propose revision” for proposing revision of the settlement without approving the settlement are displayed together with the text “Settle with this content?”.

In this example, the current electronic money account balance of the user C.C is “11,000 yen”.

Then, when the two requests proposed by the user A.A are settled collectively, for the user C.C, “payment of 10,000 yen” and “receipt of 3,000 yen” result in “payment of 7,000 yen”. Accordingly, by subtracting the collective settlement amount of “7,000 yen” from the current electronic money account balance of “11,000 yen”, the electronic money account balance after settlement is displayed as “4,000 yen”.

FIG. 1-15 is a diagram showing an example of a notification screen displayed on the display 24 of the terminal 20A when the settlement button BT4 is tapped.

In this example, in the notification information display region NTR2 of the notification screen, two pieces of settlement result information are displayed as the contents of the collective settlement due to the collective settlement being performed with the user C.C.

Specifically, in a non-limiting example, settlement result information corresponding to each of the third and fourth remittance requests selected in FIGS. 1-11 and 1-12 is displayed.

Each piece of settlement result information displays an individual amount of money together with “requested settlement” and the icon image of the partner user.

Note that, instead of displaying the settlement result information corresponding to each of the selected remittance requests, in a non-limiting example, as shown in FIG. 1-16, the settlement result information can be displayed summarized as one piece of information as a result of collective settlement.

In a non-limiting example, when a detail checking link LK2 included in the settlement result information of FIG. 1-16 is tapped, a screen such as that shown in FIG. 1-17 is displayed.

In the current location display region CLR1 of this screen, the words “Request Settlement” are displayed, which indicate that the result of collective settlement is being displayed.

Below the current location display region CLR1, the collective settlement amount (in this example, “7,000 yen”) of the executed collective settlement and a mark (in this example, a “receipt mark”) are displayed in association with the icon image and user name of the user C.C.

Below that, a list of remittance requests that have been processed in collective settlement is displayed.

Also, an electronic money account balance display region WBR1 is displayed at the lower part of the screen.

In this electronic money account balance display region WBR1, the words “Wallet Balance” are displayed, and below that, a settlement result balance display region ARR1 that shows how the electronic money account balance has changed due to the collective settlement is displayed.

In the settlement result balance display region ARR1, as a non-limiting example, the current electronic money account balance of the user (the user A.A) is displayed on the left side, and the electronic money account balance of the user A.A as a result of collective settlement is displayed on the right side.

Also, below that, the text “Two requests have been settled” is displayed as text indicating that collective settlement has been performed.

In this example, it is displayed that the electronic money account balance of the user A.A has changed from “500 yen” to “7,500 yen” due to the collective settlement.

### Processing

### (1) One Example of Processing

First, one example of processing according to an embodiment will be described.

The processing described below is merely an example of processing for realizing the method of the present disclosure, and there is no limitation to this processing.

Also, another step may be added to the processing described below, and some steps may be omitted (deleted) therefrom.

This also applies to each flow chart (processing) described below.

FIG. 1-18 is a flow chart showing an example of the flow of processing executed by each device according to an embodiment.

In order from left to right, processing executed by the controller 21 of the terminal 20A, processing executed by the controller 21 of the terminal 20B, and processing executed by the controller 11 of the server 10 are shown.

As a non-limiting example, a case is illustrated in which the user A.A of terminal 20A requests that remittance requests performed with the user B.B of terminal 20B are collectively processed.

In this processing, the end determination of the processing is omitted for simplification.

First, the controller 21 of the terminal 20A transmits remittance request list request information for requesting a list of remittance requests to the server 10 through the communication I/F 22, in a non-limiting example, based on the input to the input device (A110).

In response, the controller 11 of the server 10 refers to the first remittance request management data 157A, and transmits remittance request list information regarding the user A.A to the terminal 20A via the communication I/F 14 (S120).

Upon receiving the remittance request list information via the communication I/F 22, the controller 21 of the terminal 20A displays the received remittance request list information on the display 24 (A120).

After that, the controller 21 of the terminal 20A determines whether or not one or more remittance requests have been selected (A130), and if it is determined that one or more have been selected (A130: YES), the controller 21 transmits request selection information relating to the selected remittance request to the server 10 via the communication I/F 22 (A140).

The controller 11 of the server 10 determines whether or not the request selection information has been received from the terminal 20A through the communication I/F 14 (S140), and if it is determined that the request selection information has been received, the controller 11 executes settlement processing (S150).

FIG. 1-19 is a flow chart showing an example of the flow of first settlement processing, which is an example of the settlement processing.

Based on the request selection information received from the terminal 20A, the controller 11 of the server 10 determines whether or not the settlement target is a collective settlement target (S1510). Specifically, the controller 11 determines whether or not two or more (a plurality of) remittance requests have been selected.

If it is determined that the settlement target is a collective settlement target (S1510: YES), the controller 11 of the server 10 calculates the collective settlement amount based on the remittance request amount of the selected remittance request and the type of each selected remittance request (received remittance request (payment)/transmitted remittance request (receipt)) (S1515).

Thereafter, the controller 11 of the server 10 determines whether or not the electronic money account balance of at least one of the proposing user and the partner user will become negative based on the calculated collective settlement amount (S1520).

If it is determined that the electronic money account balance will become negative (S1520: YES), the controller 11 of the server 10, as a non-limiting example, transmits collective settlement NG information indicating that collective settlement cannot be performed to the terminal 20A via the communication I/F 14 (S1523).

Then, the controller 11 of the server 10 ends the first settlement processing.

On the other hand, if it is determined that the electronic money account balance will not become negative (S1520: NO), the controller 11 of the server 10 transmits settlement confirmation information including collective settlement amount information, which is information on the calculated collective settlement amount, to the terminal 20A via the communication I/F 14 (S1525).

When the settlement confirmation information is received from the server 10 via the communication I/F 22, the controller 21 of the terminal 20A displays the received settlement confirmation information on the display 24 (A150).

Thereafter, the controller 21 of the terminal 20A determines whether or not to request the server 10 to execute the settlement based on, in a non-limiting example, whether or not there has been input regarding the settlement confirmation information displayed on the display 24 (A160). Then, if it is determined that execution of the settlement is requested (A160: YES), the controller 21 of the terminal 20A transmits settlement execution request information to the server 10 via the communication I/F 22 (A170).

The controller 11 of the server 10 determines whether or not to execute settlement based on whether or not the settlement execution request information has been received from the terminal 20A via the communication I/F 14 (S1530). Then, if it is determined that settlement is to be executed (S1530: YES), the controller 11 of the server 10 executes collective settlement (S1540).

FIG. 1-20 is a diagram showing an example of a table for describing collective settlement.

In this table, the types of unprocessed requests of the user who proposed the collective settlement (the user A.A in this processing example) are shown vertically and horizontally, and if the partner user (the user B.B in this processing example) is one user, the processing in the case of collective settlement of two unprocessed requests is shown based on the proposal by the proposing user.

The vertical and horizontal unprocessed requests include received remittance requests and transmitted remittance requests.

(1-1) Combination of Received Remittance Request and Received Remittance Request

In this combination, the proposing user (the user A.A) performs remittance to the partner user (the user B.B) based on two unprocessed remittance requests received from the partner user (the user B.B).

In this case, the controller 11 of the server 10 performs processing for remitting, as a collective remittance amount, an amount obtained by adding together the remittance request amounts of the two received remittance requests, from the proposing user to the partner user in collective settlement. Specifically, the controller 11 of the server 10 updates the electronic money account balance of the proposing user by subtracting the collective settlement amount therefrom, and updates the electronic money account balance of the partner user by adding the collective settlement amount thereto.

(1-2) Combination of Received Remittance Request and Transmitted Remittance Request, (1-3) Combination of Transmitted Remittance Request and Received Remittance Request

In this combination, the proposing user can perform remittance/money reception to/from the partner user based on an unprocessed remittance request received from the partner user and an unprocessed remittance request transmitted to the partner user. In this case, since there is a relationship between payment and receipt, the difference between the remittance request amount of the received remittance request and the remittance request amount of the transmitted remittance request is the collective settlement amount.

Hereinafter, finding the difference between the remittance request amounts (subtracting the amounts) is referred to as “amount deduction”.

Note that amount deduction includes canceling out amounts (hereinafter referred to as “amount cancellation”).

Amount cancellation means, in a non-limiting example, that the amounts of remittance requests selected as processing targets cancel each other out and become zero through amount deduction.

The case where amount deduction is performed and the amount becomes zero is amount cancellation.

In this example, if the remittance request amount of the received remittance request (the amount to be remitted) and the remittance request amount of the transmitted remittance request (the amount to be received) are the same amount, amount cancellation will be performed.

In this case, if the remittance request amount (second amount) of the received remittance request is greater than the remittance request amount (first amount) of the transmitted remittance request, the controller 11 of the server 10 calculates an amount (third amount) obtained by subtracting the remittance request amount of the transmitted remittance request from the remittance request amount of the received remittance request as the collective settlement amount. Then, the electronic money account balance of the proposing user is updated by subtracting the collective settlement amount therefrom, and the electronic money account balance of the partner user is updated by adding the collective settlement amount thereto.

In the opposite case, the electronic money account balance of the partner user is updated by subtracting the collective settlement amount therefrom, and the electronic money account balance of the proposing user is updated by adding the collective settlement amount thereto.

Also, if the remittance request amount (second amount) of the received remittance request and the remittance request amount (first amount) of the transmitted remittance request are the same amount, the amounts are cancelled out and no remittance is performed.

Note that, as will be described in detail in later embodiments, in the combination of a received remittance request and a transmitted remittance request, in a non-limiting example, it is also possible to perform processing of “remittance+remittance reminder (or new remittance request)”.

That is, it is possible to perform remittance to the partner user based on the received remittance request and perform a remittance reminder (or a new remittance request) to the partner user based on the transmitted remittance request.

(1-4) Combination of Transmitted Remittance Request and Transmitted Remittance Request

In this combination, based on two unprocessed remittance requests addressed to the partner user (transmitted remittance requests), the proposing user of the collective settlement sends a new remittance request combining the two unprocessed remittance requests into one to the partner user.

This remittance request is a type of remittance request that combines a plurality of remittance requests (hereinafter referred to as a “collective remittance request”), and is used for the purpose of prompting collective remittance of the requested amounts or the like.

For convenience, this remittance request will be referred to as a “confirmation collective remittance request”.

In this case, the controller 11 of the server 10 creates a confirmation collective remittance request based on the request from the terminal 20 of the proposer. Then, the controller 11 of the server 10 transmits the confirmation collective remittance request information corresponding to the created confirmation collective remittance request to the terminal 20 of the partner user.

Note that in the combination of (1-4), instead of transmitting the confirmation collective remittance request information to the terminal 20 of the partner user, the controller 11 of the server 10 may optionally transmit remittance reminder information corresponding to each of a selected plurality of transmitted remittance requests to the terminal 20 of the partner user.

Also, in the combination of (1-4), the user who proposed collective settlement (the user A.A in this processing example) may optionally receive money from the partner user (the user B.B in this example) based on two unprocessed remittance requests.

In this case, in collective settlement, the controller 11 of the server 10 executes processing for remitting an amount obtained by finding the sum of the remittance request amounts of the selected transmitted remittance requests as a collective settlement amount from the partner user to the proposing user. Specifically, the controller 11 of the server 10 updates the electronic money account balance of the partner user by subtracting the collective settlement amount therefrom, and updates the electronic money account balance of the proposing user by adding the collective settlement amount thereto.

Strictly speaking, performing a confirmation collective remittance request (transmitting confirmation collective remittance request information) and performing a remittance reminder (transmitting remittance reminder information) can also be considered to be different from “settlement” in meaning and concept.

However, in this specification, for the sake of simplification, these are also illustrated and described as being encompassed in settlement (being types of settlement).

Returning to FIG. 1-19, after executing the collective settlement in S1540, the controller 11 of the server 10 ends the first settlement processing.

On the other hand, if it is determined that the settlement target is not a collective settlement target, that is, if it is determined that there is one selected remittance request (S1510: NO), the controller 11 of the server 10 determines whether or not the electronic money account balance of the proposing user will become negative (S1570). Then, if it is determined that the electronic money account balance will become negative (S1570: YES), the controller 11 of the server 10, in a non-limiting example, transmits settlement NG information indicating that the settlement cannot be performed to the terminal 20A via the communication I/F 14 (S1573).

Then, the controller 11 of the server 10 ends the first settlement processing.

On the other hand, if it is determined that the electronic money account balance will not become negative (S1570: NO), the controller 11 of the server 10 transmits settlement confirmation information including the settlement amount (remittance request amount of the selected received remittance request) to the terminal 20A via the communication I/F 14 (S1575).

When the settlement confirmation information is received from the server 10 via the communication I/F 22, the controller 21 of the terminal 20A displays the received settlement confirmation information on the display 24 (A150).

Thereafter, in a non-limiting example, the controller 21 of the terminal 20A determines whether or not to request execution of the settlement based on whether or not there has been input regarding the settlement confirmation information displayed on the display 24 (A160). Then, if it is determined that execution of the settlement is to be requested (A160: YES), the controller 21 of the terminal 20A transmits settlement execution request information to the server 10 via the communication I/F 22 (A170).

The controller 11 of the server 10 determines whether or not to execute settlement based on whether or not the settlement execution request information has been received from the terminal 20A via the communication I/F 14 (S1580). Then, if it is determined that settlement is to be executed (S1580: YES), the controller 11 of the server 10 executes the settlement (S1590).

Then, the controller 11 of the server 10 ends the first settlement processing.

Returning to FIG. 1-18, if settlement processing has been executed, the controller 11 of the server 10 determines whether or not the settlement result is “OK” (S170). Then, if it is determined that the settlement result is “OK” (S170: YES), the controller 11 of the server 10 transmits the settlement result information to the terminals 20A and 20B via the communication I/F 14 (S190). Then, the controller 11 of the server 10 ends the processing.

When the settlement result information is received from the server 10 via the communication I/F 22, the controller 21 of the terminal 20A displays the received settlement result information on the display 24 (A190).

Then, the controller 21 of the terminal 20A ends the processing.

Similarly, upon receiving the settlement result information from the server 10 via the communication I/F 22, the controller 21 of the terminal 20B displays the received settlement result information on the display 24 (B190).

Then, the controller 21 of the terminal 20B ends the processing.

### (2) Another Example of Processing

Next, another example of processing according to an embodiment will be described.

The partner user's approval can also be required when performing collective settlement. This is because the following cases are conceivable.

(A) Case where a Malicious User Seeks to Profit Through Collective Settlement

This can be said to be an unavoidable problem in a system in which a remittance request can be created through a user's operation.

In a non-limiting example, it is conceivable that a malicious user will send a false remittance request to a partner user. Specifically, it is assumed that a malicious user creates a false remittance request, sends it to the partner user, and then performs amount cancellation through collective settlement. More specifically, in a non-limiting example, if the user A.A receives a remittance request for a predetermined remittance request amount (e.g., “3,000 yen”) from the user B.B, the user A.A creates a remittance request for the same remittance request amount (e.g., 3,000 yen) and sends it back to the user B.B, whereafter the user A.A performs collective settlement.

In addition to this, it is conceivable that a malicious user slips a false remittance request among remittance requests. Specifically, this is a case in which the malicious user creates and sends several false remittance requests without the partner user realizing it, and the partner user uses the false remittance requests to perform collective settlement.

In these cases, the partner user will be deceived unless the partner user's approval is required.

(B) Case where Collective Settlement is Performed Against the Will of the Partner

In a non-limiting example, this means that collective settlement is performed while including at least one of the remittance requests that have already been sent to the partner user in the target, whereby a remittance request where the partner user is in the position of remittance (payment) is included in the collective settlement, and therefore there is a possibility that the partner user will feel that they have lost out.

However, if all remittance requests are processed, the end result is the same as long as valid remittance requests are processed.

In any of the above cases, the partner user's approval can be required in order to have the partner user confirm whether the remittance requests subject to collective settlement are valid remittance requests (whether the remittance requests are really correct).

FIG. 1-21 is a flow chart showing another example of the flow of processing executed by each device according to an embodiment. The view of the figure is the same as that of FIG. 1-18.

In this processing, the controller 11 of the server 10 executes second settlement processing in S150.

FIG. 1-22 is a flow chart showing an example of the flow of the second settlement processing.

If it is determined in S1530 that a collective settlement execution request has been made (S1530: YES), the controller 11 of the server 10 determines whether or not the approval of the partner user is required (S1531). Specifically, in a non-limiting example, it is determined whether or not a remittance request management ID for which an associated remittance master ID is the application ID of the user A.A, and for which the associated remittance request destination ID is the application ID of a user other than the user A.A, is included among the remittance request management IDs of two or more selected remittance requests, that is, whether or not a remittance request from the partner (the user B.B) to the proposing user (the user A.A) is included among the remittance request management IDs of two or more selected remittance requests.

If it is determined that the approval of the partner user is required (S1531: YES), the controller 11 of the server 10 transmits collective settlement approval confirmation information including the collective settlement amount information as information for the partner user (in this example, the user B.B) to confirm whether or not collective settlement is to be approved, to the terminal 20B via the communication I/F 14 (S1533).

The controller 21 of the terminal 20B determines whether or not the collective settlement approval confirmation information has been received from the server 10 via the communication I/F 22 (B150), and if the collective settlement approval confirmation information has been received (B150: YES), the received collective settlement approval confirmation information is displayed on the display 24 (B160).

Thereafter, the controller 21 of the terminal 20B determines whether or not to approve collective settlement based on whether or not input for approving the collective settlement has been made to the input device (B170). If it is determined that collective settlement is approved (B170: YES), the controller 21 of the terminal 20B transmits collective settlement approval information indicating that collective settlement is approved to the server 10 via the communication I/F 22 (B180).

After S1533, the controller 11 of the server 10 determines whether or not collective settlement has been approved by the partner user based on whether or not the collective settlement approval information has been received from the terminal 20B via the communication I/F 14 (S1535). Then, if it is determined that collective settlement has been approved (S1535: YES), the processing moves to S1540.

### First Processing Executed by Terminal

Non-limiting examples of the first processing, which is processing executed by a terminal with the controller and is executed based on first information and second information, can include processing relating in some way to remittance from a proposing user (user of the terminal) to a partner user (first user, second user), and processing relating in some way to the proposing user receiving an amount remitted from the partner user. The first processing can include not only processing directly relating to remittance or money reception, but also processing indirectly relating to remittance or money reception.

In a non-limiting example, at least the following processing is included in the first processing.
Processing for selecting a remittance request
Processing for notifying the server 10 of a selected remittance request
Processing for acquiring settlement confirmation information from the server 10 and processing for displaying the settlement confirmation information on the display 24
Processing for requesting the server 10 to execute settlement
Processing for acquiring settlement result information from the server 10 and processing for displaying the settlement result information on the display 24
Processing for requesting the server 10 to perform amount deduction (including amount cancellation)
Processing for requesting the server 10 to create a confirmation collective remittance request

### Input to Terminal, Etc.

In the above processing, input to the terminal or input performed by the user of the terminal is operation input to the input device (operation device), but there is no limitation to this.

In a non-limiting example, sound (including voice) input to the input device (sound input device 25) may optionally be possible instead of or in addition to operation input to the input device (operation device).

The same applies also to other input to the terminal or by the user of the terminal.

### Effect of First Embodiment

According to the present embodiment, in a non-limiting example, a plurality of remittance requests can be processed collectively, and therefore convenience for the user can be improved.

Also, in a non-limiting example, since remittance and money reception can be performed within a range that does not exceed the balance of the user, convenience for the user can be improved.

More specifically, this embodiment shows a configuration in which a terminal 20 displays, on the display 24, a display (a non-limiting example of first display) based on remittance request information (a non-limiting example of first information) relating to a remittance request from a first user (a non-limiting example of a first user) of a terminal 20 that is different from the terminal 20, to a user of the terminal 20 (a non-limiting example of a user of a terminal) or first remittance request information (a non-limiting example of first information) relating to a remittance request from the user of the terminal 20 to the first user, and a display (a non-limiting example of a second display) based on second remittance request information with the above-described first user (a non-limiting example of a second user).

Then, with the controller 21, the terminal 20 performs the first processing (a non-limiting example of first processing performed based on the first information and the second information) performed based on the first remittance request information and the second remittance request information, based on the input to the terminal 20 on which the above-described first display and second display are displayed.

As an example of the effect of the embodiment obtained by such a configuration, it is possible to collectively process a plurality of pieces of information relating to remittance requests, based on input to a terminal on which a first display based on first information relating to a remittance request from the first user to the user of the terminal or a remittance request from the user of the terminal to the first user, and a second display based on second information relating to a remittance request from the second user to the user of the terminal or a remittance request from the user of the terminal to the second user, and thus convenience for the user can be improved.

Also, this embodiment shows a configuration in which the first remittance request information includes information relating to a remittance request from the partner user to the user of the terminal 20 (a non-limiting example of information relating to a remittance request from the first user to the user of the terminal), and the second remittance request information includes information relating to a remittance request from the user of the terminal 20 to the partner user (a non-limiting example of information relating to a remittance request from the user of the terminal to the second user).

As an example of the effect of the embodiment obtained by such a configuration, in a non-limiting example, the difference between the amount to be remitted by the user of the terminal to the first user (amount to be paid by the user of the terminal) and the amount to be remitted to the user of the terminal by the second user (the amount to be received by the user of the terminal) can be remitted to the first user or received from the second user through the above-described collective processing. In this case, the amount to be remitted or the amount to be received will be smaller (the absolute value of the amount corresponding to the difference will be smaller) compared to the case where a plurality of pieces of information relating to remittance requests are processed one by one. For this reason, as one non-limiting effect, the likelihood of being able to perform processing within the range of the user's balance increases, and the hassle of adding money and taking out a loan for the user to make the remittance is avoided. Also, as one non-limiting effect, a plurality of pieces of information can be processed collectively, and therefore an increase in the number of processed cases can be expected.

Also, this embodiment shows a configuration in which the first remittance request information includes information on a first remittance request amount (a non-limiting example of the first amount relating to remittance), and the second remittance request information includes information on the second remittance request amount (a non-limiting example of a second amount relating to remittance).

As an example of the effect of the embodiment obtained by such a configuration, the first display and the second display can notify the user of the terminal of the first amount relating to remittance and the second amount relating to remittance.

Also, this embodiment shows a configuration in which the first processing includes processing performed based on the first remittance request amount and the second remittance request amount.

As an example of the effect of the embodiment obtained by such a configuration, in a non-limiting example, it is possible to perform processing such as collective settlement based on the amount of the difference between the first amount and the second amount.

Also, according to an embodiment, the terminal 20 transmits the collective settlement confirmation information based on the second remittance request information to the terminal 20 of the first user (a non-limiting example of the terminal of the second user) with the communication I/F 22 via the server 10. In this case, the first processing shows a configuration in which the processing is executed by the controller 21 based on the first user's approval of the execution of the first processing, which is obtained based on the collective settlement confirmation information.

As an example of the effect of the embodiment obtained by such a configuration, the first processing can be executed if the partner approves. Also, in a non-limiting example, the first processing can be prevented from being executed if the execution of the first processing has not been approved by the partner.

Also, this embodiment shows a configuration in which the second user is the first user.

As an example of the effect of the embodiment obtained by such a configuration, the first processing can be executed based on information relating to a plurality of remittance requests with one user (first user) who is different from the user of the terminal 20.

Also, the present embodiment shows a configuration in which the first processing includes processing for, if the second remittance request amount is greater than the first remittance request amount, remitting an amount (a non-limiting example of a third amount) obtained by deducting the first remittance request amount from the second remittance request amount to the first user.

As an example of the effect of the embodiment obtained by such a configuration, the amount corresponding to the difference between the second amount and the first amount can be remitted to the first user, and therefore the amount to be paid can be reduced compared to that in the case of performing remission based on one piece of information, and thus convenience for the user can be improved.

Also, this embodiment shows a configuration in which the first remittance request information (a non-limiting example of the first information) includes information on a first remittance request amount (a non-limiting example of the first amount), the second remittance request information (a non-limiting example of the second information) includes information on a second remittance request amount (a non-limiting example of the second amount), and the first processing is performed by the controller 21 based on the first remittance request amount, the second remittance request amount, and the electronic money account balance of the user of the terminal 20 (a non-limiting example of the balance of the user of the terminal).

As an example of the effect of the embodiment obtained by such a configuration, the first processing performed based on the first amount and the second amount can be executed with consideration given to the balance of the user of the terminal. As a result, in a non-limiting example, the first processing can be executed if the balance of the user of the terminal is sufficient, but the first processing cannot be executed if the balance of the user of the terminal is insufficient.

Also, the present embodiment shows a configuration in which the first processing is executed based on operation of a proposal button by the user of the terminal 20 (a non-limiting example of input regarding a fifth display) and the approval of the partner user regarding collective settlement (a non-limiting example of the approval of the first user or the second user regarding execution of the first processing).

As an example of the effect of the embodiment obtained by such a configuration, it is possible to prevent the first processing from being executed unless both the input by the user of the terminal to the fifth display and the approval of the first user or the second user relating to the execution of the first processing are received.

Also, the present embodiment shows a configuration in which the first processing is executed based on the electronic money account balance of the proposing user (a non-limiting example of the balance of the user of the terminal) and the electronic money account balance of the partner user (a non-limiting example of the balance of the first user, or the second user).

As an example of the effect of the embodiment obtained by such a configuration, it is possible to execute the first processing with consideration given to not only the balance of the user of the terminal but also the balance of the first user or the second user. As a result, in a non-limiting example, the first processing can be executed if the balance of the first user or the second user is sufficient, and the first processing cannot be executed if the balance of the first user or the second user is insufficient.

Also, the present embodiment shows a configuration in which the first processing includes processing performed based on a first remittance request and a second remittance request based on input performed by the proposing user on the terminal 20, out of a plurality of pieces of remittance request information relating to the proposing user, which include first remittance request information and second remittance request information (a non-limiting example of a plurality of pieces of information relating to a remittance request to the user of the terminal or a remittance request performed by the user of the terminal, which include at least first information and second information).

As an example of the effect of the embodiment obtained by such a configuration, it is possible to appropriately process the first information and the second information out of the plurality of pieces of information relating to the remittance requests to the user of the terminal or the remittance requests performed by the user of the terminal, which include the first information and the second information, based on input performed by the user of the terminal to the terminal.

Also, the present embodiment shows a configuration in which the partner user is one user (a non-limiting example of the second user being the first user), and the first processing includes processing relating to remitting from the partner user to the proposing user and processing for remitting from the proposing user to the partner user.

As an example of the effect of the embodiment obtained by such a configuration, it is possible to realize remittance from the first user to the user of the terminal and remittance from the user of the terminal to the first user based on a plurality of pieces of information relating to the remittance requests, with the same user (first user=second user) as the partner user.

Also, the present embodiment shows a configuration in which the processing relating to the remittance described above includes processing for displaying collective settlement confirmation information and collective settlement result information (non-limiting examples of information indicating that processing for a remittance request based on first information and processing for a remittance request based on second information have been executed) on the display 24.

As an example of the effect of the embodiment obtained by such a configuration, it is possible to notify the user of the terminal that the processing for the remittance request based on the first information and the processing for the remittance request based on the second information have been executed.

### First Modified Example (1)

As described above, even if the partner users are a plurality of different users, the method of the above embodiment can be similarly applied.

FIG. 1-23 is a diagram showing an example of a remittance request list screen displayed on the display 24 of the terminal 20 in this modified example. This screen is an example of the remittance request list screen displayed on the display 24 of the terminal 20A, and in a non-limiting example, is an example of a screen displayed when the remittance request list icon is tapped on the main menu screen of FIG. 1-9.

In the current location display region CLR1, the words “Remittance Request List” are displayed, which indicate that remittance request list information is being displayed.

Below the current location display region CLR1, unprocessed requests sent and received with a plurality of users of different terminals 20 are displayed in chronological order from the top, as a non-limiting example. In this example, from top to bottom, a remittance request received from the user B.B, a remittance request received from the user C.C, a remittance request received from the user B.B, a remittance request received from the user C.C, a remittance request received from the user D.D, a remittance request transmitted to the user C.C, . . . are displayed.

Next to each remittance request, a check region SR2 in which a check can be switched “ON/OFF” by tapping is provided, a check mark is displayed in the check region SR2 by turning “ON” the check, and the remittance request with that user can be selected as a target for collective settlement.

In this example, a state is shown in which the first received remittance request from the user B.B (payment of 2,000 yen) and the fourth received remittance request from the user C.C (payment of 1,000 yen) are selected. When the settlement button BT5 at the lower part of the screen is tapped in this state, settlement request information for requesting collective settlement of the two selected remittance requests is transmitted from the terminal 20A to the server 10.

In this example, the remittance is remittance (payment) from the user A.A to the user B.B and remittance (payment) from the user A.A to the user C.C, and since there is no remittance (receipt) from the partner user, approval from the partner user can be omitted.

Also, collective settlement is executed by the server 10, and remittance (payment) of “2,000 yen” from the user A.A to the user B.B and remittance (payment) of “1,000 yen” from the user A.A to the user C.C are realized.

This modified example shows a configuration in which the first user is a different user from the second user.

As an example of the effect of the modified example obtained by such a configuration, the first processing can be executed based on information relating to a plurality of remittance requests between at least two users different from the user of the terminal 20 (a first user and a second user different from the second user).

### First Modified Example (2)

In the first embodiment, the proposing user manually selects the remittance requests to be the target of collective settlement, but there is no limitation to this.

The terminal 20 of the proposing user or the server 10 may optionally automatically select remittance requests to be the target of collective settlement.

The automatic selection of remittance requests to be the target of collective settlement by the terminal 20 of the proposing user or the server 10 also includes the meaning of proposing (suggesting) the selected remittance requests to the proposing user.

Specifically, the controller 21 of the terminal 20 of the proposer performs processing for inquiring of the server 10 about the current electronic money account balance of the proposing user. Then, the controller 21 of the terminal 20 of the proposer selects one or more remittance request such that, in a non-limiting example, the current electronic money account balance of the proposing user reaches an upper limit of a payment amount, based on each remittance request amount and the type of each remittance request (received remittance request (payment)/transmitted remittance request (receipt)) from among the remittance requests included in the remittance request list information received from the server 10. That is, one or a plurality of remittance requests are selected within a range in which the current electronic money account balance of the proposing user does not become negative.

Note that if the controller 11 of the server 10 selects a remittance request, similar processing may be performed based on the data of the remittance request stored in the first remittance request management data 157A.

This modified example shows a configuration in which the first processing includes processing in which at least first remittance request information and second remittance request information are selected among a plurality of pieces of remittance request information (a non-limiting example of a plurality of pieces of information) based on the electronic money account balance of the proposing user (a non-limiting example of the balance of the user of the terminal) and the processing is performed based on at least the first remittance request information and the second remittance request information.

As an example of the effect of the embodiment obtained by such a configuration, at least the first information and the second information among the plurality of pieces of information can be automatically selected with consideration given to the balance of the user of the terminal, and settlement can be performed. In this case, since the user of the terminal does not need to manually select the information, convenience for the user can be improved.

### First Modified Example (3)

The user interface of the display screen shown in Display Screen in the first embodiment is merely an example, and there is no limitation thereto.

FIG. 1-24 is a diagram showing another example of the UI (user interface) of the display screen displayed on the display 24 of the terminal 20. This display screen is an example of the remittance request list screen displayed on the display 24 of the terminal 20A, and is a diagram showing another example of the remittance request list screen corresponding to FIG. 1-12.

On this display screen, received remittance requests and transmitted remittance requests are displayed in a table format as a list of remittance requests with the user C.C. In this example, a list of received remittance requests is displayed in the left column of the table, and a list of transmitted remittance requests is displayed in the right column of the table.

For each of the list of received remittance requests and the list of transmitted remittance requests, the display field of each remittance request shows information such as the date and time of receipt/transmission of the remittance request, reason for payment, request type “payment/receipt”, and the remittance request amount.

By performing such a display, it is possible to confirm the received remittance requests and the transmitted remittance requests while comparing them, and the convenience for the user can be improved.

Also, in the above embodiment, unprocessed remittance requests are displayed on the remittance request list screen, but there is no limitation to this.

Also, in a non-limiting example, a list of unprocessed remittance requests may optionally be confirmed from a screen such as the notification screen of the payment application, the profile screen of the payment application, and the top screen of the payment application.

### First Modified Example (4)

In the above embodiment, a case was described in which approval from the partner user is required in collective settlement. However, if the system is configured such that a remittance request cannot be created based on the operation of the user, the approval of the partner user can also be omitted.

Non-limiting examples of such a system can include a system that associates and manages the user's electronic money or electronic payment with a remittance request. More specifically, a system is conceivable in which after one user makes an electronic payment with electronic money, at least part of the payment amount can be billed to another user by a remittance request as a reimbursement amount. One application of this system is, in a non-limiting example, splitting a bill among a plurality of users.

In this case, after the electronic payment is made, the server 10 can create a remittance request with the reimbursement amount as the remittance request amount according to the user's operation, and transmit the created remittance request to the terminal 20 of another user.

In such a system, a user who wants to perform collective settlement needs to use his or her electronic money account balance to make an electronic payment once, and therefore the risk that the above-described collective settlement will be abused can be reduced without limit.

### First Modified Example (5)

In performing collective settlement, a settlement proposal in which it is proposed by the partner user that one user performs payment (a settlement proposal in which one user needs to pay the partner user) may be a new remittance request in which remittance is requested from the partner user, and this new remittance request may be managed by the server 10 as an unprocessed received remittance request for one user.

Specifically, in a non-limiting example, in the example of FIG. 1-13, a settlement proposal in which the user C.C (one user) is proposed by the user A.A (the partner user) to make a payment of “7,000 yen” may be managed by the server 10 as a new remittance request by which the user A.A requests remission of “7,000 yen”, and this remittance request may be managed on the server 10 side as an unprocessed received remittance request for “payment of 7,000 yen” for the user C.C.

Also, in a non-limiting example, the user can be allowed to trace a record relating to one remittance request by, for example, making it possible to display, in a hierarchical manner in a time axis direction, information (non-limiting examples of which include detailed information on the type of the remittance request, the remittance request amount, the date and time, the reason, etc.) relating to a remittance request that contributed to the creation of the received remittance request (a remittance request that was a cause of creating the received remittance request), when the received remittance request that was newly created as described above is tapped, on a remittance request list screen or the like displayed by the terminal 20 on the display 24.

Specifically, when the unprocessed received remittance request for “payment of 7,000 yen” of the user C.C above is tapped, information relating to the remittance requests that contributed to the creation of this received remittance request, in a non-limiting example, the third received remittance request “payment of 10,000 yen” and the fourth transmitted remittance request “receipt of 3,000 yen” in the example of FIG. 1-14 may be displayed.

Note that this method can also be applied to transmitted remittance requests.

### First Modified Example (6)

In the first embodiment, the first user and the second user are described as the users of the terminals 20, who are general users, but there is no limitation to this.

At least one of the first user and the second user may optionally be a user who is a business operator of a store or the like, instead of a general user. Non-limiting examples of business operators in this case include business operators who are envisioned as billing money to the user of the terminal 20 through a remittance request, such as a business operator who sells products (including provision of services) and a business operator who runs a money lending business

In this case, in the above embodiment, these business operators acquire accounts in the payment service (payment application). Then, using this account, it is possible to transmit remittance request information and remittance reminder information to the terminal 20 of the user to whom the money is billed (remittance request destination user) via the server 10.

Note that the account acquired by the above-described business operator (store) may be a general account, which is an account for the user of the terminal 20, or may be an account for a business operator.

This modified example shows a configuration in which at least one of the first user and the second user is a store that sells a product relating to the remittance request.

As an example of the effect of the modified example obtained by such a configuration, not only a general user but also a user who is a store can be users who can make remittance requests to a user of a terminal.

### First Modified Example (7)

It is assumed that some users of the terminal 20 will feel uncomfortable and hesitate to propose collective settlement to the partner user. In a non-limiting example, this is a case where the partner user is the user's superior or the partner user is a person with whom the partner user has a particularly close relationship, such as a close friend.

In view of this, instead of the user of the terminal 20, the user who has proposed the collective proposal can also be a user who uses a business account.

A business account is, in a non-limiting example, a user who has an official account (hereinafter referred to as “official account” and expressed as “OA: Official Account” as appropriate) in that service (payment service in the above example).

As an example, a user with an official account may be, in a non-limiting example, a business operator of a payment service or a business operator of a messaging service.

In this case, the server 10 can transmit the collective settlement approval confirmation information to the terminal 20 of the partner user, with the user who proposed the collective settlement as the business operator of a payment service or the business operator of a messaging service.

This modified example shows a configuration in which the user who proposes the collective settlement is a user who uses an official account (a non-limiting example of a business account).

As an example of the effect of the modified example obtained by such a configuration, it is possible to allow a user who uses a business account to request collective settlement instead of the user who wishes to make a collective settlement, and therefore convenience for the user can be improved.

### Second Embodiment

The second embodiment is an embodiment relating to processing in the case where the user's balance is insufficient in the collective settlement described in the first embodiment.

The content described in the second embodiment can be applied also to any of the other embodiments and the other modified examples.

Also, constituent elements that are the same as constituent elements that have already appeared are denoted by the same reference signs thereas, and redundant description thereof is omitted.

### Display Screen

FIG. 2-1 is a diagram showing an example of a remittance request list screen displayed on the display 24 of the terminal 20 according to an embodiment.

This remittance request list screen is a screen displayed on the display 24 of the terminal 20A of the user A.A, and is a list screen of remittance requests with the user B.B as the partner.

In the current location display region CLR1 at the upper part of the screen, the words “Remittance Requests with User B.B” are displayed, indicating that unprocessed requests with the user B.B are being displayed.

Below the current location display region CLR1, a list of remittance requests with the user B.B as the partner is displayed. In this example, the first received remittance request, the second received remittance request, and the fourth transmitted remittance request are selected, and the change in the electronic money account balance of the user (the user A.A) is shown in the settlement content confirmation region ACR3 in the electronic money account balance display region WBR2 at the lower part of the screen. In this example, it is shown that the current electronic money account balance of the user is “500 yen”, and the electronic money account balance of the user will be “0 yen” due to the collective settlement. In this case, since the balance is sufficient, collective settlement is possible.

Also, a top-up button for adding money to the wallet balance, which is indicated by a plus icon in a circle, is additionally displayed to the right of the words “Wallet Balance” in the electronic money account balance display region WBR2.

FIG. 2-2 is a diagram showing a remittance request list screen similar to the screen of FIG. 2-1, but the selected remittance requests are different.

In this example, in addition to the first received remittance request, the second received remittance request, and the fourth transmitted remittance request, the third received remittance request is selected, and the change in the electronic money account balance of the user (the user A.A) is shown in the settlement content confirmation region ACR4 in the electronic money account balance display region WBR2. In this example, the current electronic money account balance is “500 yen”, and the electronic money account balance of the user will be “−500 yen” due to the collective settlement. In this example, the payment is “payment of 1,000 yen”, whereas the current electronic money account balance of the user is “500 yen”, and therefore the balance is insufficient by “500 yen” and collective settlement cannot be performed.

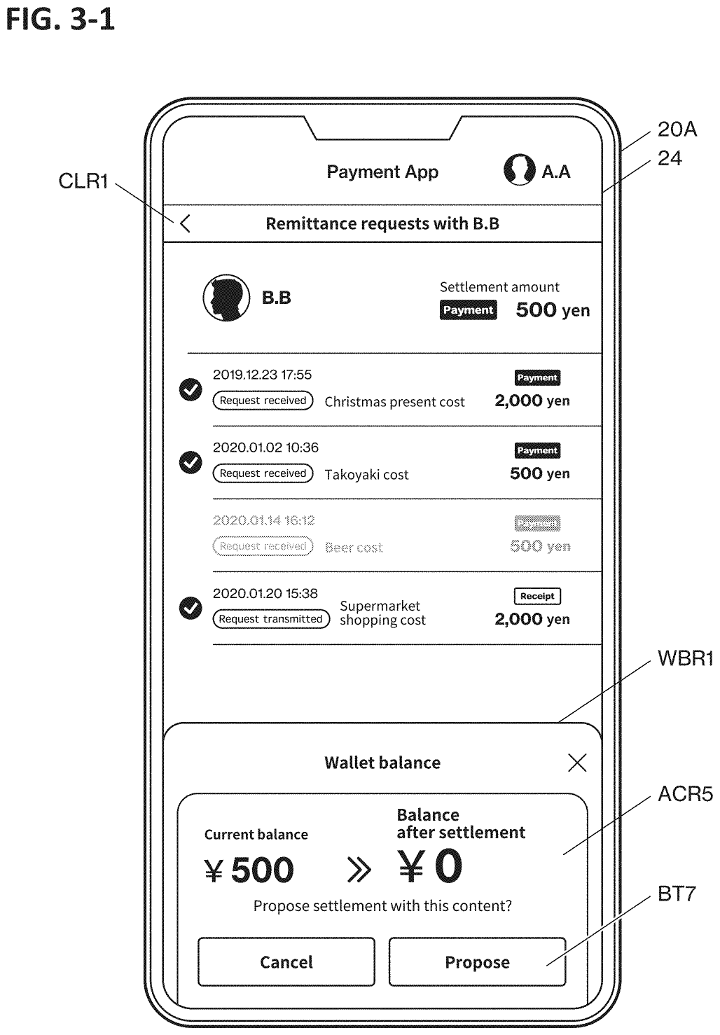

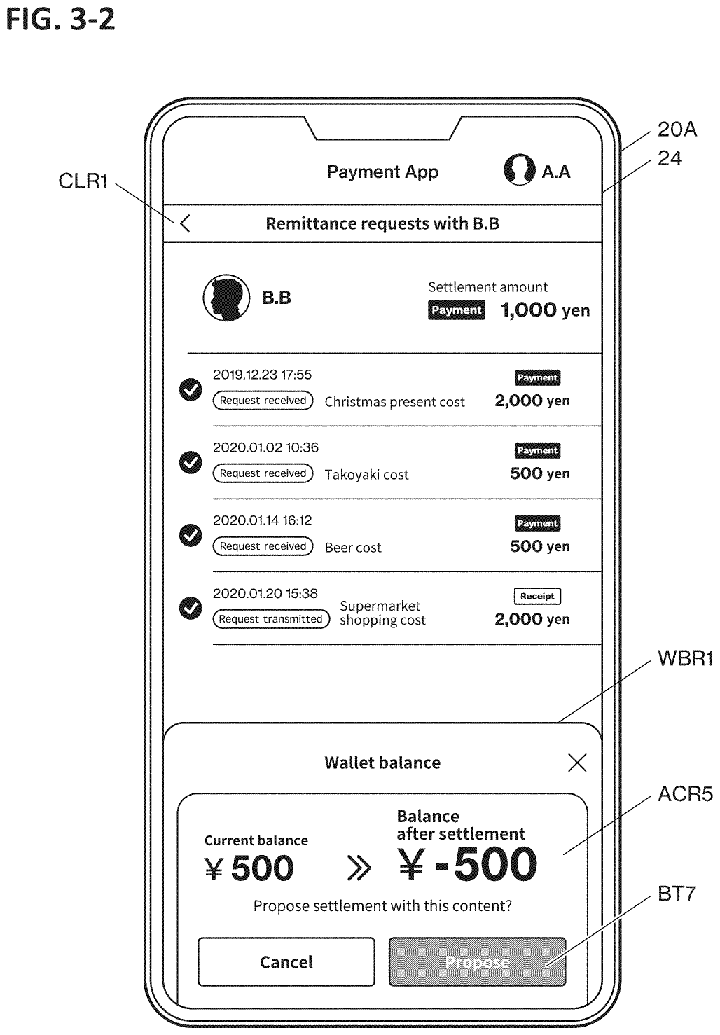

In this case, in the settlement content confirmation region ACR4, the text “Insufficient balance!” is displayed with a warning mark as a non-limiting example, as insufficient balance information indicating that the electronic money account balance is insufficient. In this state, when the proposal button BT6 is tapped, a display as shown in FIG. 2-3 is shown.

In FIG. 2-3, top-up confirmation information CG1 is displayed as a pop-up as information for the user to confirm whether or not addition of money to the electronic money account balance is to be performed, in the center of the remittance request list screen in FIG. 2-2. Specifically, an OK button for approving the topping-up and a cancel button for canceling the topping-up are displayed together with the text “Top up the shortfall of 500 yen?”.

When the OK button is tapped in this state, the server 10 executes top-up processing for adding “500 yen” to the electronic money account balance of the user A.A. Thereafter, collective settlement is performed.

### Processing

FIGS. 2-4 and 2-5 are flow charts showing an example of the flow of third settlement processing, which is an example of settlement processing executed by the controller 11 of the server 10 according to an embodiment.

If it is determined in S1520 that the electronic money account balance of any user will be negative (S1520: YES), the controller 11 of the server 10 determines whether or not the user whose electronic money account balance will become negative is the proposing user (S1550). Then, if it is determined that the user is the proposing user (S1550: YES), in a non-limiting example, the controller 11 of the server 10 transmits collective settlement confirmation information including collective settlement amount information and insufficient balance information to the terminal 20A via the communication I/F 14 (S1551).

Thereafter, the controller 11 of the server 10 determines whether or not execution of collective settlement has been requested based on whether or not settlement execution request information has been received from the terminal 20A via the communication I/F 14 (S1553). Then, if it is determined that execution of collective settlement has been requested (S1553: YES), the controller 11 of the server 10 determines whether or not to add money to the electronic money account balance of the user A.A (S1555). Specifically, in a non-limiting example, the top-up confirmation information described above is transmitted to the terminal 20A and displayed on the display 24, and it is determined whether or not information for approving the topping-up has been received from the terminal 20A.

If it is determined that topping-up is to be performed (S1555: YES), the controller 11 of the server 10 executes top-up processing (S1557). Specifically, processing for replenishing the electronic money account balance of the user A.A with the shortfall amount of the collective settlement is executed using a bank account or credit card of the user A.A that has been registered in advance. Then, the controller 11 of the server 10 moves the processing to S1531.

On the other hand, if it is determined that the user whose electronic money account balance will become negative is not the proposing user, that is, if it is determined that the user whose electronic money account balance will become negative is the partner user (S1550: NO), the controller 11 of the server 10 transmits collective settlement confirmation information including collective settlement amount information to the terminal 20A via the communication I/F 14 (S1559).

Thereafter, if it is determined that execution of collective settlement has been requested from terminal 20A (S1561: YES), the controller 11 of the server 10 transmits collective settlement approval confirmation information including collective settlement amount information and insufficient balance information to the terminal 20B via the communication I/F 14 (S1563).

Thereafter, the controller 11 of the server 10 determines whether or not collective settlement has been approved based on whether or not collective settlement approval information has been received from the terminal 20B via the communication I/F 14 (S1565).

If it is determined that collective settlement has been approved (S1565: YES), the controller 11 of the server 10 determines whether or not to add money to the electronic money account balance of the user B.B (S1567). Specifically, in a non-limiting example, the top-up confirmation information described above is transmitted to the terminal 20B and displayed on the display 24, and it is determined whether or not information for approving the topping-up has been received from the terminal 20B.

If it is determined that topping-up is to be performed (S1567: YES), the controller 11 of the server 10 executes top-up processing (S1569). Specifically, processing for replenishing the electronic money account balance of the user B.B with the shortfall amount of the collective settlement is executed using a bank account or credit card of the user B.B that has been registered in advance.

Then, the controller 11 of the server 10 shifts the processing to S1540.

If it is determined in S1553 that execution of collective settlement has not been requested (S1553: NO), or if it is determined in S1555 that topping-up is not to be performed (S1555: NO), the controller 11 of the server 10 ends the third settlement processing.

Also, if it is determined in S1561 that the execution of the collective payment has not been requested (S1561: NO), if it is determined in S1565 that the collective payment has not been approved (S1565: NO), or if it is determined in S1567 that topping-up is not to be performed (S1567: NO), the controller 11 of the server 10 ends the third settlement processing.

Note that before the processing of S1540 is executed, processing that is the same as that of S1520 may be executed again, and if it is determined that the electronic money account balance of any user will become negative, the processing of S1540 may optionally be suspended.

### Effect of Second Embodiment

This embodiment shows a configuration in which the first remittance request information (a non-limiting example of the first information) includes information of the first remittance request amount (a non-limiting example of the first amount), the second remittance request information (a non-limiting example of second information) includes information of a second remittance request amount (a non-limiting example of the second amount), and the first processing is performed by the controller 21 based on the first remittance request amount, the second remittance request amount, and the electronic money account balance of the user of the terminal 20 (a non-limiting example of the balance of the user of the terminal).

As an example of the effects of the embodiment obtained by such a configuration, it is possible to appropriately execute the first processing based on the first amount and the second amount with consideration given to the balance of the user of the terminal.

Also, this embodiment shows a configuration in which, when the sum of the first remittance request amount and the second remittance request amount exceeds the electronic money account balance of the user of the terminal 20 and the user of the terminal 20 performs remittance, display of insufficient balance information (a non-limiting example of a third display indicating that the first processing cannot be executed) is displayed on the display 24 of the terminal 20.

As an example of the effect of the embodiment obtained by such a configuration, if the user of the terminal performs remittance even though the sum of the first amount and the second amount exceeds the balance of the user of the terminal, the user of the terminal can be notified that the first processing cannot be executed.

Also, according to an embodiment, if the sum of the first remittance request amount and the second remittance request amount exceeds the electronic money account balance of the user of the terminal 20 and the user of the terminal 20 performs remittance, display of top-up confirmation information to the electronic money account balance of the user of the terminal 20 (a non-limiting example of a fourth display indicating that money is to be added to the balance) is displayed on the display 24 of the terminal 20.

As an example of the effect of the embodiment obtained by such a configuration, if the user of the terminal performs remittance even though the sum of the first amount and the second amount exceeds the balance of the user of the terminal, the user of the terminal can be notified that it is possible to add money to the balance to make up for the shortfall.

### Second Modified Example

In the second embodiment, in a non-limiting example, when the terminal 20 displays the remittance request list screen on the display 24, information (top-up information) indicating that money can be added to the electronic money account balance and information (loan information) indicating that a loan (lending) can be made may optionally be displayed on the display 24.

Non-limiting examples of business operators who provide loans can include a business operator of a payment service (a business operator of a payment application), a business operator of a messaging service (a business operator of a messaging application), or a financial institution such as a bank.

In this case, the server 10 can lend money in the form of electronic money (by means of electronic money) within a certain loan amount range based on input performed by the user to request a loan. Alternatively, the server 10 can communicate with a server of an affiliated financial institution to request a loan and have the loan approved.

Note that in this case, the electronic money account balance may be treated as either negative or positive.

If settlement is performed with a loan, in a non-limiting example, the user may be required to repay the loan amount by a set repayment deadline.

Note that as a method of repayment in this case, a method of repayment similar to that of a general loan can be applied, or the like.

This modified example shows a configuration in which the terminal 20 displays, on the display 24, a display based on the first remittance request information (a non-limiting example of the first display), a display based on the second remittance request information (a non-limiting example of the second display), a display of top-up information (a non-limiting example of display relating to adding money to the balance), or loan information (a non-limiting example of display relating to taking out a loan).

As an example of the effect of the modified example obtained by such a configuration, when the first display based on the first information and the second display based on the second information are displayed, display relating to adding money to the balance or display relating to making a loan is performed as well, whereby it is possible for the user to add money to the balance or take out a loan.

### Third Embodiment

The third embodiment relates to the second embodiment, and is an embodiment in which the display mode of the display relating to the execution of collective settlement is changed.

The content described in the third embodiment can be applied to any of the other embodiments and the other modified examples.

Also, constituent elements that are the same as constituent elements that have already appeared are denoted by the same reference signs thereas, and redundant description thereof is omitted.

### Display Screen

FIG. 3-1 is a diagram showing an example of a remittance request list screen displayed on the display 24 of the terminal 20 according to an embodiment.

This remittance request list screen is a screen corresponding to the screen of FIG. 2-1 displayed on the display 24 of the terminal 20A of the user A.A, and is displayed when the electronic money account balance of the user A.A is sufficient.

In the settlement content confirmation region ACR5 at the lower part of the screen, it is shown that although the electronic money account balance will be “0 yen” due to collective settlement, collective settlement is possible.

In this case, when the proposal button BT7 is operated (tapped), the terminal 20A accepts the operation of proposing collective settlement.

FIG. 3-2 is a diagram showing another example of the remittance request list screen displayed on the display 24 of the terminal 20 according to an embodiment.

This remittance request list screen is a screen corresponding to the screen of FIG. 2-2 displayed on the display 24 of the terminal 20A of the user A.A, and is displayed when the electronic money account balance of the user A.A is insufficient.

On this screen, based on the fact that the electronic money account balance of the user A.A is insufficient, the proposal button BT7 displayed in the settlement content confirmation region ACR5 at the lower part of the screen is displayed in a display mode different from that shown in FIG. 3-1. Specifically, in a non-limiting example, the proposal button BT7 is displayed grayed out, and even if the proposal button BT7 is operated (tapped), the terminal 20A does not accept that operation.

Note that in FIG. 3-2, a top-up button for adding money to the electronic money account may optionally be displayed in the electronic money account balance display region WBR1 to prompt the user to add money to the electronic money account.

Also, if the business operator running the payment service is affiliated with a financial institution, a loan function button may optionally be displayed for receiving a loan from the financial institution and adding money to the electronic money account.

### Effect of Third Embodiment

In this embodiment, the terminal 20 displays the display of the proposal button (a non-limiting example of the fifth display relating to execution of the first processing) on the display 24. In this case, a configuration is shown in which the display mode of the proposal button is changed based on the first remittance request amount, the second remittance request amount, and the electronic money account balance of the user.

As an example of the effect of the embodiment obtained by such a configuration, the display mode of the fifth display relating to the execution of the first processing is changed based on the first amount, the second amount, and the balance of the user of the terminal, and therefore, in a non-limiting example, it is possible to easily and appropriately notify the user of the terminal that the first processing cannot be executed, with consideration given to the balance of the user of the terminal.

Also, the present embodiment shows a configuration in which the display of the proposal button is displayed on the display 24 of the terminal 20 in a display mode (a non-limiting example of a display mode indicating that the first processing cannot be executed) indicating that operation cannot be accepted if the sum of the first remittance request amount and the second remittance request amount exceeds the electronic money account balance of the user of the terminal 20 and the user of the terminal 20 performs remittance.

As an example of the effect of the embodiment obtained by such a configuration, if the user of the terminal performs remittance even though the sum of the first amount and the second amount exceeds the balance of the user of the terminal, the user of the terminal can be notified that the first processing cannot be executed.

### Fourth Embodiment

The fourth embodiment is an embodiment relating to a method (algorithm) of processing for collective settlement.

The content described in the fourth embodiment can be applied also to any of the other embodiments and the other modified examples.

Also, constituent elements that are the same as constituent elements that have already appeared are denoted by the same reference signs thereas, and redundant description thereof is omitted.

### Processing

Collective settlement executed by the server 10 can include, in a non-limiting example, the following two schemes.

### (1) Batch Settlement

### (2) Sequential Settlement

The batch settlement of (1) is, in a non-limiting example, a collective settlement method in which two or more selected remittance requests are processed at one time.

In this method, the controller 11 of the server 10 calculates the final collective settlement amount based on the remittance request amount of each selected remittance request and the type thereof (received remittance request/transmitted remittance request).

In this case, if both the electronic money account balance of the proposing user of the terminal 20 and the electronic money account balance of the partner user will not become negative even if settlement is performed based on the calculated collective settlement amount, settlement is possible.

On the other hand, when settlement is performed based on the calculated collective settlement amount, if either the electronic money account balance of the user of the terminal 20 of the proposer or the electronic money account balance of the partner user will become negative, settlement is not possible.

The sequential settlement of (2) is, in a non-limiting example, a collective settlement method in which two or more selected remittance requests are sequentially processed.

In this method, the controller 11 of the server 10 repeatedly performs sequential processing including calculation of the settlement amount and updating of the electronic money account balance of the proposing user and the electronic money account balance of the partner user, based on the remittance request amount and the type (received remittance request/transmitted remittance request) of each of two or more selected remittance requests.

During sequential processing, if either the electronic money account balance of the user of the terminal 20 of the proposer or the electronic money account balance of the partner user will become negative, settlement in that sequence is not possible. Then, the sequence in which the remittance requests are processed is changed, and the sequential processing is performed again from the beginning.

On the other hand, if at least one of the electronic money account balance of the user of the terminal 20 of the proposer and the electronic money account balance of the partner user will not become negative as a result of the sequential processing up to the final remittance request, settlement is possible, and settlement in that sequence.

Note that even if the sequence in which the remittance requests are processed is in a round-robin manner, if either the electronic money account balance of the user of the terminal 20 of the proposer or the electronic money account balance of the partner user will become negative during the sequential processing, sequential settlement cannot be executed, and therefore settlement is not possible.

### Display Screen

The difference between batch settlement and sequential settlement will be described with reference to the example of FIG. 3-1 described above.

Here, the following two cases are considered.

(Case 1) The current electronic money account balance of the user A.A=500 yen, the current electronic money account balance of the user B.B=1,500 yen

(Case 2) The current electronic money account balance of the user A.A=500 yen, the current electronic money account balance of the user B.B=1,000 yen

First, (Case 1) will be described.

### (1) When Batch Settlement is Applied

When batch settlement is applied, the first received remittance request, the second received remittance request, and the fourth transmitted remittance request selected in FIG. 3-1 are processed simultaneously.

In this case, the collective settlement is “payment of 500 yen” (payment of 500 yen from the user A.A to the user B.B), resulting from “payment of 2,000 yen”, “payment of 500 yen”, and “receipt of 2,000 yen”.

The current electronic money account balance of the user A.A is “500 yen”, and the balance of the user A.A does not become negative, and therefore if batch settlement is performed, settlement is possible regardless of the electronic money account balance of the user B.B.

### (2) When Sequential Settlement is Applied

If sequential settlement is applied, the first received remittance request, the second received remittance request, and the fourth transmitted remittance request selected in FIG. 3-1 are processed one by one.

A case is considered in which, in a non-limiting example, processing is performed in the following order: second received remittance request→fourth transmitted remittance request→first received remittance request.

First, since the second received remittance request is a payment of “500 yen” from the user A.A to the user B.B, when this settlement is performed, the electronic money account balance of the user A.A will be “500 yen→0 yen”, and the electronic money account balance of the user B.B will be “1,500 yen→2,000 yen”.

Next, since the fourth transmitted remittance request is for the user A.A to receive “2,000 yen” from the user B.B, when this settlement is performed, the electronic money account balance of the user A.A will be “0 yen→2,000 yen”, and the electronic money account balance of the user B.B will be “2,000 yen→0 yen”.

Finally, since the first received remittance request is a payment of “2,000 yen” from the user A.A to the user B.B, when this settlement is performed, the electronic money account balance of the user A.A will be “2,000 yen→0 yen”, and the electronic money account balance of the user B.B will be “0 yen→2,000 yen”.

Since the current electronic money account balance of the user B.B is “1,500 yen”, the user B.B will receive “500 yen” from the user A.A as a result of the above settlement.

In this example, neither the electronic money account balance of the user A.A nor the electronic money account balance of the user B.B will be negative, and therefore settlement is possible through sequential settlement as well.

Next, (Case 2) will be described.

### (1) When Batch Settlement is Applied

If batch settlement is applied, it is the same as (Case 1).

That is, since the current electronic money account balance of the user A.A is “500 yen” and the balance of the user A.A will not become negative, if batch settlement is performed, settlement is possible regardless of the electronic money account balance of the user B.B.

### (2) When Sequential Settlement is Applied

If sequential settlement is applied, the first received remittance request, the second received remittance request, and the fourth transmitted remittance request selected in FIG. 3-1 will be processed one by one, similarly to (Case 2).

However, in (Case 2), unlike in (Case 1), due to the fact that the current electronic money account balance of the user B.B is “1,000 yen”, settlement cannot be performed such that neither the electronic money account balance of the user A.A nor the electronic money account balance of the user B.B will become negative, no matter the sequence in which the first received remittance request, the second received remittance request, and the fourth transmitted remittance request are processed.

Because of this, in (Case 1), settlement can be performed through either batch settlement or sequential settlement, but in (Case 2), settlement through batch settlement is possible, but settlement through sequential settlement is not possible.

Note that in both of the above cases, in a non-limiting example, if the business operator of the payment service is affiliated with a financial institution, settlement may optionally be made possible by temporarily allowing the insufficient balance of the electronic money account of the user to be an account balance with a negative value.

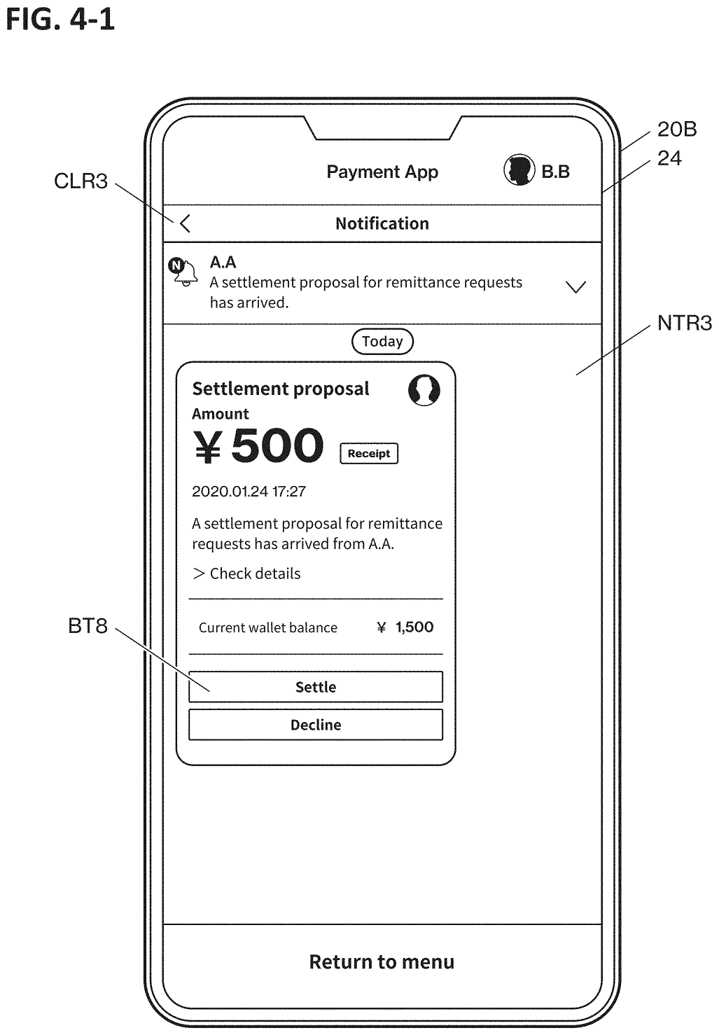

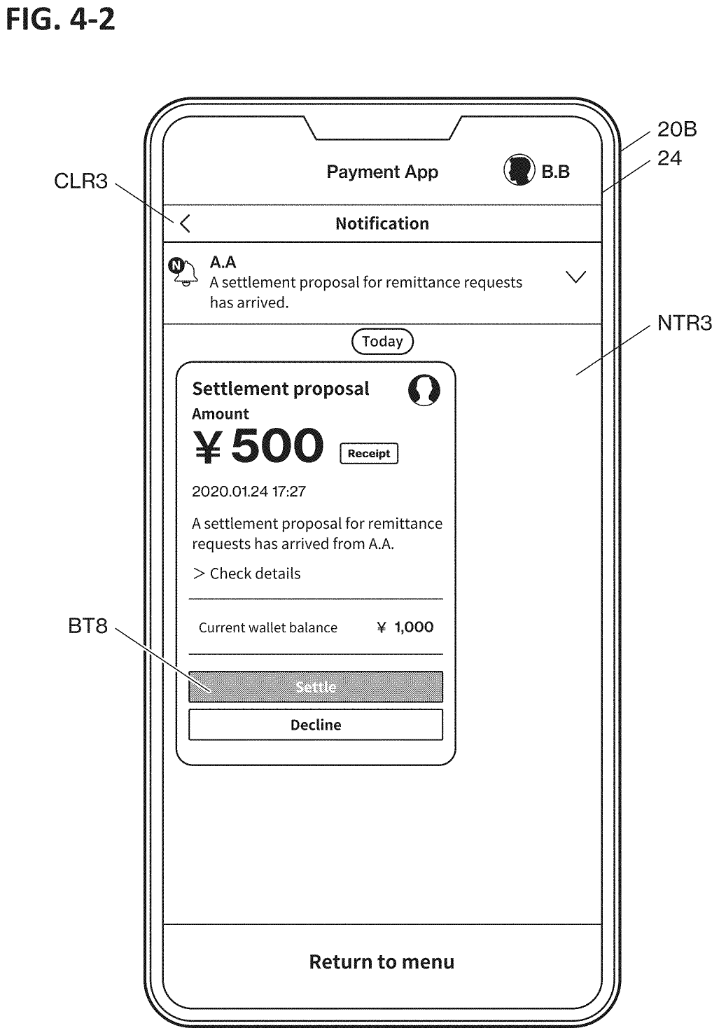

FIG. 4-1 is a diagram showing an example of a notification screen displayed on the display 24 of the terminal 20B when sequential settlement is applied in the above (Case 1).

A current location display region CLR3 is formed in the upper part of the notification screen, and the word “Notification” is displayed, which indicates that a notification relating to the payment application is being displayed.

In the notification information display region NTR3 below the current location display region CLR3, collective settlement approval confirmation information transmitted from the server 10 to the terminal 20B based on the proposal from the user A.A is displayed.

In (Case 1), since settlement through sequential settlement is possible, the settlement button BT8 included in the collective settlement approval confirmation information is displayed in an operable state.

On the other hand, FIG. 4-2 is a diagram showing an example of a notification screen displayed on the display 24 of the terminal 20B when sequential settlement is applied in the above (Case 2).

The information displayed on this notification screen is the same as that shown in FIG. 4-1, but in (Case 2), since settlement through sequential settlement cannot be performed, the settlement button BT8 included in the collective settlement approval confirmation information is displayed grayed out, and thus even if an operation (tap) is performed on the settlement button, the terminal 20B does not accept the operation.

### Fifth Embodiment

The fifth embodiment is an embodiment relating to “request cancellation” of the collective processing described above.

The content described in the fifth embodiment can be applied also to any of the other embodiments and the other modified examples.

Also, constituent elements that are the same as constituent elements that have already appeared are denoted by the same reference signs thereas, and redundant description thereof is omitted.

As described above, if the remittance request amount of the selected received remittance request (amount to be remitted) and the remittance request amount of the selected transmitted remittance request (amount to be received) are the same amount, it is possible to cancel out the amounts through collective settlement.

However, in such a case, it is also possible to perform request cancellation instead of collective settlement.

Request cancellation means, in a non-limiting example, mutually canceling out the remittance requests selected as processing targets to eliminate those remittance requests and deleting the data of those remittance requests.

### Display Screen

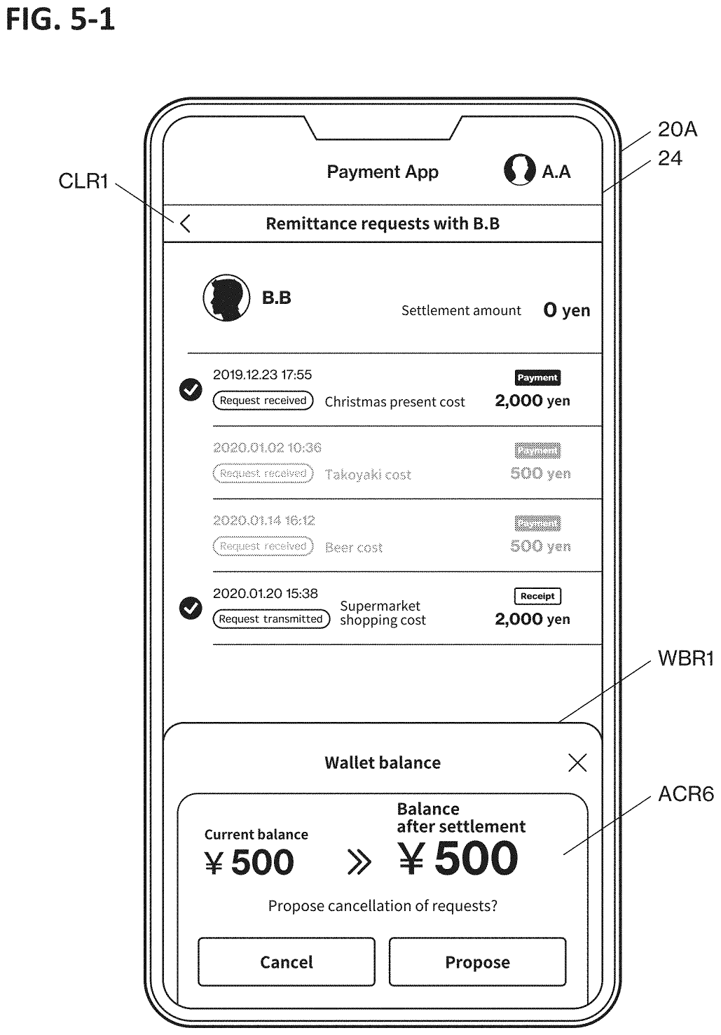

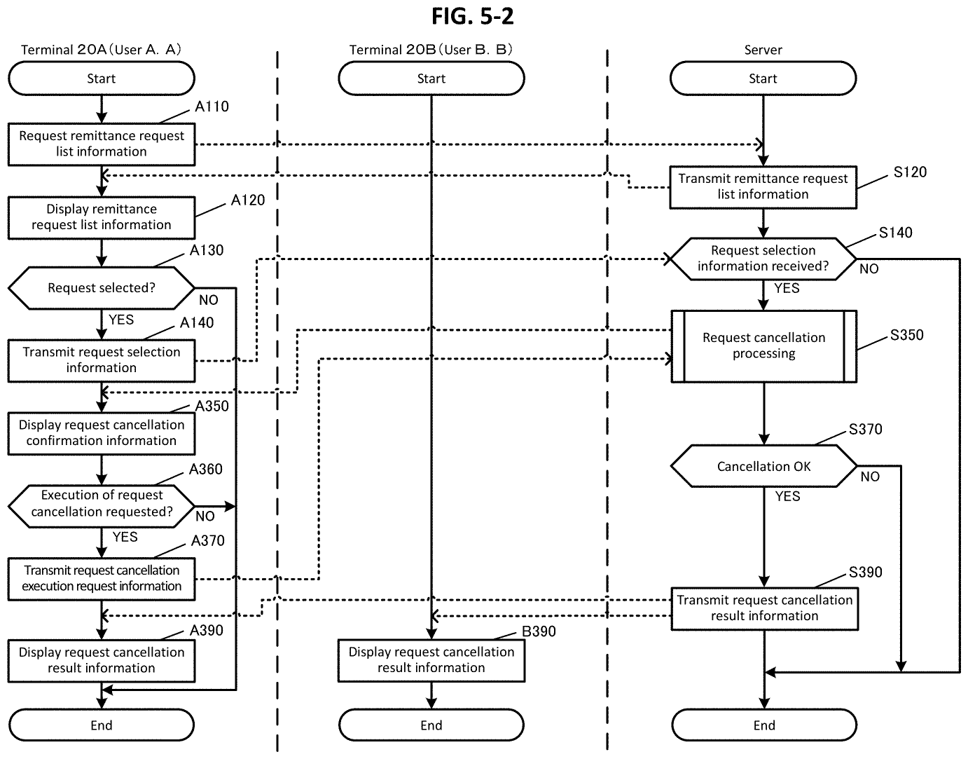

FIG. 5-1 is a diagram showing an example of a remittance request list screen displayed on the display 24 of the terminal 20A of the user A.A according to an embodiment. This remittance request list screen is a screen in which the partner user is the user B.B.

This remittance request list screen shows a state in which the first received remittance request (payment of 2,000 yen) and the fourth transmitted remittance request (receipt of 2,000 yen) have been selected.

The current electronic money account balance of the user A.A and the electronic money account balance of the user A.A after settlement are displayed in the settlement content confirmation region ACR6 at the lower part of the screen. If collective settlement is performed based on the above two selected remittance requests, the amounts will cancel each other out. For this reason, in this example, the current electronic money account balance of the user A.A and the electronic money account balance after settlement of the user A.A are the same amount (500 yen).

Also, a proposal button and a cancel button are displayed below it, along with the text “Propose cancellation of requests?”

In a non-limiting example, when the proposal button is tapped, information for requesting request cancellation is transmitted from the terminal 20A to the server 10. Then, the server 10 executes request cancellation processing and deletes the data of the two selected remittance requests.

### Processing

### (1) Example of Processing

FIG. 5-2 is a flow chart showing an example of the flow of processing executed by each device according to an embodiment.

If it is determined in S140 that the request selection information has been received from the terminal 20A (S140: YES), the controller 11 of the server 10 executes request cancellation processing (S350).

In the request cancellation processing, the controller 11 of the server 10 calculates the collective settlement amount based on the remittance requests selected by the terminal 20A, and determines whether or not the remittance requests can cancel each other out based on the calculated collective settlement amount. Then, if it is determined that the remittance requests can cancel each other out, the controller 11 of the server 10 transmits request cancellation confirmation information to the terminal 20A.

On the terminal 20A, the request cancellation confirmation information is displayed on the display 24 (A350), and when it is determined that a request cancellation execution request is to be made based on input regarding this display (A360: YES), the terminal 20A transmits request cancellation execution request information from the terminal 20A to the server 10 (A370).

The controller 11 of the server 10 executes request cancellation based on the reception of the request cancellation execution request information from the terminal 20A. Specifically, the data of the remittance requests to be canceled out is deleted from the first remittance request management data 157A.

Note that the remittance completion flags of the remittance requests to be canceled out may be set to “ON” without deleting the data of the remittance requests.

Then, the controller 11 of the server 10 ends the request cancellation processing.

Thereafter, the controller 11 of the server 10 determines whether or not the request cancellation result is “OK” (S370). Then, if it is determined that the result is “OK” (S370: YES), the controller 11 of the server 10 transmits request cancellation result information to the terminal 20A and the terminal 20B via the communication I/F 14 (S390). Then, the controller 11 of the server 10 ends the processing.

Upon receiving the request cancellation result information from the server 10 through the communication I/F 22, the controller 21 of the terminal 20A causes the display 24 to display the received request cancellation result information (A390).

Then, the controller 21 of the terminal 20A ends the processing.

Similarly, when request cancellation result information is received from the server 10 through the communication I/F 22, the controller 21 of the terminal 20B displays the received request cancellation result information on the display 24 (B390).

Then, the controller 21 of the terminal 20B ends the processing.

### (2) Another Example of Processing

The partner user's approval can also be required when performing the above request cancellation. The case where the partner user's approval is required is the same as the case described in the collective settlement.

The processing in this case can be configured in the same way as the processing when the approval of the partner user is required in the collective settlement (non-limiting examples of which include the processing in FIGS. 1-21 and 1-22), and therefore illustration and detailed description are omitted.

### Effect of Fifth Embodiment

In this embodiment, the first processing shows a configuration in which the first processing includes processing performed based on first remittance request information and second remittance request information among a plurality of pieces of remittance request information relating to the proposing user (a non-limiting example of a plurality of information relating to a remittance request to the user of the terminal and a remittance request performed by the user of the terminal), including the first remittance request information and the second remittance request information, based on input performed by the proposing user to the terminal 20.

As an example of the effect of the embodiment obtained by such a configuration, it is possible to appropriately process the first information and the second information among a plurality of pieces of information relating to a remittance request to the user of the terminal or a remittance request performed by the user of the terminal, based on input performed by the user of the terminal to the terminal.

Also, this embodiment shows a configuration in which the first remittance request information and the second remittance request information are information of the same remittance request amount, and the first processing is processing for cancelling out the first remittance request information and the second remittance request information (a non-limiting example of cancelling out the first information and the second information) based on the first remittance request information and the second remittance request information.

As an example of the effect of the embodiment obtained by such a configuration, if the first information and the second information are information of the same amount, these pieces of information can cancel each other out. As a result, convenience can be improved for both the user who requested the remittance based on the first information and the user who requested the remittance based on the second information.

### Fifth Modified Example

In the fifth embodiment, if the remittance request amounts of the remittance requests selected as the processing targets are not canceled out, a new remittance request for which the type (payment/receipt) is determined according to the positive or negative sign of the result of amount deduction, in which an amount corresponding to the difference is used as the remittance request amount, may optionally be created.

### Sixth Embodiment

The sixth embodiment is an embodiment relating to “creation of collective remittance request” in the collective processing described above.

The content described in the sixth embodiment can be applied also to any of the other embodiments and the other modified examples.

Also, constituent elements that are the same as constituent elements that have already appeared are denoted by the same reference signs thereas, and redundant description thereof is omitted.

### Display Screen

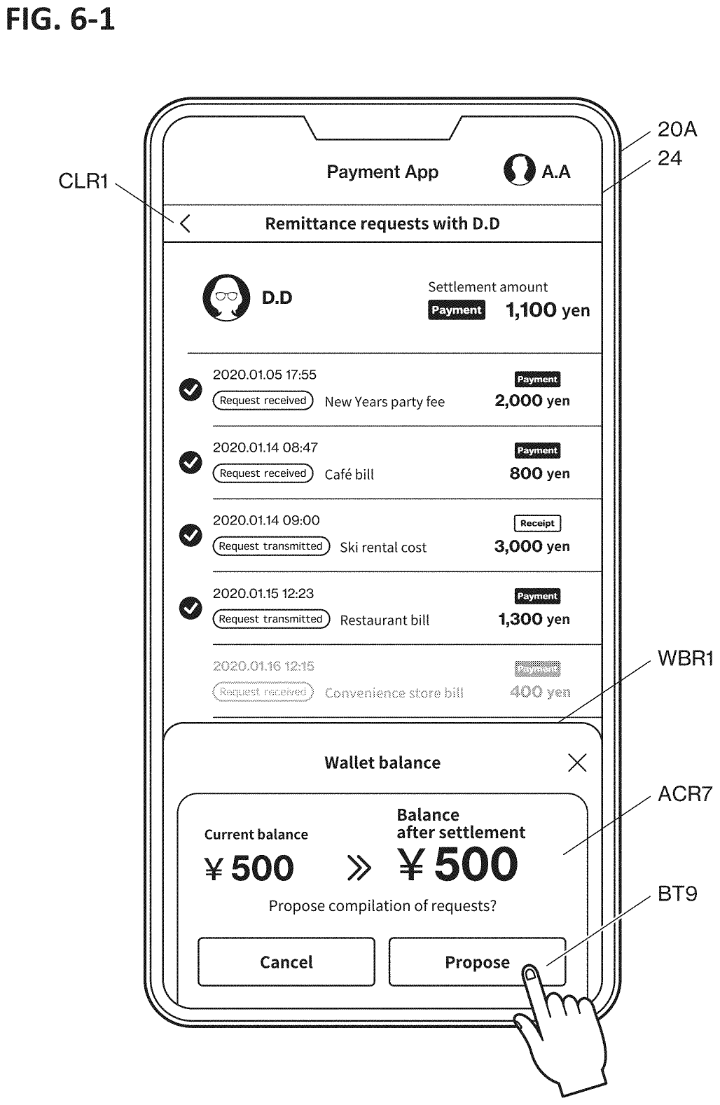

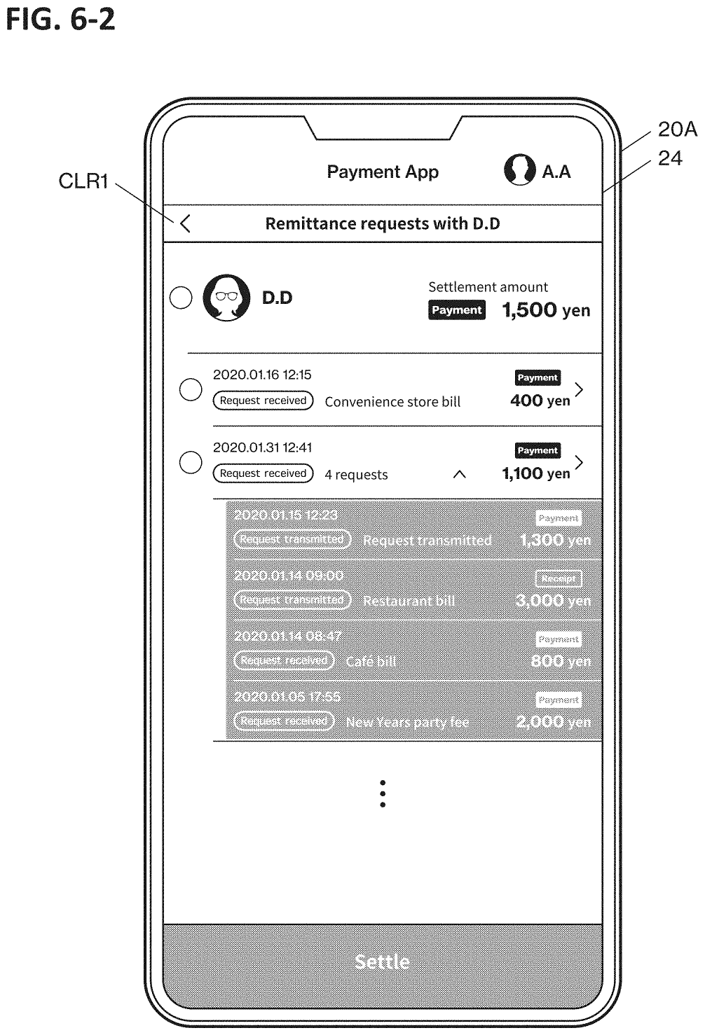

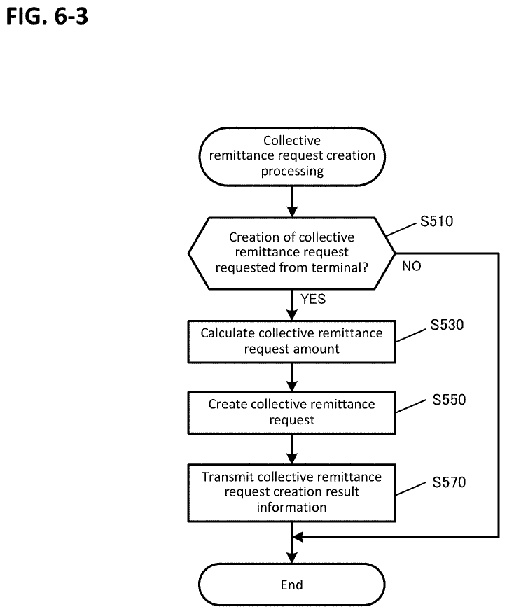

FIG. 6-1 is a diagram showing an example of a remittance request list screen displayed on the display 24 of the terminal 20A according to an embodiment.

In the current location display region CLR1 at the upper part of the screen, the words “Remittance Requests with D.D” are displayed, which indicate that unprocessed requests with the user D.D are being displayed.

Also, the current location display region CLR1 shows a state in which the first to fourth remittance requests have been selected from among the unprocessed requests with the user D.D.

When the selected first to fourth remittance requests are settled collectively, the collective settlement is “payment of 1,100 yen”, and the user A.A pays “1,100 yen” to the user D.D. However, in this example, the current electronic money account balance of the user A.A is “500 yen”, and therefore the payment amount is insufficient by “600 yen”.

In view of this, according to an embodiment, the server 10 creates a collective remittance request based on the amount of the shortfall amount of payment when the collective settlement was performed.

However, according to an embodiment, although a collective remittance request is created, collective settlement is not performed.

Specifically, in the settlement content confirmation region ACR7 at the lower part of the screen, “500 yen” is displayed as the current electronic money account balance of the user and the electronic money account balance of the user when settlement is performed.

Also, below that, a proposal button BT9 and a cancel button are displayed along with the text “Propose compilation of requests?”.

When the proposal button BT9 is tapped in this state, a new remittance request is created based on the shortfall of the payment, which is “1,100 yen”. As a result, the screen shown in FIG. 6-2 is displayed.

In FIG. 6-2, as a newly created remittance request, a collective remittance request with a payment amount of “1,100 yen”, which is obtained by compiling four received remittance requests, is displayed.

In this display screen example, the four remittance requests selected in FIG. 6-1, that is, the remittance requests used to create the collective remittance request (compiled remittance request), are displayed in a hanging form in the collective remittance request. Also, these remittance requests are displayed in a different display mode (grayed out in this example) from the other remittance requests so that the user can easily recognize them.

Note that unlike this display screen example, the remittance requests used to create the collective remittance request may not be displayed.

Also, when the collective remittance request is tapped, the remittance requests used to create the collective remittance request may be displayed.

### Processing

FIG. 6-3 is a flow chart showing an example of the flow of collective remittance request creation processing executed by the controller 11 of the server 10 according to an embodiment.

The controller 11 of the server 10 determines whether or not the terminal 20 has requested to create a collective remittance request, based on whether or not the collective remittance request creation request information has been received from the terminal 20 (S510).

The collective remittance request creation request information can include, in a non-limiting example, selection information of remittance requests for which a collective remittance request is created.

If it is determined that a request has been made (S510: YES), the controller 11 of the server 10 refers to the remittance request management data 157 and calculates the remittance request amount (hereinafter referred to as “collective remittance request amount” of the created collective remittance request based on the remittance request amount and the type (received remittance request (payment)/transmitted remittance request (receipt)) of each of the selected remittance requests (S530).

Thereafter, the controller 11 of the server 10 creates a collective remittance request based on the calculated collective remittance request amount, and stores data of the created collective remittance request in the remittance request management data 157 (S550).

Next, the controller 11 of the server 10 transmits collective remittance request creation result information relating to the creation result of the collective remittance request to the requesting terminal 20 via the communication I/F 14 (S570).

Then, the controller 11 of the server 10 ends the collective remittance request creation processing.

After this processing is performed, with the terminal 20, the collective remittance request information corresponding to the collective remittance request is displayed on the remittance request list screen or the like displayed on the display 24. Then, based on this collective remittance request, collective settlement can be executed.

Note that if it is determined in S510 that the terminal 20 has not requested creation of a collective remittance request (S510: NO), in a non-limiting example, the controller 11 of the server 10 can also perform another collective processing such as the above-described collective settlement and the above-described request cancellation based on the request from the terminal 20.

Note that there is also a risk that a malicious user will create a false remittance request as described above and then create a collective remittance request including that remittance request.

In view of this, the creation of a collective remittance request may optionally require the partner's approval.

### Effect of Sixth Embodiment

This embodiment shows a configuration in which the partner user is one user (a non-limiting example of the second user being the first user), and the first processing includes processing for displaying, on the display 24, display of a collective remittance request (a non-limiting example of sixth display) based on remittance request information (a non-limiting example of third information relating to a remittance request from the first user to the user of the terminal, or a remittance request from the user of the terminal to the partner user) obtained by adding together the remittance request amounts of the first remittance request information and the second remittance request information.

As an example of the effect of the embodiment obtained by such a configuration, when the partner user is one user, the sixth display based on the third information obtained by compiling information relating to a plurality of remittance requests is displayed, whereby the user of the terminal can be notified of the third information. Also, in a non-limiting example, it is possible to perform comprehensive settlement based on the third information obtained by compiling information relating to a plurality of remittance requests, and therefore convenience for the user can be improved.

### Seventh Embodiment

The seventh embodiment is an embodiment relating to “creation of special collective settlement/special collective remittance request” in the collective processing described above.

The content described in the seventh embodiment can be applied also to any of the other embodiments and the other modified examples.

Also, constituent elements that are the same as constituent elements that have already appeared are denoted by the same reference signs thereas, and redundant description thereof is omitted.

### Display Screen

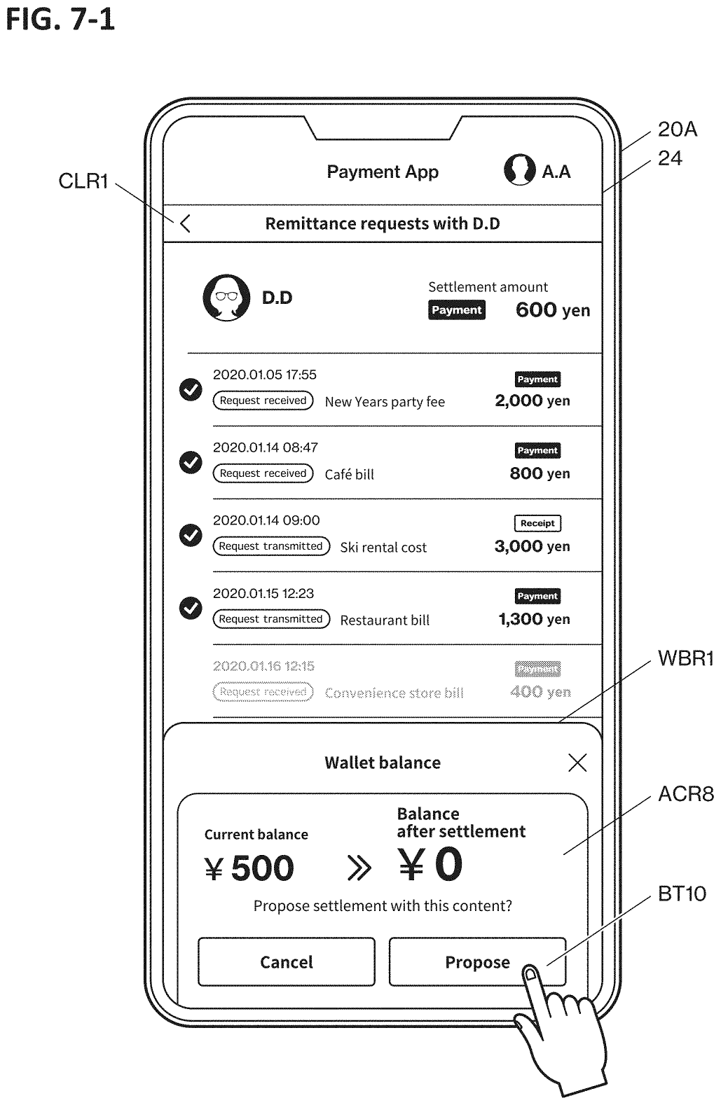

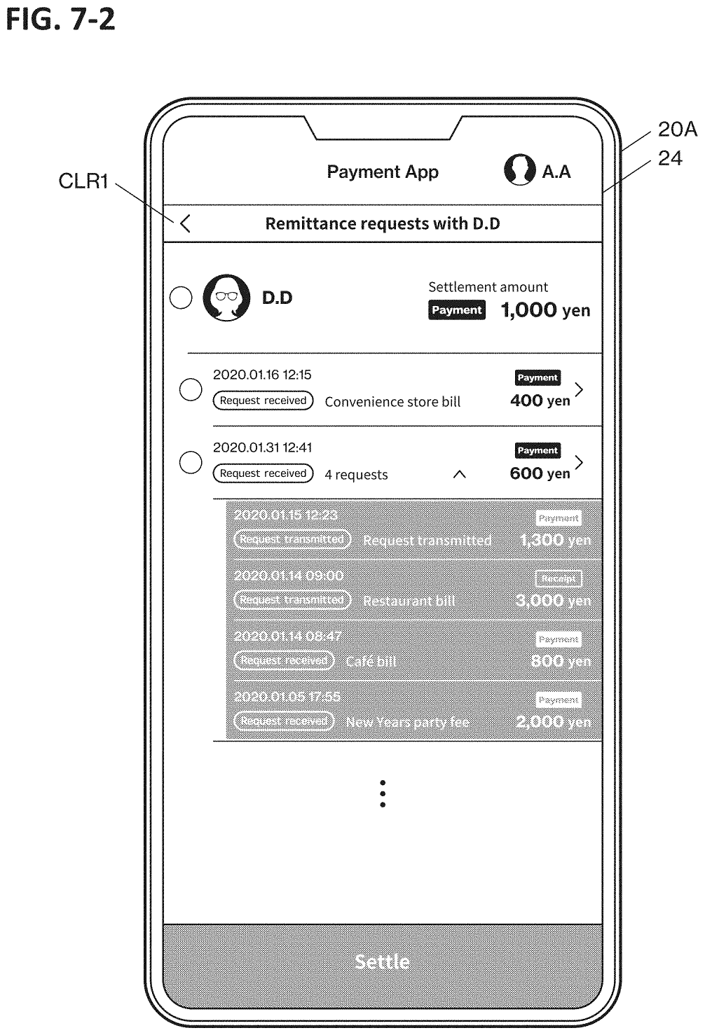

FIG. 7-1 is a diagram showing an example of a remittance request list screen displayed on the display 24 of the terminal 20A according to an embodiment, and shows a screen on which a list of remittance requests with the user D.D is displayed, similarly to FIG. 6-1. Here, similarly to FIG. 6-1, a state in which the first to fourth remittance requests have been selected is shown.

If the selected first to fourth remittance requests are settled collectively, the collective settlement is “payment of 1,100 yen”, and the user A.A pays “1,100 yen” to the user D.D. However, in this example, the current electronic money account balance of the user A.A is “500 yen”, and therefore the payment amount is insufficient by “600 yen”.

In this case, according to an embodiment, the controller 11 of the server 10 performs collective settlement in which settlement is performed by remitting the entire amount of the current electronic money account balance of the user A.A to the user D.D.

Also, the controller 11 of the server 10 creates a new remittance request with the amount of the payment shortfall in the collective settlement as the remittance request amount.

That is, according to an embodiment, unlike the sixth embodiment, a new remittance request is created in which an amount that cannot be paid after performing payment to the extent that is possible with the balance of the proposing user is set as the remittance request amount.

For the sake of convenience, collective settlement in which payment is performed to the extent possible based on a plurality of remittance requests is referred to as “special collective settlement”, and a collective remittance request that is newly created after performing the special collective settlement is referred to as a “special collective remittance request”.

Specifically, in the settlement content confirmation region ACR8 at the lower part of the screen, “500 yen” is displayed as the current electronic money account balance of the user, and “0 yen” is displayed as the electronic money account balance of the user when settlement is performed. Then, when the proposal button is tapped in this state, special collective settlement is executed in which the user A.A remits and pays “500 yen”, which is the total amount of the current electronic money account balance of the user A.A, to the user D.D. Thereafter, a special collective remittance request is created based on “600 yen”, which is the shortfall amount of the payment. As a result, the screen shown in FIG. 7-2 is displayed.

In FIG. 7-2, a special collective remittance request with a payment amount of “600 yen” is displayed as a special collective remittance request.

In this display screen example, in the special collective remittance request, four remittance requests selected in FIG. 7-1, that is, the remittance requests used to create the special collective remittance request (compiled remittance request) are displayed in a hang-down manner. Also, for the convenience of the user, these remittance requests are displayed in a different display mode (grayed out in this example) than normal remittance requests.

Note that unlike this display screen example, the remittance requests used to create the special collective remittance request may not be displayed.

Also, when a special collective remittance request is tapped, the remittance requests used to create the special collective remittance request may be displayed.

### Processing

FIGS. 7-3 to 7-4 are diagrams showing an example of fourth settlement processing executed by the controller 21 of the server 10 according to an embodiment.

After S1515, the controller 11 of the server 10 determines whether or not the electronic money account balance of any user will become negative (S1520), and if it is determined that the electronic money account balance will become negative, the controller 11 of the server 10 determines whether or not it is the proposing user whose account balance will become negative (S1570).

If it is determined that the proposing user will have a negative electronic money account balance (S1570: YES), the controller 11 of the server 10 transmits collective settlement type confirmation information for confirming the type of collective settlement to be executed (normal collective settlement/special collective settlement), which includes the collective settlement amount, to the terminal 20A via the communication I/F 14 (S1571).

Note that in this case, the insufficient balance information described above may optionally be transmitted included in the collective settlement type confirmation information.

Thereafter, the controller 11 of the server 10 determines whether or not execution of the special collective settlement has been requested based on the reception of the settlement execution request information including information on the type of collective settlement for which execution is requested from the terminal 20A (S1574). If it is determined that execution of the above-described normal collective settlement has been requested instead of the special collective settlement (S1574: NO), in a non-limiting example, the controller 11 of the server 10 moves the processing to S1555 in FIG. 2-5.

On the other hand, if it is determined that execution of the special collective settlement has been requested (S1574: YES), the controller 11 of the server 10 determines whether or not the approval of the partner user is required (S1575).

If it is determined that the approval of the partner user is required (S1575: YES), the controller 11 of the server 10 transmits special collective settlement approval confirmation information including special collective settlement amount information, which is information on the settlement amount due to special collective settlement (hereinafter referred to as a “special collective settlement amount”), to the terminal 20B via the communication I/F 14 (S1577).

The special collective amount can, in a non-limiting example, be an amount equivalent to the current electronic money account balance of the proposing user.

Note that there is no limitation to this, and the special collective settlement amount can be any amount as long as it is greater than “0” and less than or equal to the current electronic money account balance of the proposing user.

Thereafter, the controller 11 of the server 10 determines whether or not the special collective settlement has been approved by determining whether or not the special collective settlement approval information indicating approval of the special collective settlement has been received from the terminal 20B (S1579).

Then, if it is determined that it has been approved (S1579: YES), the controller 11 of the server 10 executes special collective settlement (S1581). Specifically, the controller 11 of the server 10 updates the electronic money account balance of the proposing user (in this example, the user A.A.) to zero, and performs update by adding the special collective settlement amount to the electronic money account balance of the partner user (in this example, the user B.B).

Thereafter, the controller 11 of the server 10 creates a special collective remittance request (S1583). Specifically, the controller 11 of the server 10 creates a remittance request from the partner user to the proposing user as a special collective remittance request, with the amount obtained by subtracting the special collective settlement amount from the collective settlement amount as the remittance request amount.

Then, the controller 11 of the server 10 ends the fourth settlement processing.

Also, as described above, the method of performing payment to the extent possible with the balance of the proposing user is not limited to the case where a plurality of remittance requests are selected as described above, but can be applied also to the case where one remittance request is selected.

That is, when one received remittance request with a larger remittance request amount than the amount of the current electronic money account balance of the proposing user is selected, the controller 11 of the server 10 creates a remittance request in which the amount (shortfall amount) obtained by subtracting the amount of the electronic money account balance from the remittance request amount is set as the remittance request amount.

### Second Processing by Terminal

In this embodiment, the controller 21 of the terminal 20 can execute second processing for processing at least one piece of information based on the electronic money account balance of the user of the terminal 20 (the balance of the user of the terminal) in addition to the above-described first processing.

In a non-limiting example, at least the following processing is included in the second processing.
Processing for transmitting request selection information to the server 10
Processing for receiving collective settlement confirmation information from the server 10
Processing for displaying collective settlement confirmation information
Processing for receiving collective settlement result information from the server 10
Processing for displaying collective settlement result information
Processing for requesting the server 10 to perform amount deduction (including amount cancellation)
Processing for requesting the server 10 to execute special collective settlement
Processing for requesting the server 10 to create a special collective remittance request

### Effect of Seventh Embodiment

This embodiment shows a configuration in which the terminal 20 of the user proposing collective remittance executes second processing for collective settlement with respect to at least one piece of remittance request information (a non-limiting example of second processing on at least one piece of remittance request information) out of a plurality of pieces of remittance request information relating to a remittance request to the user proposing collective settlement (a non-limiting example of the user of the terminal) or a remittance request performed by the user proposing collective settlement, based on the electronic money account balance of the user proposing collective remittance (a non-limiting example of the balance of the user of the terminal).

As an example of the effect of the embodiment obtained by such a configuration, at least one of a plurality of pieces of information relating to a remittance request to the user of the terminal or a remittance request performed by the user of the terminal can be processed through the second processing with consideration given to the balance of the user of the terminal, and therefore convenience for the user can be improved.

### Seventh Modified Example

Relating to the first modified example (3), in the seventh embodiment, the terminal 20 of the proposer or the server 10 may optionally automatically select (includes suggesting) a remittance request based on the current electronic money account balance of the proposing user.

Specifically, the controller 21 of the terminal 20 of the proposer performs processing for querying the server 10 about the current electronic money account balance of the proposing user. Then, the controller 21 of the terminal 20 of the proposer specifies and selects a combination of remittance requests for which, in a non-limiting example, payment exceeding the current electronic money account balance of the proposing user occurs, based on each remittance request amount and the type (received remittance request (payment)/transmitted remittance request (receipt)) of each remittance request from among the remittance requests included in the remittance request list information received from the server 10.

In this case, in a non-limiting example, in FIG. 7-1, out of the unprocessed requests with the user D.D., in a non-limiting example, a state may optionally be proposed to the user in which remittance requests (in this example, four remittance requests), which are automatically selected as processing targets for collective settlement in order starting from the oldest remittance request until the balance becomes insufficient, have been selected.

Note that if the controller 11 of the server 10 selects remittance requests, similar processing may be performed based on the data of the remittance requests stored in the remittance request management data 157.

This modified example shows a configuration in which the second processing includes processing for selecting remittance request information that can be processed with the electronic money account balance of the proposing user (a non-limiting example of the balance of the user of the terminal) out of a plurality of pieces of remittance request information, and the selected information is processed.

As an example of the effect of the embodiment obtained by such a configuration, since information that can be processed with the balance of the user of the terminal is selected and processed, in a non-limiting example, the information can be processed in the range in which the balance of the user of the terminal does not become negative, and therefore it is possible to further improve convenience for the user.

### Eighth Embodiment

The eighth embodiment is an embodiment in which unprocessed requests are displayed when the user of the terminal 20 performs remittance to the partner user or makes a remittance request to the partner user.

The content described in the eighth embodiment can be applied to any of the other embodiments and the other modified examples.

Also, constituent elements that are the same as constituent elements that have already appeared are denoted by the same reference signs thereas, and redundant description thereof is omitted.

### Display Screen

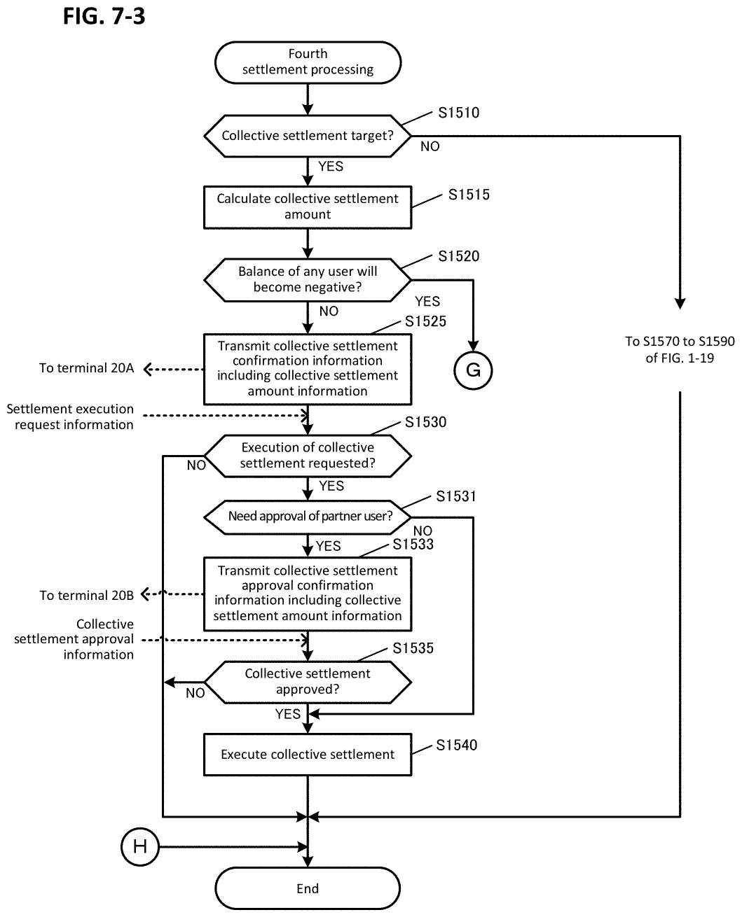

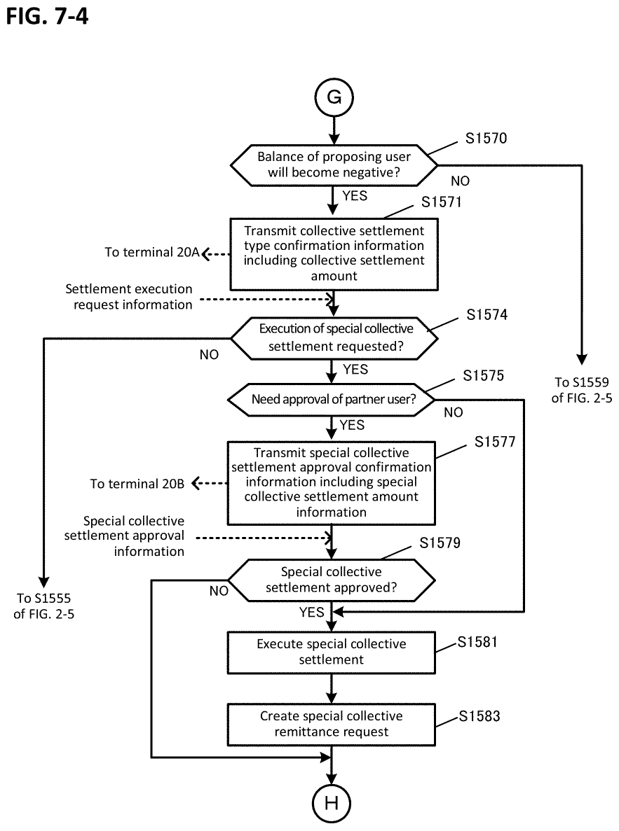

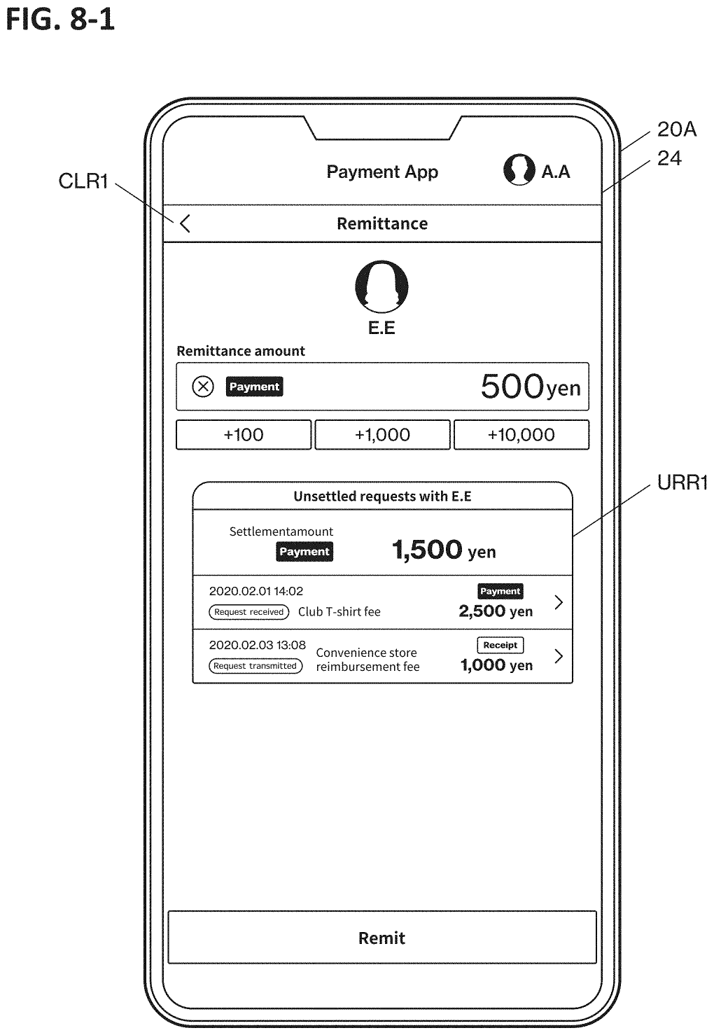

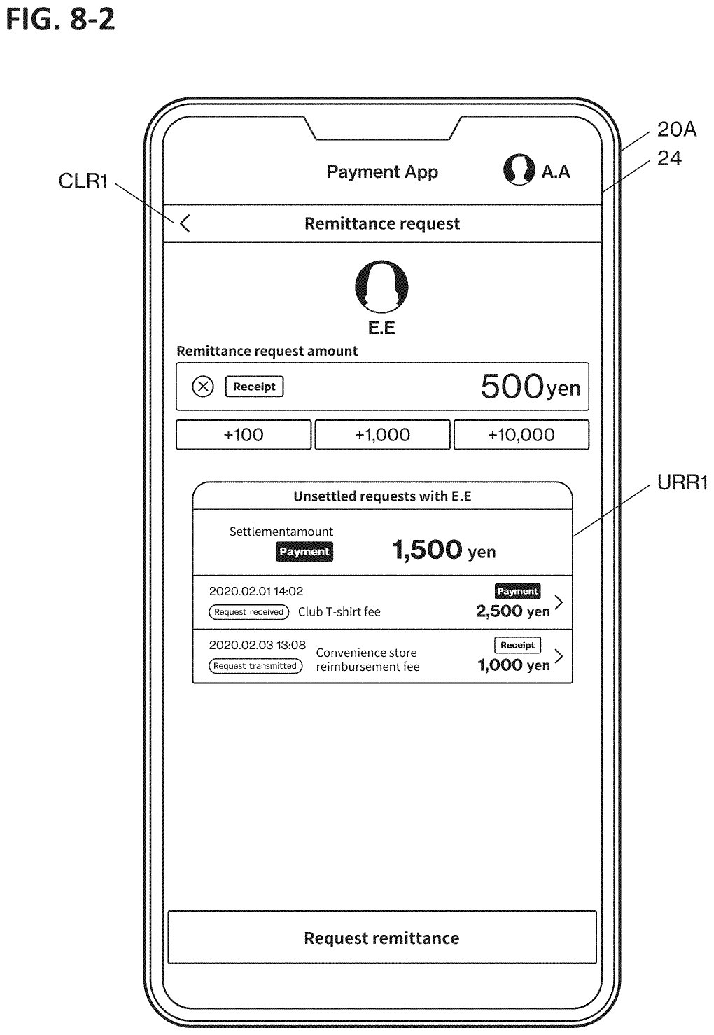

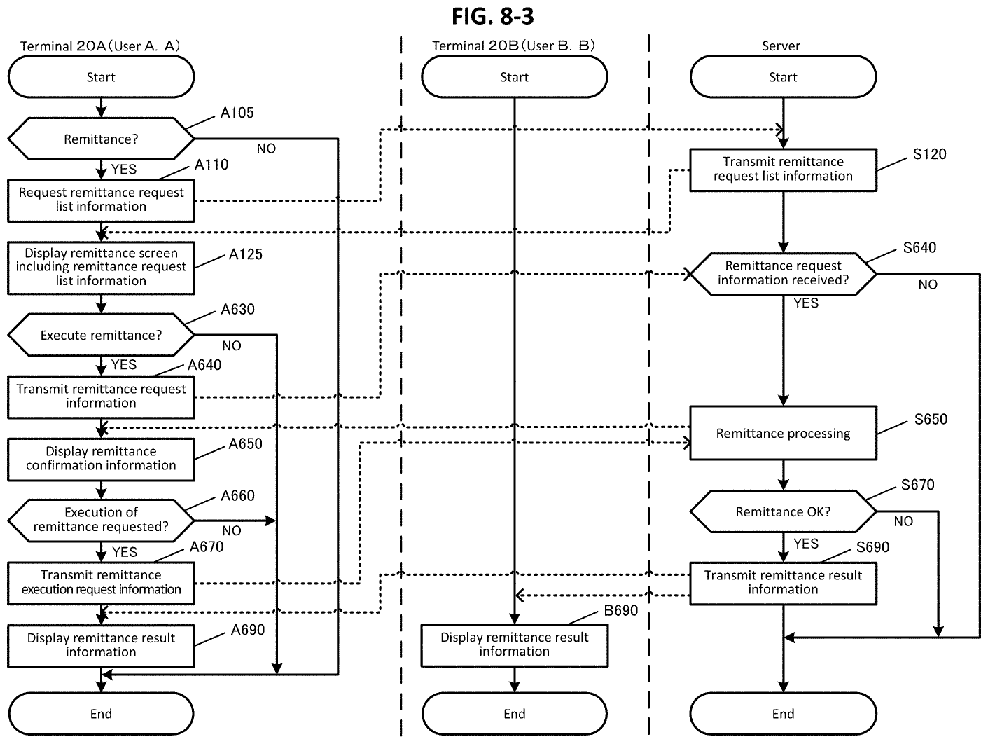

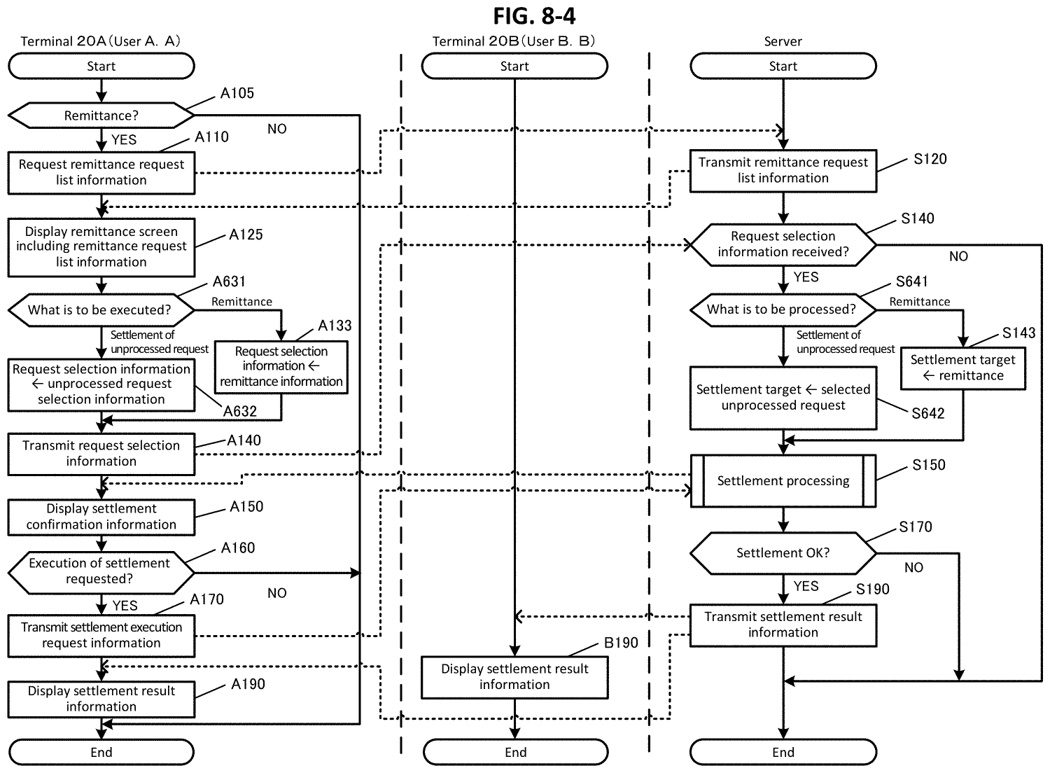

FIG. 8-1 is a diagram showing an example of a screen displayed on the display 24 of the terminal 20 according to an embodiment. This screen is, in a non-limiting example, the remittance screen of the payment application displayed on the display 24 of the terminal 20A of the user A.A.

In the current location display region CLR1 indicating the current location in the payment application, the word “Remittance” is displayed, which indicates that the current location is a remittance function of the payment application.

Below the current location display region CLR1, the icon image and user name (the user E.E in this example) of the payment application of the user selected as the remittance destination are displayed. Also, below that, the remittance amount to the user selected as the remittance destination (“500 yen” in this example) and function buttons for increasing the remittance amount by certain amounts are displayed.

Further below that, an unprocessed request confirmation region URR1 is displayed, which is configured to make it possible to confirm unprocessed requests with the user selected as the remittance destination (the user E.E in this example) and the user performing remittance (the user A.A in this example).

At the top of the unprocessed request confirmation region URR1, the words “Unsettled Requests with E.E” are displayed, which indicate that unprocessed requests with the user E.E are being displayed.

Below that, a collective settlement amount (“1,500 yen” in this example) and a mark (“payment mark” in this example) are displayed assuming that full-selection collective settlement is to be performed.

Note that the display field may be omitted if it is assumed that this full-selection collective settlement is performed.

Below that, a list of remittance requests for which the partner is the user E.E is displayed. In this example, unprocessed requests for which the partner is the user E.E are listed in chronological order from the top, starting with the oldest.

Also, below the unprocessed request confirmation region URR1, a remittance button indicated as “Remit” is displayed for executing remittance (remittance processing).

When the remittance button is tapped, the server 10 executes remittance processing (remittance from the user A.A to the user E.E).

Note that in a non-limiting example, the remittance button may be displayed in a region above the unprocessed request confirmation region URR1, or the like, below the display region of the function button for increasing the remittance amount by a certain amount.

Thus, according to an embodiment, by displaying the unprocessed requests together with the information for remittance, the user can also confirm the unprocessed requests when performing the remittance.

FIG. 8-2 is a diagram showing another example of a screen displayed on the display 24 of the terminal 20 according to an embodiment. This screen is, in a non-limiting example, a remittance request screen of the payment application displayed on the display 24 of the terminal 20A of the user A.A.

In the current location display region CLR1 indicating the current location in the payment application, the words “Remittance Request” are displayed, which indicate that the current location is a remittance request function of the payment application.

Below the current location display region CLR1, the icon image and user name (the user E.E in this example) of the payment application of the user selected as the transmission destination of the remittance request are displayed. Below that, a remittance request amount for the user selected as the transmission destination of the remittance request (“500 yen” in this example) and function buttons for increasing the remittance request amount by certain amounts are displayed.

Note that if the user selected as the transmission destination of the remittance request accepts the remittance request, remittance of the remittance request amount is executed from the electronic money account of the user selected as the transmission destination of the remittance request to the electronic money account of the user who made (sent) the remittance request.

Also, below that, an unprocessed request confirmation region URR1 is displayed as in FIG. 8-1. Below that, a remittance request button labeled as “Request remittance” is displayed for executing transmission of a remittance request (remittance request transmission processing).

When the remittance request button is tapped, the server 10 executes remittance request transmission processing (transmission of remittance request information from the user A.A to the user E.E).

Note that, in a non-limiting example, the remittance request button may be displayed in a region above the unprocessed request confirmation region URR1, or the like, below the display region of the function button for increasing the remittance request amount by a certain amount.

Thus, according to an embodiment, by displaying the unprocessed requests together with the information for remittance request transmission, the user can also check the unprocessed requests when making the remittance request.

### Processing

FIG. 8-3 is a flow chart showing an example of the flow of processing executed by each device according to an embodiment. Here, as an example, the processing for displaying unprocessed requests when the user performs remittance, which has been described with reference to FIG. 8-1, will be described.

First, the controller 21 of the terminal 20A determines whether or not input for displaying the remittance screen has been performed to the input device (A105).

If it is determined that input has been performed (A105: YES), the controller 21 of the terminal 20A performs the processing of A110, and based on the reception of the remittance request list information from the server 10 via the communication I/F 22, a remittance screen (screen for remittance) including that remittance request list information is displayed on the display 24 (A125).

Thereafter, the controller 21 of the terminal 20A determines whether or not input for executing remittance (non-limiting examples of which include operation of a remittance button) has been performed (A630).

If it is determined that the input for executing remittance has not been performed (A630: NO), the controller 21 of the terminal 20A ends the processing.

On the other hand, if it is determined that input for executing remittance has been performed (A630: YES), the controller 21 of the terminal 20A transmits remittance request information for requesting remittance to the server 10 via the communication I/F 22 (A640).

After S120, the controller 11 of the server 10 determines whether or not remittance request information has been received from the terminal 20A via the communication I/F 14 (S640).

If it is determined that the remittance request information has not been received (S640: NO), the controller 11 of the server 10 ends the processing.

On the other hand, if it is determined that the remittance request information has been received (S640: YES), the controller 11 of the server 10 executes remittance processing (S650). Specifically, in a non-limiting example, remittance confirmation information for confirming remittance content is transmitted to the terminal 20A via the communication I/F 14, and remittance from the user A.A to the user B.B is executed based on the reception of the remittance execution request information from the terminal 20A via the communication I/F 14.

In this case, in a non-limiting example, the controller 21 of the terminal 20A executes the processing of A650 to A670.

Thereafter, the controller 11 of the server 10 determines whether or not the remittance result is “OK” (S670). Then, if it is determined that the result is “OK” (S670: YES), the controller 11 of the server 10 transmits remittance result information to the terminals 20A and 20B via the communication I/F 14 (S690).

Then, the controller 11 of the server 10 ends the processing.

Upon receiving the remittance result information from the server 10 via the communication I/F 22, the controller 21 of the terminal 20A displays the received remittance result information on the display 24 (A690).

Then, the controller 21 of the terminal 20A ends the processing.

Similarly, when remittance result information is received from the server 10 via the communication I/F 22, the controller 21 of the terminal 20B displays the received remittance result information on the display 24 (B690).

Then, the controller 21 of the terminal 20B ends the processing.

Note that the processing for displaying unprocessed requests when the user makes a remittance request, as described in FIG. 8-2, can be performed in the same way by replacing “remittance” with “remittance request transmission” in the processing of FIG. 8-3, and therefore illustration and description thereof are omitted.

Specifically, in the processing of the terminal 20A, it is determined in A105 whether or not input for displaying a remittance request transmission screen has been performed, the remittance request transmission screen including the remittance request list information is displayed in A125, it is determined in A630 whether or not remittance request transmission is to be executed, remittance request transmission request information is transmitted in A640, remittance request transmission confirmation information is displayed in A650, it is determined in A660 whether or not a remittance request transmission execution request has been made, remittance request transmission execution request information is transmitted in A670, and remittance request transmission result information is displayed in A690.

Also, in the processing of the terminal 20B, the remittance request transmission result information is displayed in B690.

Also, in the processing of the server 10, it is determined in S640 whether or not the remittance request transmission request information has been received, the remittance request transmission processing is executed in S650, it is determined in S670 whether or not the remittance request transmission result is OK, and the remittance request transmission result information is transmitted in S690.

Display of Unprocessed Requests

The unprocessed requests displayed on the display 24 of the terminal 20 can be either or both of the following, in a non-limiting example.
Unprocessed requests corresponding to the partner user to whom remittance is performed (remittance destination user) or the partner user to whom the remittance request is transmitted (remittance request destination user)
Unprocessed requests corresponding to a different user than the partner user to whom remittance is performed (remittance destination user) or the partner user to whom the remittance request is transmitted (remittance request destination user)

The unprocessed requests corresponding to the partner user can be displayed. In a non-limiting example, if the user A.A performs remittance with the user E.E as the remittance destination user as shown in FIG. 8-1, or if the user A.A transmits a remittance request with the user E.E as the remittance request destination user as shown in FIG. 8-2, the unprocessed requests corresponding to the user E.E can be displayed.

However, it is conceivable that some users will want to check unprocessed requests corresponding to users different from the partner user.

In view of this, in a non-limiting example, in FIGS. 8-1 and 8-2, in addition to the unprocessed requests corresponding to the user E.E, unprocessed requests corresponding to the user B.B and the user C.C can also be displayed in a non-limiting example.

Note that in this case, it is possible to use a configuration in which the unprocessed requests corresponding to the user E.E are not displayed, and in a non-limiting example, the unprocessed requests corresponding to the user B.B and the user C.C are displayed.

That is, the following three patterns are conceivable as non-limiting examples of patterns in which unprocessed requests are displayed.

(Pattern 1) Unprocessed requests corresponding to the partner user

(Pattern 2) Unprocessed requests corresponding to the partner user+unprocessed requests corresponding to a user different from the partner user

(Pattern 3) Unprocessed requests corresponding to a user different from the partner user

Also, when applying any of the above patterns, for each user, all unprocessed requests corresponding to that user may be displayed, or some unprocessed requests corresponding to that user may be displayed.

That is, the user for whom unprocessed requests are displayed (the partner user/a user different from the partner user) and the range of unprocessed requests to be displayed (all/some) can be combined as appropriate. In a non-limiting example (Pattern 2), all unprocessed requests corresponding to the partner user may be displayed, while the some of the unprocessed requests corresponding to a different user than the partner user may be displayed, or the like.

When displaying some unprocessed requests, it is also possible to determine the unprocessed requests to be displayed based on various types of information (conditions).

In this case, the content of a later-described sixteenth embodiment can be combined. As will be described in the sixteenth embodiment as well, non-limiting examples of various types of information include the following information.
The date or the date and time when the remittance request was transmitted/received.
The remittance request amount
The payment deadline of the remittance request
A remittance request in which a user other than the user who made the remittance request and the user who received the remittance request is involved in the remittance request amount or the reason.

Note that these pieces of information are merely examples, and there is no limitation thereto.

Also, it is possible to apply a combination of a plurality of these pieces of information.

A user may forget about an unprocessed request whose date or date and time is older by a certain amount or more. For this reason, it is possible to make a determination such that even unprocessed requests corresponding to a user different from the partner user are displayed.

An unprocessed request with a remittance request amount greater than or equal to a certain amount may be of high importance. For this reason, it is possible to make a determination such that even unprocessed requests corresponding to a user different from the partner user are displayed.

A remittance request in which a user other than the user who made the remittance request and the user who received the remittance request is involved in the remittance request amount or reason may also be of high importance. For this reason, it is possible to make a determination such that even unprocessed requests corresponding to a user different from the partner user are displayed.

An unprocessed request whose payment deadline is approaching within a certain period of time may require immediate processing. For this reason, it is possible to make a determination such that even unprocessed requests corresponding to a user different from the partner user are displayed.

Also, as will be described in the sixteenth embodiment as well, the unprocessed requests can be rearranged and displayed in ascending/descending order based on the above-described various types of information (conditions). As an example, unprocessed requests of higher importance can be displayed at a higher position.

In addition to these, the unprocessed requests displayed on the display 24 of the terminal 20 can be hidden based on input performed by the user of the terminal 20 to the input device, in a non-limiting example.

In this case, in a non-limiting example, unprocessed requests corresponding to some users may be hidden, or unprocessed requests corresponding to all users may be hidden.

Also, some users may feel annoyed by the display of unprocessed requests.

In view of this, it may be possible to set display/non-display of unprocessed requests on a setting screen or the like (not shown).

Specifically, on the setting screen of the application, as setting information relating to display of unprocessed requests, in a non-limiting example, a slide button or a check box for switching display/non-display of unprocessed requests is displayed. Also, it is possible to cause the terminal 20 or the server 10 to set display/non-display based on an operation performed on the slide button or check box.

In this case, display/non-display of unprocessed requests may be set collectively for all users, or display/non-display of unprocessed requests may be set individually for each user.

Also, display/non-display of all unprocessed requests may be settable, or display/non-display of some unprocessed requests may be settable.

Note that these contents are the same for the following examples as well.

### Effect of Eighth Embodiment

This embodiment shows a configuration in which the terminal 20 of the proposing user displays, on the display 24, a first display performed based on information for remittance from the proposing user (a non-limiting example of the user of the terminal) to the partner user (a non-limiting example of the first user) (a non-limiting example of first information relating to remittance from the user of the terminal to the first user), or information for remittance request transmission from the proposing user to the partner user (a non-limiting example of first information relating to a remittance request to be transmitted from the user of the terminal to the first user), and a second display performed based on remittance request information relating to a received remittance request received by the proposing user from the partner user (a non-limiting example of second information relating to a remittance request transmitted from the second user to the user of the terminal), or remittance request information relating to a transmitted remittance request transmitted by the proposing user to the partner user (a non-limiting example of second information relating to a remittance request transmitted from the user of the terminal to the second user).

As an example of the effect of the embodiment obtained by such a configuration, when the user of the terminal checks the first information, it is possible to check the second information as well.

Also, the present embodiment shows a configuration in which the terminal 20 of the proposing user performs processing for remittance (a non-limiting example of processing relating to remittance) with the controller 21 based on input performed by the proposing user on the terminal 20 on which the first display is displayed.

As an example of the effect of the embodiment obtained by such a configuration, it is possible to easily realize remittance to the partner user based on input to the terminal on which the first display is displayed.

### Eighth Modified Example

In the above embodiment, settlement (including collective settlement of unprocessed requests) can be executed based on input regarding information of an unprocessed request displayed together with the information for remittance to the partner user and the information for transmitting the remittance request to the partner user.

Specifically, in the non-limiting screen example shown in FIG. 8-1, in addition to the remittance button, a settlement button for executing settlement of a selected unprocessed request (collective settlement in the case where a plurality of requests are selected) is displayed.

Then, when the settlement button is tapped, the server 10 can execute settlement processing for the selected unprocessed request.

Similarly, in the non-limiting screen example of FIG. 8-2, in addition to the remittance request button, a settlement button for executing settlement of the selected unprocessed requests (collective payment if a plurality of requests are selected) is displayed.

Then, when the settlement button is tapped, the server 10 can execute settlement processing for the selected unprocessed request.

Note that the settlement processing for the unprocessed request is the same as described above, and therefore redundant description thereof will be omitted.

FIG. 8-4 is a flow chart showing an example of the flow of processing executed by each device in this modified example. Here, as an example, in the processing for displaying unprocessed requests when the user performs remittance, which is shown in FIG. 8-3, the processing for performing either remittance or settlement of the unprocessed requests will be described.

After A125, the controller 21 of the terminal 20A determines an execution target based on the input to the input device (A631).

If it is determined that settlement of unprocessed requests (collective settlement if a plurality of requests are selected) is to be executed (A631: settlement of unprocessed requests), the controller 21 of the terminal 20A sets request selection information including unprocessed request selection information indicating selected unprocessed requests (A632).

On the other hand, if it is determined that remittance is to be executed (A631: remittance), the controller 21 of the terminal 20A sets request selection information including remittance information relating to the remittance to be executed (A133).

After A632 or A133, the controller 21 of the terminal 20A transmits the set request selection information to the server 10 via the communication I/F 22 (A140).

Then, the controller 21 of the terminal 20A moves the processing to A150.

After S120, if it is determined that the request selection information has been received from the terminal 20A (S140: YES), the controller 11 of the server 10 determines the processing target based on the received request selection information (S641).

If it is determined that the processing target is “settlement of unprocessed requests”, the controller 11 of the server 10 sets the selected unprocessed requests as settlement targets (collective settlement targets if a plurality of requests are selected) (S642).

On the other hand, if it is determined that the processing target is “remittance”, the controller 11 of the server 10 sets remittance as the settlement target (S143).

After S642 or S143, the controller 11 of the server 10 executes the settlement processing of S150.

In a non-limiting example, when applying the first settlement processing described in FIG. 1-19,

if the setting of S642 has been performed and there are a plurality of unprocessed requests to be processed, the result of the determination in S1510 as to whether or not the settlement target is a collective settlement target is “YES”. As a result, the processing of S1515 and onward is executed with these multiple unprocessed requests as the collective settlement targets. Also, when the setting of S642 is performed and there is one unprocessed request to be processed, the result of determination in S1510 as to whether or not the settlement target is a collective settlement target is “NO”. As a result, the processing of S1570 and onward is executed with this one unprocessed request as the settlement target.

On the other hand, when the setting of S143 has been performed, the determination result in S1510 as to whether or not the settlement target is a collective settlement target is “NO”. As a result, the processing of S1570 and onward is executed with the remittance as the settlement target.

Note that since a similar configuration is possible by replacing “remittance” in the processing of FIG. 8-4 with “remittance request transmission” for the processing for displaying unprocessed requests when the user performs a remittance request and performing one of transmission of the remittance request and settlement of the unprocessed request, illustration and description thereof are omitted.

Specifically, in the processing of the terminal 20A, it is determined in A105 whether or not input for displaying the remittance request transmission screen has been performed, a remittance request transmission screen including the remittance request list information is displayed in A125, it is determined in A631 whether the execution target is settlement of the unprocessed request or transmission of a remittance request, and request selection information including the remittance request transmission information is set in A133.

Also, in the processing of the server 10, it is determined in S641 whether the processing target is settlement of the unprocessed request or transmission of the remittance request, and transmission of the remittance request is set as the settlement target in S143.

This modified example shows a configuration in which the terminal 20 of the proposing user displays, on the display 24, a first display performed based on information for remittance from the proposing user (a non-limiting example of the user of the terminal) to the partner user (a non-limiting example of the first user) (a non-limiting example of first information relating to remittance from the user of the terminal to the first user), or information for remittance request transmission from the proposing user to the partner user (a non-limiting example of first information relating to a remittance request to be transmitted from the user of the terminal to the first user), and a second display performed based on remittance request information relating to a received remittance request received by the proposing user from the partner user (a non-limiting example of second information relating to a remittance request transmitted from the second user to the user of the terminal), or remittance request information relating to a transmitted remittance request transmitted by the proposing user to the partner user (a non-limiting example of second information relating to a remittance request transmitted from the user of the terminal to the second user).

Then, based on input performed by the proposing user to the terminal 20 on which the first display or the second display is displayed, the terminal 20 of the proposing user performs processing for remittance, processing for receiving the remitted amount, or processing for transmitting/receiving a remittance request (remittance reminder) (a non-limiting example of first processing relating to remittance, relating to receiving remittance, or relating to requesting remittance) with the controller 21.

As an example of the effect of the embodiment obtained by such a configuration, based on the input to the terminal on which the first display or the second display is displayed, remittance to the partner user, reception of remittance from the partner user, and transmission/reception of a remittance request to/from the partner user can be easily realized.

Next, as an embodiment relating to the eighth embodiment, an embodiment will be described in which, when the user of the terminal 20 performs remittance to the partner user or transmits a remittance request to the partner user, an unprocessed request selected from among the displayed unprocessed requests is also processed.

The following embodiment is roughly divided into the following five patterns and described.

(A) Pattern in which remittance+received remittance request are processed
(B) Pattern in which remittance+transmitted remittance request are processed
(C) Pattern in which transmission of remittance request+received remittance request are processed
(D) Pattern in which transmission of remittance request+transmitted remittance request are processed
(E) Pattern in which remittance request+received remittance request+transmitted remittance request are processed

Each pattern will be described in a separate embodiment.

As shown in the eighth modified example, the processing (the first processing, etc.) executed by the terminal 20 with the controller 21 includes, in a non-limiting example, processing for performing remittance (a non-limiting example of processing relating to remittance), processing for performing reception of remittance (money reception) (a non-limiting example of processing relating to receiving remittance), processing for transmitting/receiving remittance requests (a non-limiting example of processing relating to requesting remittance), and the like.

Note that in the following description, a server-client system is illustrated, and remittance, transmission of remittance requests, and the like are performed via the server 10.

Also, hereinafter, as described above, a case where the partner user is one user, that is, a case where the second user is the first user (or the first user is the second user) will be illustrated.

Note that as described above, the method described below can be similarly applied also to the case where the partner user is a plurality of different users, that is, the case where the first user is a user different from the second user (the second user is a user different from the first user).

### Ninth Embodiment

The ninth embodiment is an embodiment relating to the processing of pattern (A) above.

The content described in the ninth embodiment can be applied also to any of the other embodiments and the other modified examples.

Also, constituent elements that are the same as constituent elements that have already appeared are denoted by the same reference signs thereas, and redundant description thereof is omitted.

In this embodiment, collective settlement is performed while including “remittance” in the collective settlement target and including the “received remittance request” among the unprocessed requests in the collective settlement target.

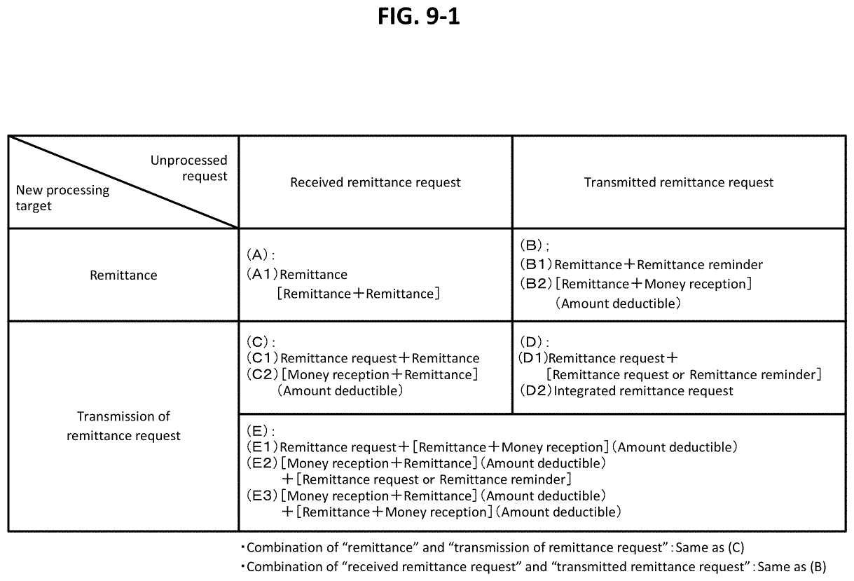

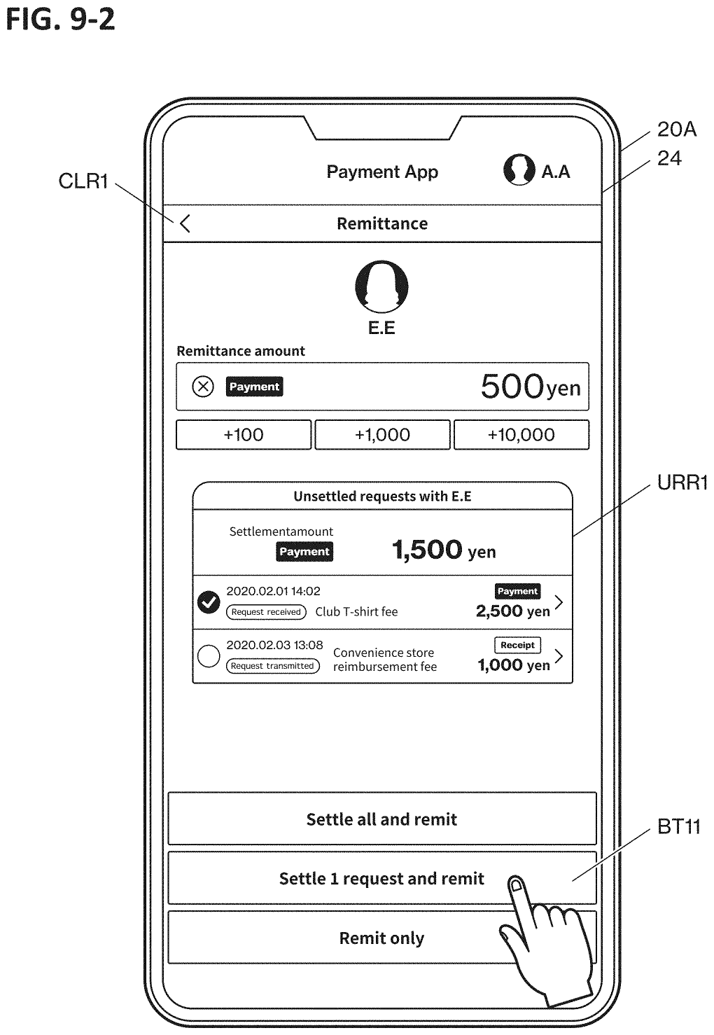

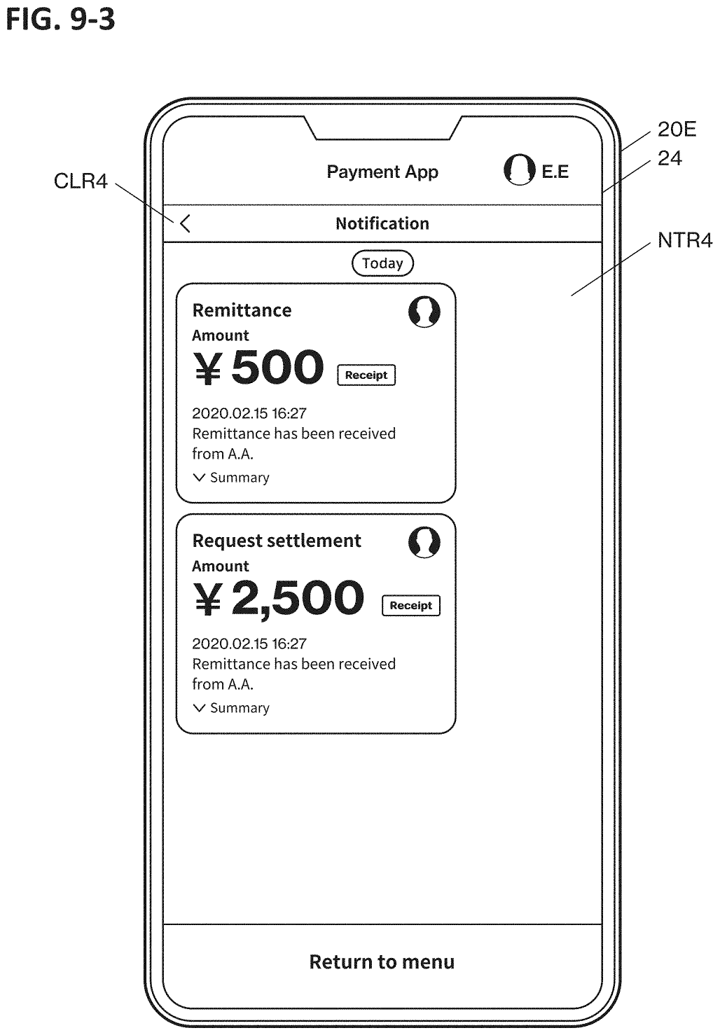

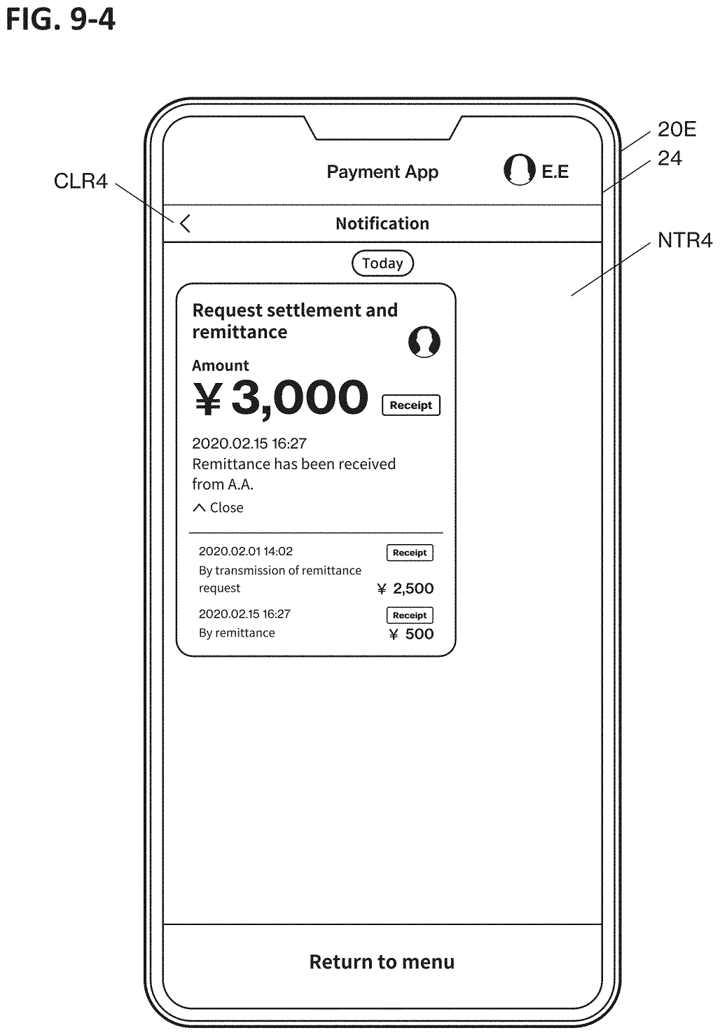

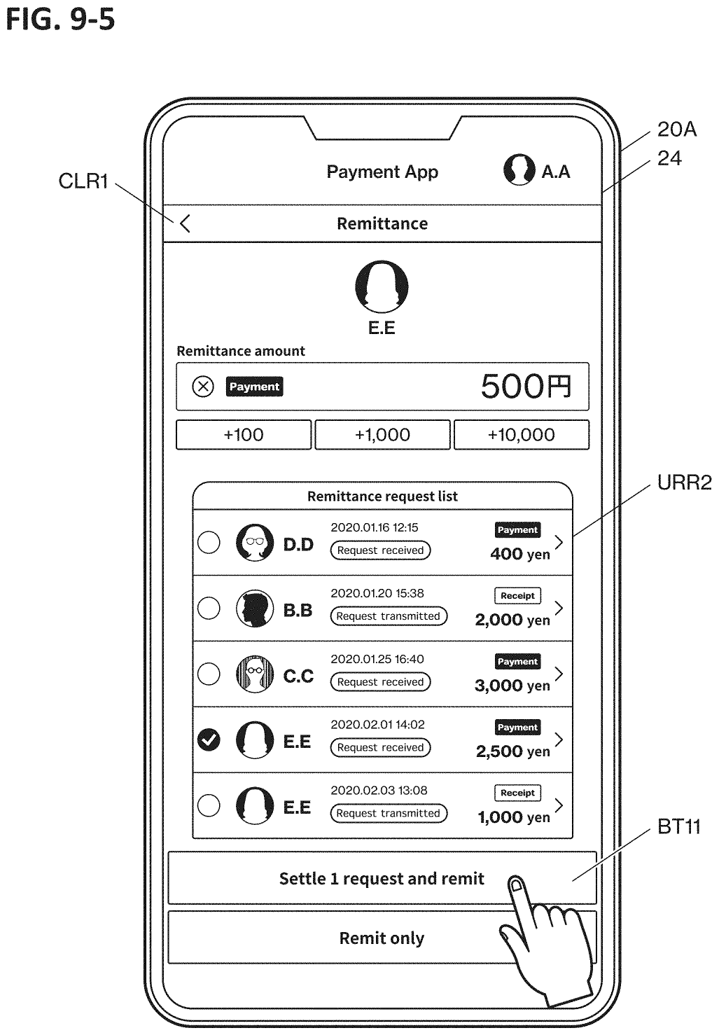

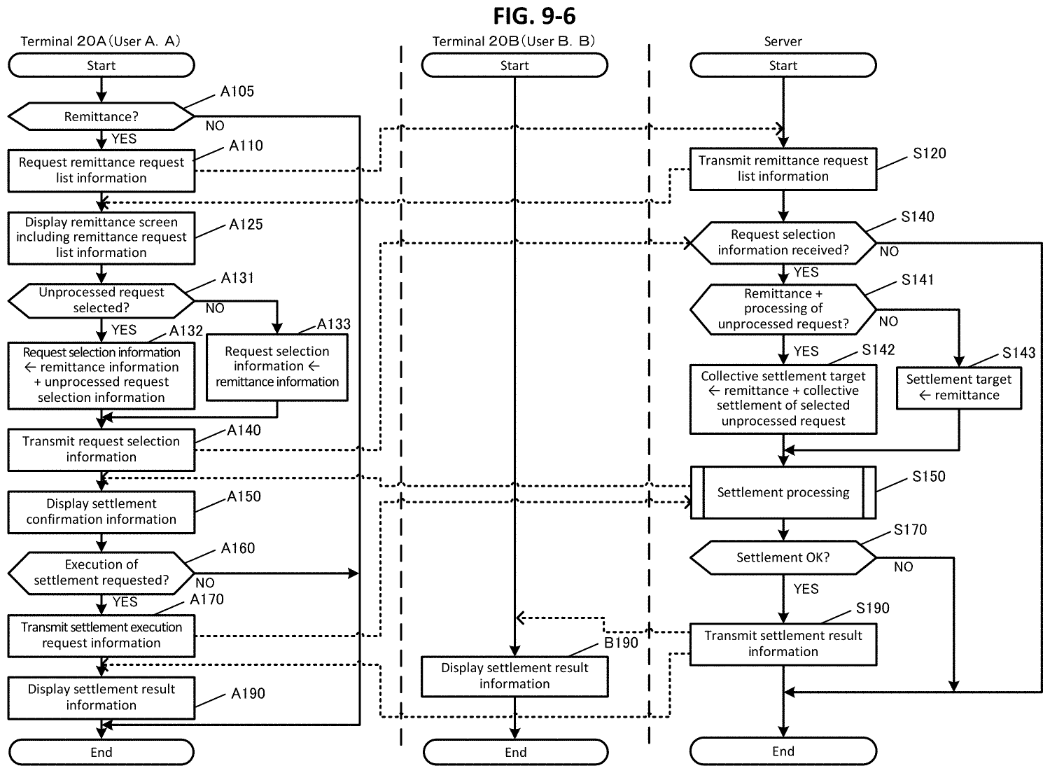

FIG. 9-1 is a diagram showing an example of a table for describing processing methods corresponding to each pattern.

In the vertical direction of the table, the targets of the processing that is to be newly executed (new processing targets) are shown as items, and in the horizontal direction of the table, the types of unprocessed requests are shown as items. An example of processing realized by a combination of a new processing target and an unprocessed request of that type is shown in the field where the vertical item and the horizontal item intersect.

In this embodiment, processing of the pattern (A) remittance+received remittance request will be described. In this pattern, processing of (A1) remittance [remittance+remittance] can be performed.

That is, when performing a new remittance to the partner user, remittance to the partner user is also performed based on a remittance request received from the partner user. More specifically, the sum of the amount to be remitted to the partner user through new remittance and the remittance request amount included in the received remittance request information (the amount requested by the partner user to be remitted) is remitted to the partner user.

### Display Screen

A display screen example in the case where the above-described processing (A1) is performed will be described.

FIG. 9-2 is a diagram showing an example of a screen displayed on the display 24 of the terminal 20 according to an embodiment. This screen is, in a non-limiting example, a remittance screen of the payment application displayed on the display 24 of the terminal 20A of the user A.A.

In the current location display region CLR1 indicating the current location in the payment application, the word “Remittance” is displayed, which indicates that the current location is the remittance function of the payment application.

Below the current location display region CLR1, the icon image and user name (the user E.E in this example) of the payment application of the user selected as the remittance destination are displayed. Also, below that, the remittance amount to the user selected as the remittance destination (“500 yen” in this example) and function buttons for increasing the remittance amount by certain amounts are displayed.

Further below that, an unprocessed request confirmation region URR1 is displayed to make it possible to confirm unprocessed requests between the user selected as the remittance destination (the user E.E in this example) and the user performing remittance (the user A.A in this example).

At the top of the unprocessed request confirmation region URR1, the words “Unsettled Requests with E.E” are displayed, indicating that the unprocessed requests with the user E.E are being displayed.

Also, below that, the collective settlement amount (“1,500 yen” in this example) and a mark (“payment mark” in this example) are displayed, assuming that full-selection collective settlement is to be performed.

Below that, a list of remittance requests for which the partner is the user E.E is displayed. In this example, unprocessed requests for which the partner is the user E.E are listed in chronological order from the top, starting with the oldest. Since the display mode of the unprocessed requests can be the same as in FIG. 1-11 in a non-limiting example, redundant description thereof will be omitted.

Below the unprocessed request confirmation region URR1, a remittance/full-selection collective settlement button indicated as “Settle all requests and remit”, which is for executing remittance processing and full-selection collective settlement, is displayed. Below that, a remittance/collective settlement button BT11 indicated as “Settle 1 request and remit”, which is for executing remittance processing and partial-selection collective settlement of the unprocessed requests selected in the unprocessed request confirmation region URR1, is displayed. Further below that, a remittance button indicated as “Remit only”, which is for executing only remittance processing, is displayed.

In a non-limiting example, in the unprocessed request confirmation region URR1, the request check for the first received remittance request (payment of 2,500 yen) is set to “ON” and selected, and when the remittance/collective settlement button BT11 is tapped, the terminal 20A requests the server 10 to execute remittance and collective settlement of the selected unprocessed requests. Then, the settlement result information relating to the execution result is transmitted from the server 10 to the terminal 20E of the user E.E who is the partner.

FIG. 9-3 is a diagram showing an example of a notification screen displayed on the display 24 of the terminal 20E when the above-described remittance/collective settlement button BT11 is tapped.

In this example, in the notification information display region NTR4 of the notification screen, two pieces of settlement result information are displayed as the contents of remittance and collective settlement.

Specifically, as a non-limiting example, settlement result information is displayed, which corresponds to each of reception of a remittance amount “500 yen”, which was remitted by the user A.A to the user E.E, and reception of a remittance amount “2,500 yen” remitted based on the remittance request amount “2,500 yen” according to a remittance request received by the user A.A from the user E.E, which was selected in FIG. 9-2.

Note that, as shown in FIG. 9-4, two pieces of settlement result information may be optionally combined and displayed in the notification information display region NTR4 of the notification screen as one piece of settlement result information.

In a non-limiting example, in FIG. 9-4, as settlement result information, information is displayed relating to reception of “3,000 yen”, which is obtained by adding the remittance amount “500 yen” resulting from reception of remittance by the user E.E from the user A.A, and the remittance request amount “2,500 yen” resulting from reception of the remittance request amount “2,500 yen” in the remittance request from the user E.E to the user A.A.

In FIG. 9-2, the unprocessed request confirmation region URR1 displays the unprocessed requests of the user selected as the remittance destination and the user performing remittance, but there is no limitation thereto.

FIG. 9-5 shows an example of the display screen when displaying all unprocessed requests of the user performing remittance. FIG. 9-5 is another example of the remittance screen in FIG. 9-2.

In FIG. 9-5, in the unprocessed request confirmation region URR2, all unprocessed requests of the user performing remittance are listed in chronological order from the top, starting with the oldest. Below the unprocessed request confirmation region URR2, a remittance/collective settlement button BT11 and a remittance button are displayed. As a non-limiting example, in the unprocessed request confirmation region URR2, when the request check of the received remittance request (payment of 2,500 yen) from the fourth the user E.E is set to “ON” and selected, and the remittance/collective settlement button BT11 is tapped, the display screen of FIG. 9-3 is displayed on the display 24 of the terminal 20E.

### Processing

FIG. 9-6 is a flow chart showing an example of the flow of processing executed by each device according to an embodiment.

This flow chart is a flow chart obtained by rewriting the flow chart of FIG. 1-18 into processing in which the new processing target is “remittance”.

In the processing of the pattern (A) remittance+received remittance request according to an embodiment, remittance is unilaterally performed to the partner user, and therefore the need for the approval of the partner user can be eliminated when performing collective settlement. In view of this, here, processing that does not require the approval of the partner user will be illustrated and described.

Note that there is not necessarily a limitation to this, and the approval of the partner user may also be required.

After A125, the controller 21 of the terminal 20A determines whether or not an unprocessed request has been selected from the remittance request list information (A131).

If an unprocessed request has been selected, that is, if it is determined that execution of processing for remittance+unprocessed request is requested (A131: YES), the controller 21 of the terminal 20A sets the request selection information including remittance information relating to the remittance to be executed, and unprocessed request selection information indicating the selected unprocessed request (A132).

On the other hand, if no unprocessed request is selected from the remittance request list information, that is, if it is determined that only remittance is to be executed (A131: NO), the controller 21 of the terminal 20A sets the request selection information including remittance information relating to the remittance to be executed (A133).

Note that description of this processing is premised on remittance being performed.

In actuality, although it may be possible to select processing of only unprocessed requests without performing remittance, the processing in that case is the same as the processing for collective settlement of the above-described unprocessed request, and therefore illustration and redundant description thereof are omitted.

After A132 or A133, the controller 21 of the terminal 20A transmits the set request selection information to the server 10 via the communication I/F 22 (A140).

Then, the controller 21 of the terminal 20A moves the processing to A150.

If it is determined in S140 that request selection information has been received from terminal 20A (S140: YES), the controller 11 of the server 10 determines whether or not to process remittance+unprocessed request, based on information included in the received request selection information (S141). Then, if it is determined that processing is to be performed (S141: YES), the controller 11 of the server 10 sets remittance+settlement of the selected unprocessed requests (collective settlement if a plurality of requests are selected) as collective settlement targets (S142).

On the other hand, if it is determined that processing for remittance+an unprocessed request is not to be performed, and only remittance is to be executed (S141: NO), the controller 11 of the server 10 sets remittance as the settlement target (S143).

After S142 or S143, the controller 11 of the server 10 executes the settlement processing of S150.

In a non-limiting example, when applying the first settlement processing described in FIG. 1-19,

if the setting of S142 is performed, the determination result of whether or not the settlement target in S1510 is the collective settlement target is “YES”. As a result, the processing from S1515 onward is executed with remittance+settlement of the selected unprocessed requests as the collective settlement target.

On the other hand, when the setting of S143 is performed, the determination result of whether or not the settlement target in S1510 is a collective settlement target is “NO”. As a result, the processing of S1570 and onward is executed with remittance as the settlement target.

### Effect of Ninth Embodiment

This embodiment shows a configuration in which the terminal 20 of the proposing user displays, on the display 24, a first display performed based on remittance information from the proposing user (a non-limiting example of the user of the terminal) to the partner user (a non-limiting example of the first user) (a non-limiting example of first information relating to remittance from the user of the terminal to the first user) or remittance request information relating to a remittance request to be transmitted from the proposing user to the partner user (a non-limiting example of first information relating to a remittance request to be transmitted from the user of the terminal to the first user), and second display performed based on remittance request information relating to a received remittance request received by the proposing user from the partner user (a non-limiting example of second information relating to a remittance request transmitted from the second user to the user of the terminal) or remittance request information relating to a transmitted remittance request transmitted by the proposing user to the partner user (a non-limiting example of second information relating to a remittance request transmitted from the user of the terminal to the second user).

Then, the terminal 20 of the proposing user performs, with the controller 21, processing for remittance, processing for receiving a remitted amount, or processing for transmitting/receiving a remittance request (a remittance reminder) (a non-limiting example of first processing relating to remittance, reception of remittance, or a remittance request), based on input performed by the proposing user on the terminal 20, on which the first display or the second display is displayed.

As an example of the effect of the embodiment obtained by such a configuration, remittance to the partner user, reception of remittance (money reception) from the partner user, transmission of a remittance request to the partner user, reception of a remittance request from the partner user, and the like can be easily realized based on input to the terminal on which the first display or the second display is displayed.

Also, the present embodiment shows a configuration in which the first processing is performed by the controller 21 based on the first information and the second information, based on input regarding the first display and the second display.

As an example of the effect of the embodiment obtained by such a configuration, it is possible to easily perform processing based on the first information and the second information, based on input regarding the first display and the second display.

Also, this embodiment shows a configuration in which the first information is remittance information from the proposing user to the partner user (a non-limiting example of information relating to remittance from the user of the terminal to the first user), the second information is received remittance request information relating to a remittance request received from the partner user (a non-limiting example of information relating to a remittance request transmitted from the second user to the user of the terminal), and the first processing includes processing for remittance to the partner user based on the remittance information and the received remittance request information.

As an example of the effect of the embodiment obtained by such a configuration, based on input to the first display and the second display, remittance between the first user and the second user can be easily realized based on information relating to remittance from the user of the terminal to the first user and information relating to a remittance request from the second user to the user of the terminal.

Also, in this case, the partner user can be one user (a non-limiting example of the second user being the first user), and the first processing can include processing for remitting an amount obtained by adding the amount remitted from the proposing user to the partner user and the remittance request amount included in the received remittance request information from the partner user (a non-limiting example of the amount based on the first information and the second information).

As an example of the effect of the embodiment obtained by such a configuration, it is possible to remit an amount based on the first information and the second information with the same user as the partner.

### Ninth Modified Example

In the above embodiment, a case was described in which, as an example of the amount based on the first information and the second information, an amount obtained by adding an amount to be remitted from the proposing user to the partner user and an amount included in received remittance request information from the partner user is remitted to the partner user. However, there is no limitation to this.

A case is envisioned in which the proposing user has borrowed money from the partner user. In such a case, in a non-limiting example, the proposing user may perform remittance to the partner user with interest.

Specifically, in a non-limiting example, processing for adding a preset rate of interest (as a non-limiting example, 5% interest) to the amount obtained by adding the above-described amounts can be performed by the terminal 20 of the proposing user or the server 10, and remittance can be performed from the proposing user to the partner user with the amount resulting from adding interest as the remittance amount.

Note that this method also applies to the case where the partner user remits an amount based on the first information and the second information.

### Tenth Embodiment

The tenth embodiment is an embodiment relating to the processing of pattern (B) described above.

The content described in the tenth embodiment can be applied to any of the other embodiments and the other modified examples.

Also, constituent elements that are the same as constituent elements that have already appeared are denoted by the same reference signs thereas, and redundant description thereof is omitted.

In this embodiment, collective settlement is performed while including “remittance” in the collective settlement target, and including “transmitted remittance request” among the unprocessed requests in the collective settlement target.

Description will be given with reference to the table in FIG. 9-6 again.

In this embodiment, the processing of pattern of (B) remittance+transmitted remittance request is performed.

In this pattern, the processing of either (B1) remittance+remittance reminder, or (B2) In the processing of (B1), when performing a new remittance to the partner user, a remittance reminder to the partner user is also performed based on the transmitted remittance request to the partner user.

Note that a new remittance request may optionally be issued as well instead of the remittance reminder.

In the processing of (B2), when performing a new remittance to the partner user, remittance is received from the partner user based on a transmitted remittance request to the partner user.

In this case, since there is a contradictory relationship between payment and receipt of money, it is possible to remit/receive the amount corresponding to the difference from the remittance request amount.

Also, if the remittance request amount is the same amount, it is possible to cancel out the amount.

Specifically, an amount obtained by subtracting the remittance request amount included in the transmitted remittance request information from the amount to be remitted from the proposing user to the partner user is remitted to the partner user.

Alternatively, conversely, an amount obtained by subtracting the amount to be remitted from the proposing user to the partner user from the remittance request amount included in the transmitted remittance request information is received from the partner user.

### Display Screen

First, a display screen example in a case where the processing of (B1) above is performed will be described.

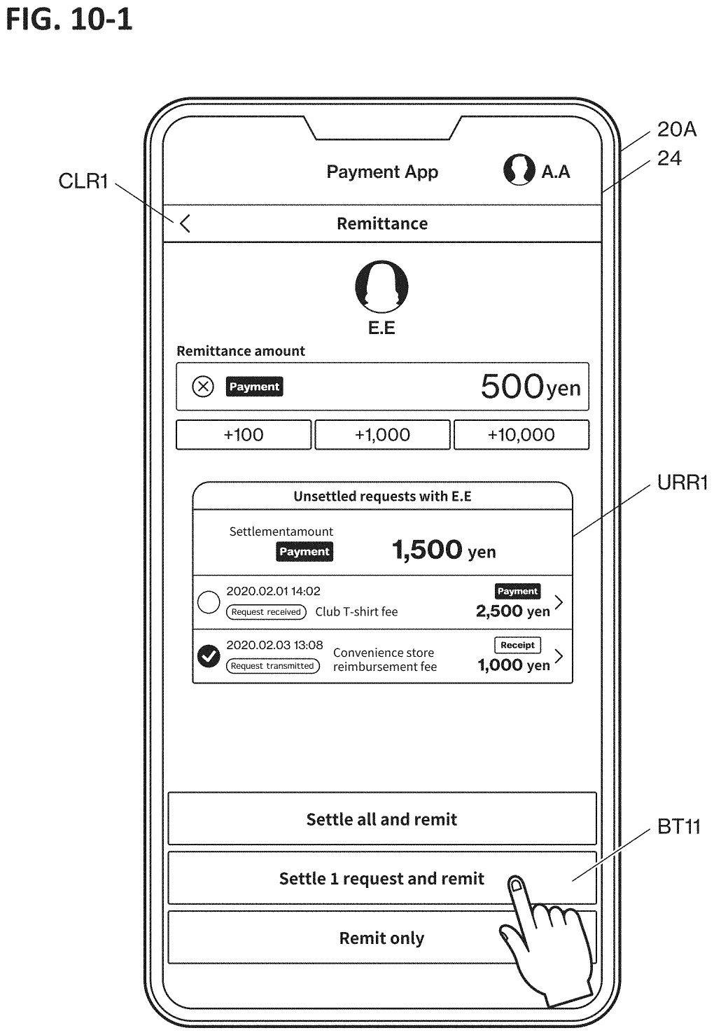

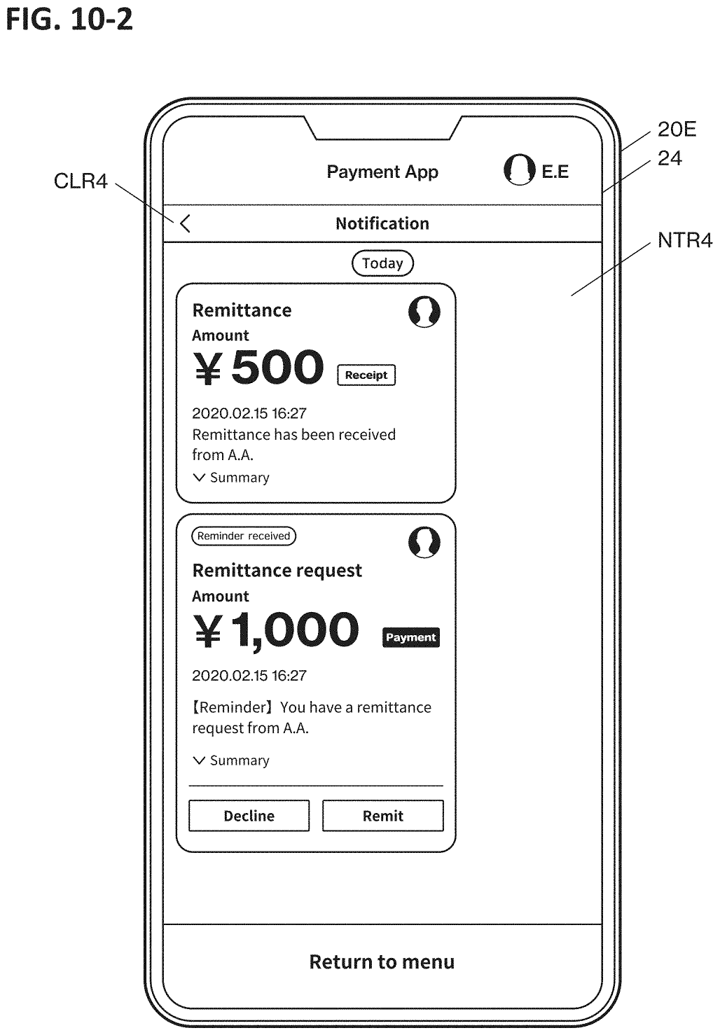

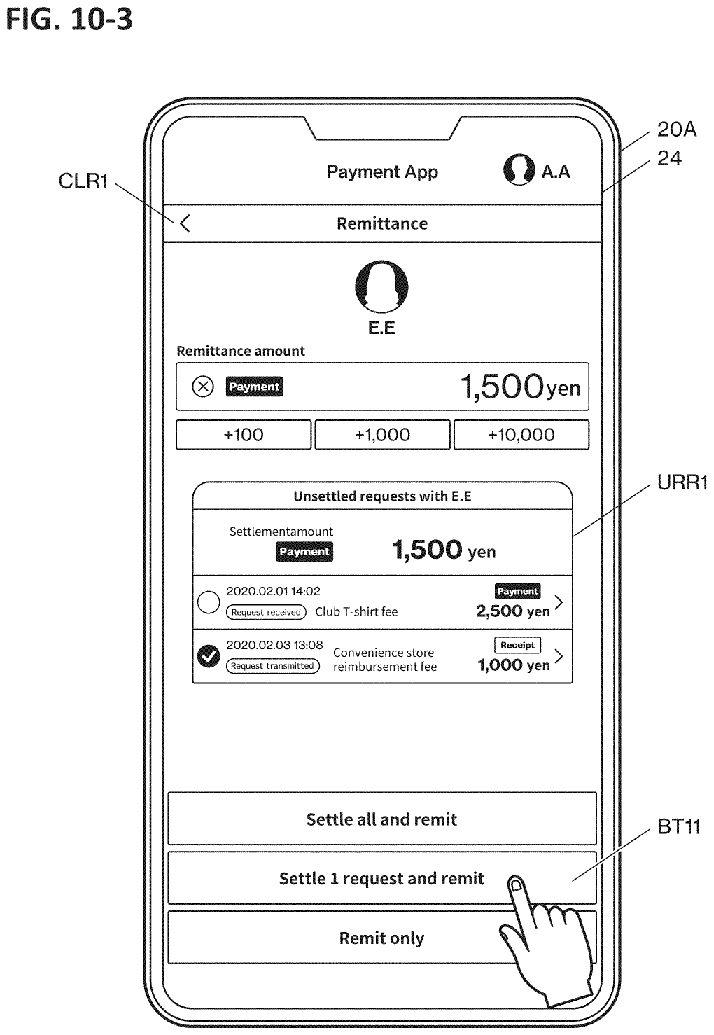

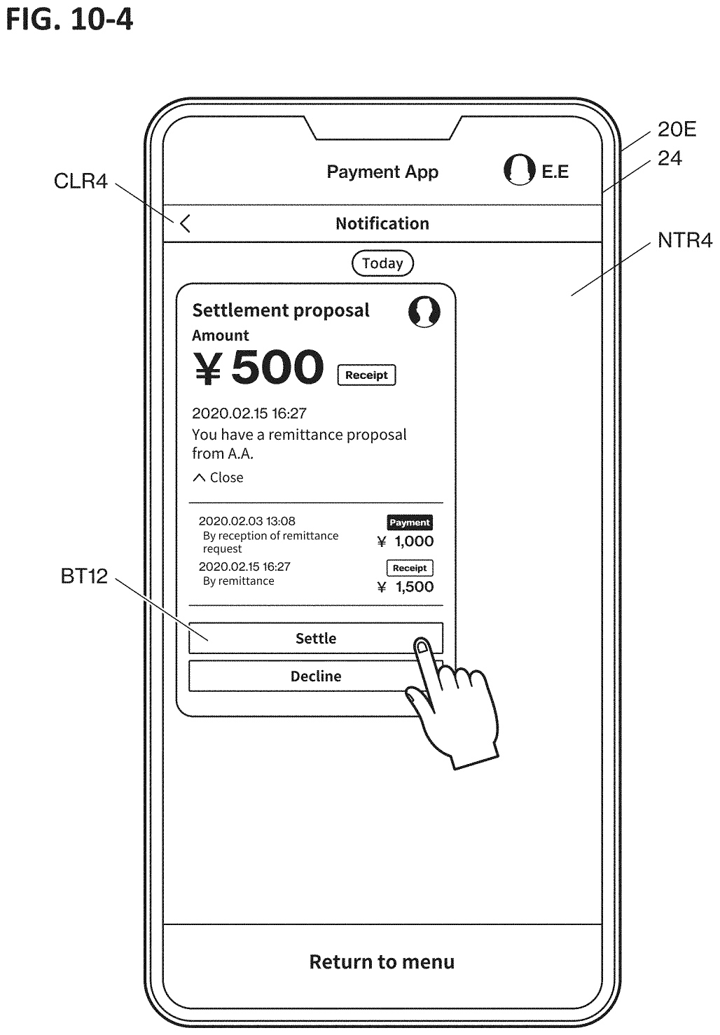

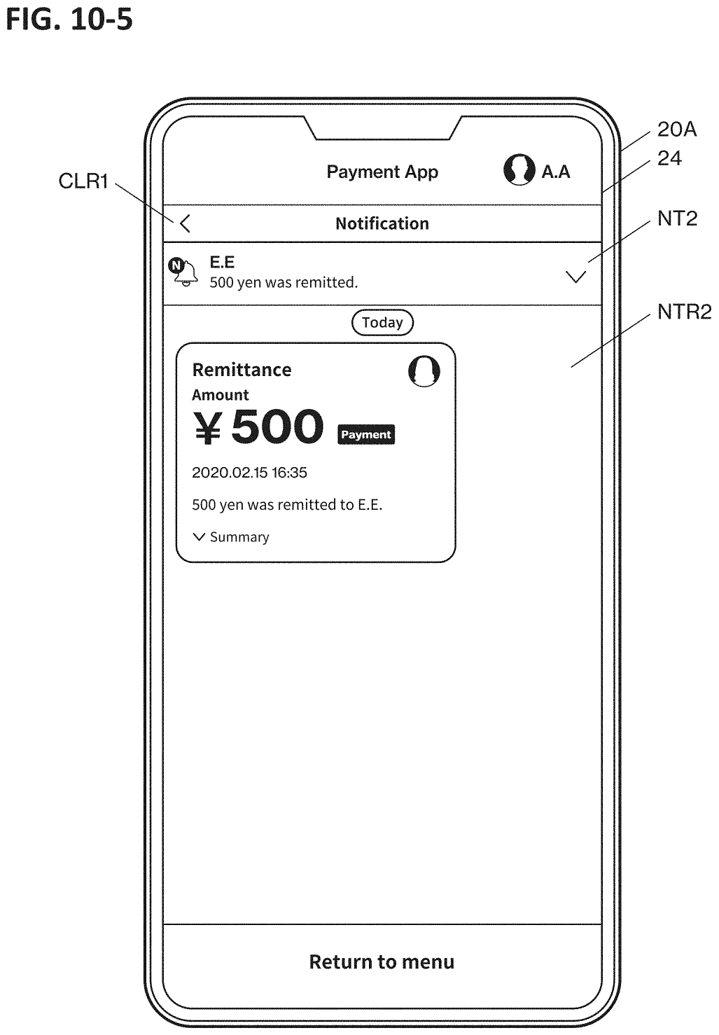

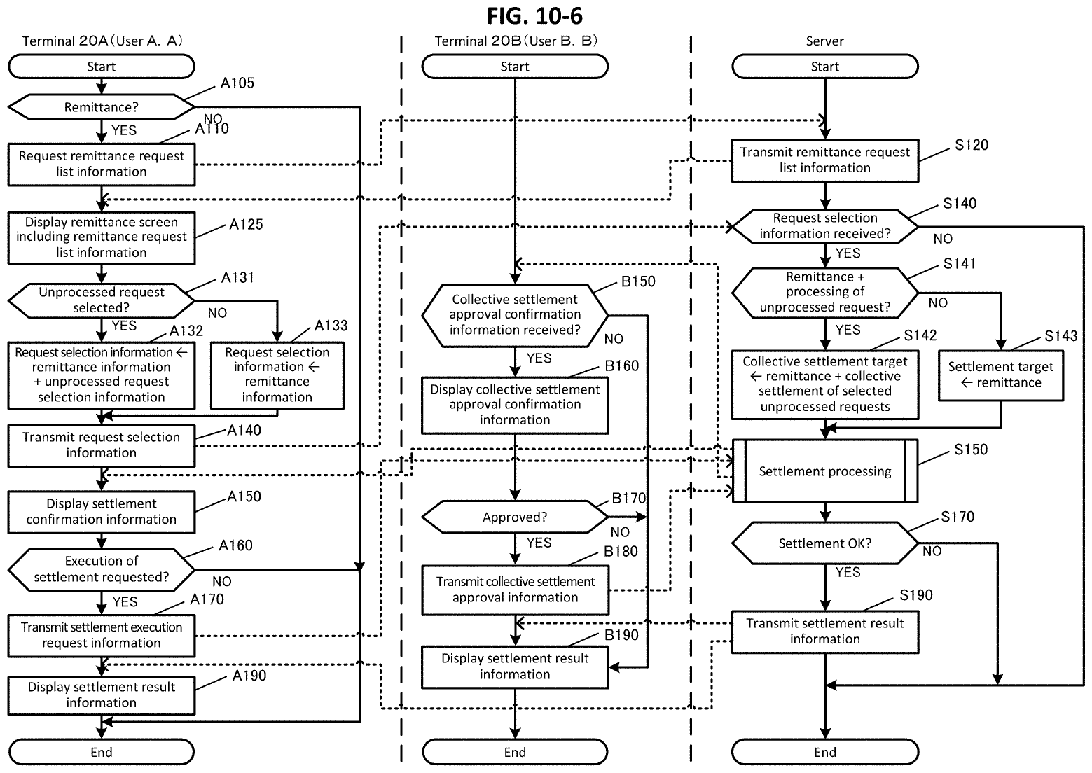

FIG. 10-1 is a diagram showing an example of a screen displayed on the display 24 of the terminal 20 according to an embodiment. This screen is, in a non-limiting example, a remittance screen of the payment application displayed on the display 24 of the terminal 20A of the user A.A. Regarding the details of the screen configuration, in a non-limiting example, the screen can be configured in the same manner as in FIG. 9-2, and therefore detailed description will be omitted.

In a non-limiting example, in the unprocessed request confirmation region URR1, when the check of the second transmitted remittance request (receipt of 1,000 yen) is turned “ON” and selected and the remittance/collective settlement button BT11 is tapped, the terminal 20A requests the server 10 to execute remittance and collective settlement of the selected unprocessed requests. Then, the settlement result information relating to the execution result is transmitted from the server 10 to the terminal 20E of the user E.E who is the partner.

FIG. 10-2 is a diagram showing an example of a notification screen displayed on the display 24 of the terminal 20E when the above-described remittance/collective settlement button BT11 is tapped.

In this example, in the notification information display region NTR4 of the notification screen, two pieces of settlement result information are displayed as the content of remittance and collective settlement.

Specifically, as a non-limiting example, the settlement result information corresponding to the receipt of the remittance amount “500 yen” remitted by the user A.A to the user E.E, and a reminder corresponding to the second remittance request selected in FIG. 10-1 (a remittance request for a remittance request amount “1,000 yen” transmitted by the user A.A to the user E.E) are displayed.

Next, an example of a display screen when the processing of (B2) described above is performed will be described.

FIG. 10-3 is a diagram showing an example of a screen displayed on the display 24 of the terminal 20 according to an embodiment. This screen is, in a non-limiting example, a remittance screen of the payment application displayed on the display 24 of the terminal 20A of the user A.A. Regarding the details of the screen configuration, in a non-limiting example, the screen can be configured in the same manner as in FIG. 9-2, and therefore detailed description will be omitted. Note that in FIG. 10-3, as a non-limiting example, the remittance amount to the user selected as the remittance destination is “1,500 yen”.

In a non-limiting example, in the unprocessed request confirmation region URR1, when the check of the second transmitted remittance request (receipt of 1,000 yen) is turned “ON” and selected and the remittance/collective settlement button BT11 is tapped, the terminal 20A requests the server 10 to execute remittance and collective settlement of the selected unprocessed requests. Then, the server 10 transmits, to the terminal 20E of the user E.E, who is the partner, collective settlement approval confirmation information for confirming whether or not to approve the collective settlement, and displays the collective settlement approval confirmation information on the display 24 of the terminal 20E.

FIG. 10-4 is a diagram showing an example of a notification screen displayed when the remittance/collective settlement button BT11 is tapped.

In the notification information display region NTR4, the icon image of the user A.A who is the partner of the “settlement proposal” and the collective settlement amount are displayed as collective settlement approval confirmation information.

In the collective settlement approval confirmation information, as the content of the collective settlement, it is shown that the user E.E will receive “1,500 yen” through this remittance from the user A.A to the user E.E, and the user E.E will pay the remittance request amount “1,000 yen” based on the receipt of past remittance requests from the user A.A.

Also, the content of the collective settlement can be stored by tapping a “Close” icon of the collective settlement approval confirmation information, and can be expanded by tapping an “Overview” icon from the stored state.

Also, in the collective settlement approval confirmation information, it is shown that the user E.E will receive “500 yen”, which is obtained by subtracting the remittance request amount “1,000 yen” according to the remittance request from the received amount “1,500 yen” according to remittance, from the user A.A as the collective settlement amount.

At the lower part of the collective settlement approval confirmation information, a settlement button BT12 indicated as “Settle” for approving settlement with the above content, and a decline button indicated as “Decline” for declining settlement with the above content are displayed.

FIG. 10-5 is a diagram showing an example of a notification screen displayed on the display 24 of the terminal 20A when the settlement button BT12 is tapped.

Below the current location display region CLR1, collective settlement of the remittance requests is approved by the terminal 20E of the user E.E via the server 10, and a notification NT2 including the words “500 yen was remitted” is displayed together with a bell mark as a notification that remittance has been performed as a result.

Information corresponding to the notification NT2 is displayed in the notification information display region NTR2 of the notification screen.

In this example, in the notification information display region NTR2 of the notification screen, due to the collective settlement being performed with the user E.E, the settlement result information (in this example, payment of the remittance amount “500 yen”, which is remitted by the user A.A to the user E.E) is displayed.

Note that in FIG. 10-3, when the remittance/collective settlement button BT11 is tapped, a confirmation screen indicating that the user A.A will pay the collective settlement amount “500 yen” if settlement is performed may optionally be displayed on the display 24 of the terminal 20A, and execution of remittance and collective payment of the selected unprocessed requests may optionally be requested based on the approval of the user A.A.

### Processing

The processing executed by each device according to an embodiment can be realized similarly following the processing in FIG. 9-6.

However, when executing the processing of (B2) [remittance+money reception] (amount deductible), processing for performing remittance by the partner user is included. For this reason, as described above, it is also possible to require the approval of the partner user in performing the collective settlement.

FIG. 10-6 is a flow chart showing an example of the flow of processing executed by each device in this case.

This flow chart is, in a non-limiting example, a flow chart obtained by applying the processing of FIG. 1-21 to the processing of FIG. 9-6.

The difference from the processing of FIG. 9-6 is that steps B150 to B190 are added as processing executed by the controller 21 of the terminal 20B.

### Effect of Tenth Embodiment

This embodiment shows a configuration in which the first information described above is remittance information from the proposing user to the partner user (a non-limiting example of information relating to remittance from the user of the terminal to the first user), and the second information is transmitted remittance request information relating to a transmitted remittance request from the proposing user to the partner user (a non-limiting example of information relating to a remittance request transmitted from the user of the terminal to the second user).

As an example of the effect of the embodiment obtained by such a configuration, the remittance from the user of the terminal to the first user and the remittance request transmitted from the user of the terminal to the second user can be processed together.

Also, in this case, the first processing can include processing for performing remittance to the partner user based on the remittance information and transmitting a remittance reminder to the partner user based on the transmitted remittance request information.

As an example of the effect of the embodiment obtained by such a configuration, remittance to the first user and a remittance request to the second user can be performed together.

Also, this embodiment shows a configuration in which the partner user is one user (a non-limiting example of the second user being the first user), and the first processing is processing for remitting an amount based on an amount remitted from the proposing user to the partner user and a remittance request amount included in transmitted remittance request information (a non-limiting example of an amount based on the first information and the second information) to the partner user (a non-limiting example of processing for remitting to the first user), or processing for receiving money from the first user (a non-limiting example of processing for receiving remittance from the first user).

As an example of the effect of the embodiment obtained by such a configuration, an amount based on the first information and the second information can be remitted or an amount based on the first information and the second information can be received with the same user as the partner.

Also, in this case, a configuration is shown in which the first processing includes processing for remitting an amount obtained by subtracting a remittance request amount (a non-limiting example of a second amount) included in transmitted remittance request information from an amount to be remitted from the proposing user to the partner user (a non-limiting example of a first amount) to the partner user (a non-limiting example of processing for remitting to the first user), or processing for receiving an amount obtained by subtracting the amount to be remitted from the proposing user to the partner user (first amount) from a remittance request amount included in transmitted remittance request information (second amount) from the partner user (an example of processing for receiving money from the first user).

As an example of the effect of the embodiment obtained by such a configuration, an amount corresponding to the difference between the first amount and the second amount can be remitted, or an amount corresponding to the difference between the first amount and the second amount can be received, with the same user as the partner.

Also, this embodiment shows a configuration in which the first processing is executed based on the approval of the partner user, which is based on input to the terminal of the partner user.

As an example of the effect of the embodiment obtained by such a configuration, the first processing can be executed based on the approval of the first user, which is based on input to the terminal of the first user. As a non-limiting example, this makes it possible to prevent the first processing from being executed against the will of the first user.

### Eleventh Embodiment

The eleventh embodiment is an embodiment relating to the processing of pattern (C) described above.

The content described in the eleventh embodiment can be applied to any of the other embodiments and the other modified examples.

Also, constituent elements that are the same as constituent elements that have already appeared are denoted by the same reference signs thereas, and redundant description thereof is omitted.

In this embodiment, collective settlement is performed while including “transmission of remittance request” in the collective settlement target, and including “received remittance request” among the unprocessed requests in the collective settlement target.

Description will be given with reference to the table in FIG. 9-6 again.

In this embodiment, processing of the pattern of (C) transmission of remittance request+received remittance request is performed.

In this pattern, processing of either (C1) remittance request+remittance or (C2) [money reception+remittance] (amount deductible) can be performed.

In the processing of (C1), when performing a new remittance request to the partner user, remittance to the partner user is also performed based on a received remittance request from the partner user.

In the processing of (C2), when a new remittance request to the partner user is performed, remittance received from the partner user is received based on this new remittance request, and remittance to the partner user is performed based on a received remittance request from the partner user.

In this case, it is possible to receive/remit an amount corresponding to the difference between the remittance request amounts.

Also, if the remittance request amounts are the same amount, it is possible to cancel out the amounts.

### Display Screen

First, a display screen example in a case where the processing of (C1) above is performed will be described.

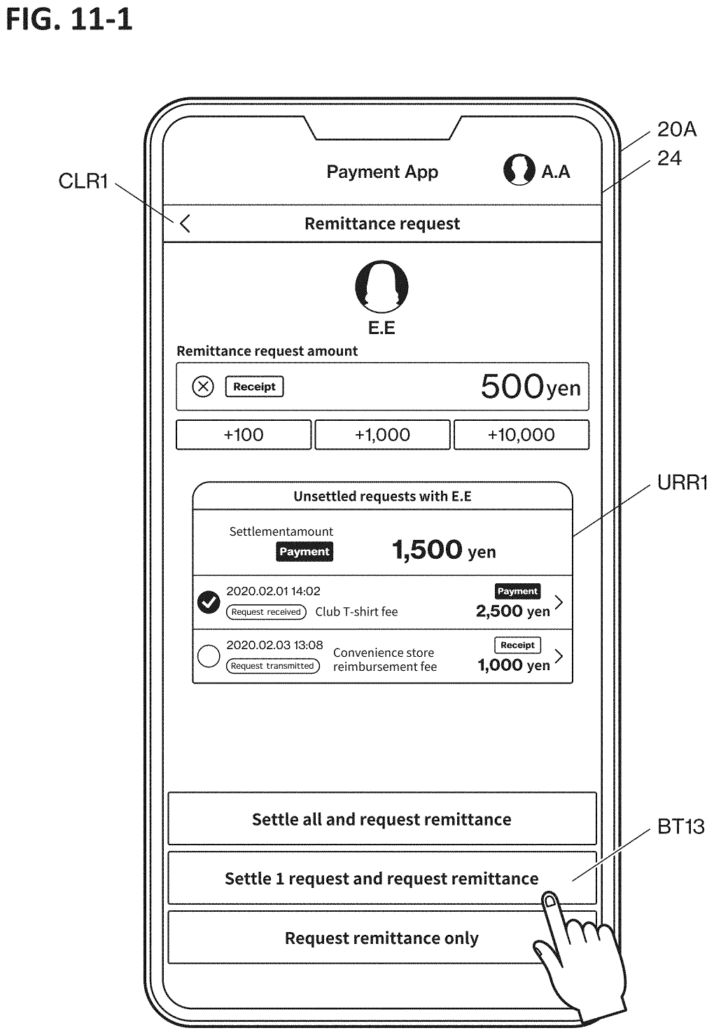

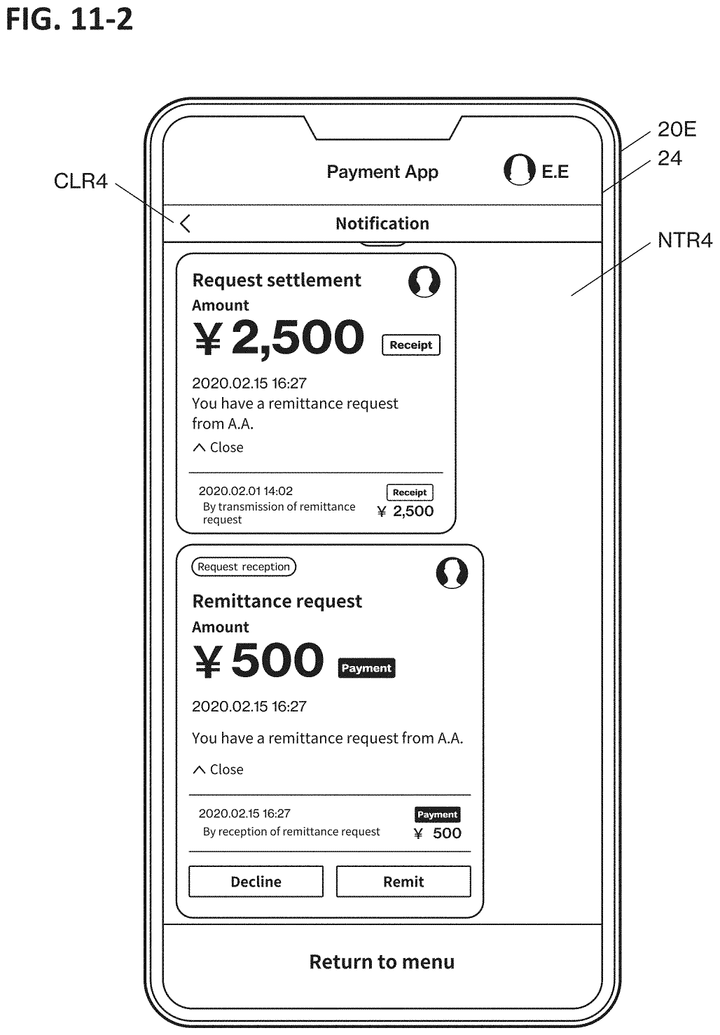

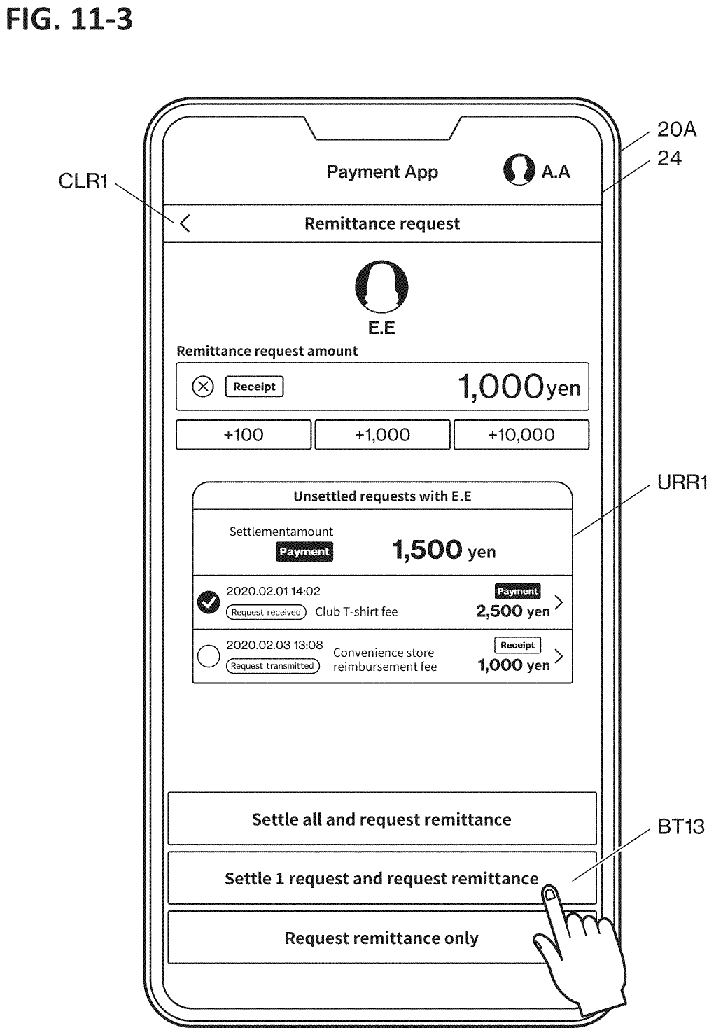

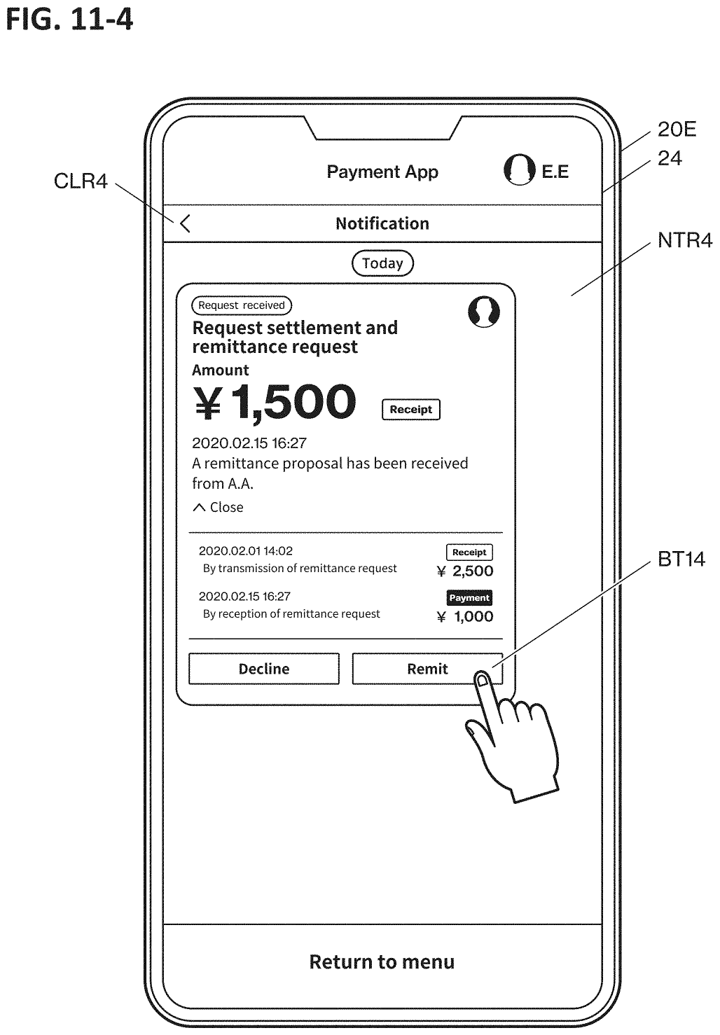

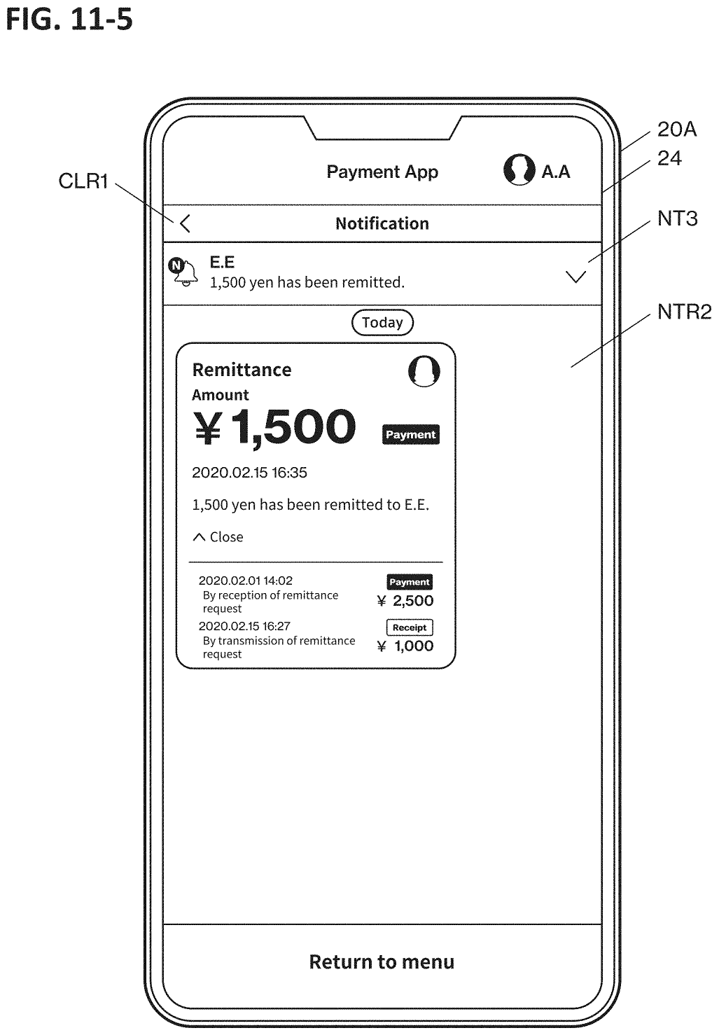

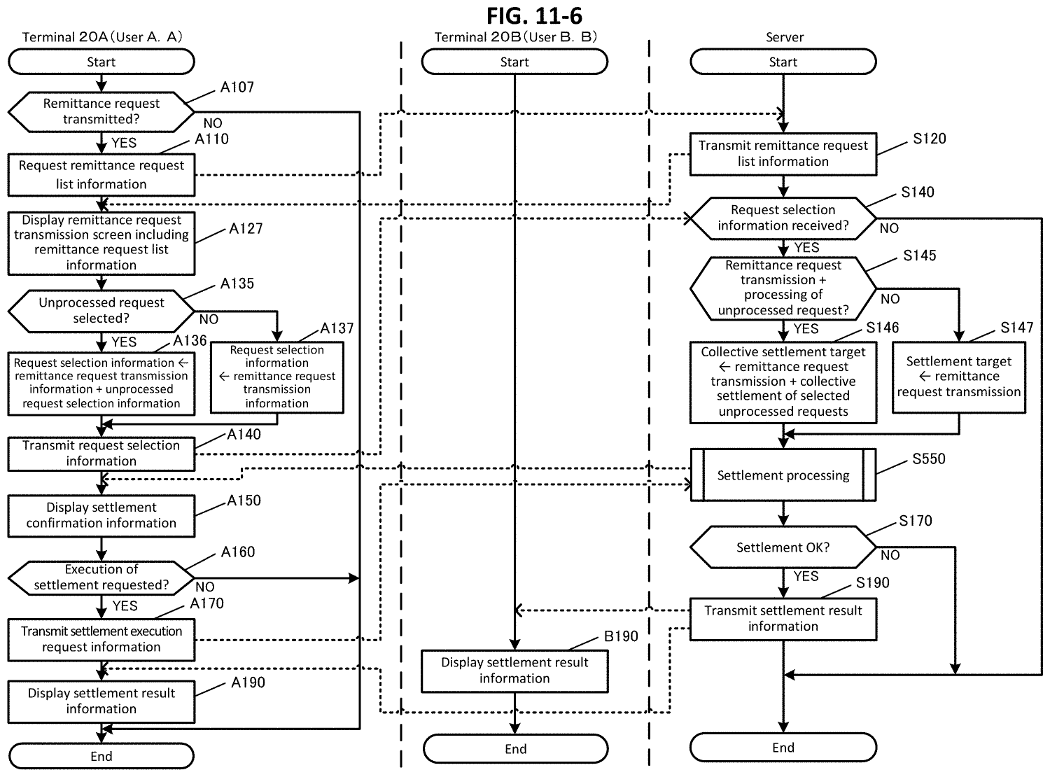

FIG. 11-1 is a diagram showing an example of a screen displayed on the display 24 of the terminal 20 according to an embodiment. This screen is, in a non-limiting example, a remittance request screen of the payment application displayed on the display 24 of the terminal 20A of the user A.A.

In the current location display region CLR1 indicating the current location in the payment application, the words “Remittance Request” are displayed, which indicate that the current location is the remittance request function of the payment application.

Below the current location display region CLR1, the icon image and user name (the user E.E in this example) of the payment application of the user selected as the transmission destination of the remittance request are displayed. Below that, a remittance request amount for the user selected as the transmission destination of the remittance request (“500 yen” in this example) and a function button for increasing the remittance request amount by a certain amount are displayed. When the user selected as the transmission destination of the remittance request accepts the remittance request, remittance of the remittance request amount is executed from the electronic money account of the user selected as the transmission destination of the remittance request to the electronic money account of the user who performed (transmitted) the remittance request.

Further below that, an unprocessed request confirmation region URR1 is displayed. In a non-limiting example, since the unprocessed request confirmation region URR1 can be configured in the same manner as in FIG. 9-2, and therefore description thereof is omitted.

Below the unprocessed request confirmation region URR1, a remittance request transmission/full-selection collective payment button indicated as “Settle all and transfer request”, which is for executing remittance request transmission processing and full-selection collective settlement. Below that, a remittance request transmission/collective settlement button BT13 indicated as “Settle one request and transmit remittance request”, which is for executing remittance request transmission processing and partial-selection collective settlement of the unprocessed requests selected in the unprocessed request confirmation region URR1, is displayed. Further below that, a remittance request transmission button indicating “Perform only remittance request” for executing only remittance request transmission processing is displayed.

In a non-limiting example, in the unprocessed request confirmation region URR1, when the check for requesting the first received remittance request (payment of 2,500 yen) is set to “ON” and selected and the remittance request transmission/collective settlement button BT13 is tapped, the terminal 20A requests the server 10 to execute transmission of a new remittance request and collective settlement of the selected unprocessed requests. Then, the server 10 transmits remittance request information and settlement result information relating to the execution result of the collective settlement to the terminal 20E of the user E.E, who is the partner.

FIG. 11-2 is a diagram showing an example of a notification screen displayed on the display 24 of the terminal 20E when the remittance request transmission/collective settlement button BT13 is tapped.

In this example, in the notification information display region NTR4 of the notification screen, settlement result information and new remittance request information relating to one remittance request selected in FIG. 11-1 are displayed.

In the settlement result information, information relating to the fact that the user E.E has received a remittance request amount “2,500 yen” resulting from a remittance request to the user A.A.

In the remittance request information, as a non-limiting example, a remittance request for the remittance request amount “500 yen” transmitted by the user A.A to the user E.E, a remittance request remittance button indicated as “Remit”, which is for approving the remittance request and performing remittance based on the remittance request, and a remittance request declining button indicated as “Decline”, which is for declining the remittance request, are displayed.

Next, a display screen example in the case where the processing of (C2) is performed will be described.

FIG. 11-3 is a diagram showing an example of a screen displayed on the display 24 of the terminal 20 according to an embodiment. This screen is, in a non-limiting example, a remittance request screen of the payment application displayed on the display 24 of the terminal 20A of the user A.A. Regarding the details of the screen configuration, in a non-limiting example, the screen can be configured in the same manner as in FIG. 11-1, and therefore detailed description will be omitted. Note that in FIG. 11-3, as a non-limiting example, the remittance request amount to the user (the user E.E in this example) selected as the transmission destination of the remittance request is “1,000 yen”.

In a non-limiting example, in the unprocessed request confirmation region URR1, when the check for requesting the first received remittance request (payment of 2,500 yen) is set to “ON” and selected and the remittance request transmission/collective settlement button BT13 is tapped, the terminal 20A requests the server 10 to execute transmission of a new remittance request and collective settlement of the selected unprocessed requests. Then, the server 10 transmits, to the terminal 20E of the user E.E, who is the partner, collective settlement approval confirmation information for confirming whether or not to approve the collective settlement, and displays the collective settlement approval confirmation information on the display 24 of the terminal 20E.

FIG. 11-4 is a diagram showing an example of a notification screen displayed when the remittance request transmission/collective settlement button BT13 is tapped.

In the notification information display region NTR4, the icon image of the user A.A, who is the partner of the “request settlement and remittance request”, and the collective settlement amount are displayed as collective settlement approval confirmation information.

In this example, in the collective settlement approval confirmation information, the fact that the user E.E will receive the remittance request amount “2,500 yen” based on the remittance request transmitted to the user A.A and will pay the remittance request amount “1,000 yen” based on the reception of this remittance request from the user A.A is displayed as the content of the collective settlement.

Also, in the collective settlement approval confirmation information, as the collective settlement amount, it is displayed that the user E.E will receive “1,500 yen”, which is obtained by subtracting the remittance amount “1,000 yen” for payment from the remittance request amount “2,500 yen” for receipt from the user A.A.

At the lower part of the collective settlement approval confirmation information, a settlement button BT14 indicated as “Settle” for approving settlement with the above content, and a decline button indicated as “Decline” for declining settlement with the above content are displayed.

FIG. 11-5 is a diagram showing an example of a notification screen displayed on the display 24 of the terminal 20A based on the tapping of the settlement button BT14.

Below the current location display region CLR1, a notification NT3 including the words “1,500 yen has been remitted” is displayed together with the bell mark as a notification that collective settlement of the remittance requests has been approved by the terminal 20E of the user E.E via the server 10 and remittance has been performed as a result.

Information corresponding to the above-described notification NT3 is displayed in the notification information display region NTR2 of the notification screen.

In a specific example, settlement result information is displayed as a result of collective settlement with the user E.E. In this example, the settlement result information displays that the user A.A has remitted “1,500 yen” to the user E.E as the collective settlement amount.

Also, in the settlement result information, it is displayed that “2,500 yen” will be paid based on the receipt of the past remittance request, and “1,000 yen” will be received based on the transmission of the current remittance request as the content of the collective settlement.

Note that in FIG. 11-3, when the remittance request transmission/collective settlement button BT13 is tapped, the display 24 of the terminal 20A may optionally display a confirmation screen indicating that the user A.A will receive “1,000 yen” when settlement is performed, and execution of transmission of a remittance request and collective settlement of the selected unprocessed requests may optionally be requested based on the approval of the user A.A.

### Processing

FIG. 11-6 is a flow chart showing an example of the flow of processing executed by each device according to an embodiment.

This flow chart is a flow chart obtained by rewriting the flow chart of FIG. 1-18 to processing in which the new processing target is “transmit remittance request”.

Strictly speaking, performing a remittance request (transmitting a remittance request) can also be considered to have a different meaning and concept from settlement (including collective settlement). However, for the sake of simplification, the processing (flow chart) will be illustrated and described here assuming that performing a remittance request (transmitting a remittance request) is also a type of settlement.

Note that, unlike this, the flow chart can also be configured such that performing a remittance request (transmitting a remittance request) is a separate process from settlement.

Also, in the processing of pattern (C) according to an embodiment, as a non-limiting example, when the processing of (C1) is performed, the approval of the partner user is not required, and when the processing of (C2) is performed, the approval of the partner user can be required.

Here, for the sake of simplicity, an example of processing (flow chart) when the approval of the partner user is not required will be illustrated.

First, the controller 21 of the terminal 20A determines whether or not to transmit a remittance request based on whether or not input for transmitting a remittance request has been made to the input device (A107).

If it is determined that a remittance request is to be transmitted (A107: YES), the controller 21 of the terminal 20A executes the processing of A110. Thereafter, based on the reception of the remittance request list information from the server 10 via the communication I/F 22, the controller 21 of the terminal 20A displays a remittance request transmission screen (screen for remittance request transmission) including the received remittance request list information on the display 24 (A127).

Thereafter, the controller 21 of the terminal 20A determines whether or not an unprocessed request has been selected from the remittance request list information (A135).

If an unprocessed request has been selected, that is, if it is determined that transmission of a remittance request+execution of processing of an unprocessed request is requested (A135: YES), the controller 21 of the terminal 20A sets request selection information including the remittance request transmission information relating to the transmission of the remittance request to be executed and unprocessed request selection information indicating the selected unprocessed request (A136).

On the other hand, if an unprocessed request has not been selected from the remittance request list information, that is, if it is determined that only the transmission of the remittance request is to be executed (A135: NO), the controller 21 of the terminal 20A sets the request selection information including the remittance request transmission information (A137).

Note that the description of this processing is premised on a remittance request being transmitted.

In actuality, although it may be possible to select processing of only unprocessed requests without transmitting a remittance request, the processing in that case is the same as the processing for collective settlement of the above-described unprocessed request, and therefore illustration and redundant description thereof are omitted.

After A136 or A137, the controller 21 of the terminal 20A transmits the set request selection information to the server 10 via the communication I/F 22 (A140).

Then, the controller 21 of the terminal 20A moves the processing to A150.

If it is determined in S140 that request selection information has been received from terminal 20A (S140: YES), the controller 11 of the server 10 determines whether or not to process remittance request transmission+unprocessed request based on the information included in the received request selection information (S144). Then, if it is determined that processing is to be performed (S145: YES), the controller 11 of the server 10 sets remittance request transmission+settlement of the selected unprocessed requests (collective settlement when a plurality of unprocessed requests are selected) as the collective settlement target (S146).

On the other hand, if it is determined that remittance request+unprocessed request is not to be processed, that is, only remittance request transmission is to be executed (S145: NO), the controller 11 of the server 10 sets the remittance request as a settlement target (S147).

After S146 or S147, the controller 11 of the server 10 executes the settlement processing of S150.

As a non-limiting example, when the first settlement processing described in FIG. 1-19 is applied,

if the setting of S146 is performed, the determination result of whether or not the settlement target in S1510 is the collective settlement target is “YES”. As a result, the processing from S1515 onward is executed with remittance request transmission+settlement of the selected unprocessed requests as the collective settlement targets.

On the other hand, when the setting of S147 is performed, the determination result of whether or not the settlement target in S1510 is a collective settlement target is “NO”. As a result, the processing of S1570 and onward is executed with the remittance request transmission as the settlement target.

### Effect of Eleventh Embodiment

This embodiment shows a configuration in which the first information is remittance request transmission information for transmitting a remittance request from the proposing user to the partner user (a non-limiting example of information relating to a remittance request to be transmitted from the user of the terminal to the first user), and the second information is received remittance request information relating to a remittance request received from the partner user (a non-limiting example of information relating to a remittance request transmitted from the second user to the user of the terminal).

As an example of the effect of the embodiment obtained by such a configuration, the remittance request to be transmitted from the user of the terminal to the first user and the remittance request transmitted from the second user to the user of the terminal can be processed together.

Also, in this case, the first processing can include processing for transmitting remittance request information to the partner user based on the remittance request transmission information, and performing remittance to the partner user based on the received remittance request information.

As an example of the effect of the embodiment obtained by such a configuration, a remittance request to the first user and remittance to the second user can be performed together.

Also, the present embodiment shows a configuration in which the partner user is one user (a non-limiting example of the second user being the first user), and the first processing includes processing for remitting or receiving, to or from the partner user, an amount based on the remittance request amount included in remittance request information to be transmitted to the partner user and a remittance request amount included in the remittance request information received from the partner user.

As an example of the effect of the embodiment obtained by such a configuration, it is possible to remit or receive, to or from the first user, the amount based on the first information and the second information.

Also, in this case, the first processing can include processing for remitting, to the partner user, an amount obtained by subtracting a remittance request amount (first amount) included in remittance request information to be transmitted to the partner user from a remittance request amount (second amount) included in remittance request information received from the partner user, or processing for receiving, from the partner user, an amount obtained by subtracting a remittance request amount (second amount) included in remittance request information received from the partner user from a remittance request amount (first amount) included in remittance request information to be transmitted to the partner user.

As an example of the effect of the embodiment obtained by such a configuration, an amount corresponding to the difference between the first amount and the second amount can be remitted, or an amount corresponding to the difference between the first amount and the second amount can be received, with the same user as the partner.

Also, this embodiment shows a configuration in which the first processing is executed based on the approval of the partner user, which is based on input to the terminal of the partner user.

As an example of the effect of the embodiment obtained by such a configuration, the first processing can be executed based on the approval of the first user, which is based on input to the terminal of the first user. As a non-limiting example, this makes it possible to prevent the first processing from being executed against the will of the first user.

### Twelfth Embodiment

The twelfth embodiment is an embodiment relating to the processing of pattern (D) described above.

The content described in the twelfth embodiment can be applied to any of the other embodiments and the other modified examples.

Also, constituent elements that are the same as constituent elements that have already appeared are denoted by the same reference signs thereas, and redundant description thereof is omitted.

In this embodiment, collective settlement is performed while including “transmitted remittance requests” among the unprocessed requests in the collective settlement targets, and while including “transmission of remittance requests” in the collective settlement targets.

Description will be given with reference to the table in FIG. 9-6 again.

In this embodiment, processing of the pattern of (D) transmission of remittance request+transmitted remittance request is performed.

In this pattern, processing of either (D1) remittance request+[remittance request or remittance reminder] or (D2) integrated remittance request can be performed.

In the processing of (D1), when making a new remittance request to the partner user, a remittance request to the partner user or a remittance reminder to the partner user is performed based on a transmitted remittance request to the partner user.

Note that in this case, a remittance request based on a transmitted remittance request may be used as a remittance request that is the same as the transmitted request and two different remittance requests, namely a new remittance request and a transmitted remittance request, may be sent to the partner user, or a remittance request based on a transmitted remittance request may be used as a remittance reminder, and a new remittance request and remittance reminder may be sent to the partner user.

In the processing of (D2), when performing a new remittance request to the partner user, an integrated remittance request is transmitted to the partner user as a request that combines (integrates) this new remittance request and the remittance request based on the transmitted remittance request to the partner user.

### Display Screen

An example of a display screen in the case where processing of each of (D1) and (D2) is performed will be described.

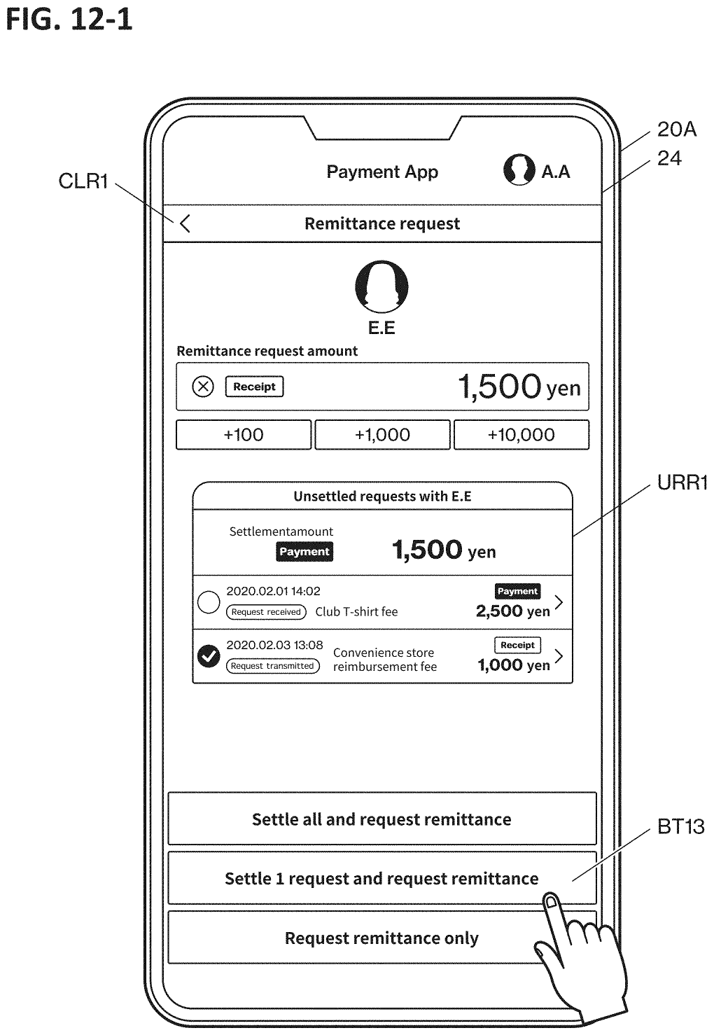

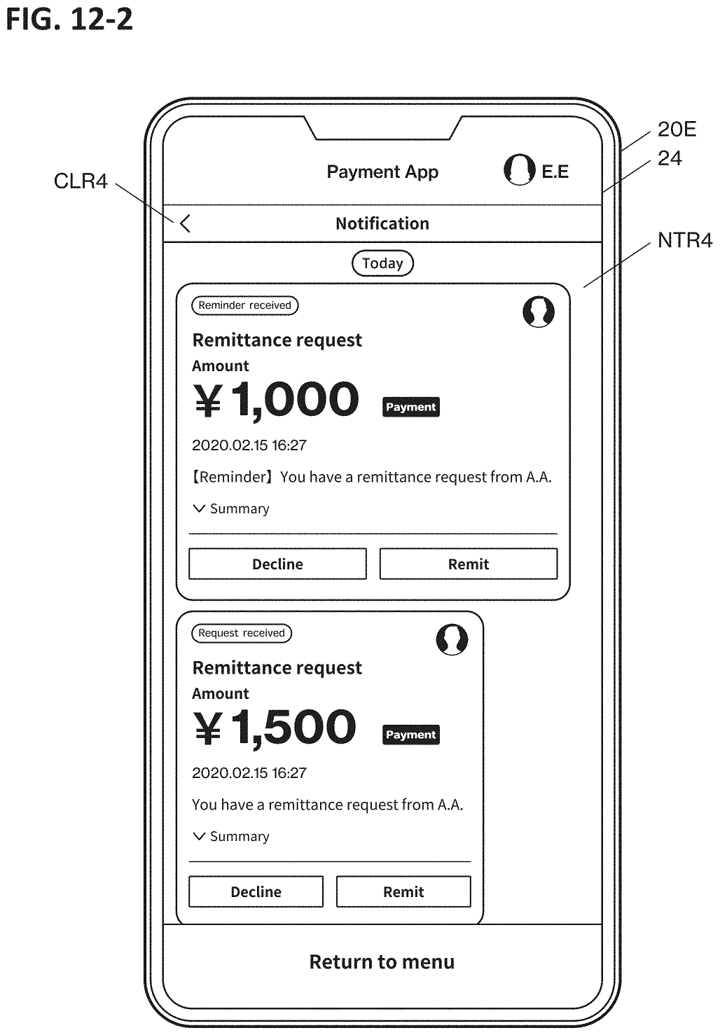

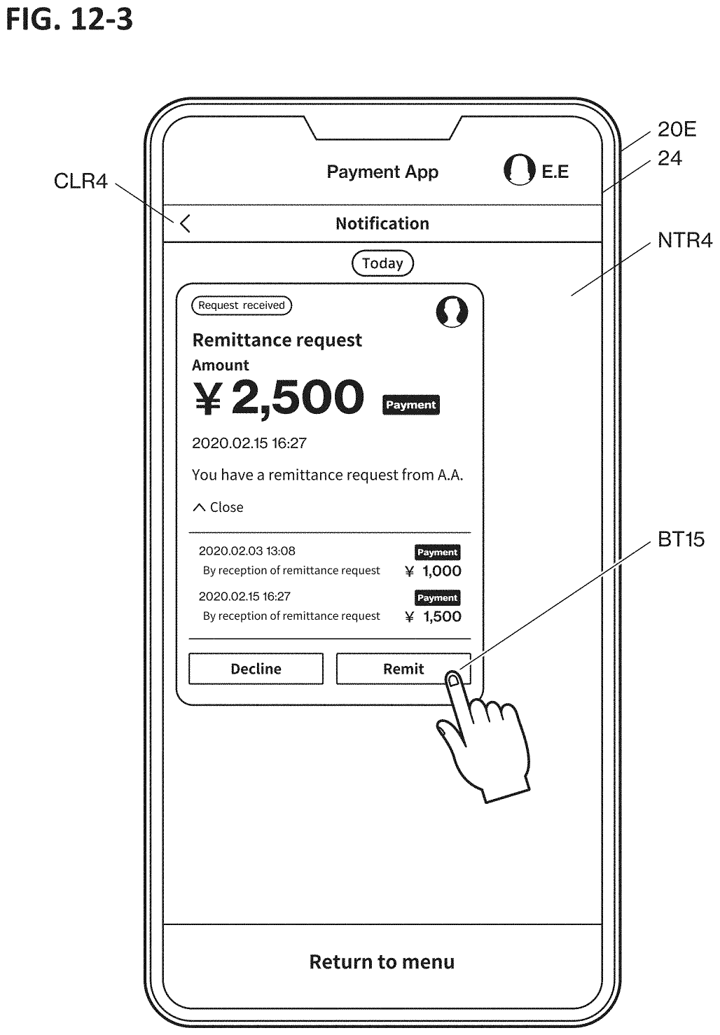

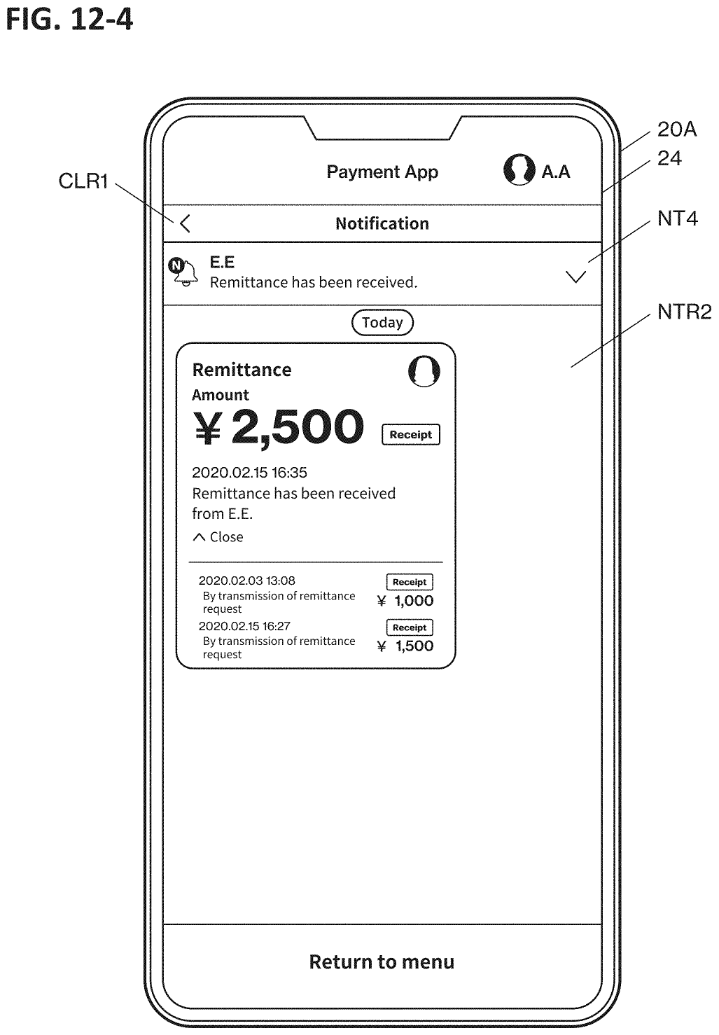

FIG. 12-1 is a diagram showing an example of a screen displayed on the display 24 of the terminal 20 according to an embodiment. This screen is, in a non-limiting example, a remittance request screen of the payment application displayed on the display 24 of the terminal 20A of the user A.A. Regarding the details of the screen configuration, in a non-limiting example, the screen can be configured in the same manner as in FIG. 11-3, and therefore detailed description will be omitted.

As a non-limiting example, in the unprocessed request confirmation region URR1, when the check for requesting the second transmitted remittance request (receipt of 1,000 yen) is set to “ON” and selected, and the remittance request transmission/collective settlement button BT13 is tapped, the terminal 20A requests the server 10 to execute transmission of a new remittance request and collective settlement of the selected unprocessed requests. Then, the server 10 transmits new remittance request information and remittance reminder information based on past remittance request transmission to the terminal 20E of the user E.E, who is the partner, and the information is displayed on the display 24 of the terminal 20E.

FIG. 12-2 is a diagram showing an example of a notification screen displayed on the display 24 of the terminal 20E when the remittance request transmission/collective settlement button BT13 is tapped.

In this example, in the notification information display region NTR4 on the notification screen, reminder information relating to one remittance request selected in FIG. 12-1 (in this example, a reminder relating to a remittance request with a remittance request amount “1,000 yen” from the user A.A to the user E.E) and new remittance request information (in this example, a remittance request for a remittance request amount “1,500 yen” from the user A.A to the user E.E) are displayed.

Also, in the collective settlement processing, a new remittance request and past remittance requests can be integrated.

FIG. 12-3 is a diagram showing an example of the notification screen displayed on the display 24 of the terminal 20E in this case.

In the notification information display region NTR4, the icon image of the user A.A who is the partner of the “remittance request” and the collective settlement amount are displayed as collective settlement approval confirmation information. In this example, as the collective settlement amount, it is displayed that the user E.E will pay “2,500 yen”, which is obtained by adding the remittance request amount “1,000 yen” and the remittance request amount “1,500 yen”, to the user A.A.

Also, in the collective settlement approval confirmation information, as the collective settlement content, it is displayed that the user E.E will pay a remittance request amount “1,000 yen” based on a past remittance request transmitted by the user A.A to the user E.E, and the user E.E will pay the remittance request amount “1,500 yen” based on the current remittance request.

At the lower part of the collective settlement approval confirmation information, a settlement button BT15 indicated as “Settle” for approving settlement with the above content, and a decline button indicated as “Decline” for declining settlement with the above content are displayed.

FIG. 12-4 is a diagram showing an example of a notification screen displayed on the display 24 of the terminal 20A when the settlement button BT15 is tapped.

Below the current location display region CLR1, a notification NT4 including the words “Remittance has been received” is displayed together with a bell mark as a notification that collective settlement of the remittance request has been approved from the terminal 20E of the user E.E via the server 10, and as a result, the remittance has been received from the user E.E.

Also, information corresponding to the above-described notification NT4 is displayed in the notification information display region NTR2 of the notification screen.

In a specific example, settlement result information is displayed as a result of collective settlement being performed with the user E.E. In the settlement result information, in this example, it is displayed that the user A.A has received remittance of a collective settlement amount “2,500 yen”, which is the sum of the remittance request amount “1,000 yen” and the remittance request amount “1,500” to the user E.E.

Also, in the settlement result information, as the content of the collective settlement, it is displayed that the user A.A has received a remittance request amount “1,000 yen” based on the transmission of the past remittance request to the user E.E, and has received the remittance request amount “1,500” yen based on the transmission of the current remittance request.

### Processing

The processing executed by each device according to an embodiment can be realized in the same manner as the processing in FIG. 11-6, and therefore illustration and detailed description thereof will be omitted.

### Effect of Twelfth Embodiment

This embodiment shows a configuration in which the first information is remittance request transmission information for transmitting a remittance request from the proposing user to the partner user (a non-limiting example of information relating to a remittance request to be transmitted from the user of the terminal to the first user), and the second information is transmitted remittance request information relating to a remittance request transmitted from the proposing user to the partner user (a non-limiting example of information relating to a remittance request transmitted from the user of the terminal to the user of the second terminal).

As an example of the effect of the embodiment obtained by such a configuration, a remittance request from the user of the terminal to the first user and a remittance request from the user of the terminal to the user of the second terminal can be processed together.

Also, in the above, the partner user can be one user (a non-limiting example of the second user being the first user), and the first processing can include processing for transmitting a remittance request (a non-limiting example of a first remittance request) to the partner user based on the remittance request transmission information and transmitting a remittance request or a remittance reminder (a non-limiting example of a second remittance request) to the partner user based on the transmitted remittance request information.

As an example of the effect of the embodiment obtained by such a configuration, a first remittance request to the first user and a second remittance request to the first user can be performed together.

Also, in the above, a configuration is shown in which the partner user is one user (a non-limiting example of the second user being the first user), and the first processing includes processing for transmitting an integrated remittance request (a non-limiting example of a third remittance request) in which an amount that is the sum of the remittance request amount of the remittance request to be sent to the partner user and the remittance request amount included in the transmitted remittance request information is the remittance request amount.

As an example of the effect of the embodiment obtained by such a configuration, by transmitting a compiled third remittance request based on the third amount, which is the sum of the first amount and the second amount, to the first user, it is possible to effectively prompt the first user to perform remittance to the user of the terminal.

### Thirteenth Embodiment

The thirteenth embodiment is an embodiment relating to the processing of pattern (E) described above.

The content described in the thirteenth embodiment can be applied to any of the other embodiments and the other modified examples.

Also, constituent elements that are the same as constituent elements that have already appeared are denoted by the same reference signs thereas, and redundant description thereof is omitted.

In this embodiment, collective settlement is performed while including “received remittance requests” and “transmitted remittance requests” among the unprocessed requests in the collective settlement targets, and while including “transmission of remittance requests” in the collective settlement targets.

Description will be given with reference to the table in FIG. 9-6 again.

In this pattern, processing of one of (E1) remittance request+[remittance+money reception] (amount deductible), (E2) [money reception+remittance] (amount deductible)+[remittance request or remittance reminder], and (E3) [money reception+remittance] (amount deductible)+[remittance+money reception] (amount deductible) can be performed.

In the processing of (E1), when performing a new remittance request to the partner user, remittance and money reception are performed together based on a remittance request received from the partner user and a remittance request transmitted to the partner user. In this case, it is possible to remit/receive an amount corresponding to the difference between the remittance request amounts. Also, if the remittance request amounts are the same amount, it is possible to cancel out the amounts.

In the processing of (E2), when a new remittance request to the partner user is made, remittance is received from the partner user based on this new remittance request, and remittance to the partner user is performed as well based on a received remittance request from the partner user. In this case, it is possible to receive/remit an amount corresponding to the difference between the remittance request amounts. Also, if the remittance request amounts are the same amount, it is possible to cancel out the amounts.

Also, based on the remittance request transmitted to the partner user, the same remittance request is made to the partner user, or a remittance reminder is sent to the partner user.

In the processing of (E3), when a new remittance request to the partner user is performed, remittance is received from the partner user based on this new remittance request, and remittance to the partner user is performed as well based on a received remittance request from the partner user. In this case, it is possible to receive/remit an amount corresponding to the difference between the remittance request amounts. Also, if the remittance request amounts are the same amount, it is possible to cancel out the amounts.

Also, remittance is performed to the partner user based on a received remittance request from the partner user, and remittance is received from the partner user based on a transmitted remittance request to the partner user. In this case, it is possible to remit/receive an amount corresponding to the difference between the remittance request amounts. Also, if the remittance request amounts are the same amount, it is possible to cancel out the amounts.

### Display Screen

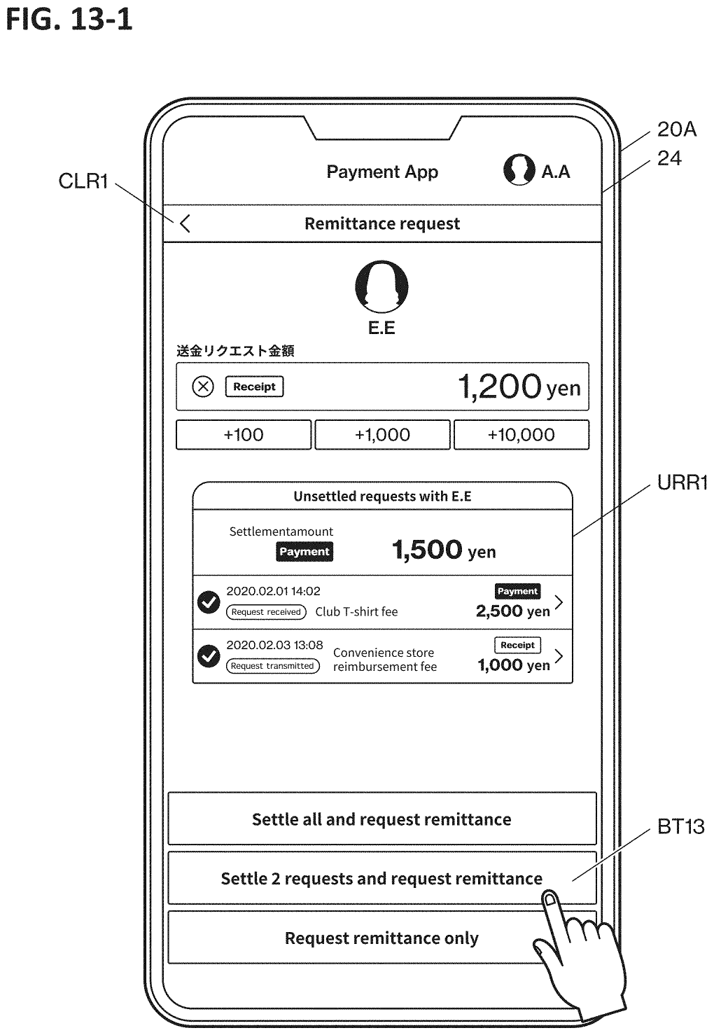

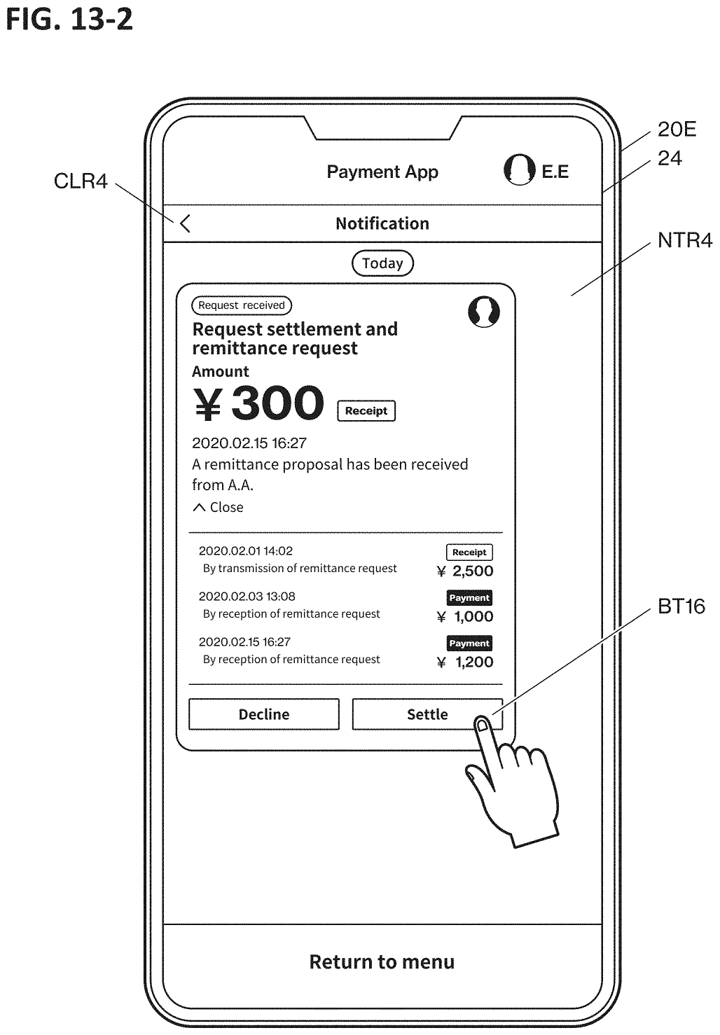

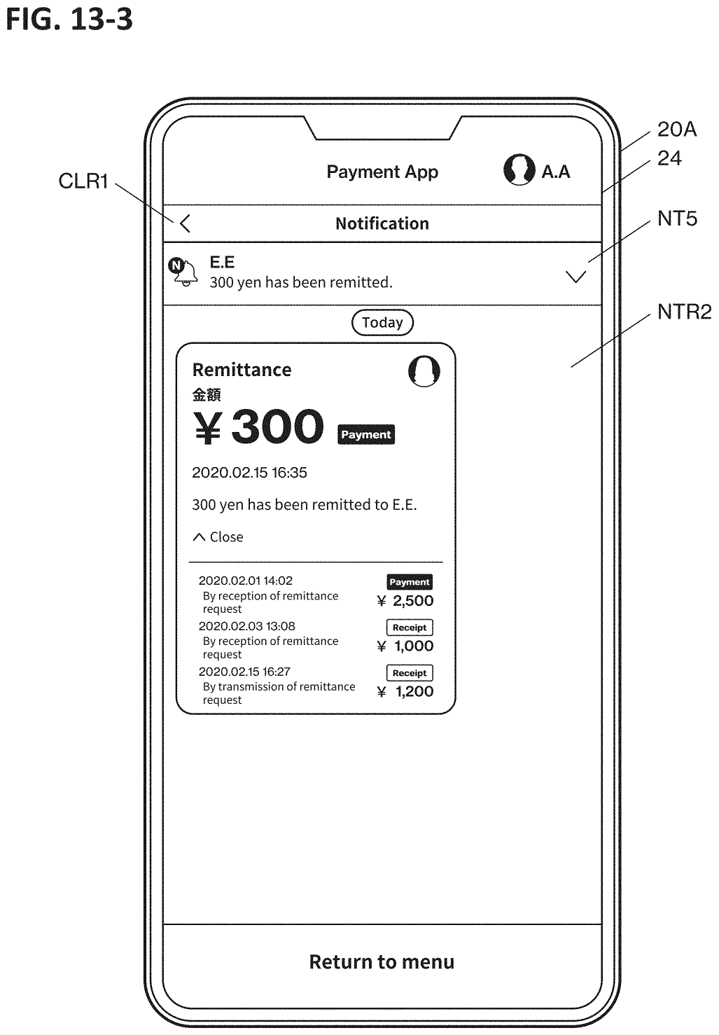

FIG. 13-1 is a diagram showing an example of a screen displayed on the display 24 of the terminal 20 according to an embodiment. This screen is, in a non-limiting example, a remittance request screen of the payment application displayed on the display 24 of the terminal 20A of the user A.A. Regarding the details of the screen configuration, in a non-limiting example, the screen can be configured in the same manner as in FIG. 11-1, and therefore detailed description thereof will be omitted. Note that in FIG. 13-1, as a non-limiting example, the remittance request amount to the user (in this example, the user E.E) selected as the transmission destination of the remittance request is “1,200 yen”.

As a non-limiting example, when the checks for both the first received remittance request (payment of 2,500 yen) and the second transmitted remittance request (receipt of 1,000 yen) in the unprocessed request confirmation region URR1 are set to “ON” and selected, and the remittance request transmission/collective settlement button BT13 is tapped, the terminal 20A requests the server 10 to execute new remittance request transmission and collective settlement of the selected unprocessed requests. Then, the server 10 transmits, to the terminal 20E of the user E.E, who is the partner, collective settlement approval confirmation information for confirming whether or not to approve the collective settlement, and displays the collective settlement approval confirmation information on the display 24 of the terminal 20E.

FIG. 13-2 is a diagram showing an example of a notification screen displayed when the remittance request transmission/collective settlement button BT13 is tapped.

In the notification information display region NTR4, the icon image of the user A.A, who is the partner of the “request settlement and remittance request”, and the collective settlement amount are displayed as collective settlement approval confirmation information.

In this example, in the collective settlement approval confirmation information, as the content of the collective settlement, it is displayed that the user E.E will receive a remittance request amount “2,500 yen” based on the transmission of a past remittance request to the user A.A, will pay a remittance request amount “1,000 yen” based on the reception of a past remittance request from the user A.A, and will pay a remittance request amount “1,200 yen” based on the reception of the current remittance request from the user A.A.

Also, in the collective settlement approval confirmation information, as the collective settlement amount, it is displayed that the user E.E will receive “300 yen”, which is obtained by subtracting the remittance request amount “1,200 yen” and the remittance request amount “1,000 yen” to be paid to the user A.A from the remittance request amount “2,500 yen” to be received from the user A.A.

At the lower part of the collective settlement approval confirmation information, a settlement button BT16 indicated as “Settle” for approving settlement with the above content, and a decline button indicated as “Decline” for declining settlement with the above content are displayed.

FIG. 13-3 is a diagram showing an example of a notification screen displayed on the display 24 of the terminal 20A based on the tapping of the above-described settlement button BT16.

Below the current location display region CLR1, a notification NT5 including the word “300 yen has been remitted” is displayed together with a bell mark as a notification that the collective settlement of remittance requests has been approved from the terminal 20E of the user E.E via the server 10, and as a result, the remittance has been performed.

Also, information corresponding to the above-described notification NT5 is displayed in the notification information display region NTR2 of the notification screen.

In a specific example, settlement result information is displayed as a result of collective settlement being performed with the user E.E. In this example, the settlement result information indicates that the user A.A paid “300 yen” to the user E.E as a collective settlement amount.

Also, in the settlement result information, as the content of the collective settlement, it is displayed that the user A.A paid the remittance request amount “2,500 yen” based on the reception of a past remittance request from the user E.E, received the remittance request amount “1,000 yen” based on transmission of past remittance requests to the user E.E, and received the remittance request amount “1,200 yen” based on transmission of the current remittance request to the user E.E.

### Processing

The processing relating to (E1) to (E3) above can be configured similarly based on the processing described in the previous embodiments, and is self-evident, and therefore illustration and detailed description thereof are omitted.

### Fourteenth Embodiment

The fourteenth embodiment is an embodiment relating to processing of a pattern different from the above-described patterns.

The content described in the fourteenth embodiment can be applied to any of the other embodiments and the other modified examples.

Also, constituent elements that are the same as constituent elements that have already appeared are denoted by the same reference signs thereas, and redundant description thereof is omitted.

In addition to the patterns described above, in a non-limiting example, processing of a pattern of a combination of new processing targets in the table of FIG. 9-6, that is, the pattern of
Remittance+transmission of remittance request can also be performed.

The processing of this pattern is the same as the processing of pattern (C).

That is, processing of either “Remittance+transmission of remittance request” or “Remittance+money reception (amount deductible)” can be performed.

Note that the approval of the partner user may optionally be obtained when performing the processing of “Remittance+money reception (amount deductible)”.

### Effect of Fourteenth Embodiment

This embodiment shows a configuration in which the first information is remittance request information from the proposing user to the partner user, and the terminal 20 of the proposing user displays, on the display 24, a third display based on remittance request information to be transmitted from the proposing user to the partner user (a non-limiting example of third information). Then, the terminal 20 of the proposing user performs, with the controller 21, second processing relating to remittance, money reception, or a remittance request based on input performed by the proposing user to the terminal 20 on which a display of remittance from the proposing user to the partner user (a non-limiting example of the first display) and the above-described third display are displayed.

As an example of the effect of the embodiment obtained by such a configuration, remittance, reception of remittance, or a remittance request can be performed together.

Also, in the above description, a configuration is shown in which the second processing includes processing for performing remittance to the partner user based on remittance information (a non-limiting example of the first information) and transmitting a remittance request to the partner user based on remittance request information to be transmitted from the proposing user to the partner user.

As an example of the effect of the embodiment obtained by such a configuration, remittance to the first user based on the first information and transmission of the remittance request to the first user based on the third information can be performed together.

Also, in the above description, a configuration is shown in which the second processing includes processing for transmitting or receiving, to or from the partner user, an amount based on an amount to be remitted by the proposing user to the partner user and a remittance request amount that the proposing user requests from the partner user (a non-limiting example of an amount based on the first information and the third information).

As an example of the effect of the embodiment obtained by such a configuration, an amount of money based on the first information and the third information can be paid to or received from the first user.

Also, in this case, a configuration is shown in which the second processing includes processing for remitting, to the partner user, an amount obtained by subtracting a remittance request amount requested by the proposing user to the partner user from an amount to be remitted by the proposing user to the partner user, or receiving, from the partner user, an amount obtained by subtracting an amount to be remitted by the proposing user to the partner user from a remittance request amount requested by the proposing user to the partner user.

As an example of the effect of the embodiment obtained by such a configuration, an amount corresponding to the difference between the first amount and the third amount can be paid to or received from the first user.

Also, in this case, the second processing may be executed based on approval given by the partner user (a non-limiting example of the first user) based on input to the terminal 20 of the partner user.

As an example of the effect of the embodiment obtained by such a configuration, the second processing can be executed based on approval given by the first user, which is based on input to the terminal of the first user. As a non-limiting example, this makes it possible to prevent the second processing from being executed against the will of the first user.

### Fifteenth Embodiment

The fifteenth embodiment, like the fourteenth embodiment, is an embodiment relating to processing of a pattern different from the above-described patterns.

The content described in the fifteenth embodiment can be applied to any of the other embodiments and the other modified examples.

Also, constituent elements that are the same as constituent elements that have already appeared are denoted by the same reference signs thereas, and redundant description thereof is omitted.

In addition to the patterns described above, in a non-limiting example, processing of a pattern of a combination of unprocessed requests shown in the horizontal direction of the table in FIG. 9-6, namely, the pattern of
Received remittance request+transmitted request can also be performed.

The processing of this pattern is the same as the processing of pattern (B).

That is, processing of either “Remittance+money reception (amount deductible)” or “Remittance+transmission of remittance request” can be performed.

Note that the approval of the partner user may be required and the approval of the partner user may optionally be obtained when performing the processing of “Remittance+money reception (amount deductible)”.

### Effect of Fifteenth Embodiment

This embodiment shows a configuration in which the second information is remittance request information from the partner user to the proposing user, and the terminal 20 of the proposing user displays, on the display 24, a fourth display based on the transmitted request information transmitted from the proposing user to the partner user (a non-limiting example of fourth information). Also, the terminal 20 of the proposing user performs, with the controller 21, third processing relating to remittance, money reception, or a remittance request, based on input to the terminal 20 on which a second display based on the received remittance request information relating to the received remittance request received by the proposing user from the partner user (a non-limiting example of second information) and the above-described fourth display are displayed.

As an example of the effect of the embodiment obtained by such a configuration, remittance, reception of remittance, or a remittance request can be performed together.

Also, a configuration is shown in which the above-described third processing includes processing for performing remittance to the partner user based on the received remittance request information and transmitting a remittance request to the partner user based on the transmitted remittance request information.

As an example of the effect of the embodiment obtained by such a configuration, remittance to the second user based on the second information and transmission of the remittance request to the second user based on the fourth information can be performed together.

Also, a configuration is shown in which the above-mentioned third processing includes processing for performing remittance to the partner user or receiving money from the partner user based on the received remittance request information and the transmitted remittance request information.

As an example of the effect of the embodiment obtained by such a configuration, an amount based on the second information and the fourth information can be paid to the second user or received from the first user.

Also, a configuration is shown in which the above-mentioned third processing includes processing for remitting, to the partner user, an amount obtained by subtracting a remittance request amount of transmitted remittance request information from a remittance request amount of received remittance request information, or receiving, from the partner user, an amount obtained by subtracting a remittance request amount of received remittance request information from a remittance request amount of transmitted remittance request information.

As the amount of the embodiment obtained through such a configuration, an amount corresponding to the difference between the second amount and the fourth amount can be paid to the second user or received from the second user.

Also, in this case, the third processing may be executed based on approval given by the partner user (a non-limiting example of the second user) based on input to the terminal 20 of the partner user.

As an example of the effect of the embodiment obtained by such a configuration, the third processing can be executed based on approval given by the second user based on input to the terminal of the second user. As a non-limiting example, this makes it possible to prevent the third processing from being executed against the will of the second user.

### Sixteenth Embodiment

The sixteenth embodiment relates to a method for displaying remittance request information.

The content described in the sixteenth embodiment can be applied to any of the other embodiments and the other modified examples.

Also, constituent elements that are the same as constituent elements that have already appeared are denoted by the same reference signs thereas, and redundant description thereof is omitted.

### Display Screen

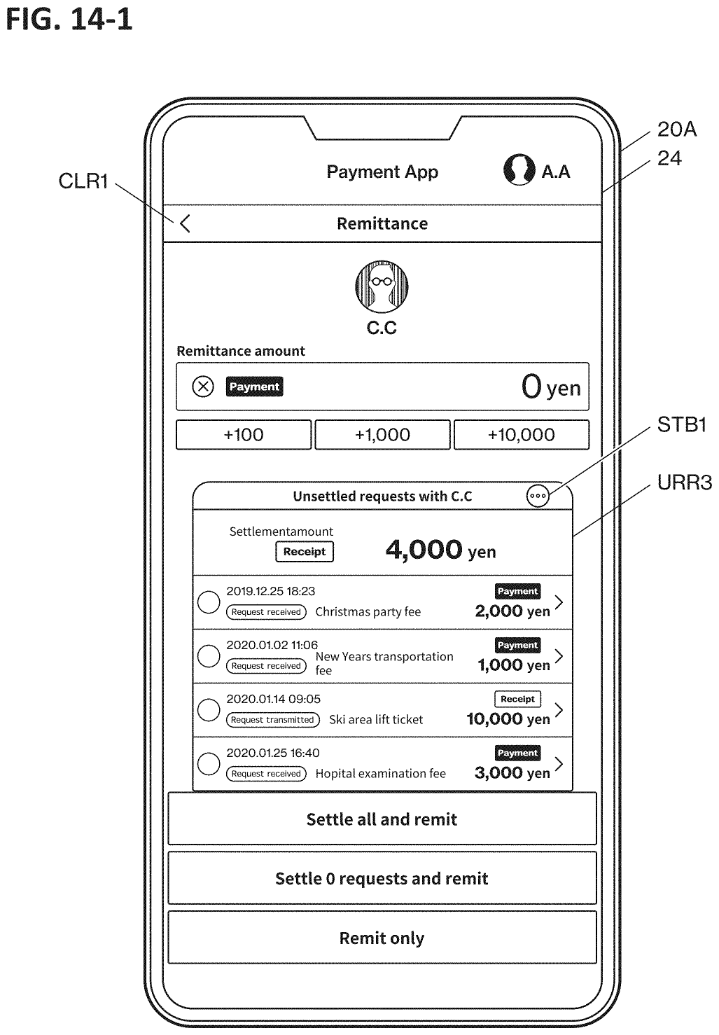

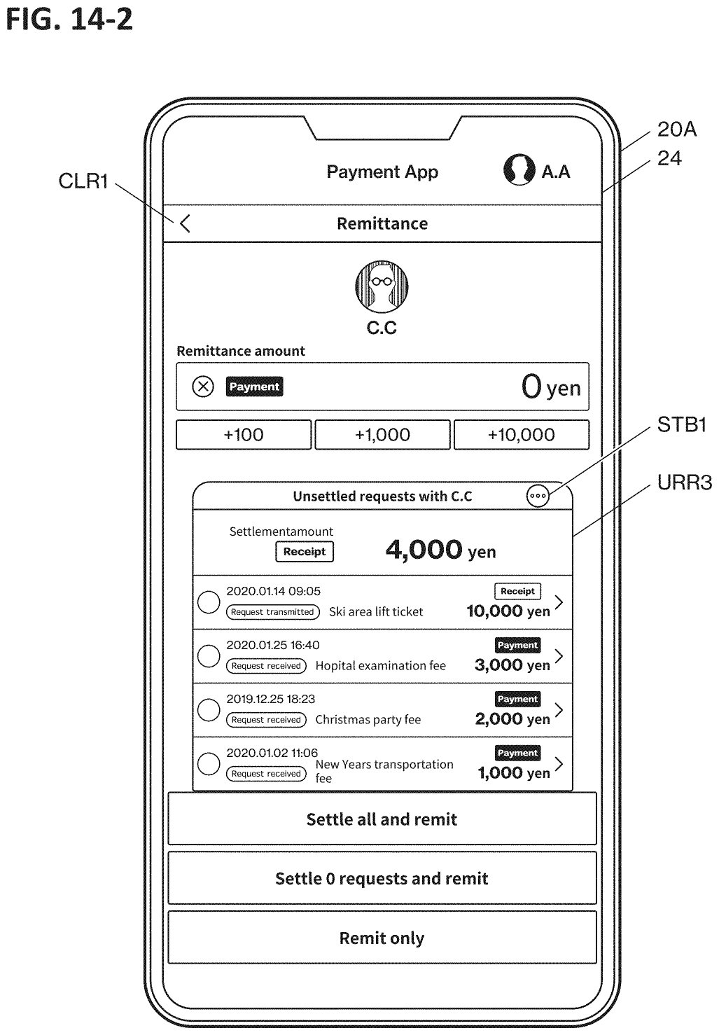

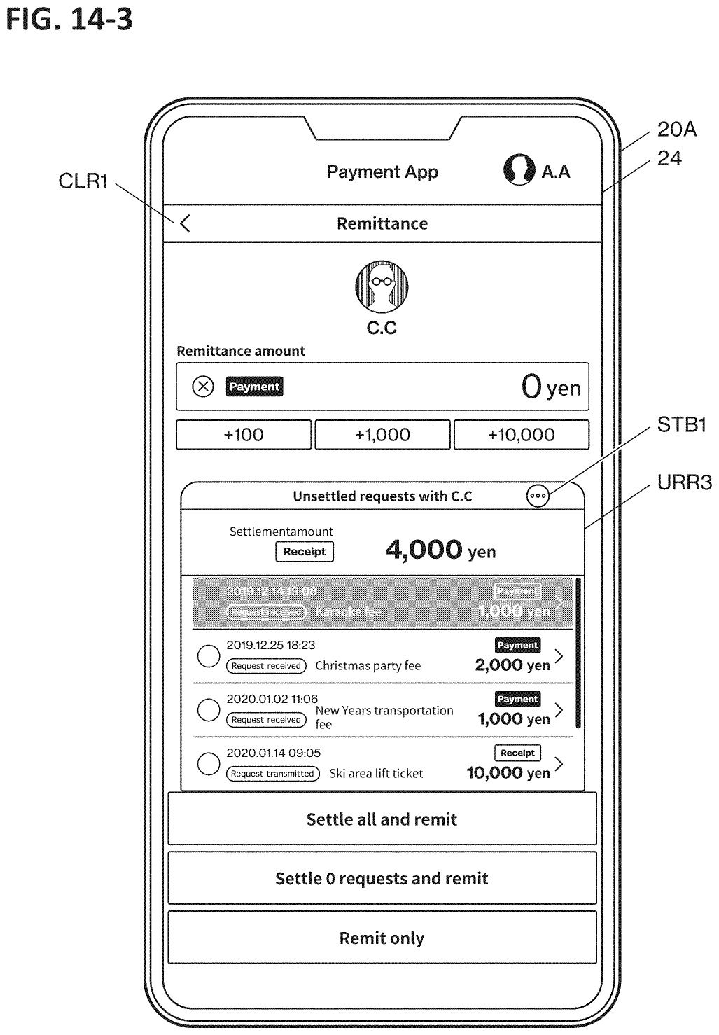

FIG. 14-1 is a diagram showing an example of a screen displayed on the display 24 of the terminal 20 according to an embodiment. This screen is, in a non-limiting example, a remittance screen of the payment application displayed on the display 24 of the terminal 20A of the user A.A.

Below the current location display region CLR1, the icon image and user name (the user C.C in this example) of the payment application of the user selected as the remittance destination are displayed.

Below the function buttons for increasing the remittance amount by certain amounts, an unprocessed request confirmation region URR3 that makes it possible to confirm unprocessed requests between the user selected as the remittance destination (the user C.C in this example) and the user performing remittance (the user A.A in this example) is displayed.

At the top of the unprocessed request confirmation region URR3, the words “Unsettled Requests with C.C” are displayed, which indicate that unprocessed requests with the user C.C are being displayed.

On the right side, a remittance request history sort button STB1 for changing the display order of unprocessed remittance requests is displayed. Other display modes are the same as those of the unprocessed request confirmation region URR1.

When the remittance request history sort button STB1 is touched, as a non-limiting example, a sort selection region for selecting the sort order is displayed rising from the lower part of the screen.

Based on a user operation on the sort selection region, it is possible to perform display with the display order of unprocessed remittance requests rearranged in ascending or descending order according to, in a non-limiting example, the dates when the remittance requests were transmitted/received, the remittance request amounts of the remittance requests, or the like.

Note that it is also possible to rearrange and display the display order of the unprocessed remittance requests in order of the dates and times when the remittance requests were transmitted/received instead of the dates when the remittance requests were transmitted/received.

FIG. 14-2 is a diagram showing, as a non-limiting example, an example of a display screen in the case where the remittance requests in the unprocessed request confirmation region URR3 have been rearranged in descending order of remittance request amount based on a user operation on the sort selection region.

In FIG. 14-1, the remittance requests in the unprocessed request confirmation region URR3 are arranged in ascending order by date, but in FIG. 14-2, they are rearranged in descending order of remittance request amount.

Note that when a payment deadline is set for a remittance request, in a non-limiting example, the remittance requests may optionally be displayed in the order of the closeness to the payment deadline. Setting payment deadlines includes not only payments between general users (C to C), but also setting repayment deadlines for loans from business operators such as financial institutions (C to B) in a non-limiting example.

Also, a remittance request in which a user other than the user who performed the remittance request or the user who received the remittance request is involved in the remittance request amount or reason may be displayed with priority. In a non-limiting example, this is a case where another user is included as a member of a split bill.

Also, although unprocessed remittance requests are displayed in the unprocessed request confirmation region URR3, there is no limitation to this.

FIG. 14-3 is an example of a display screen in the case where processed remittance requests are also displayed in the unprocessed request confirmation region URR3.

In FIG. 14-3, as a non-limiting example, in the first remittance request in the unprocessed request confirmation region URR3, the fact that a remittance request for payment of the remittance request amount “1,000 yen” has been received is displayed in a grayed-out display mode indicating that it is a processed remittance request. Since processed remittance requests are not selected as collective settlement targets, there is no check region.

### Effect of Sixteenth Embodiment

This embodiment shows a configuration in which the terminal 20 of the proposing user displays, on the display 24, a fourth display based on remittance request information relating to a received remittance request received by the proposing user from the partner user (a non-limiting example of fourth information relating to a remittance request transmitted from the second user to the user of the terminal), or remittance request information relating to a transmitted remittance request transmitted by the proposing user to the partner user (a non-limiting example of fourth information relating to a remittance request transmitted from the user of the terminal to the second user). Then, the terminal 20 of the proposing user displays, on the display 24, the second display and the fourth display in the order based on the above-described second information and the above-described fourth information.

As an example of the effect of the embodiment obtained by such a configuration, the second display and the fourth display can be displayed in an appropriate order based on the second information and the fourth information.

Also, this embodiment shows a configuration in which the above-described second information and the fourth information include information relating to a date a remittance request was transmitted/received (a non-limiting example of information relating to the date), or information relating to a date and time when a remittance request was transmitted/received (a non-limiting example of information relating to the date and time), and the order in which the second display and the fourth display are displayed is determined based on this information relating to the date or the date and time.

As an example of the effect of the embodiment obtained by such a configuration, by displaying the second display and the fourth display in the order based on the information relating to the date and time or the date, it is possible to realize a display that is intuitively understandable for the user.

Also, the present embodiment shows a configuration in which the above-described second information and fourth information include information relating to the amount for which remittance is requested (a non-limiting example of information relating to the amount), and the order in which the second display and the fourth display are displayed is determined based on information relating to this amount.

As an example of the effect of the embodiment obtained by such a configuration, by displaying the second display and the fourth display in the order based on the information relating to the amount, it is possible to realize a display that is intuitively understandable for the user.

Also, in this case, the information relating to the amount for which remittance is requested can include information relating to a payment deadline as a non-limiting example, in addition to the remittance request amount.

As an example of the effect of the embodiment obtained by such a configuration, by displaying the second display and the fourth display in the order based on the information relating to the payment deadline, it is possible to realize a display that is intuitively understandable for the user.

Next, as a view from a side opposite to that of the ninth to sixteenth embodiments, an embodiment relating to processing in the case where the user of the terminal 20 receives an amount remitted from the partner user, or receives a remittance request from the partner user will be described.

### Seventeenth Embodiment

The seventeenth embodiment is an embodiment in which an unprocessed request is displayed when the user of the terminal 20 receives an amount remitted from the partner user or receives a remittance request from the partner user.

The content described in the seventeenth embodiment can also be applied to any of the other embodiments and the other modified examples.

Moreover, constituent elements that are the same as constituent elements that have already appeared are denoted by the same reference signs, and redundant description thereof is omitted.

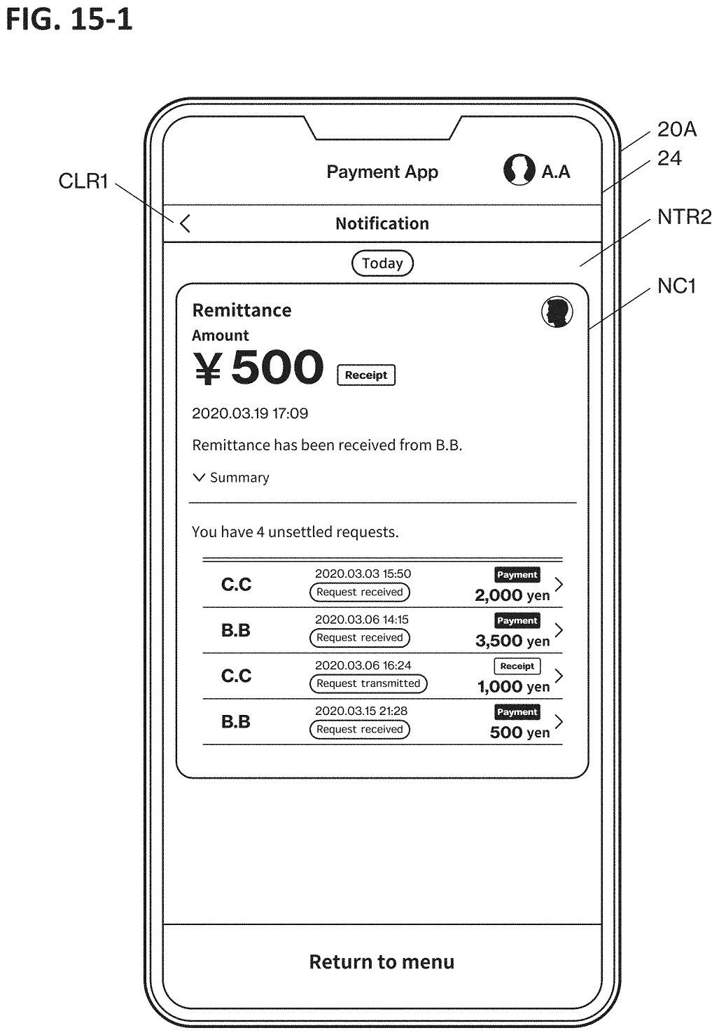

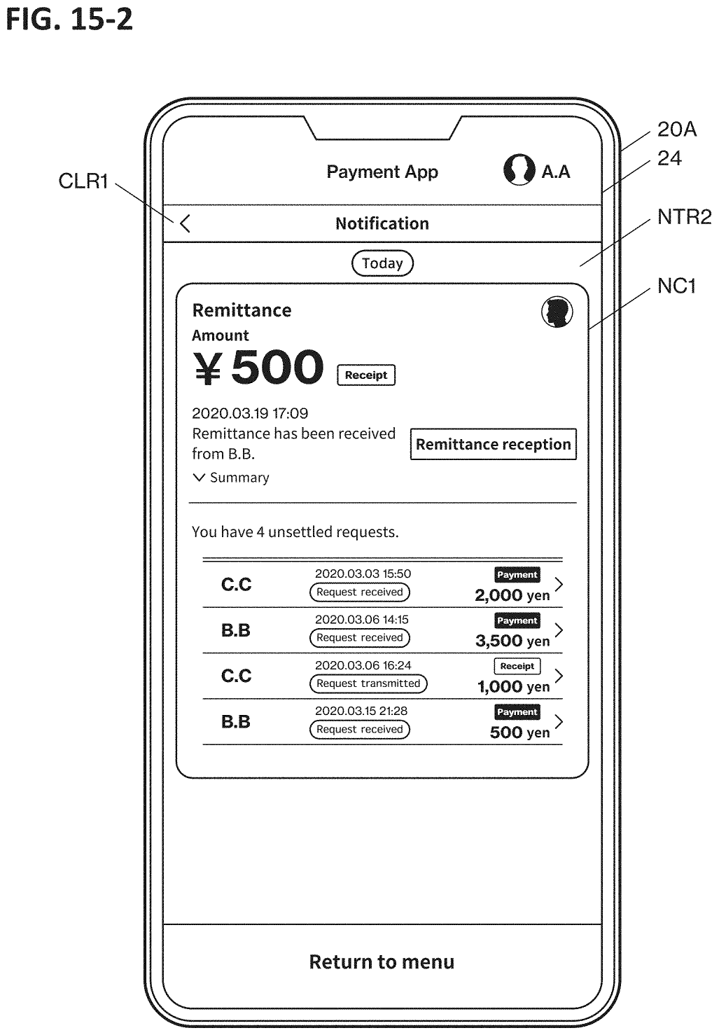

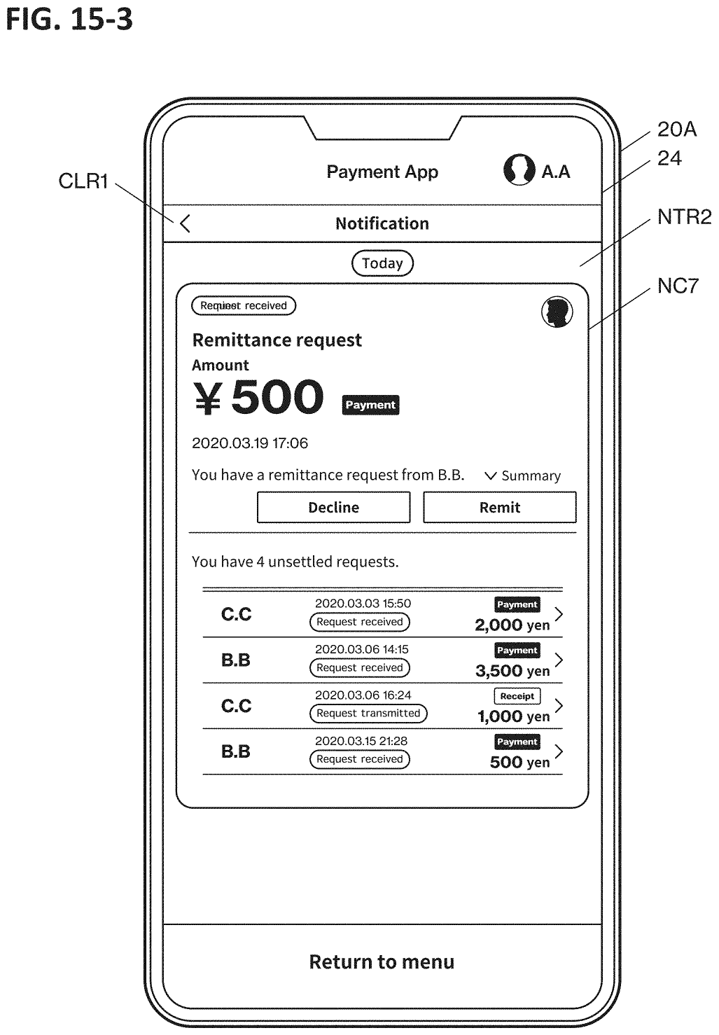

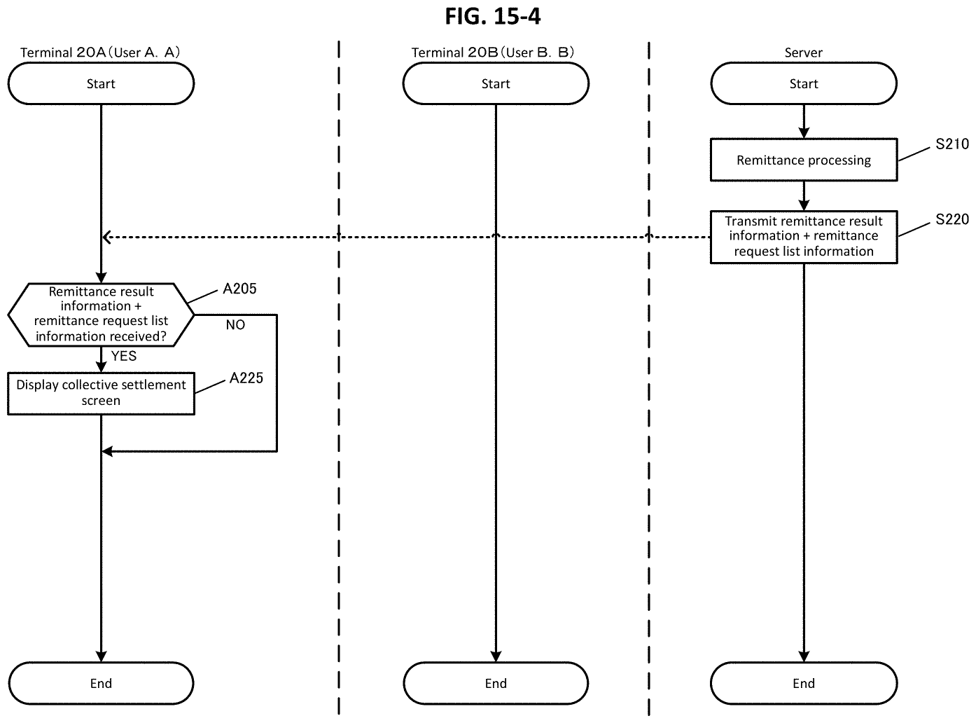

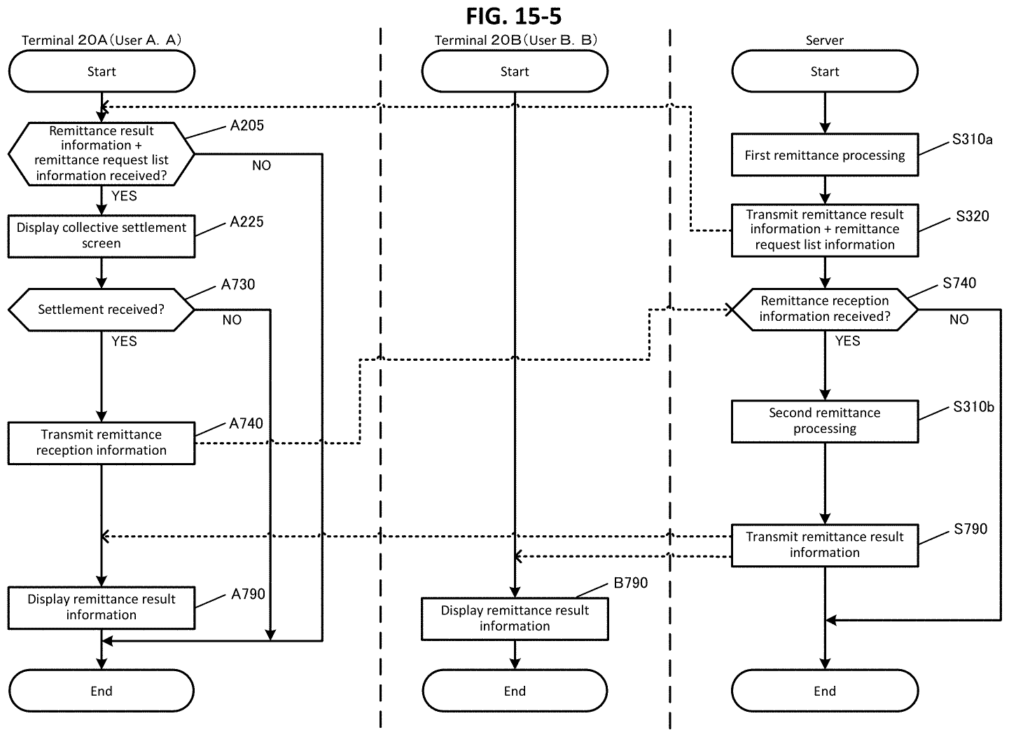

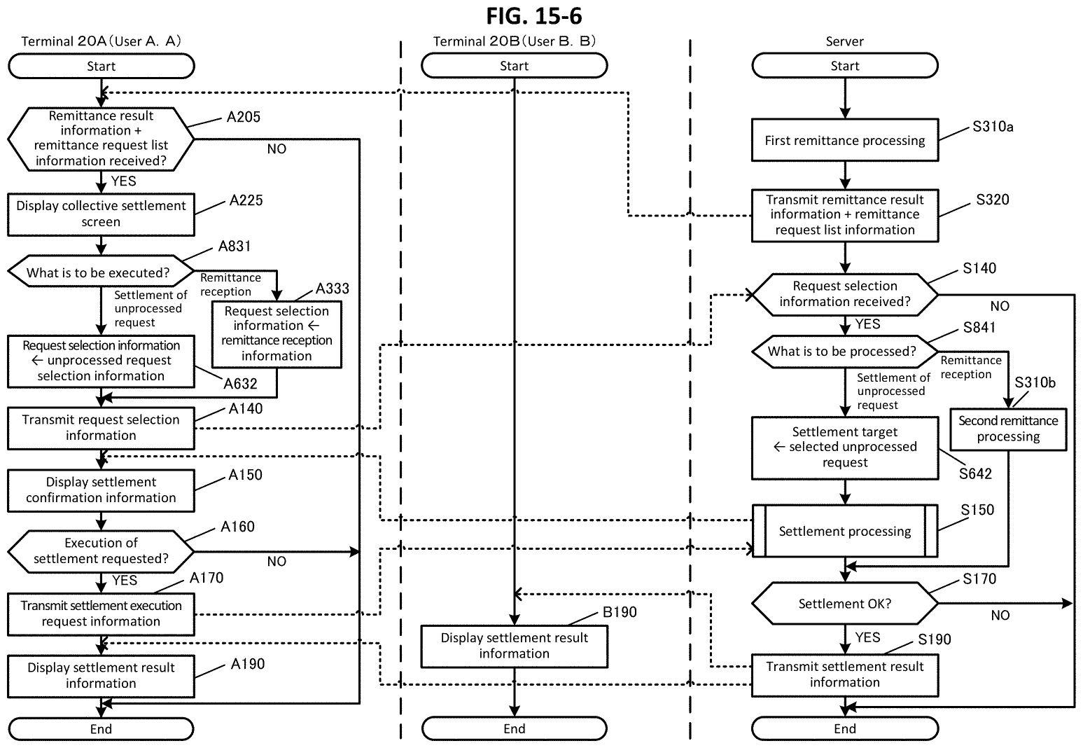

FIG. 15-1 is a diagram showing an example of a screen displayed on the display 24 of the terminal 20 according to an embodiment. This screen is, in a non-limiting example, a notification screen of the payment application displayed on the display 24 of the terminal 20A of the user A.A.

In the current location display region CLR1 indicating the current location in the payment application, the word “Notification” is displayed, indicating that the current location is the notification function of the payment application.

Remittance result information NC1 is displayed in the notification information display region NTR2 of the notification screen as content relating to reception of remittance (money reception).

Note that for the server 10 and the partner user (in this example, the user B.B), the remittance result information NC1 is the remittance result information because it is the result of the remittance processing, but for the user (in this example, the user A.A), it can also be said to be money reception result information because it is the result of money reception.

In this remittance result information NC1, in a non-limiting example, the content corresponding to receipt of the remittance amount “500 yen” remitted to (received by) the user A.A from the user B.B is displayed.

Below that, a list of unprocessed remittance requests of the user who received the remittance (the user A.A in this example) is displayed when the remittance is received. In this example, 4 unprocessed requests are listed in chronological order from oldest to newest.

In a non-limiting example, the display mode of each unprocessed request can be configured in the same manner as in FIG. 1-23, and therefore redundant description thereof is omitted.

Note that as unprocessed requests, only the unprocessed requests between the user who received remittance (the user A.A in this example) and the user who performed remittance (the user B.B in this example) may optionally be displayed.

In this manner, according to an embodiment, by displaying unprocessed requests together with information on the remittance result (money reception result), the unprocessed requests can be displayed as well when confirming that the user has received the remitted amount.

FIG. 15-2 is a diagram showing another example of the screen displayed on the display 24 of the terminal 20 according to an embodiment. This screen corresponds to FIG. 15-1, but the display content is partially different.

Specifically, in a non-limiting example, a remittance reception button indicated as “Remittance reception”, which is for approving and receiving remittance, is displayed within the remittance result information NC1.

The remittance processing is not complete until the user A.A taps the remittance reception button, and when the remittance reception button is tapped, the remittance amount (“500 yen” in this example) is added to the electronic money account balance of the user (the user A.A in this example) who received remittance.

In this example, when the partner user (the first user or the second user) performs remittance to the proposing user (the user of the terminal), the proposing user can stop the reception (money reception) of the remitted amount.

Although the details will be described later, this is referred to as “suspension of reception of remittance” or “suspension of money reception”.

Also, since the remittance is not completed, this can be regarded as “suspending remittance”.

In this manner, according to an embodiment, by displaying the unprocessed requests together with information on the remittance result (money reception result) in which reception of the remittance is suspended, the user can also check unprocessed requests when determining whether or not to receive the remitted amount.

FIG. 15-3 is a diagram showing another example of the screen displayed on the display 24 of the terminal 20 according to an embodiment. This screen is, in a non-limiting example, a notification screen of the payment application displayed on the display 24 of the terminal 20A of the user A.A.

In the notification information display region NTR2 of the notification screen, remittance request information NC7 is displayed as content relating to reception of the remittance request.

In the remittance request information NC7, in a non-limiting example, content corresponding to the remittance request for the remittance request amount “500 yen” received by the user A.A from the user B.B is displayed. Also, in the remittance request information NC7, a remittance request/remittance button indicated as “Remit”, which is for approving this remittance request and performing remittance, and a remittance request declining button indicated as “Decline”, which is for declining this remittance request, are displayed.

Below that, a list of remittance requests that were not processed by the user who received the remittance request (the user A.A in this example) when the remittance request was received are displayed.

Note that as unprocessed requests, only the unprocessed requests between the user who received the remittance request (the user A.A in this example) and the user who transmitted the remittance request (the user B.B in this example) may optionally be displayed.

In this way, according to an embodiment, by displaying the unprocessed requests together with the information on the reception result of the remittance request, the user can also confirm the unprocessed requests when confirming that the remittance request has been received.

### Processing

FIG. 15-4 is a flow chart showing an example of the flow of processing executed by each device according to an embodiment. Here, as an example, processing for displaying unprocessed requests when the user receives remittance (receives money), which has been described with reference to FIG. 15-1, will be described.

The controller 11 of the server 10 executes remittance processing for the user A.A of the terminal 20A based on the request from the terminal 20B (not shown) (S210). Specifically, as a non-limiting example, the electronic money account balance of the user B.B is updated by subtracting the remittance amount therefrom, and the electronic money account balance of the user A.A is updated by adding the remittance amount thereto.

Then, the controller 11 of the server 10 transmits the remittance result information and the remittance request list information to the terminal 20A via the communication I/F 14 (S220).

Then, the controller 11 of the server 10 ends the processing.

Note that in this case, the controller 11 of the server 10 may optionally transmit the remittance result information to the terminal 20B.

The controller 21 of the terminal 20A determines whether or not remittance result information and remittance request list information have been received from the server 10 via the communication I/F 22 (A205), and if it is determined that they have been received (A205: YES), the display 24 displays a collective settlement screen including remittance result information and remittance request list information (A225).

The collective settlement screen is, in a non-limiting example, the notification screen shown in the display screen example.

Then, the controller 21 of the terminal 20A ends the processing.

FIG. 15-5 is a flowchart showing another example of the flow of processing executed by each device according to an embodiment. Here, as an example, the processing in the case of applying the suspension of reception of remittance (suspension of money reception) described with reference to FIG. 15-2 will be described.

The controller 11 of the server 10 executes the first remittance processing for the user A.A of the terminal 20A based on the request from the terminal 20B (not shown) (S310a). Specifically, in a non-limiting example, the electronic money account balance of the user B.B is updated by subtracting the remittance amount therefrom.

In the first remittance processing, unlike the remittance processing (S210) in FIG. 15-4, the remittance amount is subtracted from the electronic money account balance of the user who is the remittance source, but the remittance amount is not added to the electronic money account balance of the user who is the remittance destination. This state is a state in which remittance is incomplete.

Thereafter, the controller 11 of the server 10 transmits the remittance result information of the first remittance processing and the remittance request list information to the terminal 20A via the communication I/F 14 (S320).

Note that in this case, the controller 11 of the server 10 may optionally transmit the remittance result information of the first remittance processing to the terminal 20B.

After A225, the controller 21 of the terminal 20A determines whether or not input for receiving remittance has been made to the input device (A730), and if it is determined that input has been made (A730: YES), the controller 21 transmits remittance receipt information for requesting receipt of remittance to the server 10 via the communication I/F 22 (A740).

After S320, the controller 11 of the server 10 determines whether or not remittance receipt information has been received from the terminal 20A via the communication I/F 14 (S740), and if it is determined that the remittance receipt information has been received (S740: YES), the controller 11 executes second remittance processing (S310b). Specifically, in a non-limiting example, based on the result of the first remittance processing, the electronic money account balance of the user A.A is updated by adding the remittance amount thereto. That is, the state in which the reception of the remittance (money reception) is suspended is released, and the remittance is completed.

Thereafter, the controller 11 of the server 10 transmits the remittance result information of the second remittance processing to the terminals 20A and 20B via the communication I/F 14 (S790).

Then, the controller 11 of the server 10 ends the processing.

When the remittance result information is received from the server 10 via the communication I/F 22, the controller 21 of the terminal 20A displays the received remittance result information on the display 24 (A790).

Then, the controller 21 of the terminal 20A ends the processing.

Similarly, when the remittance result information is received from the server 10 via the communication I/F 22, the controller 21 of the terminal 20B displays the received remittance result information on the display 24 (B790).

Then, the controller 21 of the terminal 20B ends the processing.

Note that since the processing for displaying an unprocessed request when the user receives a remittance request, which is described in FIG. 15-3, can be configured in the same manner by replacing “remittance” (money reception for the user A.A) in the processing of FIG. 15-4 with “remittance request reception”, illustration and description of the processing are omitted.

Specifically, in the processing of the terminal 20A, it is determined in A205 whether or not the remittance request transmission result information and the remittance request list information have been received, and in A225, a collective settlement screen including these pieces of information is displayed.

In the processing of the server 10, remittance request transmission processing is executed in S210, and remittance request transmission result information and remittance request list information are transmitted in S220.

### Display of Unprocessed Requests

The unprocessed requests displayed on the display 24 of the terminal 20 can be either or both of the following, in a non-limiting example.

An unprocessed request corresponding to the partner user (remittance source user) who performs remittance to the user, or the partner user (remittance request source user) who transmits a remittance request to the user

An unprocessed request corresponding to a user different from the partner user (remittance source user) who performs remittance to the user, or the partner user (remittance request source user) who transmits a remittance request to the user

The unprocessed requests corresponding to the partner user can be displayed. As a non-limiting example, if the user A.A receives remittance with the user B.B as the remittance source user, or if the user A.A receives a remittance request with the user B.B as the remittance request source user, the unprocessed requests corresponding to the user B.B can be displayed.

However, some users may wish to check unprocessed requests corresponding to a user different from the partner user.

Therefore, as illustrated in FIGS. 15-1 to 15-3, in a non-limiting example, in addition to the unprocessed requests corresponding to the user B.B, the unprocessed requests corresponding to the user C.C can be displayed.

Note that in this case, in a non-limiting example, the unprocessed requests corresponding to the user C.C can be displayed without displaying the unprocessed requests corresponding to the user B.B.

That is, similarly to the eighth embodiment, the following three patterns are conceivable as non-limiting examples of patterns in which unprocessed requests are displayed.

(Pattern 1) Unprocessed requests corresponding to the partner user
(Pattern 2) Unprocessed requests corresponding to the partner user+unprocessed requests corresponding to a user different from the partner user
(Pattern 3) Unprocessed requests corresponding to a user different from the partner user

Also, when applying any of the above patterns, for each user, all unprocessed requests corresponding to that user may be displayed, or some unprocessed requests corresponding to that user may be displayed.

That is, the user for whom unprocessed requests are displayed (the partner user/a user different from the partner user) and the range of unprocessed requests to be displayed (all/some) can be combined as appropriate. In a non-limiting example, in (Pattern 2), all unprocessed requests corresponding to the partner user may be displayed, while some of the unprocessed requests corresponding to a different user than the partner user may be displayed, or the like.

When displaying some unprocessed requests, it is also possible to determine the unprocessed requests to be displayed based on various types of information (conditions).

In this case, the content of a later-described twenty-sixth embodiment can be combined. As will be described in the twenty-sixth embodiment as well, non-limiting examples of various types of information include the following information.
The date or the date and time when the remittance request was transmitted or received.
The remittance request amount
The payment deadline of the remittance request
A remittance request in which a user other than the user who made the remittance request and the user who received the remittance request is involved in the remittance request amount or reason.

Note that these pieces of information are merely examples, and there is no limitation thereto.

Also, it is possible to apply a combination of a plurality of these pieces of information.

A user may forget about an unprocessed request whose date or date and time is older by a certain amount or more. For this reason, it is possible to make a determination such that even unprocessed requests corresponding to a user different from the partner user are displayed.

An unprocessed request with a remittance request amount greater than or equal to a certain amount may be of high importance. For this reason, it is possible to make a determination such that even unprocessed requests corresponding to a user different from the partner user are displayed.

A remittance request in which a user other than the user who made the remittance request and the user who received the remittance request is involved in the remittance request amount or reason may also be of high importance. For this reason, it is possible to make a determination such that even unprocessed requests corresponding to a user different from the partner user are displayed.

An unprocessed request whose payment deadline is approaching within a certain period of time may require immediate processing. For this reason, it is possible to make a determination such that even unprocessed requests corresponding to a user different from the partner user are displayed.

Also, as will be described in the twenty-sixth embodiment as well, the unprocessed requests can be rearranged and displayed in ascending or descending order based on the above-described various types of information (conditions). As an example, unprocessed requests with higher importance can be displayed at a higher position.

In addition to these, the unprocessed requests displayed on the display 24 of the terminal 20 can be hidden based on the input of the user of the terminal 20 to the input device, in a non-limiting example.

In this case, in a non-limiting example, unprocessed requests corresponding to some users may be hidden, or unprocessed requests corresponding to all users may be hidden.

Also, some users may feel annoyed by the display of unprocessed requests.

In view of this, it may be possible to set display/non-display of unprocessed requests on a setting screen or the like (not shown).

Specifically, on the setting screen of the application, as setting information relating to display of unprocessed requests, in a non-limiting example, a slide button or a check box for switching display/non-display of unprocessed requests is displayed. Also, it is possible to cause the terminal 20 or the server 10 to set display/non-display based on an operation performed on the slide button or check box.

In this case, display/non-display of unprocessed requests may be set collectively for all users, or display/non-display of unprocessed requests may be set individually for each user.

Also, display/non-display of all unprocessed requests may be settable, or display/non-display of some unprocessed requests may be settable.

Note that these contents are the same for the following examples as well.

### Effect of Seventeenth Embodiment

This embodiment shows a configuration in which the terminal 20 of the proposing user receives remittance result information from the partner user (a non-limiting example of first information relating to remittance from the first user to the user of the terminal), or remittance request information transmitted from the partner user (a non-limiting example of the first information relating to the remittance request transmitted from the first user to the user of the terminal) from the server 10 via the communication I/F 22.

Then, the terminal 20 of the proposing user displays a first display based on the received information on the display 24, and based on reception of the first information, displays a second display based on received remittance request information relating to a remittance request received from the partner user (a non-limiting example of second information relating to a remittance request transmitted from the second user to the user of the terminal) or transmitted remittance request information relating to a remittance request transmitted to the partner user (a non-limiting example of second information relating to a remittance request transmitted from the user of the terminal to the second user), on the display 24.

As an example of the effect of the embodiment obtained by such a configuration, when the user of the terminal checks the first information, it is possible to check the second information as well.

Also, this embodiment shows a configuration in which the terminal 20 of the proposing user performs, with the controller 21, processing for receiving a remitted amount based on input performed by the proposing user to the terminal 20 on which the first display and the second display are displayed (a non-limiting example of first processing relating to receipt of remittance).

As an example of the effect of the embodiment obtained by such a configuration, it is possible to easily receive remittance from the partner user based on the input to the terminal on which the first display and the second display are displayed.

### Seventeenth Modified Example (1)

In the seventeenth embodiment, settlement (including collective settlement of unprocessed requests) may be executed based on input regarding information on an unprocessed request displayed together with the remittance result information from the partner user and the remittance request information transmitted from the partner user.

Specifically, in the non-limiting screen examples of FIGS. 15-1 to 15-3, a settlement button for executing settlement of the selected unprocessed requests (collective settlement if a plurality of requests are selected) is displayed.

Then, when the settlement button is tapped, the server 10 can execute settlement processing for the selected unprocessed request.

Note that the settlement processing for unprocessed requests is the same as described above, and therefore redundant description thereof is omitted.

FIG. 15-6 is a flowchart showing an example of the flow of processing executed by each device in this modified example. Here, as an example, in the processing of suspending the receipt of remittance (suspension of money reception) shown in FIG. 15-5, the processing in the case of performing either remittance reception or settlement of an unprocessed request will be described.

After A225, the controller 21 of the terminal 20A determines an execution target based on the input to the input device (A831).

If it is determined that the execution target is settlement of an unprocessed request (collective settlement if a plurality of unprocessed requests are selected) (A831: settlement of unprocessed requests), the controller 21 of the terminal 20A moves the processing to A632. That is, request selection information including unprocessed request selection information indicating the selected unprocessed request is set.

On the other hand, if it is determined that the execution target is reception of remittance (A831: remittance reception), the controller 21 of the terminal 20A sets request selection information including remittance reception information (A333).

After A632 or A333, the controller 21 of the terminal 20A transmits the set request selection information to the server 10 via the communication I/F 22 (A140).

Then, the controller 21 of the terminal 20A moves the processing to A150.

If it is determined in S140 that the request selection information has been received from the terminal 20A (S140: YES), the controller 11 of the server 10 determines the processing target based on the received request selection information (S841).

If it is determined that the processing target is the settlement of unprocessed requests (S841: settlement of unprocessed requests), the controller 11 of the server 10 moves the processing to S642. That is, the selected unprocessed request is set as the settlement target (if multiple requests are selected, the collective settlement target). Then, the controller 11 of the server 10 executes the settlement processing of S150.

On the other hand, if it is determined that the processing target is reception of remittance (S841: remittance reception), the controller 11 of the server 10 moves the processing to S310b. That is, the second remittance processing is executed.

Then, the controller 11 of the server 10 moves the processing to S170.

As a non-limiting example, when applying the first settlement processing described in FIG. 1-19,

if the setting of S642 has been made and there are a plurality of unprocessed requests to be processed, the result of the determination in S1510 as to whether or not the settlement target is a collective settlement target is “YES”. As a result, the processing of S1515 and onward is executed with these multiple unprocessed requests as the collective settlement targets.

Also, when the setting of S642 is made and there is one unprocessed request to be processed, the result of determination in S1510 as to whether or not the settlement target is a collective settlement target is “NO”. As a result, the processing of S1570 and onward is executed with this one unprocessed request as the settlement target.

Note that since the processing for displaying unprocessed requests when the user receives the remitted amount without suspending reception of the remittance, and performing settlement of the unprocessed request can be configured in the same manner as in FIG. 15-6, illustration and description thereof are omitted.

Also, the processing for displaying the unprocessed request when the user receives a remittance request and performing either remittance or settlement of the unprocessed request can be configured in the same way as shown in FIG. 15-6, and therefore illustration and description thereof are omitted.

This modified example shows a configuration in which the terminal 20 of the proposing user receives remittance result information from the partner user (a non-limiting example of first information relating to remittance from the first user to the user of the terminal), or remittance request information transmitted from the partner user (a non-limiting example of the first information relating to the remittance request transmitted from the first user to the user of the terminal) is received from the server 10 via the communication I/F 22.

Also, the terminal 20 of the proposing user displays the first display based on the received information on the display 24, and based on the reception of the first information, displays the second display based on received remittance request information relating to a received remittance request from the partner user (a non-limiting example of second information relating to a remittance request transmitted from the second user to the user of the terminal) and transmitted remittance request information relating to a remittance request transmitted to the partner user (a non-limiting example of second information relating to a remittance request transmitted from the user of the terminal to the second user) on the display 24.

Then, based on input performed by the proposing user to the terminal 20 on which the first display and the second display are displayed, the terminal 20 of the proposing user performs, with the controller 21, processing for performing remittance, processing for receiving the remitted amount, processing for transmitting a remittance request, or processing for receiving a remittance request (a non-limiting example of the first processing relating to remittance, relating to receiving remittance, or relating to requesting remittance).

As an example of the effect of the embodiment obtained by such a configuration, based on the input to the terminal on which the first display and the second display are displayed, it is possible to easily realize remittance to the partner user, reception of remittance from the partner user, and transmission/reception of a remittance request to/from the partner user.

### Seventeenth Modified Example (2)

In the above embodiment, the settlement result information in the display screen is rendered and displayed based on the first information. That is, the first display and the second display are displayed substantially simultaneously.

However, in the above embodiment, the display of the first display and the second display includes the following two cases.

(1) Reception of first information→first display→second display
(2) Reception of first information→first display, reception of first information→second display

(1) is a case of displaying a first display based on the received first information and displaying a second display based on the displayed first display.

(2) is a case of displaying a first display based on the received first information and displaying a second display based on the received first information.

In any case, there is no change in the fact that the reception of the first information is the trigger.

Also, the order in which the first display and the second display are displayed can be random.

That is, the above case (1) may be “reception of first information→second display→first display”, and the above case (2) may be “reception of first information→second display, reception of first information→first display”.

Note that this also applies to the embodiments described below.

Next, as an embodiment relating to the seventeenth embodiment, an embodiment will be described in which unprocessed requests selected from among the displayed unprocessed requests are also processed when the user of the terminal 20 receives the amount remitted from the partner user or receives a remittance request from the partner user.

The following embodiments will be roughly divided into the following five patterns and described.

(a) Pattern in which money reception+received remittance request are processed
(b) Pattern in which money reception+transmitted remittance request are processed
(c) Pattern in which money reception+received remittance request are processed+transmitted remittance request is processed
(d) Pattern in which reception of remittance request+received remittance request are processed
(e) Pattern in which reception of remittance request+transmitted remittance request are processed

Embodiments of each pattern will be described separately.

As shown in the seventeenth modified example as well, the processing (first processing, etc.) executed by the terminal 20 with the controller 21 includes, in a non-limiting example, processing such as processing for remittance (a non-limiting example of processing relating to remittance), processing for receiving remittance (money reception) (a non-limiting example of processing relating to reception of remittance), and processing for transmitting/receiving a remittance request (a non-limiting example of processing relating to a remittance request).

Note that in the following description, a server-client system is illustrated, and remittance, transmission of a remittance request, and the like are performed via the server 10.

Also, hereinafter, as described above, a case where the partner user is one user, that is, a case where the second user is the first user (or the first user is the second user) will be illustrated.

Note that as described above, the method described below can be similarly applied also to a case where the partner user is a plurality of different users, that is, a case where the first user is a user different from the second user (the second user is a user different from the first user).

### Eighteenth Embodiment

This embodiment relates to processing of the pattern (a) above.

The content described in the eighteenth embodiment can also be applied to any of the other embodiments and the other modified examples.

Moreover, constituent elements that are the same as constituent elements that have already appeared are denoted by the same reference signs, and redundant description thereof is omitted.

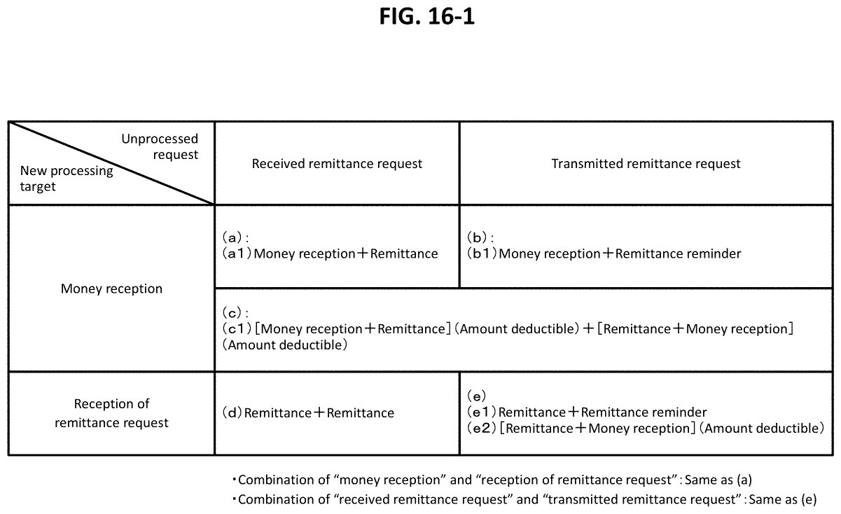

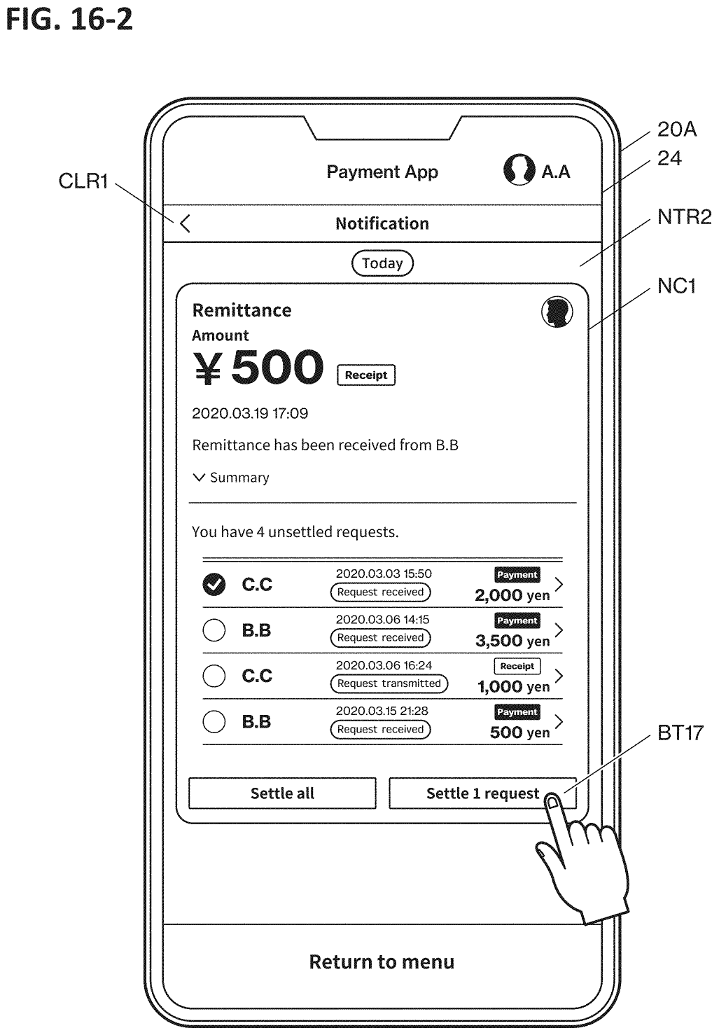

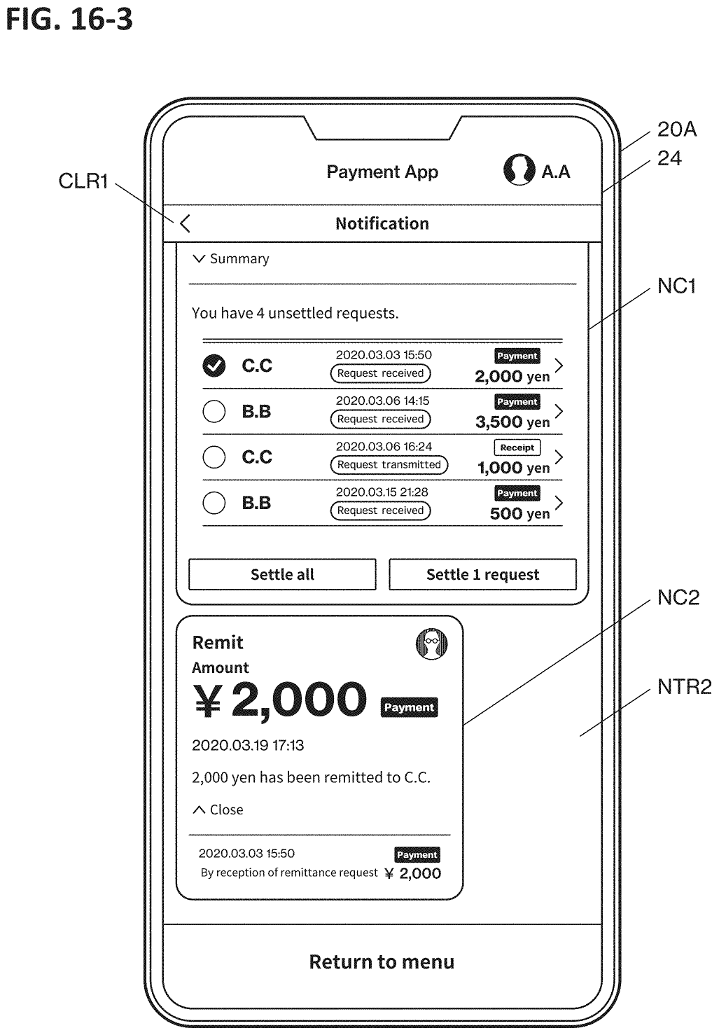

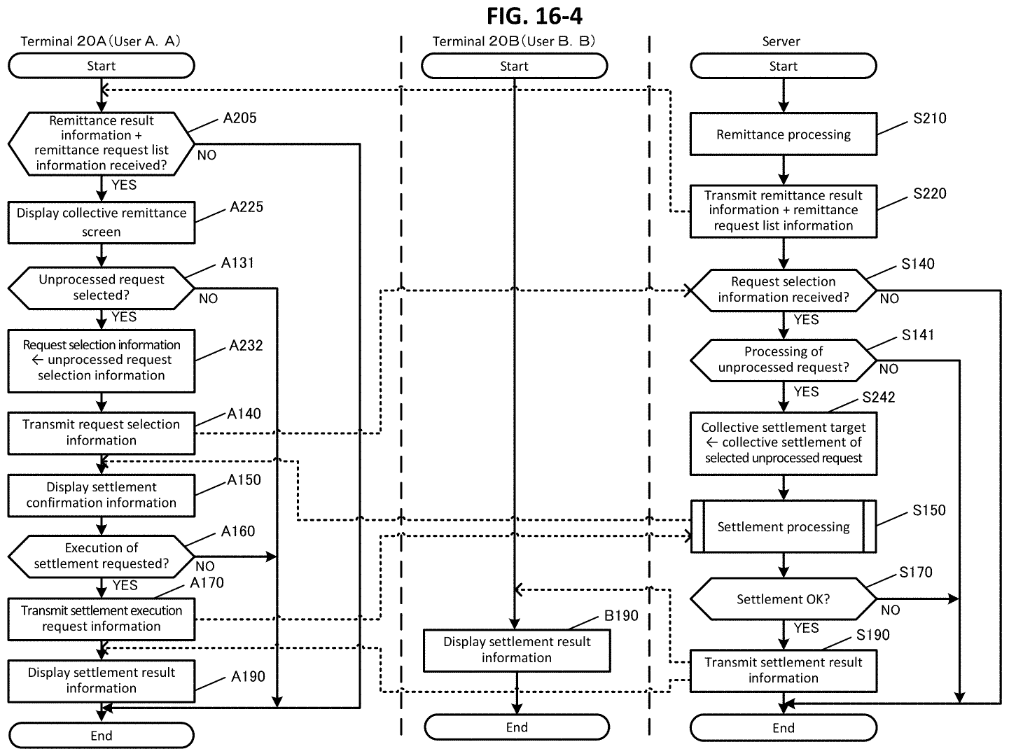

FIG. 16-1 is a diagram showing an example of a table for describing the processing method corresponding to each of the above patterns.

In the vertical direction of the table, the target of the processing to be newly executed (new processing target) is shown as an item, and in the horizontal direction of the table, the type of unprocessed request is shown as an item. An example of processing realized by a combination of the new processing target and the type of unprocessed request is shown in the field where the vertical item and the horizontal item intersect each other.

Description will be given in order.

In the pattern of (a) money reception+received remittance request, processing of (a1) money reception+remittance can be performed. That is, when receiving money from the partner user, remittance to the partner user is also performed based on the received remittance request from the partner user.

### Display Screen

FIG. 16-2 is a diagram showing an example of the screen displayed on the display 24 of the terminal 20 according to an embodiment. This screen is, in a non-limiting example, a notification screen of the payment application displayed on the display 24 of the terminal 20A of the user A.A.

In the current location display region CLR1 indicating the current location in the payment application, the word “Notification” is displayed, which indicates that the current location is the notification function of the payment application.

Remittance result information NC1 is displayed in the notification information display region NTR2 of the notification screen as content relating to reception of remittance (money reception).

Hereinafter, remittance request list information is shown included in the remittance result information for convenience in some cases. In this case, the remittance result information may be called collective settlement information.

The information is referred to as the remittance result information for the server 10 and for the partner user (the user B.B in this example) as well, because it is the result of the remittance processing, but for the user (the user A.A in this example), the information can be said to be money reception result information because it is the result of money reception.

In this remittance result information NC1, in a non-limiting example, the content corresponding to receipt of the remittance amount “500 yen” remitted to (received by) the user A.A from the user B.B is displayed.

Below that, a list of unprocessed remittance requests of the user who received the remittance (the user A.A in this example) is displayed when the remittance is received. In this example, four unprocessed requests are listed in chronological order from oldest to newest. In a non-limiting example, the display mode of each unprocessed request can be configured in the same manner as in FIG. 1-23, and therefore redundant description thereof is omitted.

Note that as unprocessed requests, only the unprocessed requests between the user who received remittance (the user A.A in this example) and the user who performed remittance (the user B.B in this example) may optionally be displayed. In this case, in a non-limiting example, the display mode of each unprocessed request can be configured in the same manner as in FIG. 1-11.

At the bottom of the remittance result information NC1, a full-selection collective settlement button indicated as “full-selection collective settlement” for executing full-selection collective settlement is displayed. Also, next to the full-selection collective settlement button, a partial-selection collective settlement button BT17 indicated as “Settle 1 request”, which is for executing partial-selection collective settlement of the unprocessed requests selected by the user among the unprocessed requests displayed in the remittance result information NC1, is displayed.

As a non-limiting example, in the remittance result information NC1, when the request check for the first received remittance request (payment of 2,000 yen to the user C.C) is set to “ON” and selected, and the partial-selection collective settlement button BT17 is tapped, the terminal 20A requests the server 10 to perform collective settlement of the selected unprocessed request. Then, the server 10 transmits settlement result information relating to the execution result to the terminal 20C of the user C.C, who is the partner, and the terminal 20A of the user A.A, who is the proposer.

FIG. 16-3 is a diagram showing an example of a notification screen displayed on the display 24 of the terminal 20A when the partial-selection collective settlement button BT17 is tapped.

In this example, in the notification information display region NTR2 of the notification screen, the settlement result information NC2 is displayed as the content of the collective settlement below the remittance result information NC1.

In the settlement result information NC2, as a non-limiting example, information relating to the fact that the user A.A has executed remittance of the remittance amount “2,000 yen” to the user C.C through settlement relating to payment of the remittance request amount “2,000 yen” according to a remittance request from the user C.C is displayed.

Note that in the settlement result information displayed on the terminal 20C of the user C.C, not only is the receipt of the remittance amount “2,000 yen” from the user A.A displayed, but also a list of unprocessed requests of the user C.C are displayed according to the display mode of the remittance result information NC1.

### Processing

FIG. 16-4 is a flow chart showing an example of the flow of processing executed by each device according to an embodiment.

The controller 11 of the server 10 executes remittance processing for the user A.A of the terminal 20A based on the request from the terminal 20B (S210). Specifically, as a non-limiting example, the electronic money account balance of the user B.B is updated by subtracting the remittance amount therefrom, and the electronic money account balance of the user A.A is updated by adding the remittance amount thereto.

Then, the controller 11 of the server 10 transmits the remittance result information and the remittance request list information to the terminal 20A via the communication I/F 14 (S220).

The controller 21 of the terminal 20A determines whether or not remittance result information and remittance request list information have been received from the server 10 via the communication I/F 22 (A205), and if it is determined that they have been received (A205: YES), the display 24 displays a collective settlement screen including remittance result information and remittance request list information (A225).

If it is determined in A131 that an unprocessed request has been selected (A131: YES), the controller 21 of the terminal 20A sets unprocessed request selection information as request selection information (A232). Then, the controller 21 of the terminal 20A moves the processing to A140.

On the other hand, if it is determined that no unprocessed request has been selected (A131: NO), the controller 21 of the terminal 20A ends the processing.

If it is determined in S141 that an unprocessed request is to be processed (S141: YES), the controller 11 of the server 10 sets the selected unprocessed request as a collective settlement target (S242). Then, the controller 11 of the server 10 moves the processing to S150.

If it is determined that the unprocessed request is not to be processed (S141: NO), the controller 11 of the server 10 ends the processing.

### Effect of Eighteenth Embodiment

This embodiment shows a configuration in which the terminal 20 of the proposing user receives remittance result information from the partner user (a non-limiting example of first information relating to remittance from the first user to the user of the terminal) from the server 10 via the communication I/F 22.

Also, the terminal 20 of the proposing user displays a first display based on the received remittance result information (a non-limiting example of the first display) on the display 24, and based on the reception of the remittance result information, displays a second display (a non-limiting example of a second display) based on received remittance request information relating to a received remittance request from the partner user (a non-limiting example of second information relating to a remittance request transmitted from the second user to the user of the terminal) on the display 24.

Then, based on input performed by the proposing user to the terminal 20 on which the first display and the second display are displayed, the terminal 20 of the proposing user executes first processing relating to remittance or relating to money reception (an example of reception of remittance) with the controller 21.

As an example of the effect of the embodiment obtained by such a configuration, the first processing relating to remittance or reception of remittance can be easily and appropriately performed based on the input to the terminal on which the first display and the second display are displayed.

Also, this embodiment shows a configuration in which the second information is remittance result information (a non-limiting example of information relating to remittance from the first user to the user of the terminal), the second information is received remittance request information (a non-limiting example of information relating to a remittance request transmitted from the second user to the user of the terminal), and the first processing includes processing for performing remittance to the partner user (a non-limiting example of the second user) based on input to the terminal 20 on which the second display is displayed.

As an example of the effect of the embodiment obtained by such a configuration, the user of the terminal can be informed that remittance is scheduled to be performed from the first user to the user of the terminal, and remittance can be performed to the second user based on the input to the terminal on which the second display is displayed.

Also, this embodiment shows a configuration in which the first display and the second display are displayed on the display 24 by the payment application installed in the terminal 20 of the proposing user, and the payment application is included in the program according to the present disclosure.

As an example of the effect of the embodiment obtained by such a configuration, an application installed in the terminal can display the first display and the second display on the display of the terminal.

### Eighteenth Modified Example

In the above embodiment, the remittance from the partner user is complete when the terminal 20 of the proposing user receives the remittance result information, but there is no limitation to this.

Specifically, when input for remittance receipt (an operation or the like) is performed while the above-described method for suspending reception of remittance (suspension of money reception) is applied and the second display is displayed, remittance from the partner user may optionally be completed.

Note that this also applies to other embodiments.

### Nineteenth Embodiment

The nineteenth embodiment is an embodiment relating to processing of the above-described pattern (b).

The content described in the nineteenth embodiment can also be applied to any of the other embodiments and the other modified examples.

Moreover, constituent elements that are the same as constituent elements that have already appeared are denoted by the same reference signs, and redundant description thereof is omitted.

In the pattern of (b) money reception+transmitted remittance request, processing of (b1) money reception+remittance reminder can be performed. That is, when receiving money from the partner user, a remittance reminder for a transmitted remittance request to the partner user is performed based on this remittance request.

Note that in this case, a new remittance request may optionally be issued instead of the remittance reminder.

### Display Screen

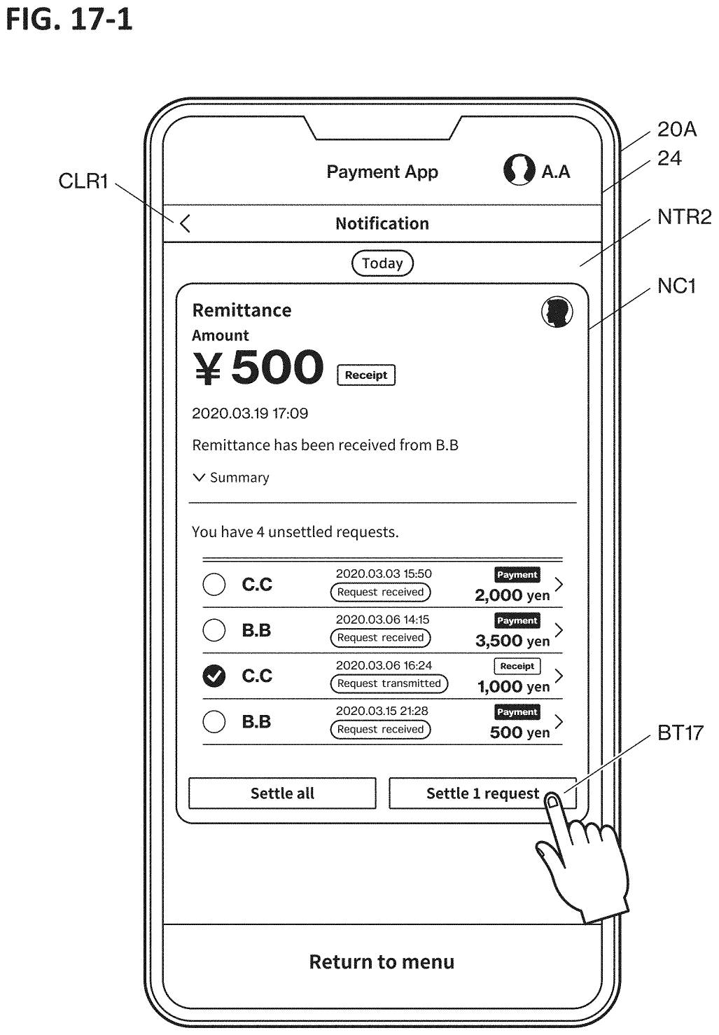

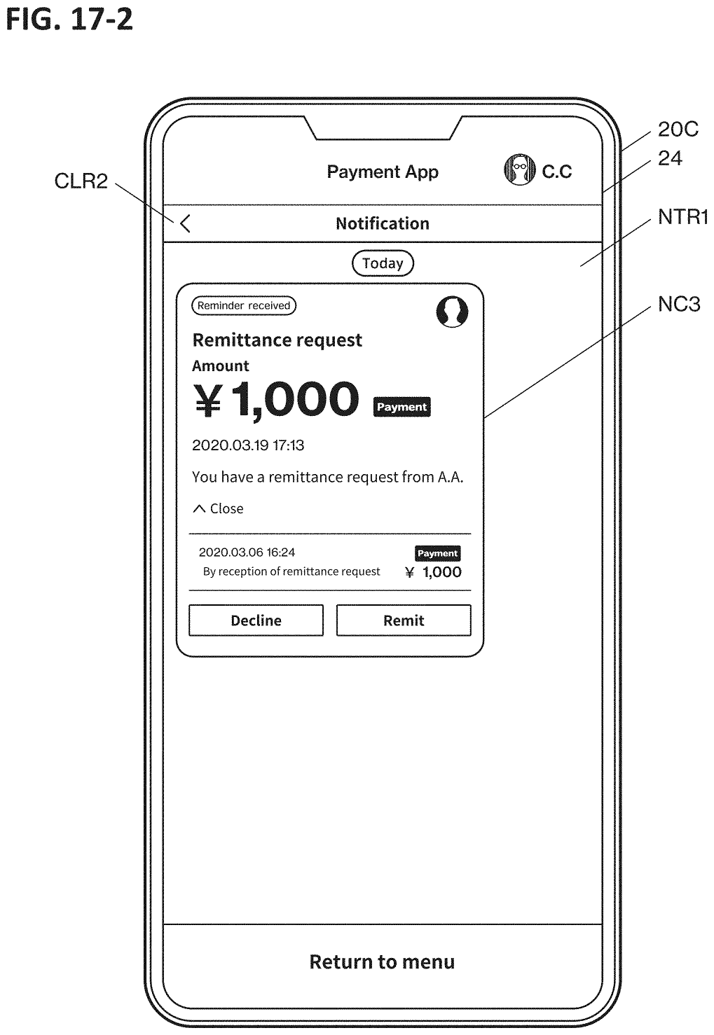

FIG. 17-1 is a diagram showing an example of a screen displayed on the display 24 of the terminal 20 according to an embodiment. This screen is, in a non-limiting example, a notification screen of the payment application displayed on the display 24 of the terminal 20A of the user A.A. Regarding the details of the screen configuration, in a non-limiting example, the screen can be configured in the same manner as in FIG. 16-2, and therefore detailed description thereof will be omitted.

In a non-limiting example, in the remittance result information NC1, when the request check for the third received remittance request (receipt of 1,000 yen from the user C.C) is set to “ON” and selected, and the partial-selection collective settlement button BT17 is tapped, the terminal 20A requests the server 10 to perform collective settlement of the selected unprocessed requests. Then, the settlement result information relating to the execution result is transmitted from the server 10 to the terminal 20C of the user C.C, who is the partner.

FIG. 17-2 is a diagram showing an example of a notification screen displayed on the display 24 of the terminal 20C when the partial-selection collective settlement button BT17 is tapped.

In this example, in the notification information display region NTR1 of the notification screen, the settlement result information NC3 is displayed as the content of the collective settlement.

In the settlement result information NC3, as a non-limiting example, a reminder corresponding to the third remittance request selected in FIG. 17-1 (a remittance request for the remittance request amount “1,000 yen” transmitted by the user A.A to the user C.C) is displayed.

Also, when the above-described partial-selection collective settlement button BT17 is tapped, information indicated by the words “A reminder has been transmitted to the user C.C”, which indicate that a remittance reminder has been transmitted to the user C.C, may optionally be displayed in the notification information display region NTR2 of the terminal 20A.

### Processing

The processing executed by each device according to an embodiment can be realized in the same manner as the processing in FIG. 16-4, and therefore illustration and detailed description thereof will be omitted.

### Effect of Nineteenth Embodiment

This embodiment shows a configuration in which the terminal 20 of the proposing user receives remittance result information from the partner user (a non-limiting example of first information relating to remittance from the first user to the user of the terminal) from the server 10 via the communication I/F 22.

Also, the terminal 20 of the proposing user displays a first display (a non-limiting example of the first display) based on the received remittance result information on the display 24, and based on the reception of the remittance result information, displays a display (a non-limiting example of the second display) based on transmitted remittance request information relating to a transmitted remittance request to the partner user (a non-limiting example of second information relating to a remittance request transmitted from the user of the terminal to the second user) on the display 24.

Then, the terminal 20 of the proposing user executes, with the controller 21, first processing relating to money reception (a non-limiting example of reception of remittance), or relating to a remittance reminder or a new remittance request (a non-limiting example of a remittance request), based on input performed by the proposing user to the terminal 20 on which the first display and the second display are displayed.

As an example of the effect of the embodiment obtained by such a configuration, the first processing relating to reception of remittance or relating to a remittance request can be easily and appropriately performed based on the input to the terminal on which the first display and the second display are displayed.

Also, this embodiment shows a configuration in which the first information is remittance result information from the partner user (a non-limiting example of information relating to remittance from the first user to the user of the terminal), and the second information is transmitted remittance request information relating to a remittance request transmitted from the proposing user to the partner user (a non-limiting example of information relating to a remittance request transmitted from the user of the terminal to the second user).

As an effect of the embodiment obtained by such a configuration, processing based on remittance from the first user to the user of the terminal and a remittance request transmitted from the user of the terminal to the second user can be performed all together.

Also, in this case, a configuration is shown in which the first processing includes processing for transmitting a remittance reminder or a new remittance request to the partner user (a non-limiting example of the second user) based on the input to the terminal 20 on which the second display is displayed.

As an example of the effect of the embodiment obtained by such a configuration, it is possible to easily make a remittance request to the second user based on the input to the terminal on which the second display is displayed.

### Twentieth Embodiment

The twentieth embodiment is an embodiment relating to processing of the above-described pattern (c).

The content described in the twentieth embodiment can also be applied to any of the other embodiments and the other modified examples.

Moreover, constituent elements that are the same as constituent elements that have already appeared are denoted by the same reference signs thereas, and redundant description thereof is omitted.

In the pattern of (c) money reception+received remittance request+transmitted remittance request, processing of (c1) [money reception+remittance] (amount deductible)+[remittance+money reception] (amount deductible) can be performed.

In this processing, when receiving money from the partner user, remittance to the partner user is also performed based on a received remittance request from the partner user. In this case, it is possible to receive/remit an amount corresponding to the difference in the remittance request amounts. Also, if the remittance request amounts are the same amount, it is possible to cancel out the amounts.

Also, remittance is made to the partner user based on a received remittance request from the partner user, and remittance is received from the partner user based on a transmitted remittance request to the partner user. In this case, it is possible to receive/remit an amount corresponding to the difference in the remittance request amounts. Also, if the remittance request amounts are the same amount, it is possible to cancel out the amounts.

### Display Screen

Here, as an example, a display screen example in the case of applying the above-described suspension of reception of remittance (suspension of money reception) will be described.

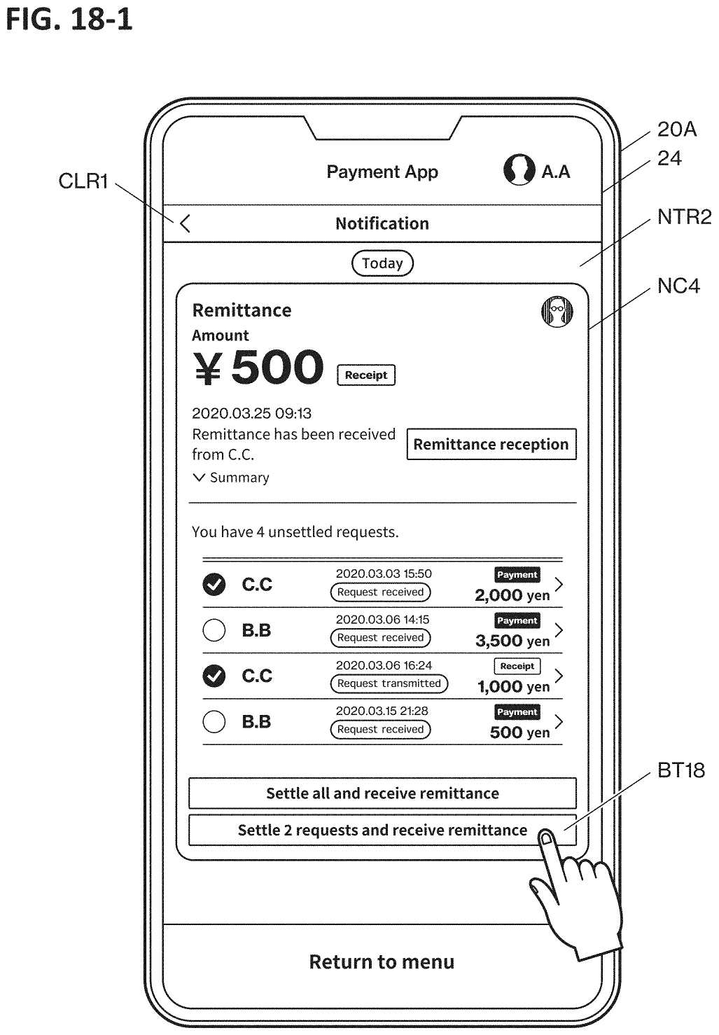

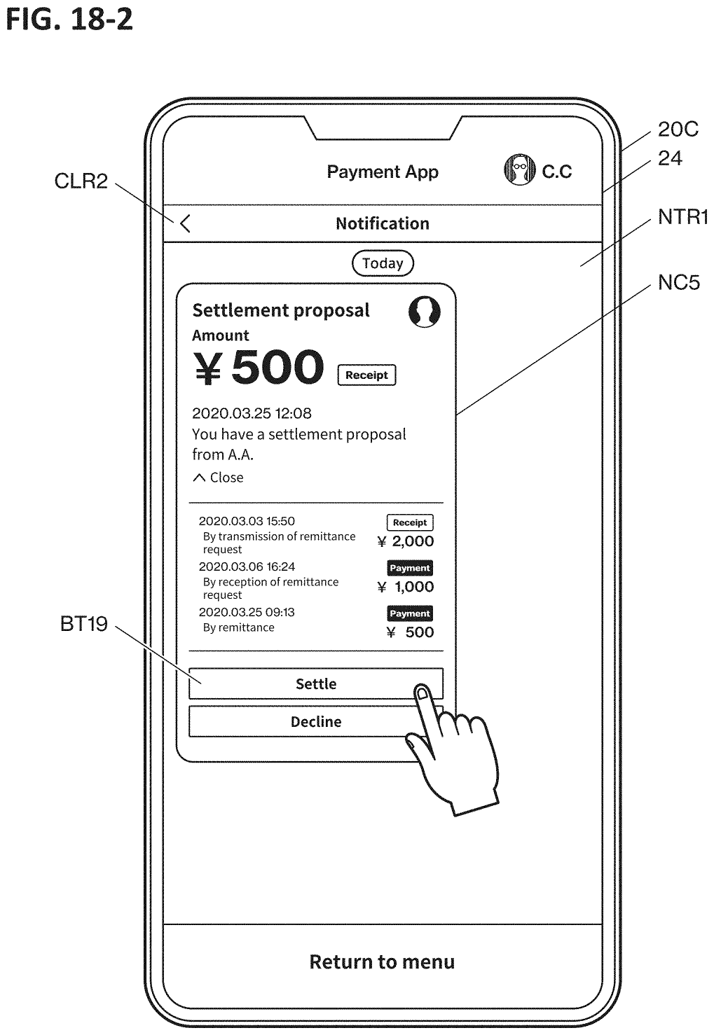

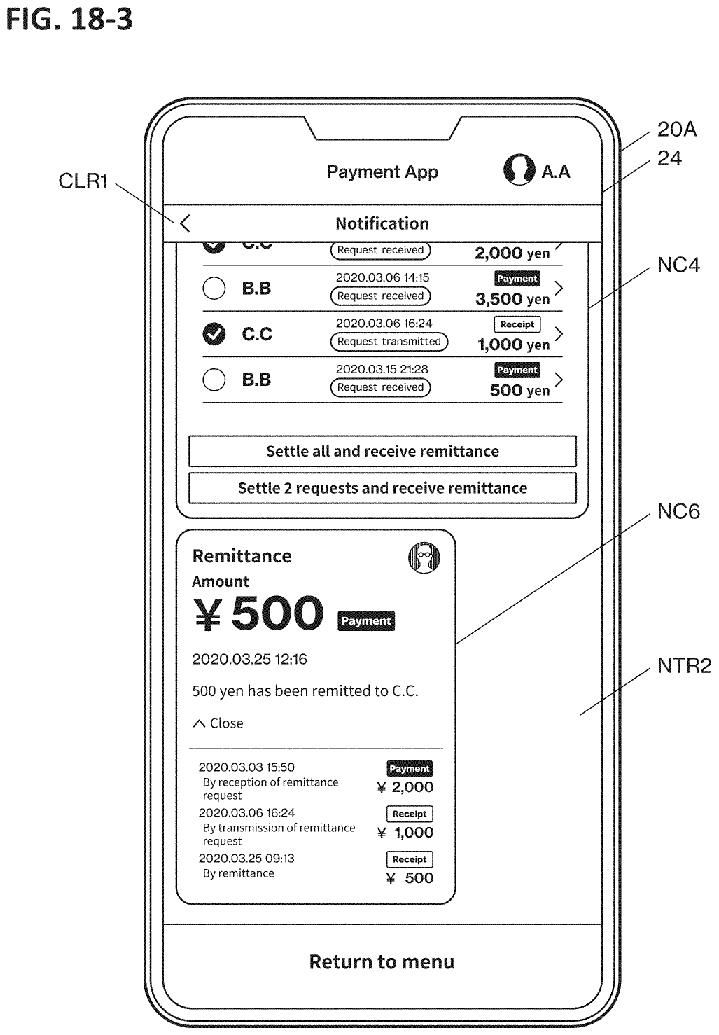

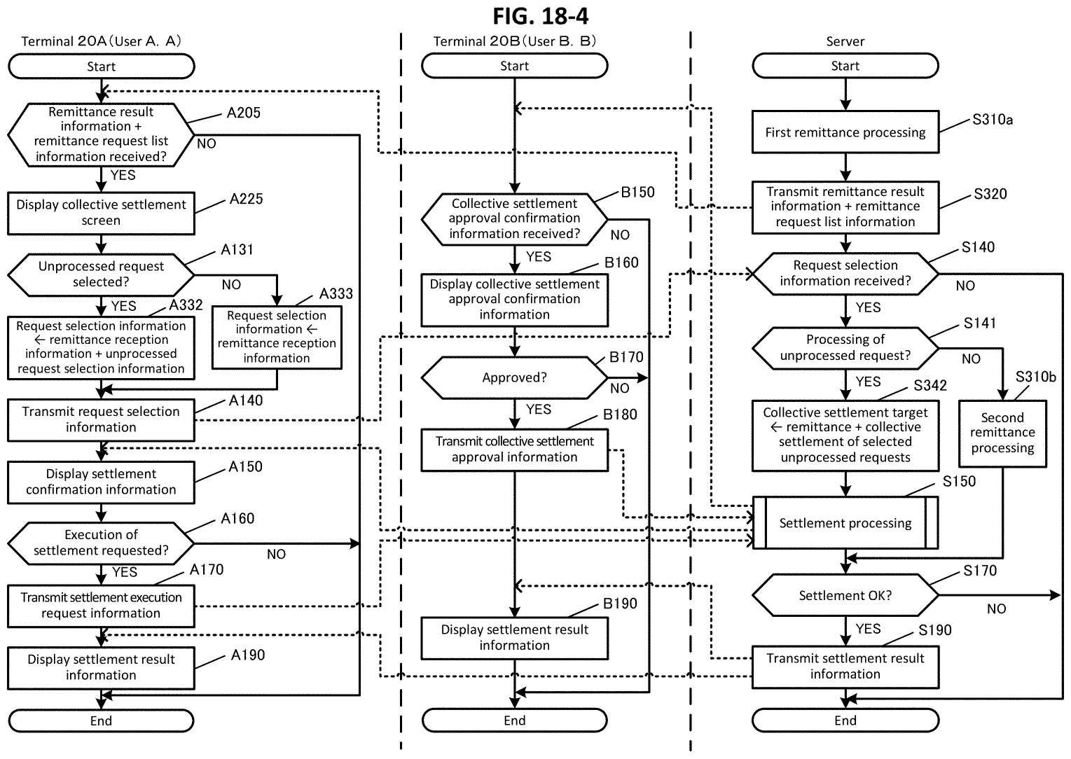

FIG. 18-1 is a diagram showing an example of a screen displayed on the display 24 of the terminal 20 according to an embodiment. This screen is, in a non-limiting example, a notification screen of the payment application displayed on the display 24 of the terminal 20A of the user A.A.

Remittance result information NC4 is displayed in the notification information display region NTR2 of the notification screen as content relating to reception of remittance (money reception).

In the remittance result information NC4, as a non-limiting example, the content corresponding to the receipt of the remittance amount “500 yen” remitted by the user C.C to the user A.A is displayed.

In the remittance result information NC4, a remittance reception button indicated as “Remittance reception” is displayed, which is for approving and receiving remittance. That is, the remittance processing is not complete until the user A.A taps the remittance reception button, and when the remittance reception button is tapped, the remittance amount (“500 yen” in this example) is added to the electronic money account balance of the user who received remittance (the user A.A in this example).

Also, in the remittance result information NC4, similarly to the remittance result information NC1, a list of remittance requests that have not been processed by the user who received the remittance (the user A.A in this example) at the time of receiving the remittance is displayed.

At the bottom of the remittance result information NC4, a money reception/full-selection settlement button indicated as “Settle all and receive remittance”, which is for executing full-selection collective settlement assuming that remittance has been approved, is displayed. Also, next to the money reception/full-selection collective settlement button, a money reception/collective settlement button BT18 indicated as “Settle 1 request”, which is for executing partial-selection collective remittance of the unprocessed requests selected by the user from among the unprocessed requests displayed in the remittance request information NC4 assuming that remittance has been approved, is displayed.

When the remittance reception button of the remittance result information NC4 is tapped by the user A.A, in a non-limiting example, the display mode of the remittance result information NC4 changes in the same manner as the remittance result information NC1 when the user who made the remittance is the user C.C.

As a non-limiting example, in the remittance result information NC4, when the checks of the first received remittance request (payment of 2,000 yen to the user C.C) and the third transmitted remittance request (receipt of 1,000 yen from the user C.C) are set to “ON” and selected, and the money reception/collective settlement button BT18 is tapped, the terminal 20A requests the server 10 to execute remittance (remittance from the user C.C to the user A.A) and collectively settle the selected unprocessed requests. This remittance is reception of remittance (money reception) for the user A.A.

Then, the server 10 transmits collective settlement approval confirmation information for confirming whether or not to approve collective settlement to the terminal 20C of the user C.C, who is the partner, and the collective settlement approval confirmation information is displayed on the display 24 of the terminal 20C.

FIG. 18-2 is a diagram showing an example of a notification screen that is displayed when the money reception/collective settlement button BT18 is tapped.

In the notification information display region NTR1, the icon image of the user A.A, who is the partner of the “settlement proposal”, and the collective settlement amount are displayed as collective settlement approval confirmation information NC5.

In the collective settlement approval confirmation information NC5, as the content of the collective settlement, it is displayed that the user C.C will receive the remittance request amount “2,000 yen” based on transmission of past remittance requests to the user A.A, will pay the remittance request amount “1,000 yen” based on the reception of past remittance requests from the user A.A, and will pay “500 yen” due to the current remittance to the user A.A.

Also, in the collective settlement approval confirmation information NC5, as the collective settlement amount, it is displayed that the user C.C will receive, from the user A.A, “500 yen”, which is obtained by subtracting the remittance request amount “1,000 yen” resulting from reception of a remittance request and the current remittance amount “500 yen” from the reception amount “2,000 yen” resulting from transmission of a remittance request.

At the bottom of the collective settlement approval confirmation information NC5, a settlement button BT19 indicated as “Settle”, which is for approving settlement with the above-described content, and a decline button indicated as “Decline”, which is for declining settlement with the above-described content, are displayed.

FIG. 18-3 is a diagram showing an example of a notification screen displayed on the display 24 of the terminal 20A when the settlement button BT19 is tapped.

In this example, in the notification information display region NTR2 of the notification screen, settlement result information NC6 is displayed as the content of the collective settlement, below the remittance result information NC4.

As a non-limiting example, in the settlement result information NC6, the amount of the settlement result (in this example, payment of the remittance amount “500 yen” remitted by the user A.A to the user C.C) is displayed as the content of the collective settlement due to collective settlement being performed between the user A.A and the user C.C.

That is, according to an embodiment, even if the money reception/full-selection collective settlement button or the money reception/collective settlement button BT18 is tapped in the remittance result information NC4, the remittance is not immediately received. Reception of the remitted amount is suspended once (suspension of reception of remittance, suspension of money reception), and settlement is performed all together by including the remitted amount in the content of the collective settlement.

Note that the remittance may be canceled upon the elapse of a certain amount of time from when the server 10 transmitted the remittance result information. Conversely, remittance may be forcibly completed.

Note that in FIG. 18-1, when the money reception/collective settlement button BT18 is tapped, a notification screen indicating that the user A.A will pay the collective settlement amount “500 yen” when settlement is performed may optionally be displayed on the display 24 of the terminal 20A, and execution of reception of remittance and collective settlement of the selected unprocessed requests may optionally be requested based on the approval of the user A.A.

### Processing

FIG. 18-4 is a flow chart showing an example of the flow of processing executed by each device according to an embodiment.

If it is determined in A131 that an unprocessed request has been selected (A131: YES), the controller 21 of the terminal 20A sets the remittance receipt information relating to reception of remittance in the first remittance processing and the unprocessed request selection information as the request selection information (A332).

On the other hand, if it is determined that no unprocessed request has been selected (A131: NO), the controller 21 of the terminal 20A sets the remittance reception information as the request selection information (A333).

Note that the processing of A333 is executed only if reception of remittance was explicitly selected in A131, and if it is not selected, the controller 21 of the terminal 20A may optionally end the processing.

After A332 or A333, the controller 21 of the terminal 20A moves the processing to A140.

If it is determined in S141 that the unprocessed requests are to be processed (S141: YES), the controller 11 of the server 10 selects the remittance (remittance from the user B.B to the user A.A) and collective settlement of the unprocessed requests as the collective settlement targets (S342). Then, the controller 11 of the server 10 moves the processing to S150.

On the other hand, if it is determined that the unprocessed request is not to be processed (S141: NO), the controller 11 of the server 10 moves the processing to S310b. That is, the second remittance processing is executed.

Then, the controller 11 of the server 10 moves the processing to S170.

The controller 21 of the terminal 20B executes the processing of B150 to B190.

Then, the controller 21 of the terminal 20B ends the processing.

### Effect of Twentieth Embodiment

This embodiment shows a configuration in which the terminal 20 of the proposing user receives incomplete remittance result information from the partner user (a non-limiting example of first information relating to remittance from the first user to the user of the terminal) from the server 10 via the communication I/F 22.

Also, the terminal 20 of the proposing user displays, on the display 24, a first display based on received incomplete remittance result information (a non-limiting example of the first display), and based on the reception of the remittance result information, displays, on the display 24, a second display (a non-limiting example of a second display) based on received remittance request information (a non-limiting example of second information relating to a remittance request transmitted from the second user to the user of the terminal) or transmitted remittance request information (a non-limiting example of second information relating to a remittance request transmitted from the user of the terminal to the second user).

Then, the terminal 20 of the proposing user executes, with the controller 21, first processing relating to remittance or money reception (a non-limiting example of reception of remittance) based on input performed by the proposing user to the terminal 20 on which the first display and the second display are displayed.

As an example of the effect of the embodiment obtained by such a configuration, it is possible to easily and appropriately perform the first processing relating to remittance or relating to reception of remittance based on the input to the terminal on which the first display and the second display are displayed.

Also, in this case, the first processing includes processing for, after the first display is displayed on the display 24, receiving an amount remitted from the partner user (a non-limiting example of processing for receiving an amount remitted from the first user to the user of the terminal) based on an operation of receiving remittance (a non-limiting example of input to the terminal on which the first display is displayed).

As an example of the effect of the embodiment obtained by such a configuration, it is possible to receive the amount remitted from the first user based on the input to the terminal on which the first display is displayed.

Also, this embodiment shows a configuration in which the partner user is one user (a non-limiting example of the second user being the first user), and the first processing includes processing in which an amount based on a received remittance request information and a transmitted remittance request information is remitted to the partner user or is received from the partner user.

As an example of the effect of the embodiment obtained by such a configuration, the amount based on the first information and the second information can be remitted to or received from the first user.

Also, in this case, the first processing can include processing in which an amount obtained by subtracting the remittance request amount included in the transmitted remittance request information from the remittance request amount included in the received remittance request information is remitted to the partner user, or an amount obtained by subtracting the remittance request amount included in the received remittance request information from the remittance request amount included in the transmitted remittance request information is received from the partner user.

As an example of the effect of the embodiment obtained by such a configuration, an amount corresponding to the difference can be remitted to or received from the first user.

Also, in this case, the first processing can be executed based on the approval of the partner user, which is based on input to the terminal 20 of the partner user.

As an example of the effect of the embodiment obtained by such a configuration, the first processing can be executed based on approval given by the first user, which is based on input to the terminal of the first user. As a non-limiting example, this makes it possible to prevent the first processing from being executed against the will of the first user.

### Twentieth Modified Example

In relation to the above embodiment, “money reception” in the new processing targets in the table of FIG. 16-1 can also be changed to “suspension of money reception”.

In this case, it is possible to perform processing of any of the following patterns:
Suspension of money reception+received remittance request
Suspension of money reception+transmitted remittance request
Suspension of money reception+received remittance request+transmitted remittance request

The processing of these patterns is the same as the processing of patterns (a) to (c), respectively. This is because the only difference is whether the remitted amount is received immediately or after some time has passed.

### Twenty-First Embodiment

The twenty-first embodiment is an embodiment relating to processing of the above-described pattern (d).

The content described in the twenty-first embodiment can also be applied to any of the other embodiments and the other modified examples.

Moreover, constituent elements that are the same as constituent elements that have already appeared are denoted by the same reference signs thereas, and redundant description thereof is omitted.

In the pattern of (d) reception of remittance request+received remittance request, processing of (d1) remittance [remittance+remittance] can be performed. That is, remittance to the partner user is performed when a remittance request is received from the partner user, and remittance to the partner user is performed based on a received remittance request from the partner user.

### Display Screen

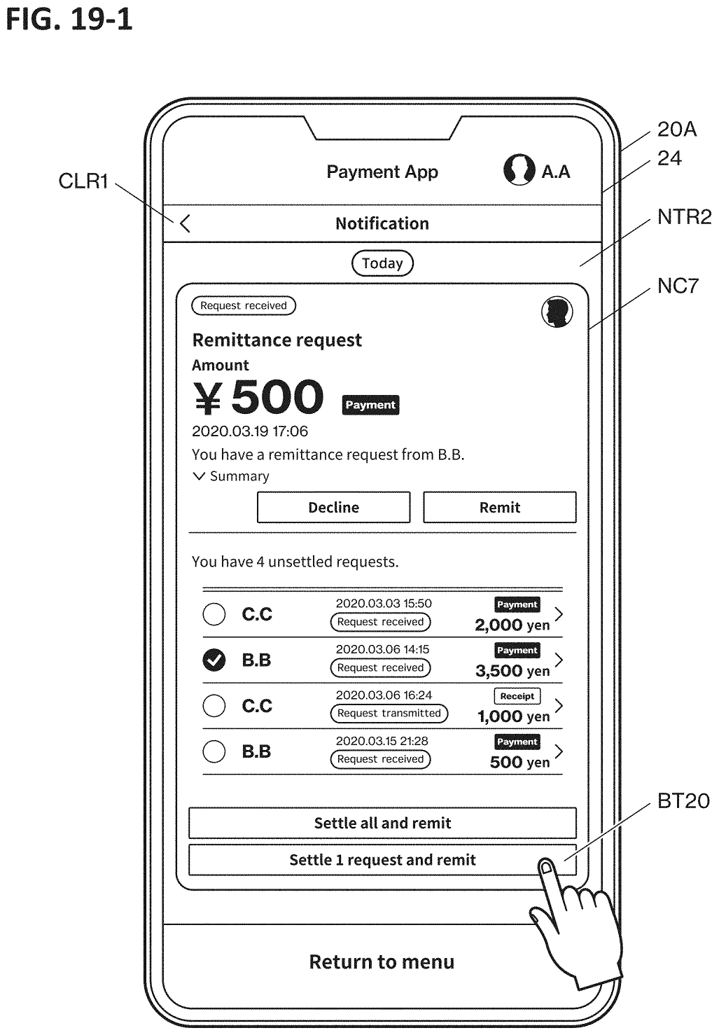

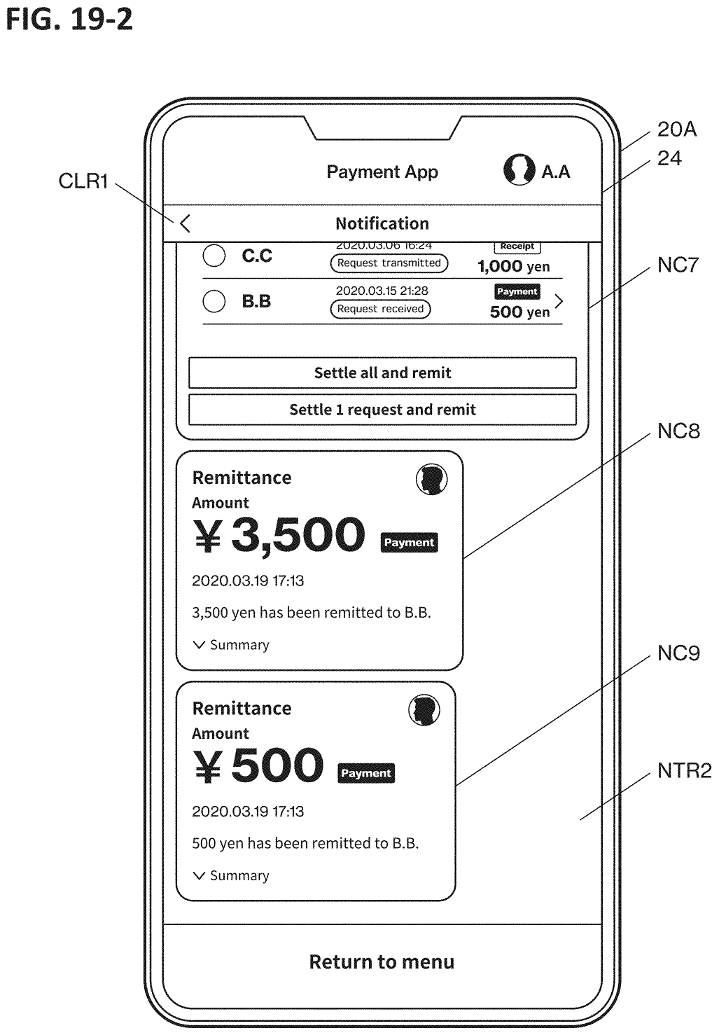

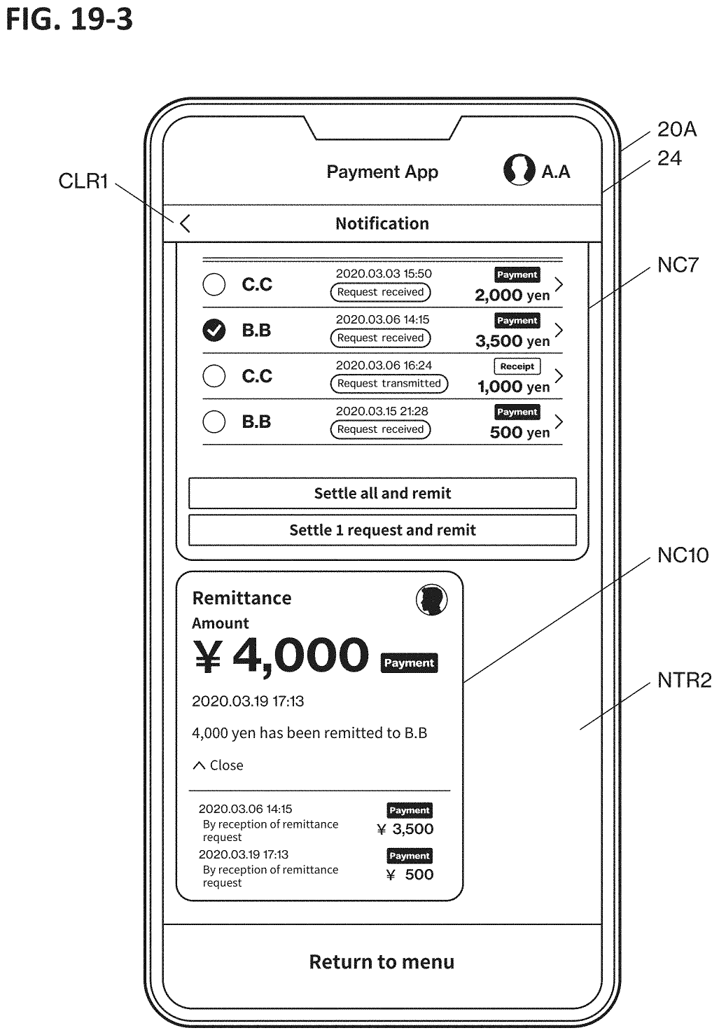

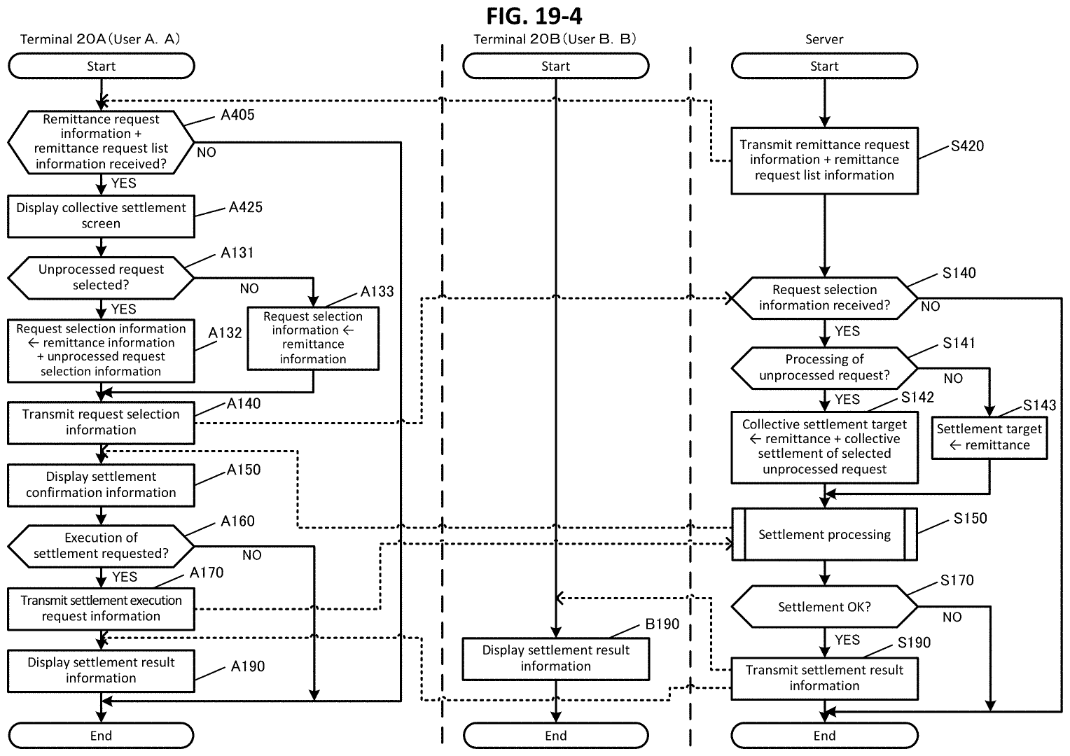

FIG. 19-1 is a diagram showing an example of a screen displayed on the display 24 of the terminal 20 according to an embodiment. This screen is, in a non-limiting example, a notification screen of the payment application displayed on the display 24 of the terminal 20A of the user A.A.

In the notification information display region NTR2 of the notification screen, remittance request information NC7 is displayed as content relating to reception of request remittance.

In the remittance request information NC7, in a non-limiting example, content corresponding to a remittance request for a remittance request amount “500 yen”, which was received by the user A.A from the user B.B, is displayed. Also, in the remittance request information NC7, a remittance request/remittance button indicated as “Remit”, which is for approving this remittance request and performing remittance, and a remittance request declining button indicated as “Decline”, which is for declining this remittance request, are displayed.

Below that, a list of remittance requests that have not been processed by the user who received the remittance request (the user A.A in this example) when the remittance request was received are displayed. In a non-limiting example, the display mode of unprocessed requests can be configured in the same manner as in FIG. 16-2, and therefore detailed description thereof will be omitted.

Note that as unprocessed requests, only the unprocessed requests between the user who received the remittance request (the user A.A in this example) and the user who transmitted the remittance request (the user B.B in this example) may optionally be displayed.

At the bottom of the remittance request information NC7, a remittance request remittance/full-selection collective settlement button indicated as “Settle all and remit”, which is for executing remittance and full-selection collective settlement according to this remittance request, is displayed. Also, next to the remittance request remittance/full-selection collective settlement button, a remittance request remittance/partial-selection collective settlement button BT20 indicated as “Settle 1 request and remit”, which is for executing remittance according to this remittance request and partial-selection collective settlement of the unprocessed requests selected by the user among the unprocessed requests displayed in the remittance request information NC7, is displayed.

In a non-limiting example, in the remittance result information NC7, when the request check for the second received remittance request (payment of 3,500 yen to the user B.B) is set to “ON” and selected, and the remittance request remittance/partial-selection collective settlement button BT20 is tapped, the terminal 20A requests the server 10 to execute collective settlement of the selected unprocessed requests. Then, the server 10 transmits settlement result information relating to the execution result to the terminal 20B of the user B.B, who is the partner, and the terminal 20A of the user A.A, who is the proposer.

FIG. 19-2 is a diagram showing an example of a notification screen displayed on the display 24 of the terminal 20A when the remittance request remittance/partial-selection collective settlement button BT20 is tapped.

In this example, settlement result information NC8 and settlement result information NC9 are displayed as the content of collective settlement below the remittance request information NC7 in the notification information display region NTR2 of the notification screen.

In the settlement result information NC8, in a non-limiting example, information relating to the fact that the user A.A has executed remittance of the remittance amount “3,500 yen” to the user B.B through settlement relating to payment of the remittance request amount “3,500 yen” according to a past remittance request from the user B.B is displayed.

In the settlement result information NC9, in a non-limiting example, information relating to the fact that the user A.A has executed remittance of the remittance amount “500 yen” to the user B.B through settlement relating to payment of the remittance request amount “500 yen” according to this remittance request from the user B.B is displayed.

Note that the settlement result information displayed on the terminal 20B of the user B.B is displayed with a list of unprocessed requests of the user B.B added according to the display mode of the remittance result information NC1, as well as the display of remittance reception from the user A.A.

FIG. 19-3 is another example of the display screen of FIG. 19-2.

In this example, in the notification information display region NTR2 of the notification screen, the settlement result information NC10 is displayed as the content of the collective settlement below the remittance request information NC7.

In a non-limiting example, in the settlement result information NC10, it is displayed that, due to collective settlement being performed between the user A.A and the user B.B, as the collective settlement amount, the user A.A has paid (remitted) “1,000 yen”, which is obtained by adding the remittance request amount “3,500 yen” according to a past remittance request, and the remittance request amount of “500 yen” according to the reception of this remittance request, to the user B.B.

Note that in the settlement result information displayed on the terminal 20B of the user B.B, the content of the collective settlement may optionally be summarized and displayed as one piece of settlement result information.

### Processing

FIG. 19-4 is a flow chart showing an example of the flow of processing executed by each device according to an embodiment.

Based on the request from terminal 20B, the controller 11 of the server 10 transmits remittance request information from the user B.B and remittance request list information to the terminal 20A through the communication I/F 14 (S420).

Then, the controller 11 of the server 10 moves the processing to S140.

The controller 21 of the terminal 20A determines whether or not remittance request information and remittance request list information have been received from the server 10 via the communication I/F 22 (A405), and if it is determined that they have been received (A405: YES), the collective settlement screen including these pieces of information is displayed on the display 24 (A425).

If it is determined in A131 that an unprocessed request has been selected (A131: YES), the controller 21 of the terminal 20A moves the processing to A132. That is, request selection information including remittance information relating to remittance based on the received remittance request information and unprocessed request selection information indicating the selected unprocessed request is set.

On the other hand, if it is determined in A131 that an unprocessed request has not been selected (A131: NO), the controller 21 of the terminal 20A moves the processing to A133. That is, request selection information including remittance information relating to remittance based on the received remittance request information is set.

Note that the description of this processing is premised on remittance being performed based on the received remittance request information.

In actuality, although it may be possible to choose to process only unprocessed requests without performing remittance based on the received remittance request information, the processing in such a case is the same as the above-described processing for collective settlement of unprocessed requests, and therefore illustration and redundant description thereof are omitted.

If it is determined in S141 that processing of an unprocessed request is to be performed (S141: YES), the controller 11 of the server 10 moves the processing to S142.

On the other hand, if it is determined in S141 that processing of an unprocessed request will not be performed (S141: NO), the controller 11 of the server 10 moves the processing to S143.

### Effect of Twenty-first Embodiment

This embodiment shows a configuration in which the first information is remittance request information relating to a remittance request that is received from the partner user, the second information is received remittance request information relating to a remittance request received from the partner user, and the first processing includes processing for performing remittance to the partner user based on input to the terminal 20 displaying the first display and the second display.

As an example of the effect of the embodiment obtained by such a configuration, it is possible to easily perform remittance to the first user and the second user based on the input to the terminal displaying the first display and the second display.

Also, in this case, the partner user can be one user, and the first processing can include processing for performing remittance to the partner user based on the input to the terminal 20 displaying the first display and the second display.

As an example of the effect of the embodiment obtained by such a configuration, one user (the first user) can easily perform remittance as the partner user based on the input to the terminal displaying the first display and the second display.

### Twenty-Second Embodiment

The twenty-second embodiment is an embodiment relating to processing of the above-described pattern (e).

The content described in the twenty-second embodiment can also be applied to any of the other embodiments and the other modified examples.

Moreover, constituent elements that are the same as constituent elements that have already appeared are denoted by the same reference signs thereas, and redundant description thereof is omitted.

In the pattern of (e) reception of remittance request+transmitted remittance request, processing of either (e1) remittance+remittance reminder or (e2) [remittance+money reception] (amount deductible) can be performed.

In the processing of (e1), remittance to the partner user is performed when a remittance request is received from the partner user, and a remittance reminder is performed as well based on a transmitted remittance request to the partner user.

Note that in this case, a new remittance request may optionally be issued instead of the remittance reminder.

In the processing of (e2), remittance to the partner user is performed when a remittance request is received from the partner user, and remittance is received from the partner user based on a transmitted remittance request to the partner user. In this case, it is possible to remit/receive an amount corresponding to the difference in the remittance request amounts. Also, if the remittance request amounts are the same amount, it is possible to cancel out the amounts.

Note that in this case, the approval of the partner user may optionally be required.

### Display Screen

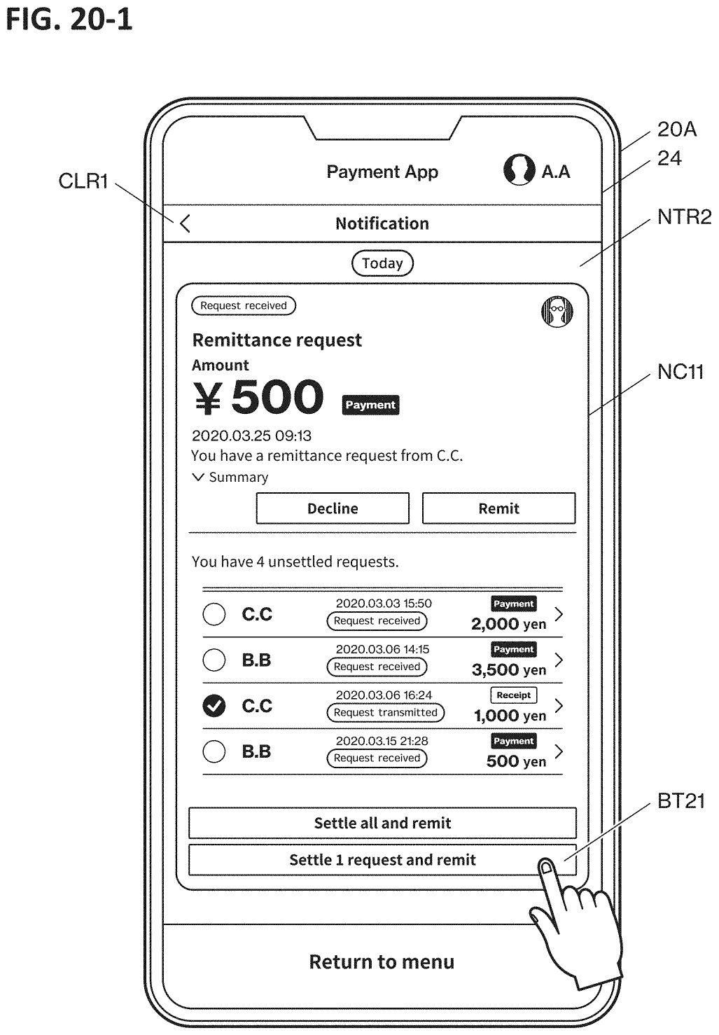

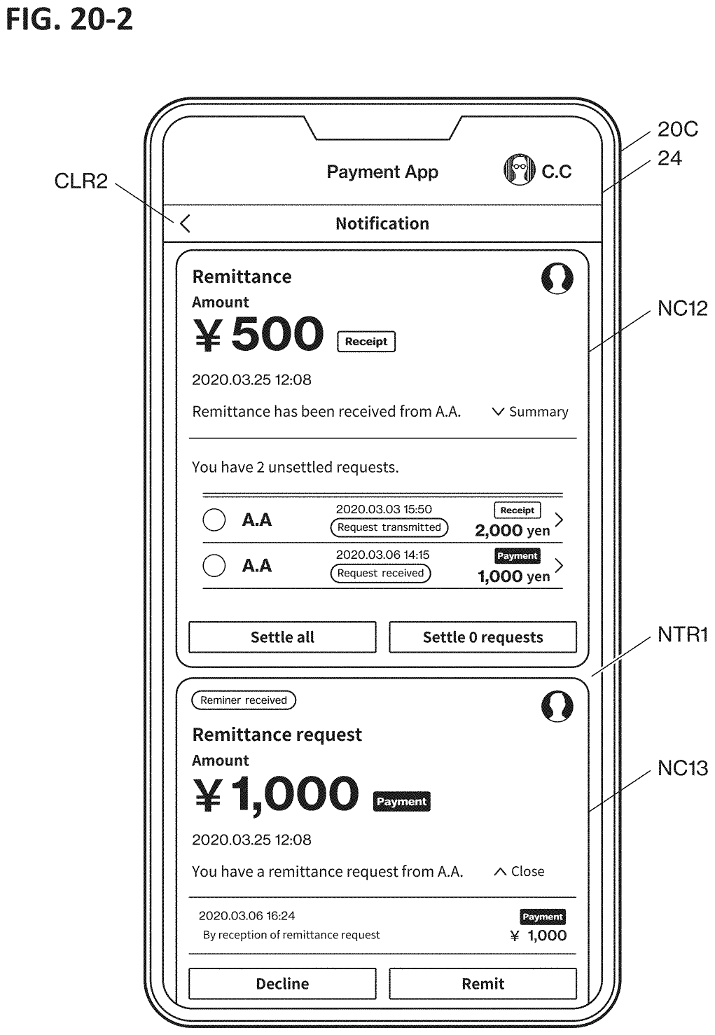

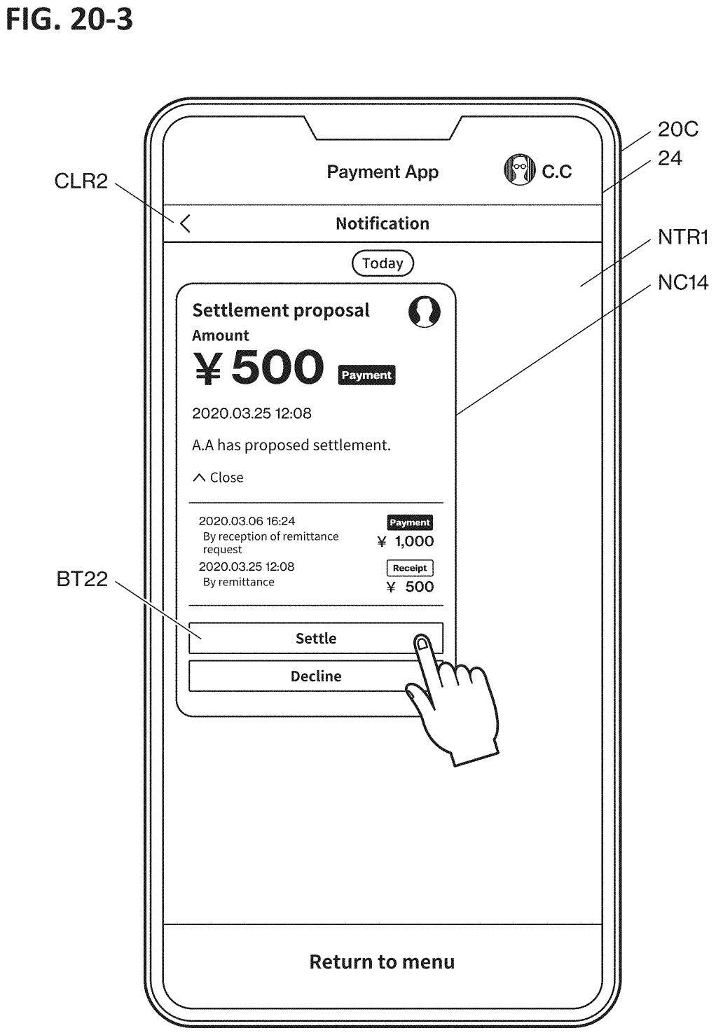

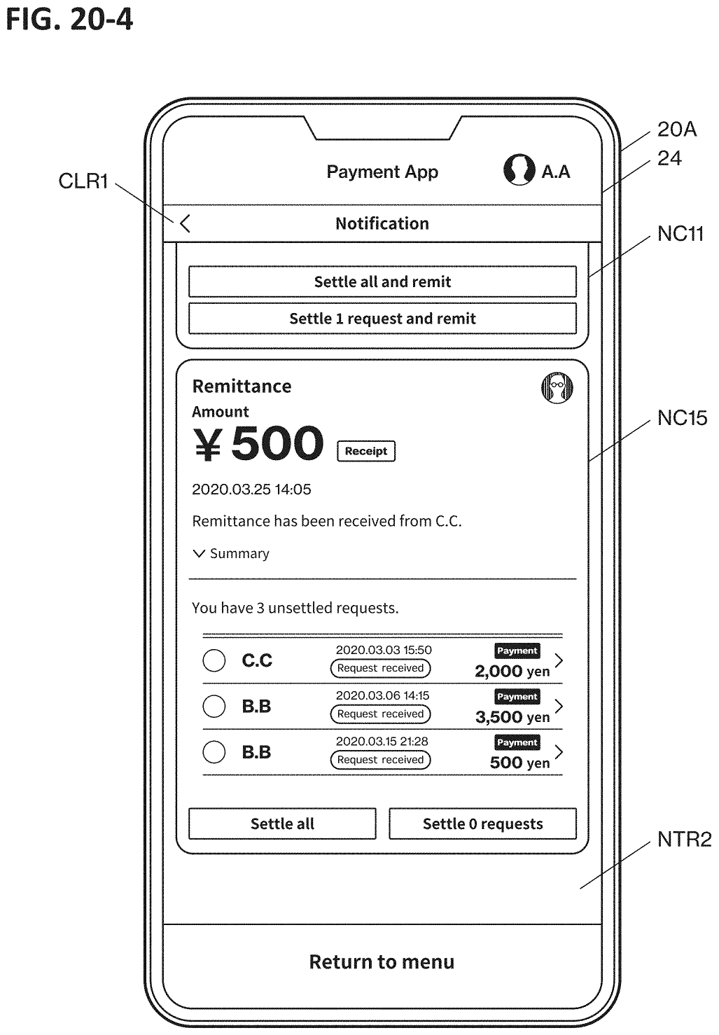

FIG. 20-1 is a diagram showing an example of a screen displayed on the display 24 of the terminal 20 according to an embodiment. This screen is, in a non-limiting example, a notification screen of the payment application displayed on the display 24 of the terminal 20A of the user A.A. As for the details of the screen configuration, in a non-limiting example, the screen can be configured in the same manner as in FIG. 19-1 in the case where the transmitter of the remittance request is the user C.C, and therefore description of the details thereof is omitted.

Note that here, the remittance request information in the case where the transmitter of the remittance request is the user C.C is remittance request information NC11.

In a non-limiting example, in the remittance request information NC11, when the request check for the third transmitted remittance request (receipt of 1,000 yen from the user C.C) is set to “ON” and selected, and a remittance request remittance/partial-selection collective settlement button BT21 is tapped, the terminal 20A requests the server 10 to execute collective settlement of the selected unprocessed requests. Then, the server 10 transmits settlement result information relating to the execution result to the terminal 20C of the user C.C, who is the partner, and the terminal 20A of the user A.A, who is the proposer.

FIG. 20-2 is a diagram showing an example of a notification screen displayed on the display 24 of the terminal 20E when the above-described remittance request remittance/partial-selection collective settlement button BT21 is tapped.

In this example, settlement result information NC12 and settlement result information NC13 are displayed in the notification information display region NTR1 of the notification screen as content of the collective settlement.

In the settlement result information NC12, in a non-limiting example, it is displayed that the user C.C has received the remittance request amount “500 yen” according to a remittance request to the user A.A based on this remittance request. Below that, it is displayed that there are two unprocessed requests for the user C.C, as a non-limiting example.

In a non-limiting example, the settlement result information NC13 displays a reminder corresponding to the third remittance request selected in FIG. 20-1 (a remittance request for the remittance request amount “1,000 yen” transmitted by the user A.A to the user C.C).

FIG. 20-3 is another example of the display screen of FIG. 20-2.

In FIG. 20-3, when the third transmitted remittance request (1,000 yen received from the user C.C) is selected in the remittance request information NC11, and the remittance request remittance/partial-selection collective settlement button BT21 is tapped, the terminal 20A requests the server 10 to execute collective settlement of the selected unprocessed requests. Then, the server 10 transmits collective settlement approval confirmation information for confirming whether or not to approve collective settlement to the terminal 20C of the user C.C, who is the partner, and displays the collective settlement approval confirmation information on the display 24 of the terminal 20C.

In FIG. 20-3, in the notification information display region NTR1 of the notification screen, collective settlement approval confirmation information NC14 is displayed instead of settlement result information NC12 and settlement result information NC13.

In the collective settlement approval confirmation information NC14, as the content of the collective settlement, it is displayed that the user C.C will pay the remittance request amount “1,000 yen” based on the reception of the past remittance request from the user A.A, and will receive the remittance request amount “500 yen” based on the reception of the current remittance request to the user A.A.

Also, in the collective settlement approval confirmation information NC14, as the collective settlement amount, it is displayed that the user C.C will pay “500 yen”, which is obtained by subtracting the remittance request amount “500 yen” according to the transmission of the current remittance request from the remittance request amount “1,000 yen” according to the reception of the remittance request from the user A.A.

FIG. 20-4 is a diagram showing an example of a notification screen displayed on the display 24 of the terminal 20A when the settlement button BT22 in FIG. 20-3 is tapped.

In this example, in the notification information display region NTR2 of the notification screen, the settlement result information NC15 is displayed as the content of the collective settlement below the remittance request information NC11.

In a non-limiting example, due to collective settlement being performed between the user A.A and the user C.C, in the settlement result information NC15, the amount of the settlement result (in this example, receipt of the remittance amount “500 yen” remitted to the user A.A from the user C.C) is displayed as the content of this collective settlement.

Also, below the content of collective settlement, unprocessed requests for the user A.A are displayed, and below that, a full-selection collective settlement button and a partial-selection collective settlement button are displayed.

As a non-limiting example, the unprocessed requests displayed in the settlement result information NC15 are three remittance requests from which the third transmitted remittance request processed this time among the unprocessed requests displayed in the remittance request information NC11 has been excluded (deleted).

### Processing

The processing executed by each device according to an embodiment can be realized in the same manner as the processing in FIG. 19-4, and illustration and detailed description thereof will be omitted.

### Effect of Twenty-Second Embodiment

This embodiment shows a configuration in which the first information is remittance request information relating to a remittance request transmitted from the partner user to the proposing user, and the second information is transmitted remittance request information relating to a transmitted remittance request from the proposing user to the partner user.

As an example of the effect of the embodiment obtained by such a configuration, processing based on a remittance request from the first user to the user of the terminal and a remittance request transmitted from the user of the terminal to the second user can be performed all together.

Also, in this case, the first processing can include processing for performing remittance to the partner user and transmitting a remittance reminder or a new remittance request to the partner user based on input to the terminal 20 on which the first display and the second display are displayed.

Also, the partner user can be one user, and the first processing can be processing for transmitting or receiving, to or from the partner user, an amount based on the remittance request information relating to the remittance request transmitted from the partner user to the proposing user and the transmitted remittance request information relating to the remittance request transmitted from the proposing user to the partner user.

As an example of the effect of the embodiment obtained by such a configuration, an amount based on the first information and the second information can be remitted to or received from the first user.

Also, in this case, the first processing can include processing for transmitting, to the partner user, an amount obtained by subtracting a remittance request amount included in transmitted remittance request information relating to a remittance request transmitted from the proposing user to the partner user, from a remittance request amount included in remittance request information relating to a remittance request transmitted from the partner user to the proposing user, or receiving, from the partner user, an amount obtained by subtracting a remittance request amount included in remittance request information relating to a remittance request transmitted from the partner user to the proposing user, from a remittance request amount included in transmitted remittance request information relating to a remittance request transmitted from the proposing user to the partner user.

As an example of the effect of the embodiment obtained by such a configuration, an amount corresponding to the difference can be remitted to or received from the first user.

Also, in this case, the first processing can be executed based on approval given by the partner user, which is based on input to the terminal 20 of the partner user.

As an example of the effect of the embodiment obtained by such a configuration, the first processing can be executed based on approval given by the first user, which is based on input to the terminal of the first user. As a non-limiting example, this makes it possible to prevent the first processing from being executed against the will of the first user.

### Twenty-Third Embodiment

The twenty-third embodiment is an embodiment relating to processing of a pattern different from the above-described patterns.

The content described in the twenty-third embodiment can be applied to any of the other embodiments and the other modified examples.

Also, constituent elements that are the same as constituent elements that have already appeared are denoted by the same reference signs thereas, and redundant description thereof is omitted.

In addition to the patterns described above, in a non-limiting example, processing of patterns of combinations of new processing targets in the table of FIG. 16-1, that is, the pattern of
Money reception+reception of remittance request

can also be performed.

The processing of this pattern is the same as the processing of pattern (a). That is, it is possible to perform the processing of “money reception+remittance”.

### Effect of Twenty-Third Embodiment

This embodiment shows a configuration in which the first information is remittance result information from the partner user (a non-limiting example of information relating to remittance from the first user to the user of the terminal), and the terminal 20 of the proposing user receives remittance request information relating to a remittance request transmitted from the partner user to the proposing user via the communication I/F 22, and displays a third display based on the received remittance request information on the display 24. Then, the terminal 20 of the proposing user executes remittance processing (a non-limiting example of second processing) with the controller 21 based on input performed by the proposing user to the terminal 20 displaying the third display.

As an example of the effect of the embodiment obtained by such a configuration, it is possible to perform second processing relating to remittance based on input performed by the user of the terminal to the terminal displaying the third display.

### Twenty-Fourth Embodiment

The twenty-fourth embodiment is an embodiment relating to processing of a pattern different from the above-described patterns.

The content described in the twenty-fourth embodiment can be applied to any of the other embodiments and the other modified examples.

Also, constituent elements that are the same as constituent elements that have already appeared are denoted by the same reference signs thereas, and redundant description thereof is omitted.

In addition to the patterns described above, in a non-limiting example, processing of patterns of combinations of unprocessed requests in the table of FIG. 16-1, that is, the pattern of
Received remittance request+transmitted remittance request

can also be performed.

The processing of this pattern is the same as the processing of pattern (e). That is, it is possible to perform either “remittance+remittance reminder” or “[remittance+money reception] (amount deductible)”.

Note that when performing the processing of “[remittance+money reception] (amount deductible)”, the approval of the partner user may optionally be required, and the approval of the partner user may optionally be obtained.

### Effect of Twenty-Fourth Embodiment

This embodiment shows a configuration in which the second information is received remittance request information relating to a remittance request received from the partner user, and a fourth display based on transmitted remittance request information relating to a remittance request transmitted from the proposing user to the partner user is displayed on the display 24 when the remittance request is received from the partner user. Then, based on input performed by the proposing user to the terminal 20 on which the second display and the fourth display are displayed, the controller 21 performs third processing relating to remittance, money reception, or a remittance request (remittance reminder).

As an example of the effect of the embodiment obtained by such a configuration, based on input performed by the user of the terminal to the terminal on which the second display and the fourth display are displayed, the controller can perform third processing relating to remittance, reception of remittance, or a remittance request.

Also, in this case, the third processing can include processing for performing remittance to the partner user and transmitting a remittance request or a remittance reminder to the partner user based on input regarding the second display and the fourth display.

As an example of the effect of the embodiment obtained by such a configuration, remittance to the second user and a remittance request to the second user can be performed together.

Also, this embodiment shows a configuration in which the partner user is one user, and the third processing includes processing in which an amount based on received remittance request information and transmitted remittance request information is remitted to or received from the partner user.

As an example of the effect of the embodiment obtained by such a configuration, an amount based on the second information and the fourth information can be remitted to or received from the second user.

Also, in this case, the third processing can include processing in which an amount obtained by subtracting a remittance request amount included in transmitted remittance request information from a remittance request amount included in received remittance request information is remitted to the partner user, or an amount obtained by subtracting a remittance request amount included in received remittance request information from a remittance request amount included in transmitted remittance request information is remitted by the partner user.

As an example of the effect of the embodiment obtained by such a configuration, an amount corresponding to a difference can be remitted to or received from the second user.

Also, in this case, third processing can be executed based on approval given by the partner user, which is based on input to the terminal 20 of the partner user.

As an example of the effect of the embodiment obtained by such a configuration, the third processing can be executed based on approval given by the second user, which is based on input to the terminal of the second user. Accordingly, in a non-limiting example, it is possible to prevent the third processing from being executed against the second user's will.

### Twenty-Fifth Embodiment

The twenty-fifth embodiment is an embodiment relating to processing of a pattern different from the above-described patterns.

The content described in the twenty-fifth embodiment can be applied to any of the other embodiments and the other modified examples.

Also, constituent elements that are the same as constituent elements that have already appeared are denoted by the same reference signs thereas, and redundant description thereof is omitted.

In a non-limiting example, “money reception” among the new processing targets in the table of FIG. 16-1 can also be changed to “declining money reception”.

“Declining money reception” means preventing the remittance destination user from receiving a remitted amount.

In this case, it is possible to perform processing of any of the following patterns.
Declining money reception+received remittance request
Declining money reception+transmitted remittance request
Declining money reception+received remittance request+transmitted remittance request.

In the pattern of declining money reception+received remittance request, it is possible to perform only processing for remittance.

In the pattern of declining money reception+transmitted remittance request, it is possible to perform only processing for transmitting a remittance reminder (or a new remittance request).

In the pattern of declining money reception+received remittance request+transmitted remittance request, it is possible to perform the processing of [remittance+money reception] (amount deductible).

### Twenty-Sixth Embodiment

The twenty-sixth embodiment relates to a method of displaying remittance request information.

The content described in the twenty-sixth embodiment can be applied to any of the other embodiments and the other modified examples.

Also, constituent elements that are the same as constituent elements that have already appeared are denoted by the same reference signs thereas, and redundant description thereof is omitted.

### Display Screen

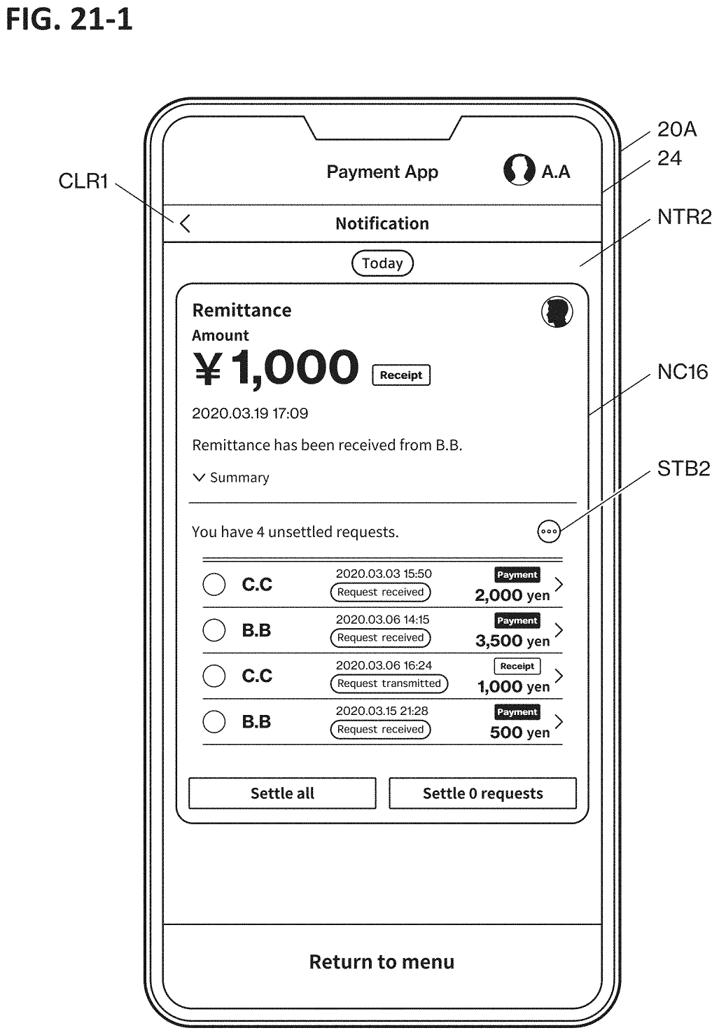

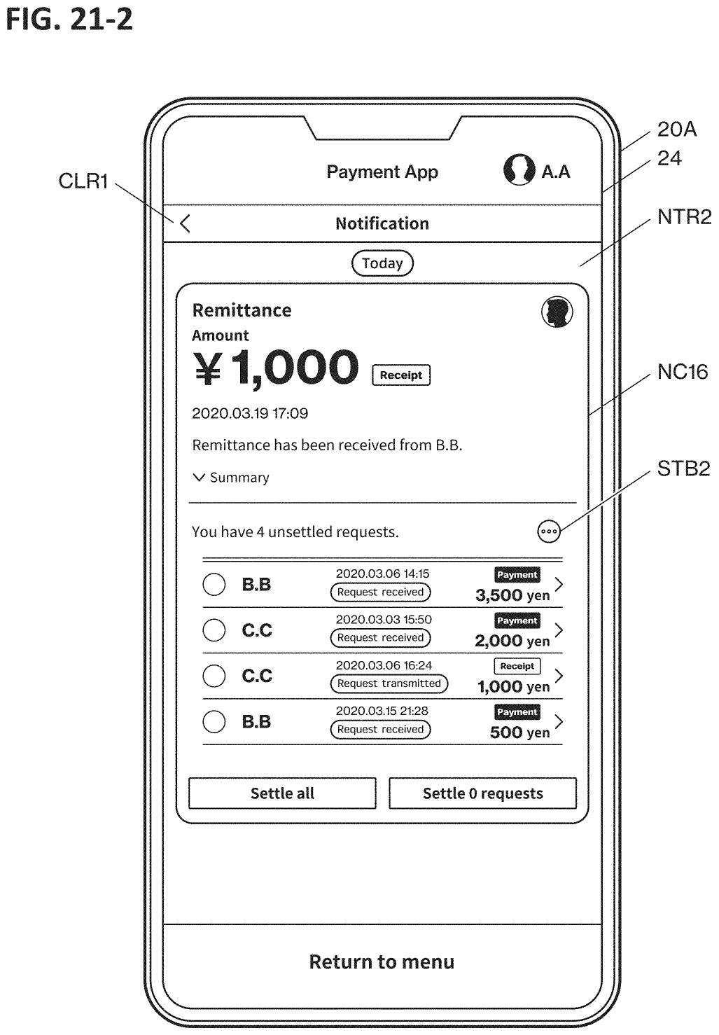

FIG. 21-1 is a diagram showing an example of a screen displayed on the display 24 of the terminal 20 according to an embodiment. This screen is, in a non-limiting example, a notification screen of the payment application displayed on the display 24 of the terminal 20A of the user A.A.

Remittance result information NC16 is displayed in the notification information display region NTR2 of the notification screen as content relating to reception of remittance (money reception).

In the remittance result information NC16, as a non-limiting example, content corresponding to reception of the remittance amount “1,000 yen” received by the user A.A from the user B.B is displayed.

Below that, a list of remittance requests that have not been processed by the user who received the remittance (the user A.A in this example) when the remittance was received is displayed. A remittance request history sort button STB2 for changing the display order of unprocessed remittance requests is displayed at the upper right part of the remittance request list display. Other display modes are the same as the remittance result information NC1.

When the remittance request history sort button STB2 is touched, in a non-limiting example, a sort selection region for selecting the sort order is displayed rising from the lower part of the screen.

Based on a user operation on the sort selection region, it is possible to perform display with the display order of unprocessed remittance requests rearranged in ascending or descending order according to the dates when the remittance requests were transmitted/received, the remittance request amounts of the remittance requests, or the like.

Note that is also possible to rearrange and display the display order of the unprocessed remittance requests in order of the dates and times when the remittance requests were transmitted/received instead of in order of the dates when the remittance requests were transmitted/received.

FIG. 21-2 is a diagram showing, as a non-limiting example, an example of a display screen when the unprocessed remittance requests of the remittance result information NC16 have been rearranged in descending order of remittance request amount based on a user operation on the sort selection region.

In FIG. 21-1, the unprocessed remittance requests in the remittance result information NC16 are arranged in ascending order of date, but in FIG. 21-2, they are rearranged in descending order of remittance request amount.

Note that when a payment deadline is set for a remittance request, in a non-limiting example, the remittance requests may optionally be displayed in the order of the closeness to the payment deadline. Setting payment deadlines includes not only personal (C to C) payments, but also setting repayment deadlines for loans from financial institutions (C to B) in a non-limiting example.

Also, a remittance request in which a user other than the user who performed the remittance request and the user who received the remittance request is involved in the remittance request amount or reason may be displayed with priority. In a non-limiting example, this is a case where another user is included as a member of a split bill.

Also, although the remittance result information and the remittance request information have been described as displaying unprocessed remittance requests, there is no limitation to this. In a non-limiting example, processed remittance requests may optionally be displayed in a different display mode, such as grayed out, together with unprocessed remittance requests.

### Effect of Twenty-Sixth Embodiment

This embodiment shows a configuration in which the terminal 20 of the proposing user displays, on the display 24, a fourth display based on remittance request information relating to a received remittance request received by the proposing user from the partner user (a non-limiting example of fourth information relating to a remittance request transmitted from the second user to the user of the terminal), or remittance request information relating to a transmitted remittance request transmitted by the proposing user to the partner user (a non-limiting example of fourth information relating to a remittance request transmitted from the user of the terminal to the second user). Then, the terminal 20 of the proposing user displays the second display and the fourth display on the display 24 in an order based on the above-described second information and the above-described fourth information.

As an example of the effect of the embodiment obtained by such a configuration, the second display and the fourth display can be displayed in an appropriate order based on the second information and the fourth information.

Also, this embodiment shows a configuration in which the above-described second information and the fourth information include information relating to a date when a remittance request was transmitted/received (a non-limiting example of information relating to the date), or information relating to a date and time when a remittance request was transmitted/received (a non-limiting example of information relating to the date and time), and the order in which the second display and the fourth display are displayed is determined based on the information relating to the date or the date and time.

As an example of the effect of the embodiment obtained by such a configuration, by displaying the second display and the fourth display in the order based on the information relating to the date and time or the date, it is possible to realize a display that is intuitively understandable for the user.

Also, the present embodiment shows a configuration in which the above-described second information and the fourth information include information relating to the amount for which remittance is requested (a non-limiting example of information relating to the amount), and the order in which the second display and the fourth display are displayed is determined based on information relating to this amount.

As an example of the effect of the embodiment obtained by such a configuration, by displaying the second display and the fourth display in the order based on the information relating to the amount, it is possible to realize a display that is intuitively understandable for the user.

Also, in this case, the information relating to the amount for which remittance is requested can include information relating to a payment deadline as a non-limiting example, in addition to the remittance request amount.

As an example of the effect of the embodiment obtained by such a configuration, by displaying the second display and the fourth display in the order based on the information relating to the payment deadline, it is possible to realize a display that is intuitively understandable for the user.

### Twenty-Seventh Embodiment

The twenty-seventh embodiment is an embodiment in which a chat service (chat application) is applied.

The content described in the twenty-seventh embodiment can be applied to any of the other embodiments and the other modified examples.

Also, constituent elements that are the same as constituent elements that have already appeared are denoted by the same reference signs thereas, and redundant description thereof is omitted.

### Display Screen

In the following, the user A.A, the user B.B, and the user C.C, who are users of both the messaging application and the payment application, all belong to group X and are registered as friends.

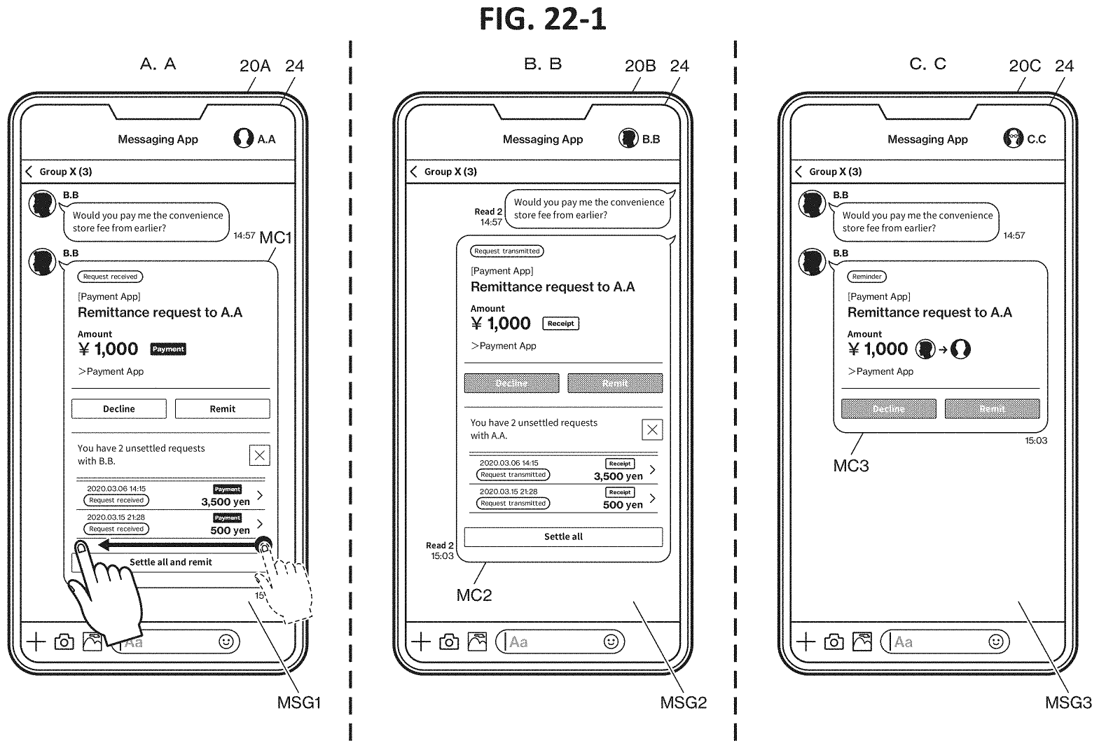

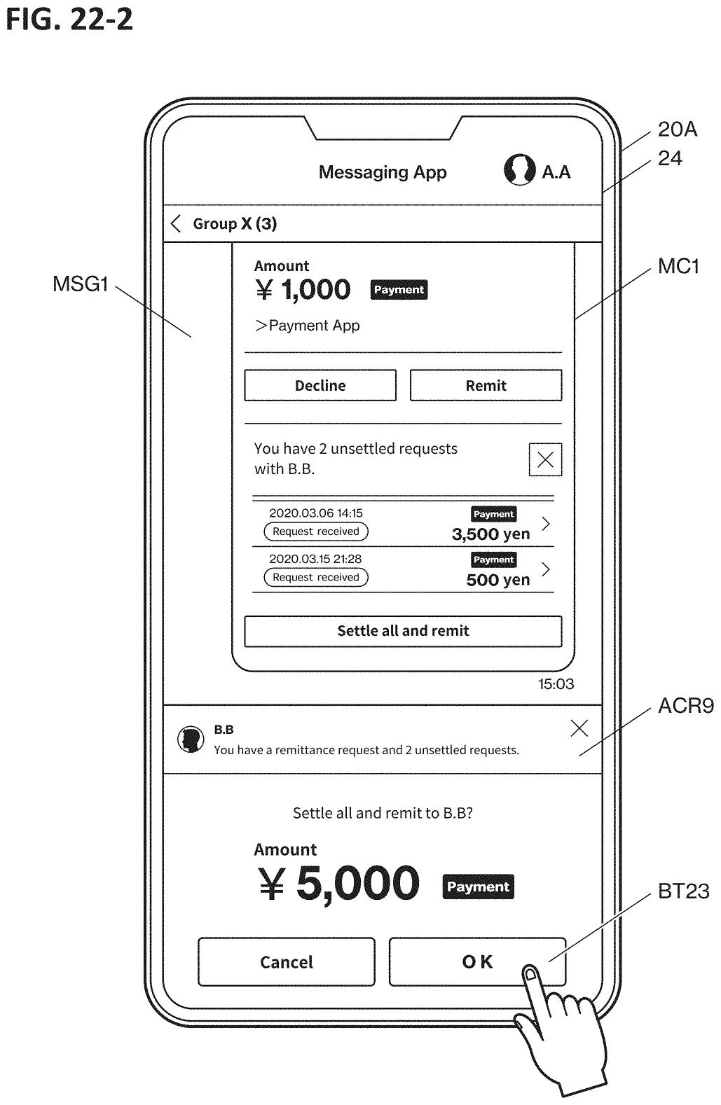

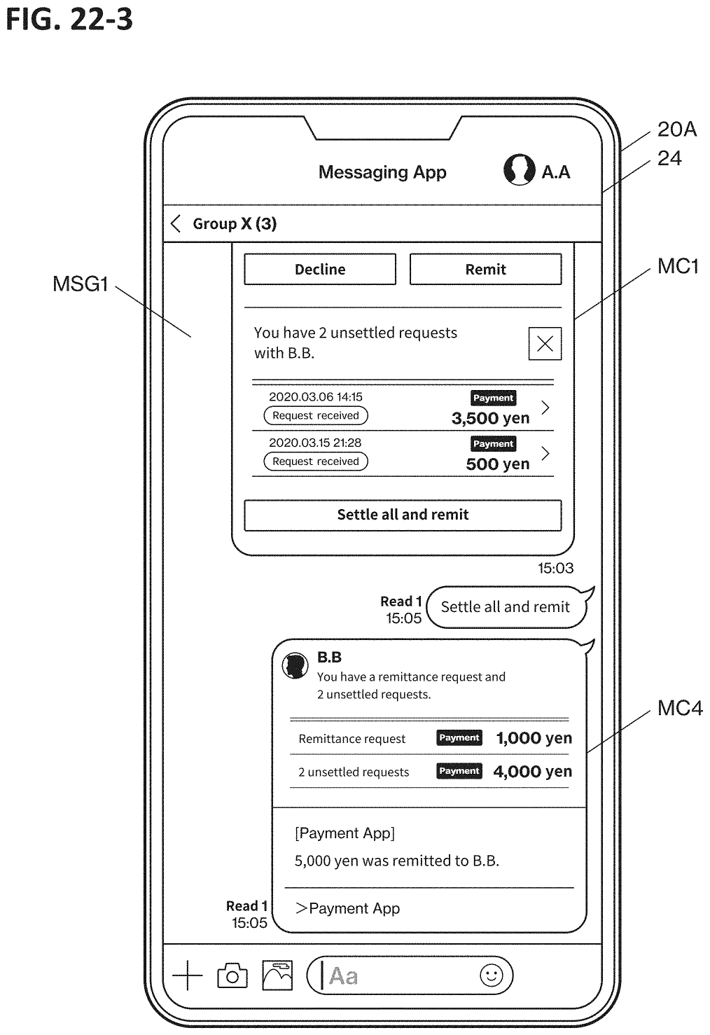

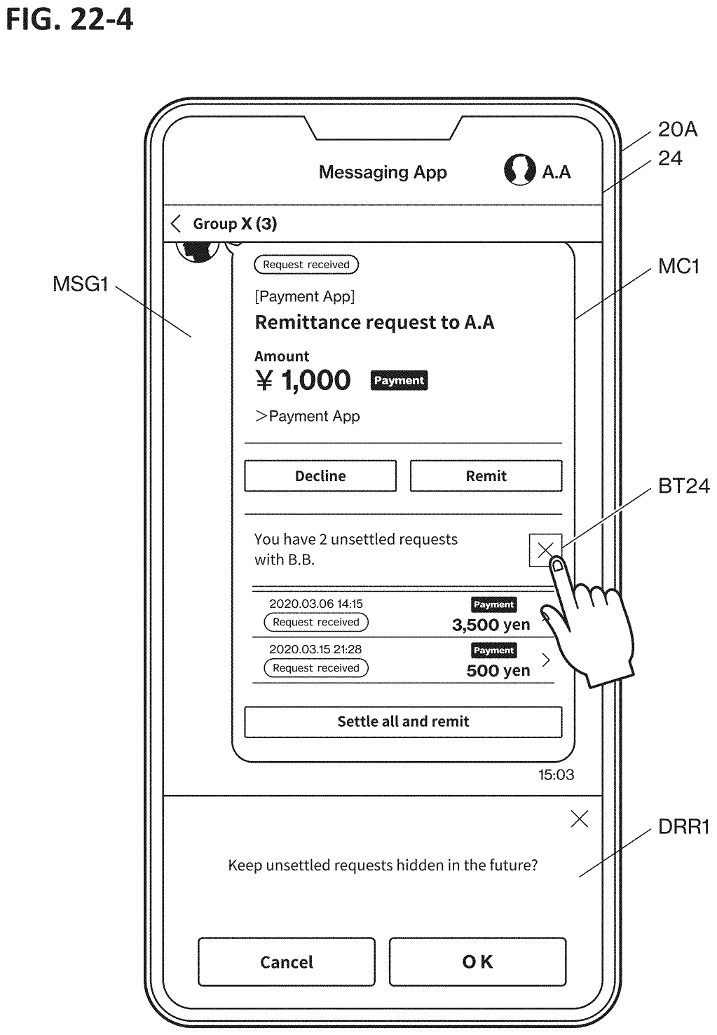

FIG. 22-1 is a diagram showing an example of a screen displayed on the displays 24 of the terminals 20A to 20C according to an embodiment. This screen is, in a non-limiting example, a messaging application group chat (in this example, “Group X” chat) screen displayed on the display 24 of the terminal 20 of each user.

At the top center of the screen, the words “Messaging App” are displayed as the name of the messaging application. Also, the icon image and user name of the messaging application of the user of the terminal 20 are displayed at the upper right part of the screen.

Also, below that, a current location display region that indicates the current location in the messaging application is included, and the words “Group X”, which indicate that the current location is the group chat for “Group X” in the messaging application, are displayed in the current location display region.

Below the current location display region, a message display region, which is a display region for group chat messages (content), is displayed. The message display regions on the displays 24 of the terminals 20A to 20C are message display regions MSG1 to MSG3, respectively.

In the message display region, a message transmitted from the terminal is displayed as a balloon from the right side, and a message received from a terminal other than the terminal is displayed as a balloon from the left side together with the transmitter's icon.

In a non-limiting example, a case is considered in which the user B.B makes a remittance request for a remittance request amount “1,000 yen” to the user A.A with, in a non-limiting example, a remittance request transmission function in the messaging application.

Then, the remittance request information MC1 is displayed in the message display region MSG1 of the terminal 20A.

In the remittance request information MC1, as a non-limiting example, content corresponding to a remittance request for a remittance request amount “1,000 yen”, which is received by the user A.A from the user B.B, are displayed. Below that, a remittance request/remittance button and a remittance request declining button are displayed.

Below that, a list of unprocessed remittance requests between the user who sent the remittance request (the user B.B in this example) and the user who received the remittance request (the user A.A in this example) at the time when the remittance request was received are listed.

At the bottom of the remittance request information MC1, a remittance request remittance/full-selection collective settlement button indicated as “Settle all and remit”, which is for executing remittance according to this remittance request and full-selection collective settlement, is displayed.

Also, remittance request information MC2 is displayed in the message display region MSG2 of the terminal 20B.

In the remittance request information MC2, as a non-limiting example, content corresponding to the remittance request for the remittance request amount “1,000 yen”, which was transmitted by the user B.B to the user A.A, is displayed. Also, below that, a remittance request remittance button and a remittance request declining button are disabled and displayed in a grayed-out display mode.

Below that, a list of unprocessed remittance requests between the user who sent the remittance request (the user B.B in this example) and the user who received the remittance request (the user A.A in this example) at the time when the remittance request was received is displayed.

At the bottom of the remittance request information MC2, a full-selection collective settlement button indicated as “Settle all”, which is for executing full-selection collective settlement, is displayed.

Remittance request information MC3 is displayed in the message display region MSG3 of the terminal 20C.

In the remittance request information MC3, in a non-limiting example, content corresponding to the remittance request for the remittance request amount “1,000 yen” transmitted by the user B.B to the user A.A is displayed. Also, below that, a remittance request remittance button and a remittance request declining button are disabled and displayed in a grayed-out display mode.

Below that, a list of unprocessed remittance requests between the user who sent the remittance requests (the user B.B in this example) and the user who received the remittance requests (the user A.A in this example) is not displayed since the user C.C is not an involved party in these remittance requests.

Note that unprocessed remittance requests of parties other than the involved parties may optionally be displayed in the remittance request information.

FIG. 22-2 is, in a non-limiting example, a diagram showing an example of a screen that is displayed on the display 24 of the terminal 20A when the remittance request information MC1 is swiped (subjected to a swipe operation) (an operation of sliding a finger while touching the screen) from right to left by a user operation.

In FIG. 22-2, as a non-limiting example, the settlement content confirmation region ACR9 is displayed rising from the lower part of the display 24 of the terminal 20A in FIG. 22-1.

At the upper part of the settlement content confirmation region ACR9, a display is performed, which indicates that the user A.A has received a remittance request from the user B.B and two unprocessed remittance requests (unsettled requests) with the user B.B remain.

Also, at the lower part of the settlement content confirmation region ACR9, a confirmation display is displayed, which indicates that when remittance request remittance/full-selection collective settlement is performed with the user B.B, the user A.A will pay “5,000 yen”, which is obtained by adding the remittance request amount “1,000 yen” received this time, and the remittance request amounts of “3,500 yen” and “500 yen” received previously, as the amount of collective settlement. Below that, a remittance request remittance/full-selection collective settlement button BT23 indicated as “OK”, which is for executing remittance request remittance/full-selection collective settlement, and a cancel button indicated as “Cancel”, which is for canceling remittance request remittance/full-selection collective settlement, are displayed.

Note that the settlement content confirmation region ACR9 may optionally be displayed also when the remittance request remittance/full-selection collective settlement button of the remittance request information MC1 is tapped.

FIG. 22-3 is a diagram showing an example of a screen displayed on the display 24 of the terminal 20A when the remittance request remittance/full-selection collective settlement button BT23 is tapped in the settlement content confirmation region ACR9 in FIG. 22-2.

In FIG. 22-3, in the message display region MSG1, remittance result information MC4 is displayed based on the remittance result of the remittance processing according to the remittance request and the remittance processing according to full-selection collective settlement, below the remittance request information MC1.

At the upper part of the remittance result information MC4, as the content of performing settlement, it is displayed that the user A.A has paid (remitted) a remittance request amount “1,000 yen” and has paid “4,000 yen” as the amount of collective settlement of the unprocessed remittance requests to the user B.B.

At the lower part of the remittance result information MC4, it is displayed that the user A.A has remitted “5,000 yen”, which is the sum of the remittance request amount “1,000 yen” and the amount “4,000 yen” for collective settlement, as the amount of settlement.

Note that the display corresponding to the remittance result information MC4 may optionally be displayed on a terminal 20 other than the terminals 20A and 20B.

Also, the terminal 20 other than the terminals 20A and 20B, which are the involved parties, may optionally display only the remittance result corresponding to the lower part of the remittance result information MC4.

FIG. 22-4 is a diagram showing an example of a screen when unprocessed remittance requests are hidden in the remittance request information MC1.

As a non-limiting example, when the user taps an unprocessed request hiding button BT24 indicated by an X mark in the remittance request information MC1, an unprocessed request display cancellation confirmation region DRR1 is displayed rising from the lower part of the message display region MSG1.

In the unprocessed request display cancellation confirmation region DRR1, an unprocessed request display cancellation button indicated as “OK”, which is for hiding a list of unprocessed requests with the user (e.g., the user B.B) who performed the remittance requests (remittance) in the remittance request information or the remittance result information when remittance or a remittance request is made, and an unprocessed request display approval button indicated as “Cancel”, which is for continuing the list display, are displayed.

In a non-limiting example, when a user taps the unprocessed request display cancellation button in the unprocessed request display cancellation confirmation region DRR1, the list of unprocessed remittance requests with that user (e.g., the user B.B) is no longer displayed in the remittance request information and the remittance result information received thereafter.

Similarly, if the user B.B taps the unprocessed request hide button in the remittance request information MC2 and then taps the unprocessed request display cancellation button in the unprocessed request display cancel confirmation region, a list of unprocessed remittance requests with the user A.A will no longer be displayed in the remittance request information and remittance result information received thereafter.

Note that when the unprocessed request display cancellation button in the unprocessed request display cancellation confirmation region is tapped, a list of unprocessed remittance requests may optionally no longer be displayed in the remittance request information and remittance result information received thereafter with all users.

That is, according to an embodiment, the unprocessed requests can be hidden based on input performed by the user of the terminal 20 to the input device.

Note that instead of doing the above, as described above, setting of the display/non-display of unprocessed requests may optionally be performed on a setting screen (not shown) or the like.

### Effect of Twenty-Seventh Embodiment

This embodiment shows a configuration in which the terminal 20 of the proposing user displays, on the display 24, a talk room (a non-limiting example of the chat room) that includes at least the proposing user (a non-limiting example of the user of the terminal) and the partner user (a non-limiting example of the first user). Then, the first display and the second display are displayed in this talk room.

As an example of the effect of the embodiment obtained by such a configuration, it is possible to notify the user of the terminal of the first information and the second information in an easy-to-understand form such as display in a chat room.

Also, in this case, the second display displayed in the talk room can be hidden based on input performed by the proposing user to the terminal 20.

As an example of the effect of the embodiment obtained by such a configuration, it is possible to ensure a large space for the display region.

Also, in this case, the talk room can include a user other than the involved parties (a non-limiting example of a third user), and the second display can be displayed in the talk room displayed on the terminal 20 of the user other than the involved parties.

As an example of the effect of the embodiment obtained by such a configuration, a third user who is a user other than the involved parties can be prevented from viewing the second display that is based on the second information relating to a remittance request transmitted from the second user to the user of the terminal or a remittance request transmitted from the user of the terminal to the second user, that is, information relating to the users involved in the remittance.

Also, in this case, the talk room displayed on the terminal 20 of the user other than the involved parties includes a fifth display that is different from the second display and is based on remittance request information relating to a remittance request transmitted by the user other than the involved parties, or remittance request information relating to a remittance request transmitted to the user other than the involved parties. Then, the fifth display can be prevented from being displayed in the talk room displayed on the terminal 20 of the proposing user.

As an example of the effect of the embodiment obtained by such a configuration, the user of the terminal can be prevented from viewing a fifth display that is different from the second display and is based on fifth information relating to a remittance request transmitted from the third user or a remittance request transmitted to the third user, that is, information in which the third user is an involved party in the remittance.

Also, in this case, the first display can be prevented from being displayed in the talk room displayed on the terminal 20 of the user other than the involved parties.

As an example of the effect of the embodiment obtained by such a configuration, the third user can be prevented from browsing a first display that is based on first information relating to remittance from the first user to the user of the terminal or a remittance request transmitted from the first user to the user of the terminal, that is, information relating to the users who are the involved parties in the remittance.

Also, this embodiment shows a configuration in which the first display and the second display are displayed on the display 24 by a messaging application installed in the terminal 20 of the proposing user, and the messaging application is included in the program according to the present disclosure.

As an example of the effect of the embodiment obtained by such a configuration, an application installed in the terminal can display the first display and the second display on the display of the terminal.

### Others

In the above embodiment, received remittance request information and transmitted remittance request information were illustrated as unprocessed information relating to a remittance request.

However, even if these pieces of information are replaced with remittance reminder information, the same processing as in the above embodiment can be applied. That is, the received remittance reminder information and the transmitted remittance reminder information can also be applied as the unprocessed information relating to the remittance request without distinguishing between the remittance request and the remittance reminder.

This is because the remittance request and the remittance reminder can be treated as being synonymous with each other.

Also, the remittance request information and the remittance reminder information can be combined as appropriate. That is, the following four combinations are applicable as combinations of received information and transmitted information.

(1) First Combination
Received: Remittance request information
Transmitted: Remittance request information

This combination is the combination described in the above embodiments.

(2) Second Combination
Received: Remittance request information
Transmitted: Remittance reminder information

(3) Third Combination
Received: Remittance reminder information
Transmitted: Remittance request information

(4) Fourth Combination
Received: Remittance reminder information
Transmitted: Remittance reminder information

The embodiments of the present disclosure have been shown and described above with reference to the accompanying drawings. The embodiments disclosed in the specification and drawings are only intended to provide specific examples for easily describing the technical content of the disclosure and for assisting understanding of the disclosure, and are not intended to limit the scope of the disclosure. It will be understood by those of ordinary skill in the art that the present disclosure may be easily modified into other detailed forms without changing the technical principle or essential features of the present disclosure, and without departing from the gist of the disclosure as claimed by the appended claims and their equivalents. Therefore, it should be interpreted that the scope of the disclosure includes all changes or modifications derived based on the technical idea of the disclosure in addition to the embodiments disclosed herein.

What is claimed is:

1. An information processing method performed by a terminal, the method comprising:
displaying, on a display of the terminal, at least a first screen based on first information relating to a remittance request from a first user to a user of the terminal or a remittance request from a user of the terminal to the first user, and a second screen based on second information relating to a remittance request from a second user to the user of the terminal or a remittance request from the user of the terminal to the second user; and
based on input to the terminal on which the first screen and the second screen are displayed, performing, by a controller of the terminal, first processing based on the first information and the second information first screen second screen.

2. The method according to claim 1,
wherein the first information comprises information relating to the remittance request from the first user to the user of the terminal, and
the second information comprises information relating to the remittance request from the user of the terminal to the second user.

3. The method according to claim 2,
wherein the first information comprises information on a first amount relating to remittance, and
the second information comprises information on a second amount relating to remittance.

4. The method according to claim 3,
wherein the first processing comprises processing based on the first amount and the second amount.

5. The method according to claim 2, further comprising:
transmitting, by a communication part of the terminal, information relating to an approval of execution of the first processing to a terminal of the second user,
wherein the first processing is executed by the controller based on approval to execute the first processing given by the second user based on the information relating to the approval.

6. The method according to claim 1,
wherein the second user is the first user.

7. The method according to claim 6,
wherein the first information comprises information relating to the remittance request from the user of the terminal to the first user,
the second information comprises information relating to a remittance request from the first user to the user of the terminal,
the first information comprises information on a first amount relating to remittance,
the second information comprises information on a second amount relating to remittance, and
the first processing comprises processing for remitting a third amount obtained by subtracting the first amount from the second amount to the first user if the second amount is greater than the first amount.

8. The method according to claim 1,
wherein the first user is a different user from the second user.

9. The method according to claim 1,
wherein the first information comprises information on a first amount relating to remittance,
the second information comprises information on a second amount relating to remittance, and
the first processing is performed by the controller based on the first amount, the second amount, and a balance of the user of the terminal.

10. The method according to claim 9,
wherein if a sum of the first amount and the second amount exceeds the balance and remittance is to be performed from the user of the terminal, the terminal displays a third screen indicating that the first processing is not executable, on the display.

11. The method according to claim 9,
wherein if a sum of the first amount and the second amount exceeds the balance and remittance is to be performed from the user of the terminal, the terminal displays a fourth screen indicating addition of money to the balance, on the display.

12. The method according to claim 9,
wherein the terminal displays the first screen, the second screen, and another display relating to adding money to the balance or relating to a loan, on the display.

13. The method according to claim 9,
wherein the terminal displays a fifth screen relating to execution of the first processing, on the display, and
a display mode of the fifth screen is changed based on the first amount, the second amount, and the balance.

14. The method according to claim 13,
wherein if a sum of the first amount and the second amount exceeds the balance and remittance is to be performed from the user of the terminal, the fifth screen is displayed on the display in a display mode indicating that the first processing is not executable.

15. The method according to claim 13,
wherein the first processing is executed based on input performed by the user of the terminal regarding the fifth screen and approval of the first user or the second user relating to execution of the first processing.

16. The method according to claim 13,
wherein the first processing is executed based on the balance of the user of the terminal and a balance of the first user or the second user.

17. The method according to claim 9,
wherein in the first processing, processing based on the first information and the second information is executed based on input performed by the user of the terminal to the terminal, among a plurality of pieces of information relating to a remittance request to the user of the terminal or a remittance request performed by the user of the terminal, the plurality of pieces of information comprising at least the first information and the second information.

18. The method according to claim 17,
wherein the first information and the second information are information on the same amount, and
the first processing is processing for canceling out the first information and the second information based on the first information and the second information.

19. The method according to claim 17,
wherein the first processing comprises processing for selecting at least the first information and the second information among the plurality of pieces of information based on the balance of the user of the terminal, the processing being performed based on at least the first information and the second information.

20. The method according to claim 17,
wherein the second user is the first user, and
the first processing comprises processing for displaying, on the display, a sixth display based on third information relating to the remittance request from the first user to the user of the terminal or the remittance request from the user of the terminal to the first user, which is obtained by adding together an amount of the first information and the second information.

21. The method according to claim 9,
wherein the terminal executes second processing for processing at least one piece of information based on the balance of the user of the terminal, among a plurality of pieces of information relating to a remittance request to the user of the terminal or a remittance request performed by the user of the terminal.

22. The method according to claim 21,
wherein the second processing comprises processing for selecting information that is processable with the balance of the user of the terminal among the plurality of pieces of information, and the selected information is processed.

23. The method according to claim 22,
wherein the second user is the first user, and
the first processing comprises processing relating to remittance from the first user to the user of the terminal or processing relating to remittance from the user of the terminal to the first user.

24. The method according to claim 23,
wherein the processing relating to remittance comprises displaying, on the display, information indicating that processing of a remittance request based on the first information and processing of a remittance request based on the second information have been executed.

25. A non-transitory computer readable medium for storing computer readable program code or instructions which are executable by a processor to perform a method, the method comprising:
displaying, on a display of a terminal, at least a first screen based on first information relating to a remittance request from a first user to a user of the terminal or a remittance request from a user of the terminal to the first user, and a second screen based on second information relating to a remittance request from a second user to the user of the terminal or a remittance request from the user of the terminal to the second user; and
based on input to the terminal on which the first screen and the second screen are displayed, performing, by a controller of the terminal, first processing based on the first information and the second information first screen second screen.

26. A terminal, comprising:
a display configured to display at least a first screen based on first information relating to a remittance request from a first user to a user of the terminal or a remittance request from a user of the terminal to the first user, and a second screen based on second information relating to a remittance request from a second user to the user of the terminal or a remittance request from the user of the terminal to the second user; and
a controller configured to perform first processing based on input to the terminal on which the first screen and the second screen are displayed, the first processing being based on the first information and the second information.
